(19) United States
(12) Patent Application Publication
(10) Pub. No.: US 2023/0385815 A1
(43) Pub. Date: Nov. 30, 2023

(54) Systems and Methods for Facilitating Access to Token Content

(71) Applicant: Artema Labs, Inc, Los Angeles, CA (US)

(72) Inventors: Bjorn Markus Jakobsson, New York, NY (US); Keir Finlow-Bates, Eura (FI); Kenneth Rosen, Portola Valley, CA (US)

(73) Assignee: Artema Labs, Inc, Los Angeles, CA (US)

(21) Appl. No.: 18/323,344

(22) Filed: May 24, 2023

Related U.S. Application Data
(60) Provisional application No. 63/365,269, filed on May 24, 2022.
(60) Provisional application No. 63/374,340, filed on Sep. 1, 2022.
(60) Provisional application No. 63/375,663, filed on Sep. 14, 2022.
(60) Provisional application No. 63/376,417, filed on Sep. 20, 2022.
(60) Provisional application No. 63/377,508, filed on Sep. 28, 2022.
(60) Provisional application No. 63/477,286, filed on Dec. 27, 2022.

(51) Int. Cl. G06Q 20/38; G06Q 20/02

(52) U.S. Cl. CPC G06Q 20/3825; G06Q 20/02

(57) ABSTRACT

Systems and techniques to facilitate content access within an NFT platform are illustrated. One embodiment includes a method for content security. The method receives a request from a requesting party, wherein the request includes: information about a transaction to be performed, a reference to a token corresponding to the transaction, and an address of a receiving party corresponding to the transaction. The method recovers, from a smart contract associated with the token, at least one address list, wherein: the at least one address list comprises a token banlist, and the token banlist comprises at least one address banned from receiving the token. The method determines whether the address of the receiving party is listed on the token banlist. When the address of the receiving party is listed on the token banlist, the method transmits a transaction rejection to the requesting party.

### CROSS-REFERENCE TO RELATED APPLICATIONS

The current application claims the benefit of and priority under 35 U.S.C. § 119(e) to U.S. Provisional Patent Application No. 63/365,269 entitled “Directed Acyclic Token Structure,” filed May 24, 2022, U.S. Provisional Patent Application No. 63/374,340 entitled “Token Access Structure with Social Overlay,” filed Sep. 1, 2022, U.S. Provisional Patent Application No. 63/375,663 entitled “NFTs that Own Assets,” filed Sep. 14, 2022, U.S. Provisional Patent Application No. 63/376,417 entitled “Access Management Through Time-limited NFTs,” filed Sep. 20, 2022, U.S. Provisional Patent Application No. 63/377,508 entitled “NFT Contract with Banlist and Allowlist to Enforce Honoring of Royalties,” filed Sep. 28, 2022, and U.S. Provisional Patent Application No. 63/477,286 entitled “AI Guided Content Creation,” filed Dec. 27, 2022, the disclosures of which are hereby incorporated by reference in their entireties for all purposes.

### FIELD OF THE INVENTION

The present invention generally relates to systems enabling and securing token and token content access.

### BACKGROUND

Non-fungible tokens (NFTs) provide a means for access management within computer systems. This provides computer services and information vendors with an opportunity to sell NFTs as ownable assets providing access to particular content. NFTs and other forms of tokens representing content, along with token-based derived works and configurable royalty policies, have the capability to bolster a number of industries including but not limited to art, music, and textual creations. Limiting token access is often used to encourage the creation of art and content, through privacy protection. For example. within token-directed environments, resale of tokens may enable content creators to obtain royalties when content is accessed.

### SUMMARY OF THE INVENTION

Systems and techniques to facilitate content access within an NFT platform are illustrated. One embodiment includes a method for content security. The method receives a request from a requesting party, wherein the request includes: information about a transaction to be performed, a reference to a token corresponding to the transaction, and an address of a receiving party corresponding to the transaction. The method recovers, from a smart contract associated with the token, at least one address list, wherein: the at least one address list comprises a token banlist, and the token banlist comprises at least one address banned from receiving the token. The method determines whether the address of the receiving party is listed on the token banlist. When the address of the receiving party is listed on the token banlist, the method transmits a transaction rejection to the requesting party.

In a further embodiment: the at least one address list further includes a token allowlist; and the token allowlist includes at least one address approved for receiving the token.

In a further embodiment, the method determines whether the address of the receiving party is listed on the token allowlist.

In a still further embodiment, when the address of the receiving party is listed on the token allowlist: the method transmits an approval to the requesting party; and allows token access to at least one of the requesting party and the receiving party.

In another further embodiment, when the address of the receiving party is not listed on the token allowlist and the token allowlist, the method makes an independent determination of whether to approve the transaction.

In a still further embodiment, making the independent determination includes transmitting the request to an external authority, wherein the external authority is at least one selected from the group consisting of an owner of the smart contract, a marketplace administrator, and an agent of the owner of the smart contract.

In another further embodiment, making the independent determination includes reviewing a record of the receiving party for paying token royalty rates.

In still another further embodiment, the method adds the address of the receiving party to at least one of the token banlist and the token allowlist, based on the independent determination.

In another embodiment, the transaction is selected from the group consisting of a self-dealing transaction and a transfer transaction. The self-dealing transaction: is a transaction where the requesting party is also the receiving party; and is at least one selected from the group consisting of: a minting of the token; a derivation of the token; and an importation of the token, wherein the requesting party is a token marketplace. The transfer transaction is a transaction wherein the requesting party is an owner of the token, and the receiving party is a consumer of the token.

In yet another embodiment, the token banlist includes a registry of token marketplaces known to ignore enforcement of royalty payments.

One embodiment includes a non-transitory computer-readable medium for content security, wherein the program instructions are executable by one or more processors to perform a process. The process receives a request from a requesting party, wherein the request includes: information about a transaction to be performed, a reference to a token corresponding to the transaction, and an address of a receiving party corresponding to the transaction. The process recovers, from a smart contract associated with the token, at least one address list, wherein: the at least one address list comprises a token banlist, and the token banlist comprises at least one address banned from receiving the token. The process determines whether the address of the receiving party is listed on the token banlist. When the address of the receiving party is listed on the token banlist, the process transmits a transaction rejection to the requesting party.

In a further embodiment: the at least one address list further includes a token allowlist; and the token allowlist includes at least one address approved for receiving the token.

In a further embodiment, the process determines whether the address of the receiving party is listed on the token allowlist.

In a still further embodiment, when the address of the receiving party is listed on the token allowlist: the process transmits an approval to the requesting party; and allows token access to at least one of the requesting party and the receiving party.

In another further embodiment, when the address of the receiving party is not listed on the token allowlist and the token allowlist, the process makes an independent determination of whether to approve the transaction.

In a still further embodiment, making the independent determination includes transmitting the request to an external authority, wherein the external authority is at least one selected from the group consisting of an owner of the smart contract, a marketplace administrator, and an agent of the owner of the smart contract.

In another further embodiment, making the independent determination includes reviewing a record of the receiving party for paying token royalty rates.

In still another further embodiment, the process adds the address of the receiving party to at least one of the token banlist and the token allowlist, based on the independent determination.

In another embodiment, the transaction is selected from the group consisting of a self-dealing transaction and a transfer transaction. The self-dealing transaction: is a transaction where the requesting party is also the receiving party; and is at least one selected from the group consisting of: a minting of the token; a derivation of the token; and an importation of the token, wherein the requesting party is a token marketplace. The transfer transaction is a transaction wherein the requesting party is an owner of the token, and the receiving party is a consumer of the token.

In yet another embodiment, the token banlist includes a registry of token marketplaces known to ignore enforcement of royalty payments.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 is a conceptual diagram of an NFT platform in accordance with an embodiment of the invention.

FIG. 2 is a network architecture diagram of an NFT platform in accordance with an embodiment of the invention.

FIG. 3 is a conceptual diagram of a permissioned blockchain in accordance with an embodiment of the invention.

FIG. 4 is a conceptual diagram of a permissionless blockchain in accordance with an embodiment of the invention.

FIGS. 5A-5B are diagrams of a dual blockchain in accordance with a number of embodiments of the invention.

FIG. 6 conceptually illustrates a process followed by a Proof of Work consensus mechanism in accordance with an embodiment of the invention.

FIG. 7 conceptually illustrates a process followed by a Proof of Space consensus mechanism in accordance with an embodiment of the invention.

FIG. 8 illustrates a dual proof consensus mechanism configuration in accordance with an embodiment of the invention.

FIG. 9 illustrates a process followed by a Trusted Execution Environment-based consensus mechanism in accordance with some embodiments of the invention

FIGS. 10-12 depicts various devices that can be utilized alongside an NFT platform in accordance with various embodiments of the invention.

FIG. 13 depicts a media wallet application configuration in accordance with an embodiment of the invention.

FIGS. 14A-14C depicts user interfaces of various media wallet applications in accordance with a number of embodiments of the invention.

FIG. 15 illustrates an NFT ledger entry corresponding to an NFT identifier.

FIGS. 16A-16B illustrate an NFT arrangement relationship with corresponding physical content in accordance with an embodiment of the invention.

FIG. 17 illustrates a process for establishing a relationship between an NFT and corresponding physical content.

FIG. 18 illustrates a block diagram of a smart contract, configured in accordance with numerous embodiments of the invention.

FIG. 19 conceptually illustrates a process for determining whether a transaction may be allowed based on inspection of a banlist and allowlist.

FIG. 20 conceptually illustrates a process for enabling token transactions through smart contracts configured in accordance with various embodiments of the invention.

FIG. 21 illustrates a physical model of a smart contract configured in accordance with many embodiments of the invention.

FIGS. 22A-22F illustrate token configurations established in accordance with numerous embodiments of the invention.

FIGS. 23 and 24 illustrates a process for transferring ownership of a token, in accordance with many embodiments of the invention.

FIG. 25 illustrates a process for generating directed acyclic graph in accordance with certain embodiments of the invention.

FIG. 26 illustrates a device 2600 for enabling the generation of directed acyclic graph configured in accordance with various embodiments of the invention.

FIG. 27 illustrates a process for granting digital content access in accordance with a number of embodiments of the invention.

FIG. 28 illustrates a block diagram of a module unit configured in accordance with some embodiments, that may be used in granting entities access to digital assets.

FIGS. 29A-29D illustrate various functions used to modify digital assets in accordance with various embodiments of the invention.

FIG. 30 illustrates an NFT smart contract capable of instantiating NFTs that may hold a plurality of token types, in accordance with numerous embodiments of the invention, is illustrated in FIG. 30.

FIG. 31 illustrates an NFT smart contract capable of updating balances of fungible token, in accordance with certain embodiments of the invention.

FIG. 32 illustrates a process for updating a balance with regard to digital assets of an NFT configured in accordance with a number of embodiments of the invention.

FIG. 33 illustrates a block diagram of a smart contract configured in accordance with many embodiments of the invention for updating digital asset balances associated with NFTs.

FIG. 34 illustrates a validity period configured in accordance with certain embodiments of the invention.

FIG. 35 illustrates a diagram of a smart contract with an NFT mapping data structure, configured in accordance with multiple embodiments of the invention.

FIG. 36 illustrates a process reflecting the flow of activity for a time-limited NFT configured in accordance with a number of embodiments of the invention.

FIG. 37 illustrates a process for facilitating content availability in accordance with many embodiments of the invention.

FIGS. 38-41 illustrate various configurations and functions of smart contract in accordance with some embodiments of the invention.

FIG. 42 illustrates a process performed by a smart contract configured in accordance with several embodiments of the invention, for managing access to an entity.

FIG. 43 illustrates a physical model of a smart contract configured in accordance with certain embodiments of the invention.

FIG. 44 illustrates the flow of explicit and implicit data through systems configured in accordance with numerous embodiments of the invention.

FIG. 45 illustrates the use of a system configured in accordance with a number of embodiments of the invention.

FIG. 46 illustrates a wallet configured in accordance with some embodiments of the invention.

FIG. 47 illustrates a system of Top-Level Digital Agents, configured in accordance with several embodiments of the invention.

### DETAILED DESCRIPTION

Systems and methods for incorporating access-directed functionalities into non-fungible token (NFT) platforms, in accordance with many embodiments of the invention, are described herein. Access-directed functionality may include, but is not limited to configurations enabling the payment of royalties, token hierarchy structures, limiting and expanding access to tokens and content, and/or artificial intelligence agents to facilitate the selection of tokens and content.

NFT platforms in accordance with a number of embodiments of the invention may enable royalty payments through allowlists and banlists that limit the capacity to own and/or transfer tokens. Through the use of smart contracts associated with tokens, entities that are unreliable with royalty payments, ranging from NFT marketplaces to individual people, may be placed on banlists that prevent the entities from performing transactions corresponding to the tokens. Additionally or alternatively, reliable parties may be added to allowlists to reflect that access to the tokens should be provided automatically.

Systems and methods in accordance with certain embodiments may establish token hierarchies that allow for tokens to directly control ownership rights. In accordance with some embodiments, meta-tokens may be implemented that allow a token to obtain ownership of another token, thereby tying ownership. Additionally or alternatively, in accordance with many embodiments, smart contracts may be implemented that allow NFTs, through the use of smart contracts, to directly own tokens including but not limited to cryptocurrency and digital fungible tokens.

In accordance with multiple embodiments, access management may involve changing various parameters governing access. In accordance with some embodiments, time-limited access to token data/services and/or token subscriptions may be implemented. Additionally or alternatively, systems and methods configured in accordance with certain embodiments of the invention, token access may be governed through social networks, wherein the right to rent, borrow, and/or use tokens may be provisionally given.

NFT platforms in accordance with a number of various embodiments of the invention may facilitate content screening and/or configuration through the use of creator and/or client-side AI agents that base their classifications on prior user determinations. Content modification may include but is not limited to modifying content being created with an eye towards potential commercial and/or modifying content being consumed based on how other consumers have engaged with the content.

While various token and smart contract configurations are discussed above, access-based functionalities that can be utilized within NFT platforms in accordance with various embodiments of the invention are discussed further below.

### Non-Fungible Token (NFT) Platforms

Turning now to the drawings, systems and methods for implementing blockchain-based Non-Fungible Token (NFT) platforms in accordance with various embodiments of the invention are illustrated. In several embodiments, blockchain-based NFT platforms are platforms which enable content creators to issue, mint, and transfer Non-Fungible Tokens (NFTs) directed to content including, but not limited to, rich media content.

In a number of embodiments, content creators can issue NFTs to users within the NFT platform. NFTs can be created around a large range of real-world media content and intellectual property. Movie studios can mint digital collectibles for their movies, characters, notable scenes and/or notable objects. Record labels can mint digital collectibles for artists, bands, albums and/or songs. Similarly, official digital trading cards can be made from likeness of celebrities, cartoon characters and/or gaming avatars.

NFTs minted using NFT platforms in accordance with various embodiments of the invention can have multifunctional programmable use cases including rewards, private access to premium content and experiences, as discounts toward the purchase of goods, among many other value-added use cases.

In many embodiments, each NFT can have a set of attributes that define its unique properties. NFTs may therefore be classified based on which attributes are emphasized. Possible classifications may address, but are not limited to: NFTs as identifying entities, NFTs output by other NFTs, NFTs as content creation assets, and NFTs as evaluating entities. NFTs can be interpreted differently by various platforms in order to create platform-specific user experiences. The metadata associated with an NFT may also include digital media assets such as (but not limited to) images, videos about the specific NFT, and the context in which it was created (studio, film, band, company song etc.).

In many embodiments, NFT storage may be facilitated through mechanisms for the transfer of payment from users to one or more service providers. Through these mechanisms, a payment system for NFT maintenance can allow for incremental payment and ongoing asset protection. NFT storage may be additionally self-regulated through willing participants disclosing unsatisfactory NFT management in exchange for rewards.

In many embodiments, the NFT platform can include media wallet applications that enable users to securely store NFTs and/or other tokens on their devices. Furthermore, media wallets (also referred to as “digital wallets”) can enable users to obtain NFTs that prove purchase of rights to access a particular piece of media content on one platform and use the NFT to gain access to the purchased content on another platform. The consumption of such content may be governed by content classification directed to visual user interface systems.

In several embodiments, users can download and install media wallet applications to store NFTs on the same computing devices used to consume streamed and/or downloaded content. Media wallet applications and NFTs can disseminate data concerning media consumption on the computing devices on which the media wallet applications are installed and/or based upon observations indicative of media consumption independently of the device. Media consumption data may include, but is not limited to, data reporting the occurrence of NFT transactions, data reporting the occurrence of NFT event interactions data reporting the content of NFT transactions, data reporting the content of media wallet interactions, and/or data reporting the occurrence of media wallet interactions.

While various aspects of NFT platforms, NFTs, media wallets, blockchain configurations, reporting structures, and maintenance systems are discussed above, NFT platforms and different components that can be utilized within NFT platforms in accordance with various embodiments of the invention are discussed further below.

### NFT Platforms

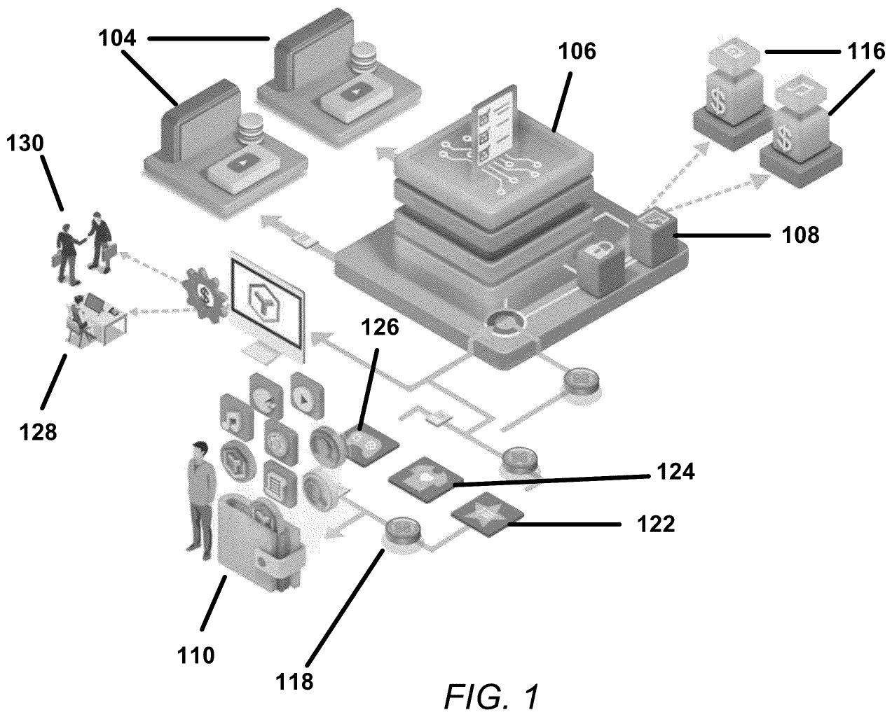

An NFT platform in accordance with an embodiment of the invention is illustrated in FIG. 1. The NFT platform 100 utilizes one or more immutable ledgers (e.g. one or more blockchains) to enable a number of verified content creators 104 to access an NFT registry service to mint NFTs 106 in a variety of forms including (but not limited to) celebrity NFTs 122, character NFTs from games 126, NFTs that are redeemable within games 126, NFTs that contain and/or enable access to collectibles 124, and NFTs that have evolutionary capabilities representative of the change from one NFT state to another NFT state.

Issuance of NFTs 106 via the NFT platform 100 enables verification of the authenticity of NFTs independently of the content creator 104 by confirming that transactions written to one or more of the immutable ledgers are consistent with the smart contracts 108 underlying the NFTs.

As is discussed further below, content creators 104 can provide the NFTs 106 to users to reward and/or incentivize engagement with particular pieces of content and/or other user behavior including (but not limited to) the sharing of user personal information (e.g. contact information or user ID information on particular services), demographic information, and/or media consumption data with the content creator and/or other entities. In addition, the smart contracts 108 underlying the NFTs can cause payments of residual royalties 116 when users engage in specific transactions involving NFTs (e.g. transfer of ownership of the NFT).

In a number of embodiments, users utilize media wallet applications 110 on their devices to store NFTs 106 distributed using the NFT platform 100. Users can use media wallet applications 110 to obtain and/or transfer NFTs 106. In facilitating the retention or transfer of NFTs 106, media wallet applications may utilize wallet user interfaces that engage in transactional restrictions through either uniform or personalized settings. Media wallet applications 110 in accordance with some embodiments may incorporate NFT filtering systems to avoid unrequested NFT assignment. Methods for increased wallet privacy may also operate through multiple associated wallets with varying capabilities. As can readily be appreciated, NFTs 106 that are implemented using smart contracts 108 having interfaces that comply with open standards are not limited to being stored within media wallets and can be stored in any of a variety of wallet applications as appropriate to the requirements of a given application. Furthermore, a number of embodiments of the invention support movement of NFTs 106 between different immutable ledgers. Processes for moving NFTs between multiple immutable ledgers in accordance with various embodiments of the invention are discussed further below.

In several embodiments, content creators 104 can incentivize users to grant access to media consumption data using offers including (but not limited to) offers of fungible tokens 118 and/or NFTs 106. In this way, the ability of the content creators to mint NFTs enables consumers to engage directly with the content creators and can be utilized to incentivize users to share with content creators' data concerning user interactions with additional content. The permissions granted by individual users may enable the content creators 104 to directly access data written to an immutable ledger. In many embodiments, the permissions granted by individual users enable authorized computing systems to access data within an immutable ledger and content creators 104 can query the authorized computing systems to obtain aggregated information. Numerous other example functions for content creators 104 are possible, some of which are discussed below.

NFT blockchains in accordance with various embodiments of the invention enable issuance of NFTs by verified users. In many embodiments, the verified users can be content creators that are vetted by an administrator of networks that may be responsible for deploying and maintaining the NFT blockchain. Once the NFTs are minted, users can obtain and conduct transactions with the NFTs. In several embodiments, the NFTs may be redeemable for items or services in the real world such as (but not limited to) admission to movie screenings, concerts, and/or merchandise.

As illustrated in FIG. 1, users can install the media wallet application 110 onto their devices and use the media wallet application 110 to purchase fungible tokens. The media wallet application could also be provided by a browser, or by a dedicated hardware unit executing instructions provided by a wallet manufacturer. The different types of wallets may have slightly different security profiles and may offer different features, but would all be able to be used to initiate the change of ownership of tokens, such as NFTs. In many embodiments, the fungible tokens can be fully converted into fiat currency and/or other cryptocurrency. In several embodiments, the fungible tokens are implemented using split blockchain models in which the fungible tokens can be issued to multiple blockchains (e.g. Ethereum). As can readily be appreciated, the fungible tokens and/or NFTs utilized within an NFT platform in accordance with various embodiments of the invention are largely dependent upon the requirements of a given application.

In several embodiments, the media wallet application is capable of accessing multiple blockchains by deriving accounts from each of the various immutable ledgers used within an NFT platform. For each of these blockchains, the media wallet application can automatically provide simplified views whereby fungible tokens and NFTs across multiple accounts and/or multiple blockchains can be rendered as single user profiles and/or wallets. In many embodiments, the single view can be achieved using deep-indexing of the relevant blockchains and API services that can rapidly provide information to media wallet applications in response to user interactions. In certain embodiments, the accounts across the multiple blockchains can be derived using BIP32 deterministic wallet key. In other embodiments, any of a variety of techniques can be utilized by the media wallet application to access one or more immutable ledgers as appropriate to the requirements of a given application.

NFTs can be purchased by way of exchanges 130 and/or from other users 128. In addition, content creators can directly issue NFTs to the media wallets of specific users (e.g. by way of push download or AirDrop). In many embodiments, the NFTs are digital collectibles such as celebrity NFTs 122, character NFTs from games 126, NFTs that are redeemable within games 126, and/or NFTs that contain and/or enable access to collectibles 124. It should be appreciated that a variety of NFTs are described throughout the discussion of the various embodiments described herein and can be utilized in any NFT platform and/or with any media wallet application.

While the NFTs are shown as static in the illustrated embodiment, content creators can utilize users' ownership of NFTs to engage in additional interactions with the user. In this way, the relationship between users and particular pieces of content and/or particular content creators can evolve over time around interactions driven by NFTs. In a number of embodiments, collection of NFTs can be gamified to enable unlocking of additional NFTs. In addition, leaderboards can be established with respect to particular content and/or franchises based upon users' aggregation of NFTs. As is discussed further below, NFTs and/or fungible tokens can also be utilized by content creators to incentivize users to share data.

NFTs minted in accordance with several embodiments of the invention may incorporate a series of instances of digital content elements in order to represent the evolution of the digital content over time. Each one of these digital elements can have multiple numbered copies, just like a lithograph, and each such version can have a serial number associated with it, and/or digital signatures authenticating its validity. The digital signature can associate the corresponding image to an identity, such as the identity of the artist. The evolution of digital content may correspond to the transition from one representation to another representation. This evolution may be triggered by the artist, by an event associated with the owner of the artwork, by an external event measured by platforms associated with the content, and/or by specific combinations or sequences of event triggers. Some such NFTs may also have corresponding series of physical embodiments. These may be physical and numbered images that are identical to the digital instances described above. They may also be physical representations of another type, e.g., clay figures or statues, whereas the digital representations may be drawings. The physical embodiments may further be of different aspects that relate to the digital series. Evolution in compliance with some embodiments may also be used to spawn additional content, for example, one NFT directly creating one or more secondary NFTs.

When the user wishes to purchase an NFT using fungible tokens, media wallet applications can request authentication of the NFT directly based upon the public key of the content creator and/or indirectly based upon transaction records within the NFT blockchain. As discussed above, minted NFTs can be signed by content creators and administrators of the NFT blockchain. In addition, users can verify the authenticity of particular NFTs without the assistance of entities that minted the NFT by verifying that the transaction records involving the NFT within the NFT blockchain are consistent with the various royalty payment transactions required to occur in conjunction with transfer of ownership of the NFT by the smart contract underlying the NFT.

Applications and methods in accordance with various embodiments of the invention are not limited to media wallet applications or use within NFT platforms. Accordingly, it should be appreciated that the data collection capabilities of any media wallet application described herein can also be implemented outside the context of an NFT platform and/or in a dedicated application and/or in an application unrelated to the storage of fungible tokens and/or NFTs. Various systems and methods for implementing NFT platforms and media wallet applications in accordance with various embodiments of the invention are discussed further below.

### NFT Platform Network Architectures

NFT platforms in accordance with many embodiments of the invention utilize public blockchains and permissioned blockchains. In several embodiments, the public blockchain is decentralized and universally accessible. Additionally, in a number of embodiments, private/permissioned blockchains are closed systems that are limited to publicly inaccessible transactions. In many embodiments, the permissioned blockchain can be in the form of distributed ledgers, while the blockchain may alternatively be centralized in a single entity.

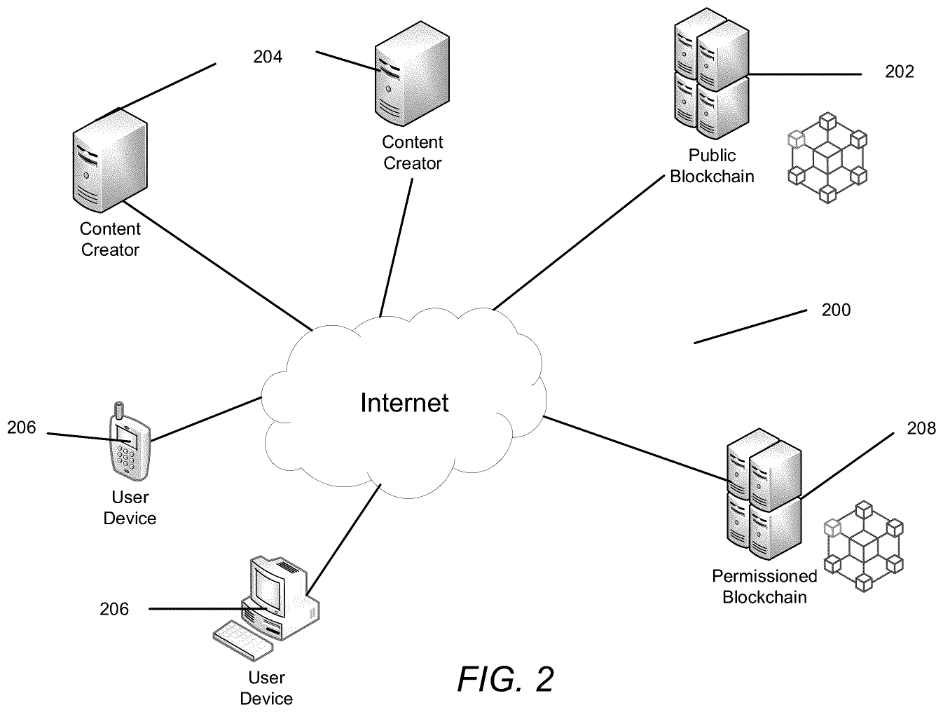

An example of network architecture that can be utilized to implement an NFT platform including a public blockchain and a permissioned blockchain in accordance with several embodiments of the invention is illustrated in FIG. 2. The NFT platform 200 utilizes computer systems implementing a public blockchain 202 such as (but not limited to) Ethereum and Solana. A benefit of supporting interactions with public blockchains 202 is that the NFT platform 200 can support minting of standards based NFTs that can be utilized in an interchangeable manner with NFTs minted by sources outside of the NFT platform on the public blockchain. In this way, the NFT platform 200 and the NFTs minted within the NFT platform are not part of a walled garden, but are instead part of a broader blockchain-based ecosystem. The ability of holders of NFTs minted within the NFT platform 200 to transact via the public blockchain 202 increases the likelihood that individuals acquiring NFTs will become users of the NFT platform. Initial NFTs minted outside the NFT platform can also be developed through later minted NFTs, with the initial NFTs being used to further identify and interact with the user based upon their ownership of both NFTs. Various systems and methods for facilitating the relationships between NFTs, both outside and within the NFT platform are discussed further below.

Users can utilize user devices configured with appropriate applications including (but not limited to) media wallet applications to obtain NFTs. In many embodiments, media wallets are smart device enabled, front-end applications for fans and/or consumers, central to all user activity on an NFT platform. As is discussed in detail below, different embodiments of media wallet applications can provide any of a variety of functionality that can be determined as appropriate to the requirements of a given application. In the illustrated embodiment, the user devices 206 are shown as mobile phones and personal computers. As can readily be appreciated user devices can be implemented using any class of consumer electronics device including (but not limited to) tablet computers, laptop computers, televisions, game consoles, virtual reality headsets, mixed reality headsets, augmented reality headsets, media extenders, and/or set top boxes as appropriate to the requirements of a given application.

In many embodiments, NFT transaction data entries in the permissioned blockchain 208 are encrypted using users' public keys so that the NFT transaction data can be accessed by the media wallet application. In this way, users control access to entries in the permissioned blockchain 208 describing the user's NFT transaction. In several embodiments, users can authorize content creators 204 to access NFT transaction data recorded within the permissioned blockchain 208 using one of a number of appropriate mechanisms including (but not limited to) compound identities where the user is the owner of the data and the user can authorize other entities as guests that can also access the data. As can readily be appreciated, particular content creators' access to the data can be revoked by revoking their status as guests within the compound entity authorized to access the NFT transaction data within the permissioned blockchain 208. In certain embodiments, compound identities are implemented by writing authorized access records to the permissioned blockchain using the user's public key and the public keys of the other members of the compound entity.

When content creators wish to access particular pieces of data stored within the permissioned blockchain 208, they can make a request to a data access service. The data access service may grant access to data stored using the permissioned blockchain 208 when the content creators' public keys correspond to public keys of guests. In a number of embodiments, guests may be defined within a compound identity. The access record for the compound entity may also authorize the compound entity to access the particular piece of data. In this way, the user has complete control over access to their data at any time by admitting or revoking content creators to a compound entity, and/or modifying the access policies defined within the permissioned blockchain 208 for the compound entity. In several embodiments, the permissioned blockchain 208 supports access control lists and users can utilize a media wallet application to modify permissions granted by way of the access control list. In many embodiments, the manner in which access permissions are defined enables different restrictions to be placed on particular pieces of information within a particular NFT transaction data record within the permissioned blockchain 208. As can readily be appreciated, the manner in which NFT platforms and/or immutable ledgers provide fine-grained data access permissions largely depends upon the requirements of a given application.

In many embodiments, storage nodes within the permissioned blockchain 208 do not provide content creators with access to entire NFT transaction histories. Instead, the storage nodes simply provide access to encrypted records. In several embodiments, the hash of the collection of records from the permissioned blockchain is broadcast. Therefore, the record is verifiably immutable and each result includes the hash of the record and the previous/next hashes. As noted above, the use of compound identities and/or access control lists can enable users to grant permission to decrypt certain pieces of information or individual records within the permissioned blockchain. In several embodiments, the access to the data is determined by computer systems that implement permission-based data access services.

In many embodiments, the permissioned blockchain 208 can be implemented using any blockchain technology appropriate to the requirements of a given application. As noted above, the information and processes described herein are not limited to data written to permissioned blockchains 208, and NFT transaction data simply provides an example. Systems and methods in accordance with various embodiments of the invention can be utilized to enable applications to provide fine-grained permission to any of a variety of different types of data stored in an immutable ledger as appropriate to the requirements of a given application in accordance with various embodiments of the invention.

While various implementations of NFT platforms are described above with reference to FIG. 2, NFT platforms can be implemented using any number of immutable and pseudo-immutable ledgers as appropriate to the requirements of specific applications in accordance with various embodiments of the invention. Blockchain databases in accordance with various embodiments of the invention may be managed autonomously using peer-to-peer networks and distributed timestamping servers. In some embodiments, any of a variety of consensus mechanisms may be used by public blockchains, including but not limited to Proof of Space mechanisms, Proof of Work mechanisms, Proof of Stake mechanisms, and hybrid mechanisms.

NFT platforms in accordance with many embodiments of the invention may benefit from the oversight and increased security of private blockchains. As can readily be appreciated, a variety of approaches can be taken to the writing of data to permissioned blockchains and the particular approach is largely determined by the requirements of particular applications. As such, computer systems in accordance with various embodiments of the invention can have the capacity to create verified NFT entries written to permissioned blockchains.

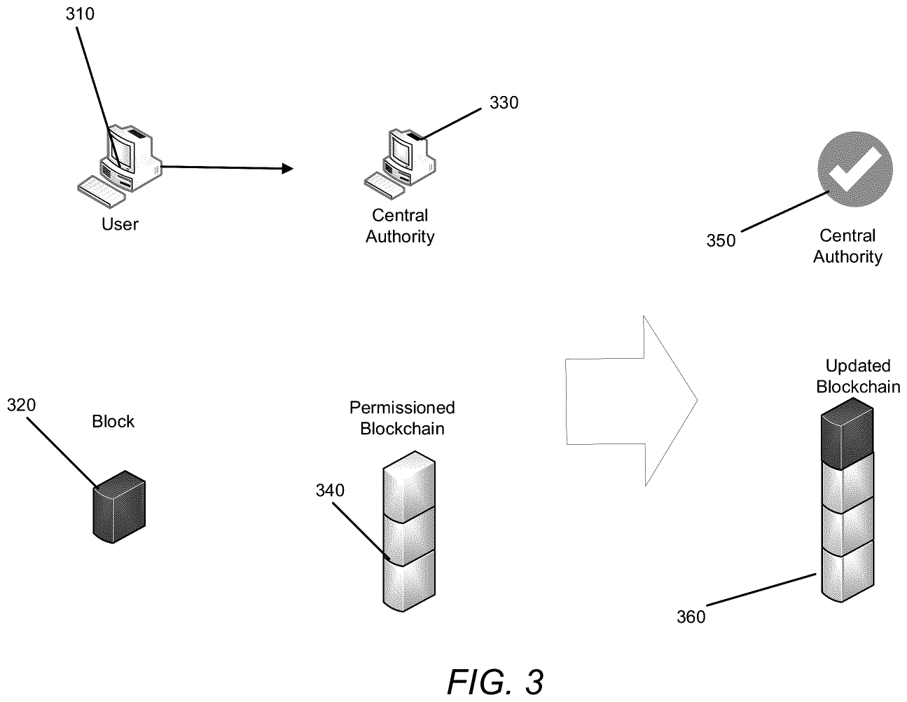

An implementation of permissioned (or private) blockchains in accordance with some embodiments of the invention is illustrated in FIG. 3. Permissioned blockchains 340 can typically function as closed computing systems in which each participant is well defined. In several embodiments, private blockchain networks may require invitations. In a number of embodiments, entries, or blocks 320, to private blockchains can be validated. In some embodiments, the validation may come from central authorities 330. Private blockchains can allow an organization or a consortium of organizations to efficiently exchange information and record transactions. Specifically, in a permissioned blockchain, a preapproved central authority 330 (which should be understood as potentially encompassing multiple distinct authorized authorities) can approve a change to the blockchain. In a number of embodiments, approval may come without the use of a consensus mechanism involving multiple authorities. As such, through a direct request from users 310 to the central authority 330, the determination of whether blocks 320 can be allowed access to the permissioned blockchain 340 can be determined. Blocks 320 needing to be added, eliminated, relocated, and/or prevented from access may be controlled through these means. In doing so the central authority 330 may manage accessing and controlling the network blocks incorporated into the permissioned blockchain 340. Upon the approval 350 of the central authority, the now updated blockchain 360 can reflect the added block 320.

NFT platforms in accordance with many embodiments of the invention may also benefit from the anonymity and accessibility of a public blockchain. Therefore, NFT platforms in accordance with many embodiments of the invention can have the capacity to create verified NFT entries written to a permissioned blockchain.

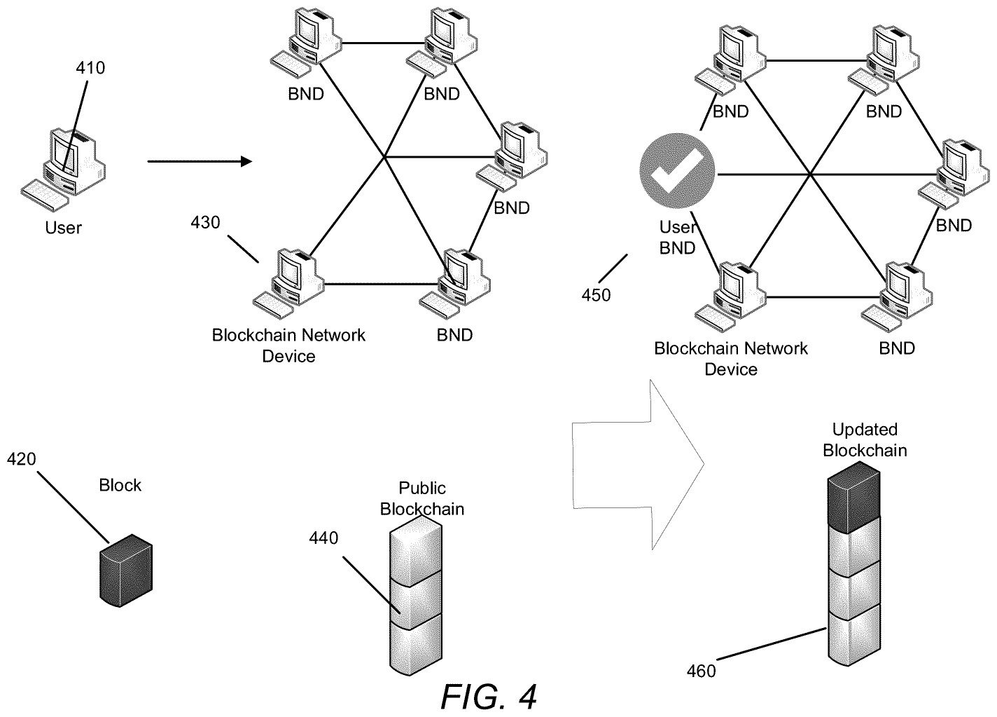

An implementation of a permissionless, decentralized, or public blockchain in accordance with an embodiment of the invention is illustrated in FIG. 4. In a permissionless blockchain, individual users 410 can directly participate in relevant networks and operate as blockchain network devices 430. As blockchain network devices 430, parties would have the capacity to participate in changes to the blockchain and participate in transaction verifications (via the mining mechanism). Transactions are broadcast over the computer network and data quality is maintained by massive database replication and computational trust. Despite being decentralized, an updated blockchain 460 cannot remove entries, even if anonymously made, making it immutable. In many decentralized blockchains, many blockchain network devices 430, in the decentralized system may have copies of the blockchain, allowing the ability to validate transactions. In many instances, the blockchain network device 430 can personally add transactions, in the form of blocks 420 appended to the public blockchain 440. To do so, the blockchain network device 430 would take steps to allow for the transactions to be validated 450 through various consensus mechanisms (Proof of Work, Proof of Stake, etc.). A number of consensus mechanisms in accordance with various embodiments of the invention are discussed further below.

Additionally, in the context of blockchain configurations, the term smart contract is often used to refer to software programs that run on blockchains. While a standard legal contract outlines the terms of a relationship (usually one enforceable by law), a smart contract enforces a set of rules using self-executing code within NFT platforms. As such, smart contracts may have the means to automatically enforce specific programmatic rules through platforms. Smart contracts are often developed as high-level programming abstractions that can be compiled down to bytecode. Said bytecode may be deployed to blockchains for execution by computer systems using any number of mechanisms deployed in conjunction with the blockchain. In many instances, smart contracts execute by leveraging the code of other smart contracts in a manner similar to calling upon a software library.

A number of existing decentralized blockchain technologies intentionally exclude or prevent rich media assets from existing within the blockchain, because they would need to address content that is not static (e.g., images, videos, music files). Therefore, NFT platforms in accordance with many embodiments of the invention may address this with blockchain mechanisms, that preclude general changes but account for updated content.

NFT platforms in accordance with many embodiments of the invention can therefore incorporate decentralized storage pseudo-immutable dual blockchains. In some embodiments, two or more blockchains may be interconnected such that traditional blockchain consensus algorithms support a first blockchain serving as an index to a second, or more, blockchains serving to contain and protect resources, such as the rich media content associated with NFTs.

In storing rich media using blockchain, several components may be utilized by an entity (“miner”) adding transactions to said blockchain. References, such as URLs, may be stored in the blockchain to identify assets. Multiple URLs may also be stored when the asset is separated into pieces. An alternative or complementary option may be the use of APIs to return either the asset or a URL for the asset. In accordance with many embodiments of the invention, references can be stored by adding a ledger entry incorporating the reference enabling the entry to be timestamped. In doing so, the URL, which typically accounts for domain names, can be resolved to IP addresses. However, when only files of certain types are located on particular resources, or where small portions of individual assets are stored at different locations, users may require methods to locate assets stored on highly-splintered decentralized storage systems. To do so, systems may identify at least primary asset destinations and update those primary asset destinations as necessary when storage resources change. The mechanisms used to identify primary asset destinations may take a variety of forms including, but not limited to, smart contracts.

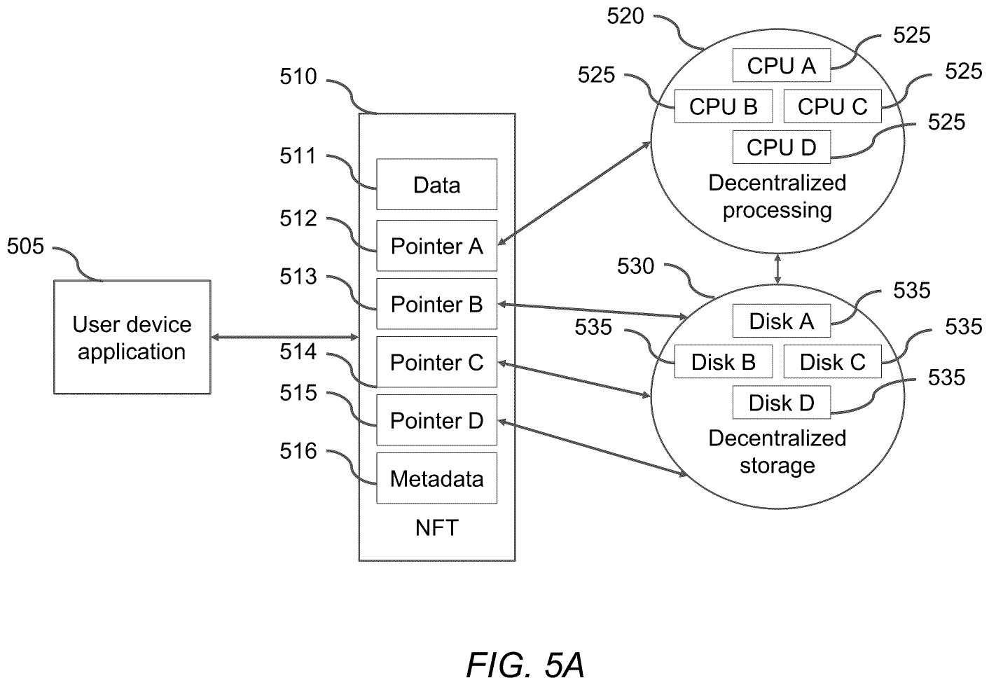

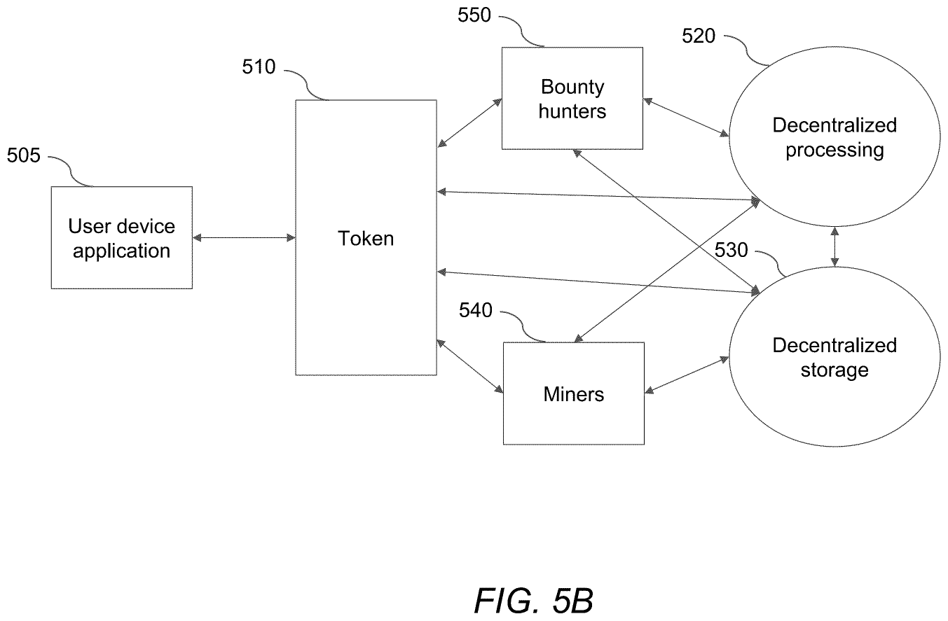

A dual blockchain, including decentralized processing 520 and decentralized storage 530 blockchains, in accordance with some embodiments of the invention is illustrated in FIG. 5A. Application running on devices 505, may interact with or make a request related to NFTs 510 interacting with such a blockchain. An NFT 510 in accordance with several embodiments of the invention may include many values including generalized data 511 (e.g. URLs), and pointers such as pointer A 512, pointer B 513, pointer C 514, and pointer D 515. In accordance with many embodiments of the invention, the generalized data 511 may be used to access corresponding rich media through the NFT 510. The NFT 510 may additionally have associated metadata 516.

Pointers within the NFT 510 may direct an inquiry toward a variety of on or off-ledger resources. In some embodiments of the invention, as illustrated FIG. 5A, pointer A 512 can direct the need for processing to the decentralized processing network 520. Processing systems are illustrated as CPU A, CPU B, CPU C, and CPU D 525. The CPUs 525 may be personal computers, server computers, mobile devices, edge IoT devices, etc. Pointer A may select one or more processors at random to perform the execution of a given smart contract. The code may be secure or nonsecure and the CPU may be a trusted execution environment (TEE), depending upon the needs of the request. In the example reflected in FIG. 5A, pointer B 513, pointer C 514, and pointer D 515 all point to a decentralized storage network 530 including remote off-ledger resources including storage systems illustrated as Disks A, B, C, and D 535.

The decentralized storage system may co-mingle with the decentralized processing system as the individual storage systems utilize CPU resources and connectivity to perform their function. From afunctional perspective, the two decentralized systems may also be separate. Pointer B 513 may point to one or more decentralized storage networks 530 for the purposes of maintaining an off-chain log file of token activity and requests. Pointer C 514 may point to executable code within one or more decentralized storage networks 530. And Pointer D 515 may point to rights management data, security keys, and/or configuration data within one or more decentralized storage networks 530.

Dual blockchains may additionally incorporate methods for detection of abuse, essentially operating as a “bounty hunter” 550. FIG. 5B illustrates the inclusion of bounty hunters 550 within dual blockchain structures implemented in accordance with an embodiment of the invention. Bounty hunters 550 allow NFTs 510, which can point to networks that may include decentralized processing 520 and/or storage networks 530, to be monitored. The bounty hunter's 550 objective may be to locate incorrectly listed or missing data and executable code within the NFT 510 or associated networks. Additionally, the miner 540 can have the capacity to perform all necessary minting processes or any process within the architecture that involves a consensus mechanism.

Bounty hunters 550 may also choose to verify each step of a computation, and if they find an error, submit evidence of this in return for some reward. This can have the effect of invalidating the incorrect ledger entry and, potentially based on policies, all subsequent ledger entries. Such evidence can be submitted in a manner that is associated with a public key, in which the bounty hunter 550 proves knowledge of the error, thereby assigning value (namely the bounty) with the public key.

Assertions made by bounty hunters 550 may be provided directly to miners 540 by broadcasting the assertion. Assertions may be broadcast in a manner including, but not limited to posting it to a bulletin board. In some embodiments of the invention, assertions may be posted to ledgers of blockchains, for instance, the blockchain on which the miners 540 operate. If the evidence in question has not been submitted before, this can automatically invalidate the ledger entry that is proven wrong and provide the bounty hunter 550 with some benefit.

Applications and methods in accordance with various embodiments of the invention are not limited to use within NFT platforms. Accordingly, it should be appreciated that the capabilities of any blockchain configuration described herein can also be implemented outside the context of an NFT platform network architecture unrelated to the storage of fungible tokens and/or NFTs. A variety of components, mechanisms, and blockchain configurations that can be utilized within NFT platforms are discussed further below. Moreover, any of the blockchain configurations described herein with reference to FIGS. 3-5B (including permissioned, permissionless, and/or hybrid mechanisms) can be utilized within any of the networks implemented within the NFT platforms described above.

### NFT Platform Consensus Mechanisms

NFT platforms in accordance with many embodiments of the invention can depend on consensus mechanisms to achieve agreement on network state, through proof resolution, to validate transactions. In accordance with many embodiments of the invention, Proof of Work (PoW) mechanisms may be used as a means of demonstrating non-trivial allocations of processing power. Proof of Space (PoS) mechanisms may be used as a means of demonstrating non-trivial allocations of memory or disk space. As a third possible approach, Proof of Stake mechanisms may be used as a means of demonstrating non-trivial allocations of fungible tokens and/or NFTs as a form of collateral. Numerous consensus mechanisms are possible in accordance with various embodiments of the invention, some of which are expounded on below.

Traditional mining schemes, such as Bitcoin, are based on Proof of Work, based on performing the aforementioned large computational tasks. The cost of such tasks may not only be computational effort, but also energy expenditure, a significant environmental concern. To address this problem, mining methods operating in accordance with many embodiments of the invention may instead operate using Proof of Space mechanisms to accomplish network consensus, wherein the distinguishing factor can be memory rather than processing power. Specifically, Proof of Space mechanisms can perform this through network optimization challenges. In several embodiments the network optimization challenge may be selected from any of a number of different challenges appropriate to the requirements of specific applications including graph pebbling. In some embodiments, graph pebbling may refer to a resource allocation game played on discrete mathematics graphs, ending with a labeled graph disclosing how a player might get at least one pebble to every vertex of the graph.

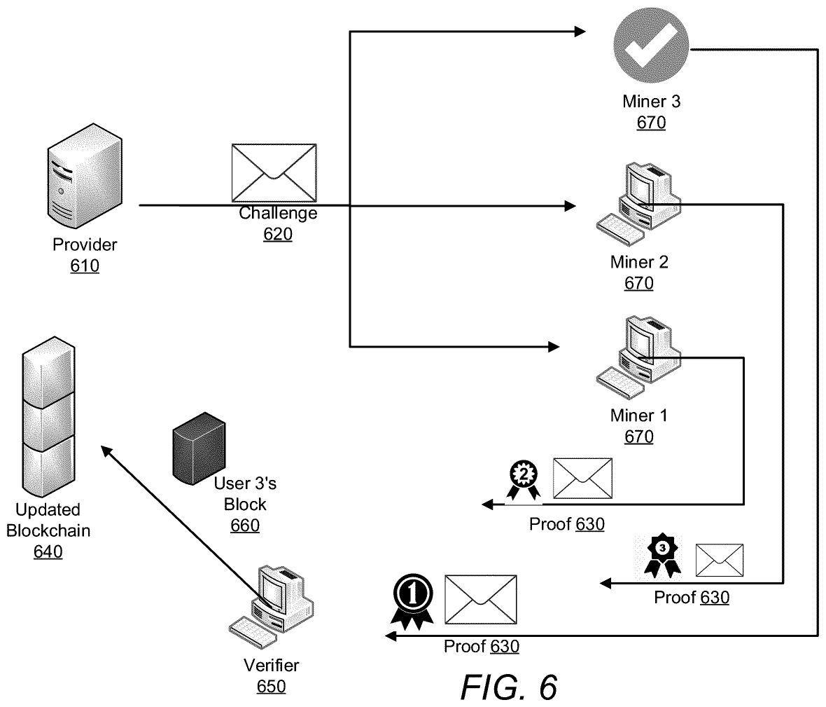

An example of Proof of Work consensus mechanisms that may be implemented in decentralized blockchains, in accordance with a number of embodiments of the invention, is conceptually illustrated in FIG. 6. The example disclosed in this figure is a challenge-response authentication, a protocol classification in which one party presents a complex problem (“challenge”) 610 and another party must broadcast a valid answer (“proof”) 620 to have clearance to add a block to the decentralized ledger that makes up the blockchain 630. As a number of miners may be competing to have this ability, there may be a need for determining factors for the addition to be added first, which in this case is processing power. Once an output is produced, verifiers 640 in the network can verify the proof, something which typically requires much less processing power, to determine the first device that would have the right to add the winning block 650 to the blockchain 630. As such, under a Proof of Work consensus mechanism, each miner involved can have a success probability proportional to the computational effort expended.

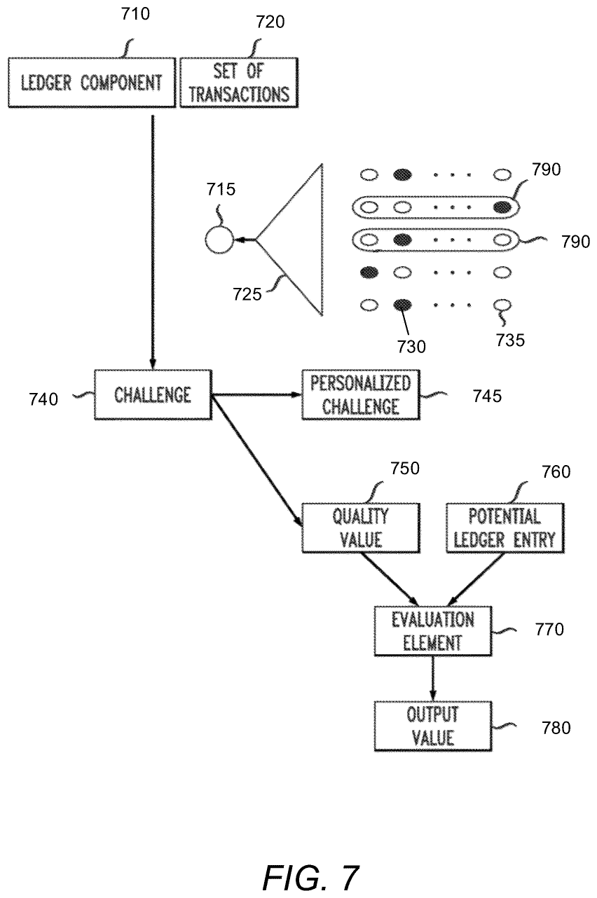

An example of Proof of Space implementations on devices in accordance with some embodiments of the invention is conceptually illustrated in FIG. 7. The implementation includes a ledger component 710, a set of transactions 720, and a challenge 740 computed from a portion of the ledger component 710. A representation 715 of a miner's state may also be recorded in the ledger component 710 and be publicly available.

In some embodiments, the material stored on the memory of the device includes a collection of nodes 730, 735, where nodes that depend on other nodes have values that are functions of the values of the associated nodes on which they depend. For example, functions may be one-way functions, such as cryptographic hash functions. In several embodiments the cryptographic hash function may be selected from any of a number of different cryptographic hash functions appropriate to the requirements of specific applications including (but not limited to) the SHA1 cryptographic hash function. In such an example, one node in the network may be a function of three other nodes. Moreover, the node may be computed by concatenating the values associated with these three nodes and applying the cryptographic hash function, assigning the result of the computation to the node depending on these three parent nodes. In this example, the nodes are arranged in rows, where two rows 790 are shown. The nodes are stored by the miner, and can be used to compute values at a setup time. This can be done using Merkle tree hash-based data structures 725, or another structure such as a compression function and/or a hash function.

Challenges 740 may be processed by the miner to obtain personalized challenges 745, made to the device according to the miner's storage capacity. The personalized challenge 745 can be the same or have a negligible change, but could also undergo an adjustment to account for the storage space accessible by the miner, as represented by the nodes the miner stores. For example, when the miner does not have a large amount of storage available or designated for use with the Proof of Space system, a personalized challenge 745 may adjust challenges 740 to take this into consideration, thereby making a personalized challenge 745 suitable for the miner's memory configuration.

In some embodiments, the personalized challenge 745 can indicate a selection of nodes 730, denoted in FIG. 7 by filled-in circles. In the FIG. 7 example specifically, the personalized challenge corresponds to one node per row. The collection of nodes selected as a result of computing the personalized challenge 745 can correspond to a valid potential ledger entry 760. However, here a quality value 750 (also referred to herein as a qualifying function value) can also be computed from the challenge 740, or from other public information that is preferably not under the control of any one miner.

A miner may perform matching evaluations 770 to determine whether the set of selected nodes 730 matches the quality value 750. This process can take into consideration what the memory constraints of the miner are, causing the evaluation 770 to succeed with a greater frequency for larger memory configurations than for smaller memory configurations. This can simultaneously level the playing field to make the likelihood of the evaluation 770 succeeding roughly proportional to the size of the memory used to store the nodes used by the miner. In some embodiments, non-proportional relationships may be created by modifying the function used to compute the quality value 750. When the evaluation 770 results in success, then the output value 780 may be used to confirm the suitability of the memory configuration and validate the corresponding transaction.

In many embodiments, nodes 730 and 735 can also correspond to public keys. The miner may submit valid ledger entries, corresponding to a challenge-response pair including one of these nodes. In that case, public key values can become associated with the obtained NFT. As such, miners can use a corresponding secret/private key to sign transaction requests, such as purchases. Additionally, any type of digital signature can be used in this context, such as RSA signatures, Merkle signatures, DSS signatures, etc. Further, the nodes 730 and 735 may correspond to different public keys or to the same public key, the latter preferably augmented with a counter and/or other location indicator such as a matrix position indicator, as described above. Location indicators in accordance with many embodiments of the invention may be applied to point to locations within a given ledger. In accordance with some embodiments of the invention, numerous Proof of Space consensus configurations are possible, some of which are discussed below.

Hybrid methods of evaluating Proof of Space problems can also be implemented in accordance with many embodiments of the invention. In many embodiments, hybrid methods can be utilized that conceptually correspond to modifications of Proof of Space protocols in which extra effort is expanded to increase the probability of success, or to compress the amount of space that may be applied to the challenge. Both come at a cost of computational effort, thereby allowing miners to improve their odds of winning by spending greater computational effort. Accordingly, in many embodiments of the invention dual proof-based systems may be used to reduce said computational effort. Such systems may be applied to Proof of Work and Proof of Space schemes, as well as to any other type of mining-based scheme.

When utilizing dual proofs in accordance with various embodiments of the invention, the constituent proofs may have varying structures. For example, one may be based on Proof of Work, another on Proof of Space, and a third may be a system that relies on a trusted organization for controlling the operation, as opposed to relying on mining for the closing of ledgers. Yet other proof structures can be combined in this way. The result of the combination will inherit properties of its components. In many embodiments, the hybrid mechanism may incorporate a first and a second consensus mechanism. In several embodiments, the hybrid mechanism includes a first, a second, and a third consensus mechanisms. In a number of embodiments, the hybrid mechanism includes more than three consensus mechanisms. Any of these embodiments can utilize consensus mechanisms selected from the group including (but not limited to) Proof of Work, Proof of Space, and Proof of Stake without departing from the scope of the invention. Depending on how each component system is parametrized, different aspects of the inherited properties will dominate over other aspects.

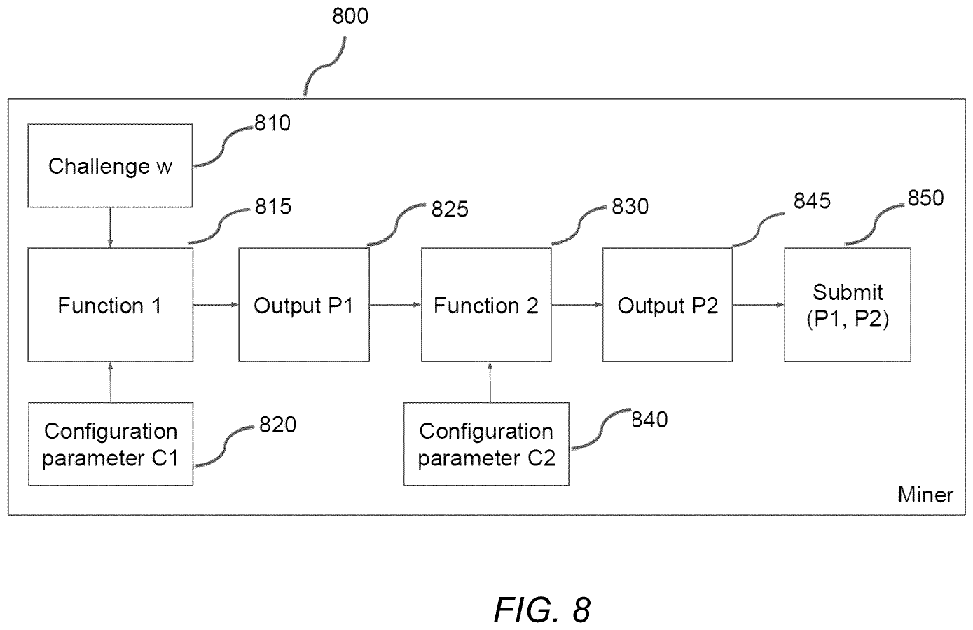

Dual proof configurations in accordance with a number of embodiments of the invention is illustrated in FIG. 8. A proof configuration in accordance with some embodiments of the invention may tend to use the notion of quality functions for tie-breaking among multiple competing correct proofs relative to a given challenge (w) 810. This classification of proof can be described as a qualitative proof, inclusive of proofs of work and proofs of space. In the example reflected in FIG. 8, proofs P1 and P2 are each one of a Proof of Work, Proof of Space, Proof of Stake, and/or any other proof related to a constrained resource, wherein P2 may be of a different type than P1, or may be of the same type.

Systems in accordance with many embodiments of the invention may introduce the notion of a qualifying proof, which, unlike qualitative proofs, are either valid or not valid, using no tie-breaking mechanism. Said systems may include a combination of one or more qualitative proofs and one or more qualifying proofs. For example, it may use one qualitative proof that is combined with one qualifying proof, where the qualifying proof is performed conditional on the successful creation of a qualitative proof. FIG. 8 illustrates challenge w 810, as described above, with a function 1 815, which is a qualitative function, and function 2 830, which is a qualifying function.

To stop miners from expending effort after a certain amount of effort has been spent, thereby reducing the environmental impact of mining, systems in accordance with a number of embodiments of the invention can constrain the search space for the mining effort. This can be done using a configuration parameter that controls the range of random or pseudo-random numbers that can be used in a proof. Upon challenge w 810 being issued to one or more miners 800, it can be input to Function 1 815 along with configuration parameter C1 820. Function 1 815 may output proof P1 825, in this example the qualifying proof to Function 2 830. Function 2 830 is also provided with configuration parameter C2 840 and computes qualifying proof P2 845. The miner 800 can then submit the combination of proofs (P1, P2) 850 to a verifier, in order to validate a ledger associated with challenge w 810. In some embodiments, miner 800 can also submit the proofs (P1, P2) 850 to be accessed by a 3rd-party verifier.

NFT platforms in accordance with many embodiments of the invention may additionally benefit from alternative energy-efficient consensus mechanisms. Therefore, computer systems in accordance with several embodiments of the invention may instead use consensus-based methods alongside or in place of proof-of-space and proof-of-space based mining. In particular, consensus mechanisms based instead on the existence of a Trusted Execution Environment (TEE), such as ARM TrustZone™ or Intel SGX™ may provide assurances exist of integrity by virtue of incorporating private/isolated processing environments.

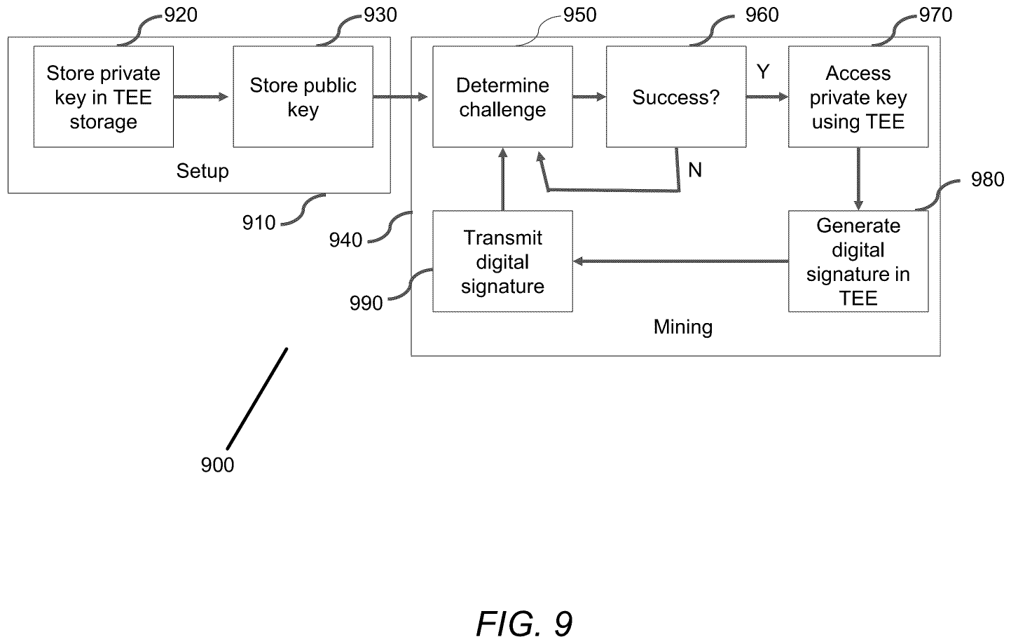

An illustration of sample process 900 undergone by TEE-based consensus mechanisms in accordance with some embodiments of the invention is depicted in FIG. 9. In some such configurations, a setup 910 may be performed by an original equipment manufacturer (OEM) or a party performing configurations of equipment provided by an OEM. Once a private key/public key pair is generated in the secure environment, process 900 may store (920) the private key in TEE storage (i.e. storage associated with the Trusted Execution Environment). While storage may be accessible from the TEE, it can be shielded from applications running outside the TEE. Additionally, processes can store (930) the public key associated with the TEE in any storage associated with the device containing the TEE. Unlike the private key, the public key may also be accessible from applications outside the TEE. In a number of embodiments, the public key may also be certified. Certification may come from OEMs or trusted entities associated with the OEMs, wherein the certificate can be stored with the public key.

In many embodiments of the invention, mining-directed steps can also be influenced by the TEE. In the illustrated embodiment, the process 900 can determine (950) a challenge. For example, this may be by computing a hash of the contents of a ledger. In doing so, process 900 may also determine whether the challenge corresponds to success 960. In some embodiments of the invention, the determination of success may result from some pre-set portion of the challenge matching a pre-set portion of the public key, e.g. the last 20 bits of the two values matching. In several embodiments the success determination mechanism may be selected from any of a number of alternate approaches appropriate to the requirements of specific applications. The matching conditions may also be modified over time. For example, modification may result from an announcement from a trusted party or based on a determination of a number of participants having reached a threshold value.

When the challenge does not correspond to a success 960, process 900 can return to determine (950) a new challenge. In this context, process 900 can determine (950) a new challenge after the ledger contents have been updated and/or a time-based observation is performed. In several embodiments the determination of a new challenge may come from any of a number of approaches appropriate to the requirements of specific applications, including, but not limited to, the observation of as a second elapsing since the last challenge. If the challenge corresponds to a success 960, then the processing can continue on to access (970) the private key using the TEE.

When the private key is accessed, process can generate (980) a digital signature using the TEE. The digital signature may be on a message that includes the challenge and/or which otherwise references the ledger entry being closed. Process 900 can also transmit (980) the digital signature to other participants implementing the consensus mechanism. In cases where multiple digital signatures are received and found to be valid, a tie-breaking mechanism can be used to evaluate the consensus. For example, one possible tie-breaking mechanism may be to select the winner as the party with the digital signature that represents the smallest numerical value when interpreted as a number. In several embodiments the tie-breaking mechanism may be selected from any of a number of alternate tie-breaking mechanisms appropriate to the requirements of specific applications.

Applications and methods in accordance with various embodiments of the invention are not limited to use within NFT platforms. Accordingly, it should be appreciated that consensus mechanisms described herein can also be implemented outside the context of an NFT platform network architecture unrelated to the storage of fungible tokens and/or NFTs. Moreover, any of the consensus mechanisms described herein with reference to FIGS. 6-9 (including Proof of Work, Proof of Space, Proof of Stake, and/or hybrid mechanisms) can be utilized within any of the blockchains implemented within the NFT platforms described above with reference to FIGS. 3-5B. Various systems and methods for implementing NFT platforms and applications in accordance with numerous embodiments of the invention are discussed further below.

### NFT Platform Constituent Devices and Applications

A variety of computer systems that can be utilized within NFT platforms and systems that utilize NFT blockchains in accordance with various embodiments of the invention are illustrated below. The computer systems in accordance with many embodiments of the invention may implement a processing system 1010, 1120, 1220 using one or more CPUs, GPUs, ASICs, FPGAs, and/or any of a variety of other devices and/or combinations of devices that are typically utilized to perform digital computations. As can readily be appreciated each of these computer systems can be implemented using one or more of any of a variety of classes of computing devices including (but not limited to) mobile phone handsets, tablet computers, laptop computers, personal computers, gaming consoles, televisions, set top boxes and/or other classes of computing device.

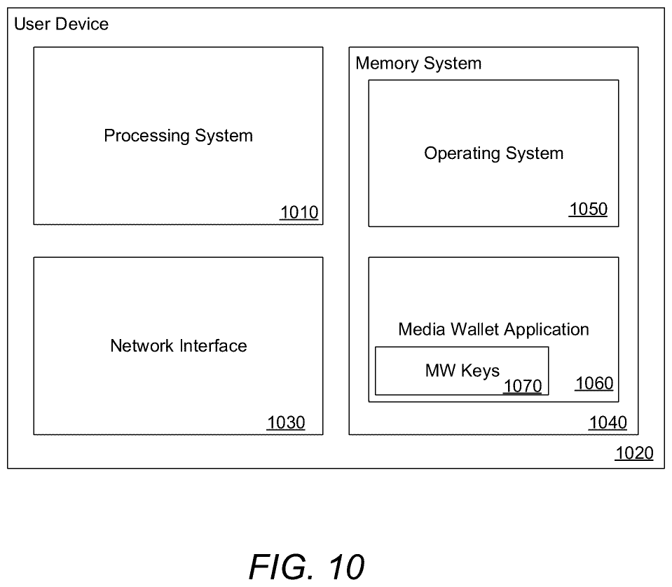

A user device capable of communicating with an NFT platform in accordance with an embodiment of the invention is illustrated in FIG. 10. The memory system 1040 of particular user devices may include an operating system 1050 and media wallet applications 1060. Media wallet applications may include sets of media wallet (MW) keys 1070 that can include public key/private key pairs. The set of MW keys may be used by the media wallet application to perform a variety of actions including, but not limited to, encrypting and signing data. In many embodiments, the media wallet application enables the user device to obtain and conduct transactions with respect to NFTs by communicating with an NFT blockchain via the network interface 1030. In some embodiments, the media wallet applications are capable of enabling the purchase of NFTs using fungible tokens via at least one distributed exchange. User devices may implement some or all of the various functions described above with reference to media wallet applications as appropriate to the requirements of a given application in accordance with various embodiments of the invention.

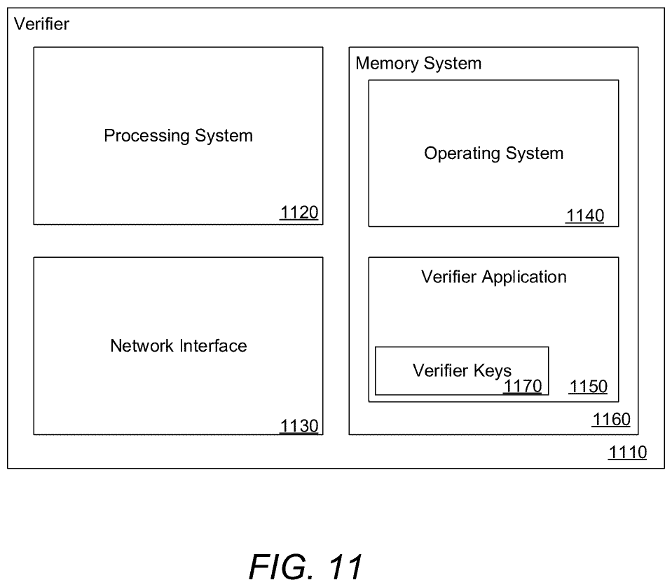

A verifier 1110 capable of verifying blockchain transactions in an NFT platform in accordance with many embodiments of the invention is illustrated in FIG. 11. The memory system 1160 of the verifier computer system includes an operating system 1140 and a verifier application 1150 that enables the verifier 1110 computer system to access a decentralized blockchain in accordance with various embodiments of the invention. Accordingly, the verifier application 1150 may utilize a set of verifier keys 1170 to affirm blockchain entries. When blockchain entries can be verified, the verifier application 1150 may transmit blocks to the corresponding blockchains. The verifier application 1150 can also implement some or all of the various functions described above with reference to verifiers as appropriate to the requirements of a given application in accordance with various embodiments of the invention.

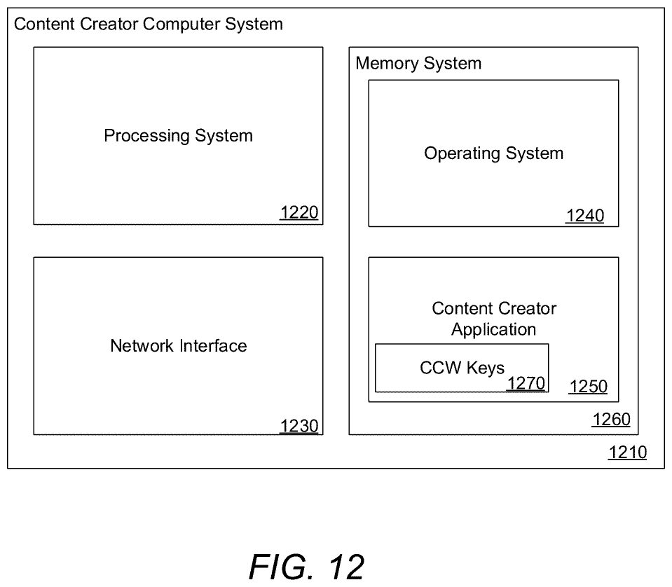

A content creator system 1210 capable of disseminating content in an NFT platform in accordance with an embodiment of the invention is illustrated in FIG. 12. The memory system 1260 of the content creator computer system may include an operating system 1240 and a content creator application 1250. The content creator application 1250 may enable the content creator computer system to mint NFTs by writing smart contracts to blockchains via the network interface 1230. The content creator application can include sets of content creator wallet (CCW) keys 1270 that can include a public key/private key pairs. Content creator applications may use these keys to sign NFTs minted by the content creator application. The content creator application can also implement some or all of the various functions described above with reference to content creators as appropriate to the requirements of a given application in accordance with various embodiments of the invention.

Computer systems in accordance with many embodiments of the invention incorporate digital wallets (herein also referred to as “wallets” or “media wallets”) for NFT and/or fungible token storage. In several embodiments, the digital wallet may securely store rich media NFTs and/or other tokens. Additionally, in some embodiments, the digital wallet may display user interface through which user instructions concerning data access permissions can be received.

In a number of embodiments of the invention, digital wallets may be used to store at least one type of token-directed content. Example content types may include, but are not limited to cryptocurrencies of one or more sorts; non-fungible tokens; and user profile data.

Example user profile data may incorporate logs of user actions. In accordance with some embodiments of the invention, example anonymized user profile data may include redacted, encrypted, and/or otherwise obfuscated user data. User profile data in accordance with some embodiments may include, but are not limited to, information related to classifications of interests, determinations of a post-advertisement purchases, and/or characterizations of wallet contents.

Media wallets, when storing content, may store direct references to content. Media wallets may also reference content through keys to decrypt and/or access the content. Media wallets may use such keys to additionally access metadata associated with the content. Example metadata may include, but is not limited to, classifications of content. In a number of embodiments, the classification metadata may govern access rights of other parties related to the content.

Access governance rights may include, but are not limited to, whether a party can indicate their relationship with the wallet; whether they can read summary data associated with the content; whether they have access to peruse the content; whether they can place bids to purchase the content; whether they can borrow the content, and/or whether they are biometrically authenticated.

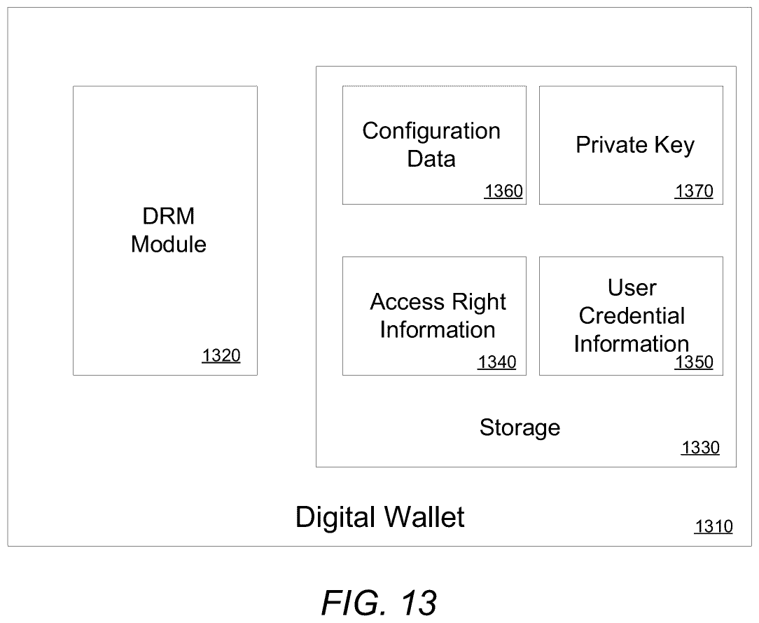

An example of a media wallet 1310 capable of storing rich media NFTs in accordance with an embodiment of the invention is illustrated in FIG. 13. Media wallets 1310 may include a storage component 1330, including access right information 1340, user credential information 1350, token configuration data 1360, and/or at least one private key 1370. In accordance with many embodiments of the invention, a private key 1370 may be used to perform a plurality of actions on resources, including but not limited to decrypting NFT and/or fungible token content. Media wallets may also correspond to a public key, referred to as a wallet address. An action performed by private keys 1370 may be used to prove access rights to digital rights management modules. Additionally, private keys 1370 may be applied to initiating ownership transfers and granting NFT and/or fungible token access to alternate wallets. In accordance with some embodiments, access right information 1340 may include lists of elements that the wallet 1310 has access to. Access right information 1340 may also express the type of access provided to the wallet. Sample types of access include, but are not limited to, the right to transfer NFT and/or fungible ownership, the right to play rich media associated with a given NFT, and the right to use an NFT and/or fungible token. Different rights may be governed by different cryptographic keys. Additionally, the access right information 1340 associated with a given wallet 1310 may utilize user credential information 1350 from the party providing access.

In accordance with many embodiments of the invention, third parties initiating actions corresponding to requesting access to a given NFT may require user credential information 1350 of the party providing access to be verified. User credential information 1350 may be taken from the group including, but not limited to, a digital signature, hashed passwords, PINs, and biometric credentials. User credential information 1350 may be stored in a manner accessible only to approved devices. In accordance with some embodiments of the invention, user credential information 1350 may be encrypted using a decryption key held by trusted hardware, such as a trusted execution environment. Upon verification, user credential information 1350 may be used to authenticate wallet access.

Available access rights may be determined by digital rights management (DRM) modules 1320 of wallets 1310. In the context of rich media, encryption may be used to secure content. As such, DRM systems may refer to technologies that control the distribution and use of keys required to decrypt and access content. DRM systems in accordance with many embodiments of the invention may require a trusted execution zone. Additionally, said systems may require one or more keys (typically a certificate containing a public key/private key pair) that can be used to communicate with and register with DRM servers. DRM modules 1320 in some embodiments may also use one or more keys to communicate with a DRM server. In several embodiments, the DRM modules 1320 may include code used for performing sensitive transactions for wallets including, but not limited to, content access. In accordance with a number of embodiments of the invention, the DRM module 1320 may execute in a Trusted Execution Environment. In a number of embodiments, the DRM may be facilitated by an Operating System (OS) that enables separation of processes and processing storage from other processes and their processing storage.

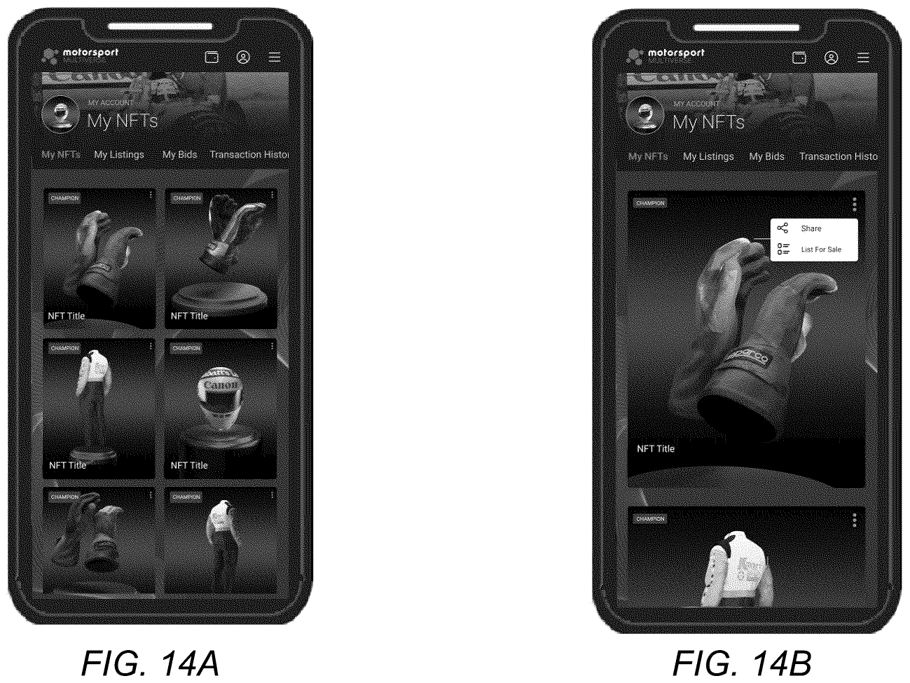

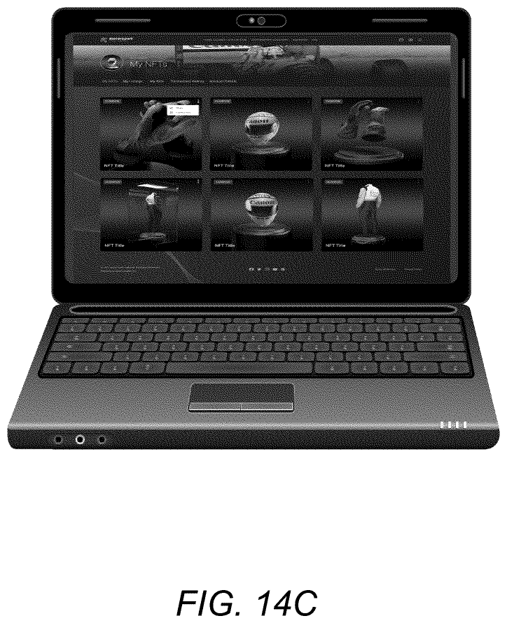

Operation of media wallet applications implemented in accordance with some embodiments of the invention is conceptually illustrated by way of the user interfaces shown in FIGS. 14A-14C. In many embodiments, media wallet applications can refer to applications that are installed upon user devices such as (but not limited to) mobile phones and tablet computers running the iOS, Android and/or similar operating systems. Launching media wallet applications can provide a number of user interface contexts. In many embodiments, transitions between these user interface contexts can be initiated in response to gestures including (but not limited to) swipe gestures received via a touch user interface. As can readily be appreciated, the specific manner in which user interfaces operate through media wallet applications is largely dependent upon the user input capabilities of the underlying user device. In several embodiments, a first user interface context is a dashboard (see, FIGS. 14A, 14C) that can include a gallery view of NFTs owned by the user. In several embodiments, the NFT listings can be organized into category index cards. Category index cards may include, but are not limited to digital merchandise/collectibles, special event access/digital tickets, fan leaderboards. In certain embodiments, a second user interface context (see, for example, FIG. 14B) may display individual NFTs. In a number of embodiments, each NFT can be main-staged in said display with its status and relevant information shown. Users can swipe through each collectible and interacting with the user interface can launch a collectible user interface enabling greater interaction with a particular collectible in a manner that can be determined based upon the smart contract underlying the NFT.

A participant of an NFT platform may use a digital wallet to classify wallet content, including NFTs, fungible tokens, content that is not expressed as tokens such as content that has not yet been minted but for which the wallet can initiate minting, and other non-token content, including executable content, webpages, configuration data, history files and logs. This classification may be performed using a visual user interface. Users interface may enable users to create a visual partition of a space. In some embodiments of the invention, a visual partition may in turn be partitioned into sub-partitions. In some embodiments, a partition of content may separate wallet content into content that is not visible to the outside world (“invisible partition”), and content that is visible at least to some extent by the outside world (“visible partition”). Some of the wallet content may require the wallet use to have an access code such as a password or a biometric credential to access, view the existence of, or perform transactions on. A visible partition may be subdivided into two or more partitions, where the first one corresponds to content that can be seen by anybody, the second partition corresponds to content that can be seen by members of a first group, and/or the third partition corresponds to content that can be seen by members of a second group.

For example, the first group may be users with which the user has created a bond, and invited to be able to see content. The second group may be users who have a membership and/or ownership that may not be controlled by the user. An example membership may be users who own non-fungible tokens (NFTs) from a particular content creator. Content elements, through icons representing the elements, may be relocated into various partitions of the space representing the user wallet. By doing so, content elements may be associated with access rights governed by rules and policies of the given partition.

One additional type of visibility may be partial visibility. Partial visibility can correspond to a capability to access metadata associated with an item, such as an NFT and/or a quantity of crypto funds, but not carry the capacity to read the content, lend it out, or transfer ownership of it. As applied to a video NFT, an observer to a partition with partial visibility may not be able to render the video being encoded in the NFT but see a still image of it and a description indicating its source.

Similarly, a party may have access to a first anonymized profile which states that the user associated with the wallet is associated with a given demographic. The party with this access may also be able to determine that a second anonymized profile including additional data is available for purchase. This second anonymized profile may be kept in a sub-partition to which only people who pay a fee have access, thereby expressing a form of membership. Alternatively, only users that have agreed to share usage logs, aspects of usage logs or parts thereof may be allowed to access a given sub-partition. By agreeing to share usage log information with the wallet comprising the sub-partition, this wallet learns of the profiles of users accessing various forms of content, allowing the wallet to customize content, including by incorporating advertisements, and to determine what content to acquire to attract users of certain demographics.

Another type of membership may be held by advertisers who have sent promotional content to the user. These advertisers may be allowed to access a partition that stores advertisement data. Such advertisement data may be encoded in the form of anonymized profiles. In a number of embodiments, a given sub-partition may be accessible only to the advertiser to whom the advertisement data pertains. Elements describing advertisement data may be automatically placed in their associated partitions, after permission has been given by the user. This partition may either be visible to the user. Visibility may also depend on a direct request to see “system partitions.” A first partition may correspond to material associated with a first set of public keys, a second partition to material associated with a second set of public keys not overlapping with the first set of public keys, wherein such material may comprise tokens such as crypto coins and NFTs. A third partition may correspond to usage data associated with the wallet user, and a fourth partition may correspond to demographic data and/or preference data associated with the wallet user. Yet other partitions may correspond to classifications of content, e.g., child-friendly vs. adult; classifications of whether associated items are for sale or not, etc.

The placing of content in a given partition may be performed by a drag-and-drop action performed on a visual interface. By selecting items and clusters and performing a drag-and-drop to another partition and/or to a sub-partition, the visual interface may allow movement including, but not limited to, one item, a cluster of items, and a multiplicity of items and clusters of items. The selection of items can be performed using a lasso approach in which items and partitions are circled as they are displayed. The selection of items may also be performed by alternative methods for selecting multiple items in a visual interface, as will be appreciated by a person of skill in the art.

Some content classifications may be automated in part or full. For example, when user place ten artifacts, such as NFTs describing in-game capabilities, in a particular partition, they may be asked if additional content that are also in-game capabilities should be automatically placed in the same partition as they are acquired and associated with the wallet. When “yes” is selected, then this placement may be automated in the future. When “yes, but confirm for each NFT” is selected, then users can be asked, for each automatically classified element, to confirm its placement. Before the user confirms, the element may remain in a queue that corresponds to not being visible to the outside world. When users decline given classifications, they may be asked whether alternative classifications should be automatically performed for such elements onwards. In some embodiments, the selection of alternative classifications may be based on manual user classification taking place subsequent to the refusal.

Automatic classification of elements may be used to perform associations with partitions and/or folders. The automatic classification may be based on machine learning (ML) techniques considering characteristics including, but not limited to, usage behaviors exhibited by the user relative to the content to be classified, labels associated with the content, usage statistics; and/or manual user classifications of related content.

Multiple views of wallets may also be accessible. One such view can correspond to the classifications described above, which indicates the actions and interactions others can perform relative to elements. Another view may correspond to a classification of content based on use, type, and/or users-specified criterion. For example, all game NFTs may be displayed in one collection view. The collection view may further subdivide the game NFTs into associations with different games or collections of games. Another collection may show all audio content, clustered based on genre. users-specified classification may be whether the content is for purposes of personal use, investment, or both. A content element may show up in multiple views. users can search the contents of their wallet by using search terms that result in potential matches.

Alternatively, the collection of content can be navigated based the described views of particular wallets, allowing access to content. Once a content element has been located, the content may be interacted with. For example, located content elements may be rendered. One view may be switched to another after a specific item is found. For example, this may occur through locating an item based on its genre and after the item is found, switching to the partitioned view described above. In some embodiments, wallet content may be rendered using two or more views in a simultaneous manner. They may also select items using one view.

Media wallet applications in accordance with various embodiments of the invention are not limited to use within NFT platforms. Accordingly, it should be appreciated that applications described herein can also be implemented outside the context of an NFT platform network architecture unrelated to the storage of fungible tokens and/or NFTs. Moreover, any of the computer systems described herein with reference to FIGS. 10-14C can be utilized within any of the NFT platforms described above.

### NFT Platform NFT Interactions

NFT platforms in accordance with many embodiments of the invention may incorporate a wide variety of rich media NFT configurations. The term “Rich Media Non-Fungible Tokens” can be used to refer to blockchain-based cryptographic tokens created with respect to a specific piece of rich media content and which incorporate programmatically defined digital rights management. In some embodiments of the invention, each NFT may have a unique serial number and be associated with a smart contract defining an interface that enables the NFT to be managed, owned and/or traded.

Under a rich media blockchain in accordance with many embodiments of the invention, a wide variety of NFT configurations may be implemented. Some NFTs may be referred to as anchored NFTs (or anchored tokens), used to tie some element, such as a physical entity, to an identifier. Of this classification, one sub-category may be used to tie users' real-world identities and/or identifiers to a system identifier, such as a public key. In this disclosure, this type of NFT applied to identifying users, may be called a social NFT, identity NFT, identity token, and a social token. In accordance with many embodiments of the invention, an individual's personally identifiable characteristics may be contained, maintained, and managed throughout their lifetime so as to connect new information and/or NFTs to the individual's identity. A social NFT's information may include, but are not limited to, personally identifiable characteristics such as name, place and date of birth, and/or biometrics.

An example social NFT may assign a DNA print to a newborn's identity. In accordance with a number of embodiments of the invention, this first social NFT might then be used in the assignment process of a social security number NFT from the federal government. In some embodiments, the first social NFT may then be associated with some rights and capabilities, which may be expressed in other NFTs. Additional rights and capabilities may also be directly encoded in a policy of the social security number NFT.

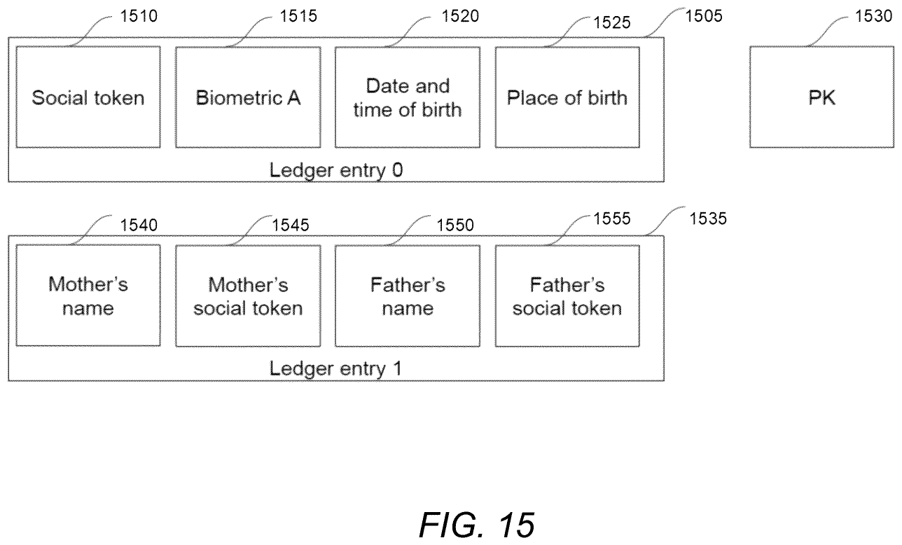

A social NFT may exist on a personalized branch of a centralized and/or decentralized blockchain. Ledger entries related to an individual's social NFT in accordance with several embodiments of the invention are depicted in FIG. 15. Ledger entries of this type may be used to build an immutable identity foundation whereby biometrics, birth and parental information are associated with an NFT. As such, this information may also be protected with encryption using a private key 1530. The initial entry in a ledger, “ledger entry 0” 1505, may represent a social token 1510 assignment to an individual with a biometric “A” 1515. In this embodiment, the biometric may include but is not limited to a footprint, a DNA print, and a fingerprint. The greater record may also include the individual's date and time of birth 1520 and place of birth 1525. A subsequent ledger entry 1 1535 may append parental information including but not limited to mothers' name 1540, mother's social token 1545, father's name 1550, and father's social token 1555.

In a number of embodiments, the various components that make up a social NFT may vary from situation to situation. In a number of embodiments, biometrics and/or parental information may be unavailable in a given situation and/or period of time. Other information including, but not limited to, race, gender, and governmental number assignments such as social security numbers, may be desirable to include in the ledger. In a blockchain, future NFT creation may create a life-long ledger record of an individual's public and private activities. In accordance with some embodiments, the record may be associated with information including, but not limited to, identity, purchases, health and medical records, access NFTs, family records such as future offspring, marriages, familial history, photographs, videos, tax filings, and/or patent filings. The management and/or maintenance of an individual's biometrics throughout the individual's life may be immutably connected to the first social NFT given the use of a decentralized blockchain ledger.

In some embodiments, a certifying third party may generate an NFT associated with certain rights upon the occurrence of a specific event. In one such embodiment, the DMV may be the certifying party and generate an NFT associated with the right to drive a car upon issuing a traditional driver's license. In another embodiment, the certifying third party may be a bank that verifies a person's identity papers and generates an NFT in response to a successful verification. In a third embodiment, the certifying party may be a car manufacturer, who generates an NFT and associates it with the purchase and/or lease of a car.

In many embodiments, a rule may specify what types of policies the certifying party may associate with the NFT. Additionally, a non-certified entity may also generate an NFT and assert its validity. This may require putting up some form of security. In one example, security may come in the form of a conditional payment associated with the NFT generated by the non-certified entity. In this case, the conditional payment may be exchangeable for funds if abuse can be detected by a bounty hunter and/or some alternate entity. Non-certified entities may also relate to a publicly accessible reputation record describing the non-certified entity's reputability.

Anchored NFTs may additionally be applied to automatic enforcement of programming rules in resource transfers. NFTs of this type may be referred to as promise NFTs. A promise NFT may include an agreement expressed in a machine-readable form and/or in a human-accessible form. In a number of embodiments, the machine-readable and human-readable elements can be generated one from the other. In some embodiments, an agreement in a machine-readable form may include, but is not limited to, a policy and/or an executable script. In some embodiments, an agreement in a human-readable form may include, but is not limited to, a text and/or voice-based statement of the promise.

In some embodiments, regardless of whether the machine-readable and human-readable elements are generated from each other, one can be verified based on the other. Smart contracts including both machine-readable statements and human-accessible statements may also be used outside the implementation of promise NFTs. Moreover, promise NFTs may be used outside actions taken by individual NFTs and/or NFT-owners. In some embodiments, promise NFTs may relate to general conditions, and may be used as part of a marketplace.

In one such example, horse betting may be performed through generating a first promise NFT that offers a payment of $10 if a horse does not win. Payment may occur under the condition that the first promise NFT is matched with a second promise NFT that causes a transfer of funds to a public key specified with the first promise NFT if horse X wins.

A promise NFT may be associated with actions that cause the execution of a policy and/or rule indicated by the promise NFT. In some embodiments of the invention, a promise of paying a charity may be associated with the sharing of an NFT. In this embodiment, the associated promise NFT may identify a situation that satisfies the rule associated with the promise NFT, thereby causing the transfer of funds when the condition is satisfied (as described above). One method of implementation may be embedding in and/or associating a conditional payment with the promise NFT. A conditional payment NFT may induce a contract causing the transfer of funds by performing a match. In some such methods, the match may be between the promise NFT and inputs that identify that the conditions are satisfied, where said input can take the form of another NFT. In a number of embodiments, one or more NFTs may also relate to investment opportunities.

For example, a first NFT may represent a deed to a first building, and a second NFT a deed to a second building. Moreover, the deed represented by the first NFT may indicate that a first party owns the first property. The deed represented by the second NFT may indicate that a second party owns the second property. A third NFT may represent one or more valuations of the first building. The third NFT may in turn be associated with a fourth NFT that may represent credentials of a party performing such a valuation. A fifth NFT may represent one or more valuations of the second building. A sixth may represent the credentials of one of the parties performing a valuation. The fourth and sixth NFTs may be associated with one or more insurance policies, asserting that if the parties performing the valuation are mistaken beyond a specified error tolerance, then the insurer would pay up to a specified amount.

A seventh NFT may then represent a contract that relates to the planned acquisition of the second building by the first party, from the second party, at a specified price. The seventh NFT may make the contract conditional provided a sufficient investment and/or verification by a third party. A third party may evaluate the contract of the seventh NFT, and determine whether the terms are reasonable. After the evaluation, the third party may then verify the other NFTs to ensure that the terms stated in the contract of the seventh NFT agree. If the third party determines that the contract exceeds a threshold in terms of value to risk, as assessed in the seventh NFT, then executable elements of the seventh NFT may cause transfers of funds to an escrow party specified in the contract of the sixth NFT.

Alternatively, the first party may initiate the commitment of funds, conditional on the remaining funds being raised within a specified time interval. The commitment of funds may occur through posting the commitment to a ledger. Committing funds may produce smart contracts that are conditional on other events, namely the payments needed to complete the real estate transaction. The smart contract also may have one or more additional conditions associated with it. For example, an additional condition may be the reversal of the payment if, after a specified amount of time, the other funds have not been raised. Another condition may be related to the satisfactory completion of an inspection and/or additional valuation.

NFTs may also be used to assert ownership of virtual property. Virtual property in this instance may include, but is not limited to, rights associated with an NFT, rights associated with patents, and rights associated with pending patents. In a number of embodiments, the entities involved in property ownership may be engaged in fractional ownership. In some such embodiments, two parties may wish to purchase an expensive work of digital artwork represented by an NFT. The parties can enter into smart contracts to fund and purchase valuable works. After a purchase, an additional NFT may represent each party's contribution to the purchase and equivalent fractional share of ownership.

Another type of NFTs that may relate to anchored NFTs may be called “relative NFTs.” This may refer to NFTs that relate two or more NFTs to each other. Relative NFTs associated with social NFTs may include digital signatures that is verified using a public key of a specific social NFT. In some embodiments, an example of a relative NFT may be an assertion of presence in a specific location, by a person corresponding to the social NFT. This type of relative NFT may also be referred to as a location NFT and a presence NFT. Conversely, a signature verified using a public key embedded in a location NFT may be used as proof that an entity sensed by the location NFT is present. Relative NFTs are derived from other NFTs, namely those they relate to, and therefore may also be referred to as derived NFTs. An anchored NFT may tie to another NFT, which may make it both anchored and relative. An example of such may be called pseudonym NFTs.

Pseudonym NFTs may be a kind of relative NFT acting as a pseudonym identifier associated with a given social NFT. In some embodiments, pseudonym NFTs may, after a limited time and/or a limited number of transactions, be replaced by a newly derived NFTs expressing new pseudonym identifiers. This may disassociate users from a series of recorded events, each one of which may be associated with different pseudonym identifiers. A pseudonym NFT may include an identifier that is accessible to biometric verification NFTs. Biometric verification NFTs may be associated with a TEE and/or DRM which is associated with one or more biometric sensors. Pseudonym NFTs may be output by social NFTs and/or pseudonym NFTs.

Inheritance NFTs may be another form of relative NFTs, that transfers rights associated with a first NFT to a second NFT. For example, computers, represented by an anchored NFT that is related to a physical entity (the hardware), may have access rights to WiFi networks. When computers are replaced with newer models, users may want to maintain all old relationships, for the new computer. For example, users may want to retain WiFi hotspots. For this to be facilitated, a new computer can be represented by an inheritance NFT, inheriting rights from the anchored NFT related to the old computer. An inheritance NFT may acquire some or all pre-existing rights associated with the NFT of the old computer, and associate those with the NFT associated with the new computer.

More generally, multiple inheritance NFTs can be used to selectively transfer rights associated with one NFT to one or more NFTs, where such NFTs may correspond to users, devices, and/or other entities, when such assignments of rights are applicable. Inheritance NFTs can also be used to transfer property. One way to implement the transfer of property can be to create digital signatures using private keys. These private keys may be associated with NFTs associated with the rights. In accordance with a number of embodiments, transfer information may include the assignment of included rights, under what conditions the transfer may happen, and to what NFT(s) the transfer may happen. In this transfer, the assigned NFTs may be represented by identifies unique to these, such as public keys. The digital signature and message may then be in the form of an inheritance NFT, or part of an inheritance NFT. As rights are assigned, they may be transferred away from previous owners to new owners through respective NFTs. Access to financial resources is one such example.

However, sometimes rights may be assigned to new parties without taking the same rights away from the party (i.e., NFT) from which the rights come. One example of this may be the right to listen to a song, when a license to the song is sold by the artist to consumers. However, if the seller sells exclusive rights, this causes the seller not to have the rights anymore.

In accordance with many embodiments of the invention, multiple alternative NFT configurations may be implemented. One classification of NFT may be an employee NFT or employee token. Employee NFTs may be used by entities including, but not limited to, business employees, students, and organization members. Employee NFTs may operate in a manner analogous to key card photo identifications. In a number of embodiments, employee NFTs may reference information including, but not limited to, company information, employee identity information and/or individual identity NFTs.

Additionally, employee NFTs may include associated access NFT information including but not limited to, what portions of a building employees may access, and what computer system employees may utilize. In several embodiments, employee NFTs may incorporate their owner's biometrics, such as a face image. In a number of embodiments, employee NFTs may operate as a form of promise NFT. In some embodiments, employee NFT may comprise policies or rules of employing organization. In a number of embodiments, the employee NFT may reference a collection of other NFTs.

Another type of NFT may be referred to as the promotional NFT or promotional token. Promotional NFTs may be used to provide verification that promoters provide promotion winners with promised goods. In some embodiments, promotional NFTs may operate through decentralized applications for which access restricted to those using an identity NFT. The use of a smart contract with a promotional NFT may be used to allow for a verifiable release of winnings. These winnings may include, but are not limited to, cryptocurrency, money, and gift card NFTs useful to purchase specified goods. Smart contracts used alongside promotional NFTs may be constructed for winners selected through random number generation.

Another type of NFT may be called the script NFT or script token. Script tokens may incorporate script elements including, but not limited to, story scripts, plotlines, scene details, image elements, avatar models, sound profiles, and voice data for avatars. Script tokens may also utilize rules and policies that describe how script elements are combined. Script tokens may also include rightsholder information, including but not limited to, licensing and copyright information. Executable elements of script tokens may include instructions for how to process inputs; how to configure other elements associated with the script tokens; and how to process information from other tokens used in combination with script tokens.

Script tokens may be applied to generate presentations of information. In accordance with some embodiments, these presentations may be developed on devices including but not limited to traditional computers, mobile computers, and virtual reality display devices. Script tokens may be used to provide the content for game avatars, digital assistant avatars, and/or instructor avatars. Script tokens may comprise audio-visual information describing how input text is presented, along with the input text that provides the material to be presented. It may also comprise what may be thought of as the personality of the avatar, including how the avatar may react to various types of input from an associated user.

In some embodiments, script NFTs may be applied to govern behavior within an organization. For example, this may be done through digital signatures asserting the provenance of the scripts. Script NFTs may also, in full and/or in part, be generated by freelancers. For example, a text script related to a movie, an interactive experience, a tutorial, and/or other material, may be created by an individual content creator. This information may then be combined with a voice model or avatar model created by an established content producer. The information may then be combined with a background created by additional parties. Various content producers can generate parts of the content, allowing for large-scale content collaboration.

Features of other NFTs can be incorporated in a new NFT using techniques related to inheritance NFTs, and/or by making references to other NFTs. As script NFTs may consist of multiple elements, creators with special skills related to one particular element may generate and combine elements. This may be used to democratize not only the writing of storylines for content, but also outsourcing for content production. For each such element, an identifier establishing the origin or provenance of the element may be included. Policy elements can also be incorporated that identify the conditions under which a given script element may be used. Conditions may be related to, but are not limited to execution environments, trusts, licenses, logging, financial terms for use, and various requirements for the script NFTs. Requirements may concern, but are not limited to, what other types of elements the given element are compatible with, what is allowed to be combined with according the terms of service, and/or local copyright laws that must be obeyed.

Evaluation units may be used with various NFT classifications to collect information on their use. Evaluation units may take a graph representing subsets of existing NFTs and make inferences from the observed graph component. From this, valuable insights into NFT value may be derived. For example, evaluation units may be used to identify NFTs whose popularity is increasing or waning. In that context, popularity may be expressed as, but not limited to, the number of derivations of the NFT that are made; the number of renderings, executions or other uses are made; and the total revenue that is generated to one or more parties based on renderings, executions or other uses.

Evaluation units may make their determination through specific windows of time and/or specific collections of end-users associated with the consumption of NFT data in the NFTs. Evaluation units may limit assessments to specific NFTs (e.g. script NFTs). This may be applied to identify NFTs that are likely to be of interest to various users. In addition, the system may use rule-based approaches to identify NFTs of importance, wherein importance may be ascribed to, but is not limited to, the origination of the NFTs, the use of the NFTs, the velocity of content creation of identified clusters or classes, the actions taken by consumers of NFT, including reuse of NFTs, the lack of reuse of NFTs, and the increased or decreased use of NFTs in selected social networks.

Evaluations may be repurposed through recommendation mechanisms for individual content consumers and/or as content originators. Another example may address the identification of potential combination opportunities, by allowing ranking based on compatibility. Accordingly, content creators such as artists, musicians and programmers can identify how to make their content more desirable to intended target groups.

The generation of evaluations can be supported by methods including, but not limited to machine learning (ML) methods, artificial intelligence (AI) methods, and/or statistical methods. Anomaly detection methods developed to identify fraud can be repurposed to identify outliers. This can be done to flag abuse risks or to improve the evaluation effort.

Multiple competing evaluation units can make competing predictions using alternative and proprietary algorithms. Thus, different evaluation units may be created to identify different types of events to different types of subscribers, monetizing their insights related to the data they access.

In a number of embodiments, evaluation units may be a form of NFTs that derive insights from massive amounts of input data. Input data may correspond, but is not limited to the graph component being analyzed. Such NFTs may be referred to as evaluation unit NFTs.

The minting of NFTs may associate rights with first owners and/or with an optional one or more policies and protection modes. An example policy and/or protection mode directed to financial information may express royalty requirements. An example policy and/or protection mode directed to non-financial requirements may express restrictions on access and/or reproduction. An example policy directed to data collection may express listings of user information that may be collected and disseminated to other participants of the NFT platform.

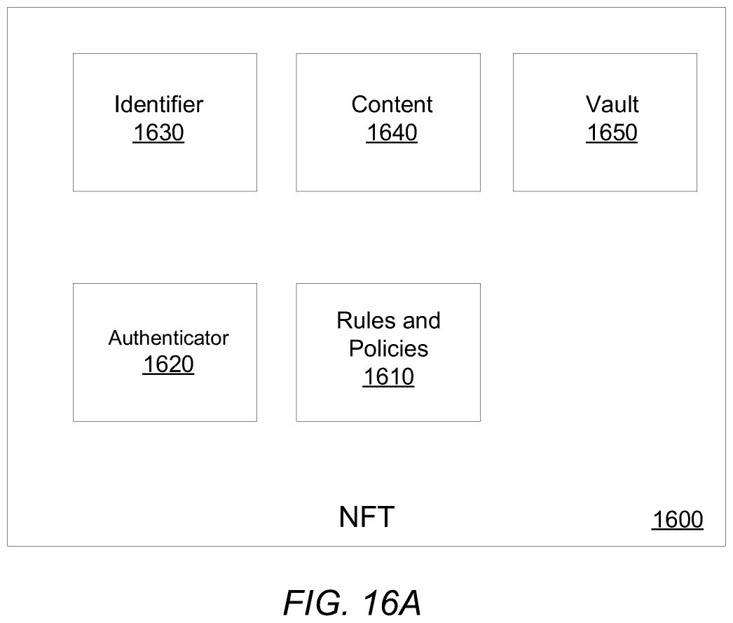

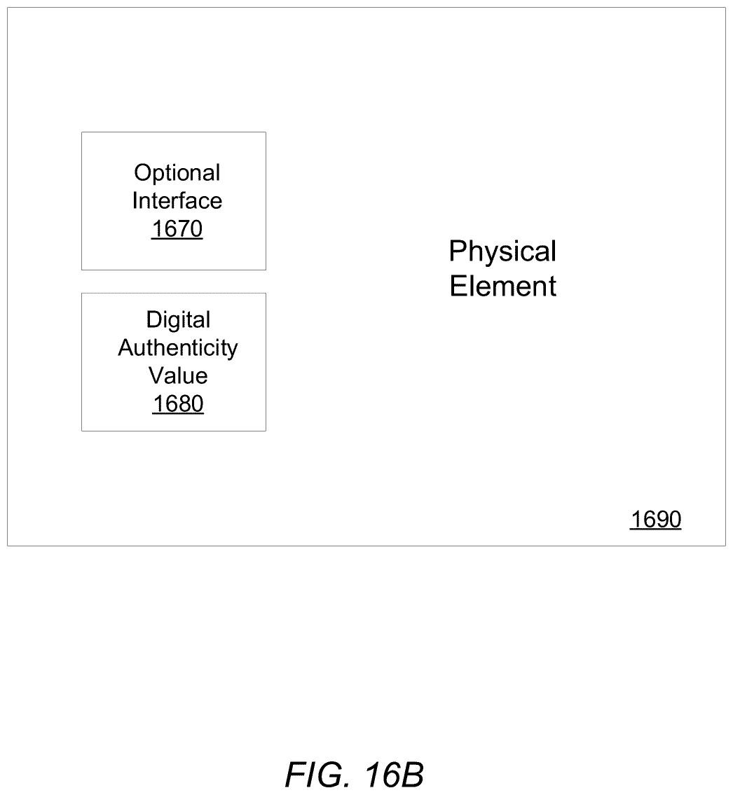

An example NFT which may be associated with specific content in accordance with several embodiments of the invention is illustrated in FIG. 16A. In some embodiments, an NFT 1600 may utilize a vault 1650, which may control access to external data storage areas. Methods of controlling access may include, but are not limited to, user credential information 1350. In accordance with a number of embodiments of the invention, control access may be managed through encrypting content 1640. As such, NFTs 1600 can incorporate content 1640, which may be encrypted, not encrypted, yet otherwise accessible, or encrypted in part. In accordance with some embodiments, an NFT 1600 may be associated with one or more content 1640 elements, which may be contained in or referenced by the NFT. A content 1640 element may include, but is not limited to, an image, an audio file, a script, a biometric user identifier, and/or data derived from an alternative source. An example alternative source may be a hash of biometric information). An NFT 1600 may also include an authenticator 1620 capable of affirming that specific NFTs are valid.

In accordance with many embodiments of the invention, NFTs may include a number of rules and policies 1610. Rules and policies 1610 may include, but are not limited to access rights information 1340. In some embodiments, rules and policies 1610 may also state terms of usage, royalty requirements, and/or transfer restrictions. An NFT 1600 may also include an identifier 1630 to affirm ownership status. In accordance with many embodiments of the invention, ownership status may be expressed by linking the identifier 1630 to an address associated with a blockchain entry.

In accordance with a number of embodiments of the invention, NFTs may represent static creative content. NFTs may also be representative of dynamic creative content, which changes over time. In accordance with many examples of the invention, the content associated with an NFT may be a digital content element.

One example of a digital content element in accordance with some embodiments may be a set of five images of a mouse. In this example, the first image may be an image of the mouse being alive. The second may be an image of the mouse eating poison. The third may be an image of the mouse not feeling well. The fourth image may be of the mouse, dead. The fifth image may be of a decaying mouse.

The user credential information 1350 of an NFT may associate each image to an identity, such as of the artist. In accordance with a number of embodiments of the invention, NFT digital content can correspond to transitions from one representation (e.g., an image of the mouse, being alive) to another representation (e.g., of the mouse eating poison). In this disclosure, digital content transitioning from one representation to another may be referred to as a state change and/or an evolution. In a number of embodiments, an evolution may be triggered by the artist, by an event associated with the owner of the artwork, randomly, and/or by an external event.

When NFTs representing digital content are acquired in accordance with some embodiments of the invention, they may also be associated with the transfer of corresponding physical artwork, and/or the rights to said artwork. The first ownership records for NFTs may correspond to when the NFT was minted, at which time its ownership can be assigned to the content creator. Additionally, in the case of “lazy” minting, rights may be directly assigned to a buyer.

In some embodiments, as a piece of digital content evolves, it may also change its representation. The change in NFTs may also send a signal to an owner after it has evolved. In doing so, a signal may indicate that the owner has the right to acquire the physical content corresponding to the new state of the digital content. Under an earlier example, buying a live mouse artwork, as an NFT, may also carry the corresponding painting, and/or the rights to it. A physical embodiment of an artwork that corresponds to that same NFT may also be able to replace the physical artwork when the digital content of the NFT evolves. For example, should the live mouse artwork NFT change states to a decaying mouse, an exchange may be performed of the corresponding painting for a painting of a decaying mouse.

The validity of one of the elements, such as the physical element, can be governed by conditions related to an item with which it is associated. For example, a physical painting may have a digital authenticity value that attests to the identity of the content creator associated with the physical painting.

An example of a physical element 1690 corresponding to an NFT, in accordance with some embodiments of the invention is illustrated in FIG. 16B. A physical element 1690 may be a physical artwork including, but not limited to, a drawing, a statue, and/or another physical representation of art. In a number of embodiments, physical representations of the content (which may correspond to a series of paintings) may each be embedded with a digital authenticity value (or a validator value) value. In accordance with many embodiments of the invention, a digital authenticity value (DAV) 1680 may be therefore be associated with a physical element 1690 and a digital element. A digital authenticity value may be a value that includes an identifier and a digital signature on the identifier. In some embodiments the identifier may specify information related to the creation of the content. This information may include the name of the artist, the identifier 1630 of the digital element corresponding to the physical content, a serial number, information such as when it was created, and/or a reference to a database in which sales data for the content is maintained. A digital signature element affirming the physical element may be made by the content creator and/or by an authority associating the content with the content creator.

In some embodiments, the digital authenticity value 1680 of the physical element 1690 can be expressed using a visible representation. The visible representation may be an optional physical interface 1670 taken from a group including, but not limited to, a barcode and a quick response (QR) code encoding the digital authenticity value. In some embodiments, the encoded value may also be represented in an authenticity database. Moreover, the physical interface 1670 may be physically associated with the physical element. One example of such may be a QR tag being glued to or printed on the back of a canvas. In some embodiments of the invention, the physical interface 1670 may be possible to physically disassociate from the physical item it is attached to. However, if a DAV 1680 is used to express authenticity of two or more physical items, the authenticity database may detect and block a new entry during the registration of the second of the two physical items. For example, if a very believable forgery is made of a painting the forged painting may not be considered authentic without the QR code associated with the digital element.

In a number of embodiments, the verification of the validity of a physical item, such as a piece of artwork, may be determined by scanning the DAV. In some embodiments, scanning the DAV may be used to determine whether ownership has already been assigned. Using techniques like this, each physical item can be associated with a control that prevents forgeries to be registered as legitimate, and therefore, makes them not valid. In the context of a content creator receiving a physical element from an owner, the content creator can deregister the physical element 1690 by causing its representation to be erased from the authenticity database used to track ownership. Alternatively, in the case of an immutable blockchain record, the ownership blockchain may be appended with new information. Additionally, in instances where the owner returns a physical element, such as a painting, to a content creator in order for the content creator to replace it with an “evolved” version, the owner may be required to transfer the ownership of the initial physical element to the content creator, and/or place the physical element in a stage of being evolved.

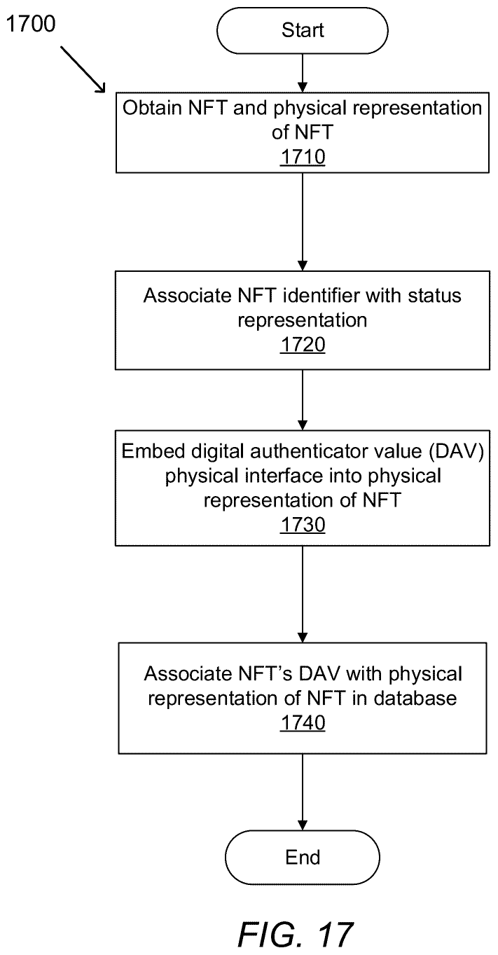

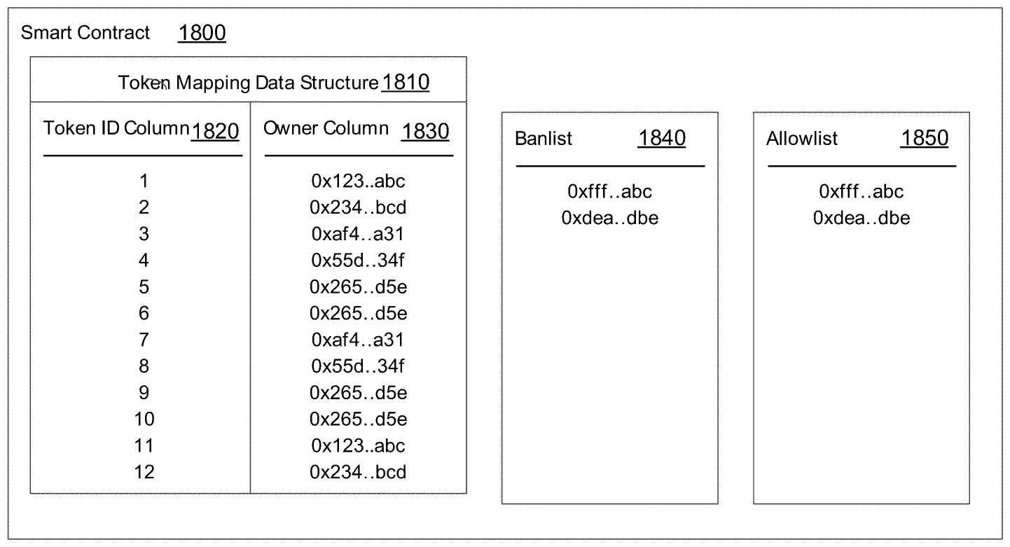

An example of a process for connecting an NFT digital element to physical content in accordance with some embodiments of the invention is illustrated in FIG. 17. Process 1700 may obtain (1710) an NFT and a physical representation of the NFT in connection with an NFT transaction. Under the earlier example, this may be a painting of a living mouse and an NFT of a living mouse. By virtue of establishing ownership of the NFT, the process 1700 may associate (1720) an NFT identifier with a status representation of the NFT. The NFT identifier may specify attributes including, but not limited to, the creator of the mouse painting and NFT (“Artist”), the blockchain the NFT is on (“NFT-Chain”), and an identifying value for the digital element (“no. 0001”). Meanwhile, the status representation may clarify the present state of the NFT (“alive mouse”). Process 1700 may also embed (1730) a DAV physical interface into the physical representation of the NFT. In a number of embodiments of the invention, this may be done by implanting a QR code into the back of the mouse painting. In affirming the connection between the NFT and painting, Process 1700 can associate (1740) the NFT's DAV with the physical representation of the NFT in a database. In some embodiments, the association can be performed through making note of the transaction and clarifying that it encapsulates both the mouse painting and the mouse NFT.

While specific processes are described above with reference to FIGS. 15-17, NFTs can be implemented in any of a number of different ways to enable as appropriate to the requirements of specific applications in accordance with various embodiments of the invention. Additionally, the specific manner in which NFTs can be utilized within NFT platforms in accordance with various embodiments of the invention is largely dependent upon the requirements of a given application.

### NFT Platform Royalty Enforcement

Systems and methods configured in accordance with many embodiments of the invention may enable token marketplaces to facilitate royalty payments due to the creators of tokens including but not limited to NFTs, fungible tokens, soul-bound tokens, cryptocurrencies, and/or other digital assets. In accordance with a number of embodiments, blockchain systems and smart contracts may be incorporated in order to enforce royalty payment requirements. Additionally or alternatively, systems configured in accordance with various embodiments of the invention may prevent token marketplaces and/or individuals that disregard royalty requirements and/or recommendations from owning and/or trading tokens.

Systems and methods in accordance with some embodiments of the invention may be generally applied in various subfields of regulatory compliance. In particular, the regulation of smart contracts and externally-owned addresses may involve identifying and governing harmful entities including but not limited to terrorists, sanctioned states, money launderers, and other prohibited entities.

In accordance with certain embodiments of the invention, smart contracts may enforce royalties by implementing data structures for instantiating tokens. The data structures may use token standards including but not limited to ERC-721, ERC-1155, and/or any of numerous other non-fungible token standards. Additionally or alternatively, smart contracts may implement functions for declaring royalty rates to be paid on token transactions including but not limited to token sales, token transfers, and/or token minting. Such functions may involve using royalty standards including but not limited to ERC-2981.

Smart contracts configured in accordance with many embodiments of the invention may include banlists used in order to reject access to tokens by particular prohibited entities. In accordance with a number of embodiments, smart contracts may incorporate data structures including but not limited to databases and extendible arrays that can incorporate addresses banned from receiving and/or owning tokens instantiated by the same smart contract(s).

Smart contracts configured in accordance with numerous embodiments of the invention may, upon receiving notice of attempted transactions, examine parties to the transaction (e.g., receivers of mintings and/or transfers) to determine they are on the banlist(s) for individual smart contracts. When smart contracts determine parties are not on the banlist, the transaction(s) may be enabled. As such, in the case of a minting transaction, a token may be minted to the receiver, and in the case of a transfer transaction, the token may be transferred to the receiver. In accordance with a number of embodiments, when parties are determined to be listed on the banlist(s), the parties' transactions may be rejected and/or ignored.

Additionally or alternatively, in accordance with many embodiments, smart contracts may include allowlist(s). In accordance with a number of embodiments, smart contracts may incorporate data structures including but not limited to databases and extendible arrays that can incorporate addresses allowed to receive and/or own tokens instantiated by the same smart contract(s).

Smart contracts configured in accordance with numerous embodiments of the invention may, upon receiving notice of attempted transactions, examine parties to the transaction (e.g., receivers of mintings and/or transfers) to determine they are on the allowlist(s) for individual smart contracts. When smart contracts determine parties are on the allowlist, the transaction(s) may be enabled. As such, in the case of a minting transaction, a token may be minted to the receiver, and in the case of a transfer transaction, the token may be transferred to the receiver. In accordance with numerous embodiment, when parties are determined to be unlisted on the allowlist(s), the parties' transactions may be rejected and/or ignored. Additionally or alternatively, when parties are determined to be unlisted on the allowlist(s), the transactions may be placed in quarantine states for review by third parties.

A block diagram illustrating a smart contract, configured in accordance with numerous embodiments of the invention, is illustrated in FIG. 18. The smart contract 1800 includes but is not limited to a token mapping data structure 1810, a banlist 1840, and an allowlist 1850.

Token mapping data structures 1810 may be utilized to instantiate various tokens including but not limited to NFTs. Token mapping data structures 1810 may use token ID columns 1820 and owner columns 1830. Each row of the token mapping data structure 1810 may include identifier(s) for individual associated tokens, listed in the token ID column 1820 and/or address(es) for individual owners of the individual associated tokens, listed in the owner column 1830. Smart contracts may be configured in a manner such that rows in the owner columns may only be edited and/or updated through transactions given some authorization by the corresponding smart contract. In accordance with some embodiments, authorization may involve transactions being digitally signed by private keys. Additionally or alternatively, the private keys may correspond to public keys that can be used to identify blockchain addresses (used as the identification in the owner columns 1830).

The smart contract 1800 includes a banlist 1840 and an allowlist 1850. In accordance with many embodiments, smart contracts may be configured in a manner such that a transaction fails when a party is listed in the banlist. Additionally or alternatively, smart contracts may be configured in a manner such that a transaction is allowed when a party is listed in the allowlist. For example, the transaction may be a transfer signed by an owner, requesting a transfer of an NFT from the owner as listed in the owner column to a recipient party. When listed in the banlist, the transfer to the recipient would be halted, but when listed in the allowlist, the transfer to the recipient would be allowed.

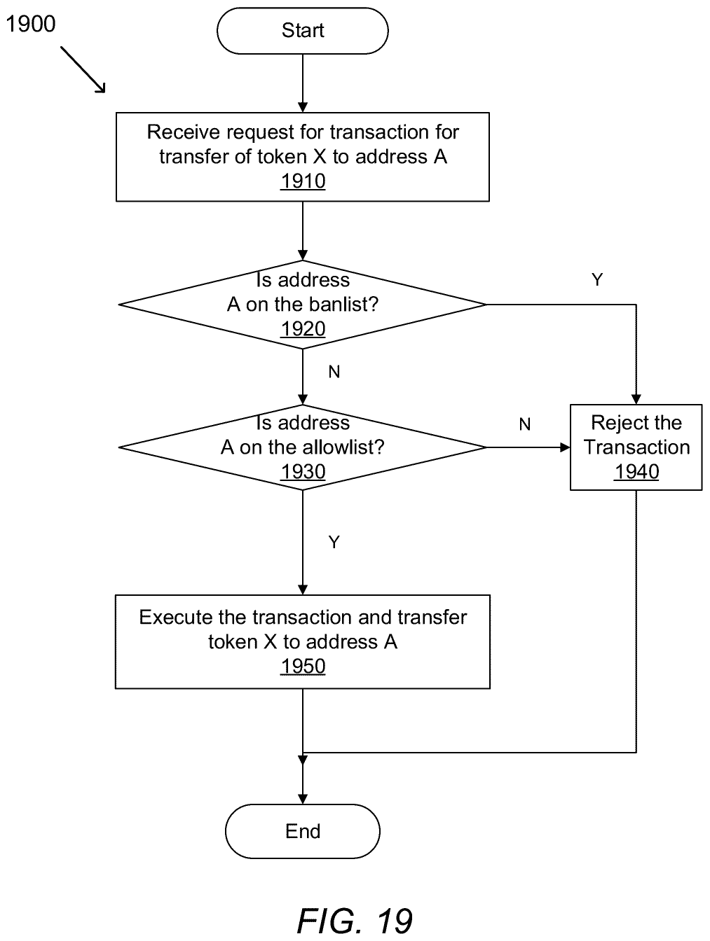

A process for determining whether a transaction may be allowed based on inspection of a banlist and allowlist is illustrated in FIG. 19. Process 1900 may be performed through entities including but not limited to smart contracts. Process 1900 receives (1910) a request for a transfer of a token X to an address A. Token transfers may also refer to the minting of tokens and/or various other token transactions. Process 1900 determines (1910) whether the address A is in a banlist. When address A is on the banlist, process 1900 rejects (1940) the transaction. In such cases, process may determine that the token X remains registered under its current owner. Additionally or alternatively, the smart contract may determine that the request to mint and/or otherwise modify the token X is refused. When address A is not on the banlist, process 1900 determines (1930) whether address A is in an allowlist. When address A is not on the allowlist, process 1900 rejects (1940) the transaction. When address A is on the allowlist, process 1900 executes (1950) the transaction and/or transfers ownership of the token X to address A. Additionally or alternatively, process may determine that the request to mint and/or otherwise modify the token X is approved.

While specific processes for approving transactions are described above, any of a variety of processes can be utilized to review transaction requests as appropriate to the requirements of specific applications. In certain embodiments, steps may be executed or performed in any order or sequence not limited to the order and sequence shown and described. In a number of embodiments, some of the above steps may be executed and/or performed substantially simultaneously where appropriate and/or in parallel to reduce latency and processing times. In some embodiments, one or more of the above steps may be omitted.

In accordance with various embodiments, smart contracts may include allowlists and banlists simultaneously. In such cases, transactions (e.g., minting and/or transferring tokens) that are made with and/or to addresses on neither on the allowlist nor the banlist may be placed in quarantine states.

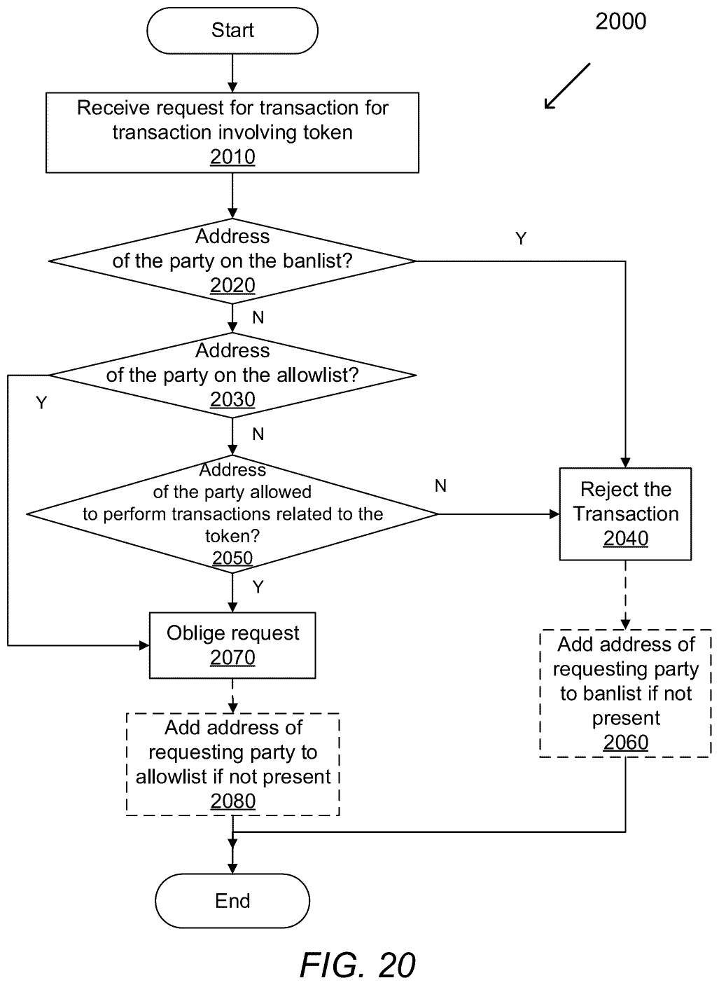

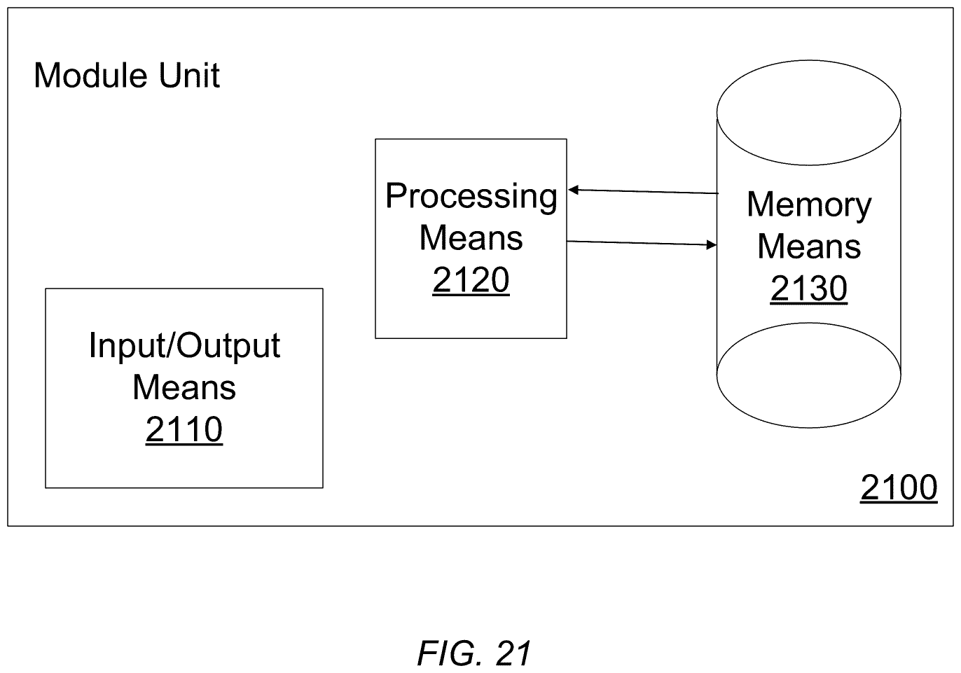

A process for enabling token transactions through smart contracts configured in accordance with various embodiments of the invention, is illustrated in FIG. 20. In accordance with many embodiments of the invention, process 2000 may be performed by smart contracts including but not limited to function portions and data portions. Function portions may include at least some of the various functions that may be initiated by smart contracts in performing the process 2000. The data portion may include various types of editable data and/or data structures. including but not limited to banlists and/or allowlists. Process 2000 receives (2010) from a requesting party, a request for a transaction involving a token, including but not limited to minting and/or token transfers. In accordance with numerous embodiments of the invention, requests may include but are not limited to party address(es) for the requesting party, receiver(s), and/or creators of the token(s).

Process 2000 determines (2020) whether the address of (at least one) party is on the banlist. When the address is on the banlist, process 2000 rejects (2040) the transaction. In such cases, process may determine that the token remains registered under its current owner and/or that the underlying request is refused.

When the address is not on the banlist, process 200 determines (2030) whether the address of (at least one) party is on an allowlist. When the address is on the allowlist, process 2000 obliges (2070) the transaction.

When the address is not on the allowlist, process 2000 directly determines (2050) whether the address is allowed to perform transactions related to the token. In accordance with some embodiments, process may determine this after moving the request to a quarantine state, wherein it may be reviewed by third parties. When process 2000 determines (2050) that the address of the party is not allowed to perform transactions, process 2000 rejects the transaction (2040). When the process rejects a transaction without the transaction already being on a banlist, process 2000 may add (2080) the address of the requesting party to the banlist for future reference. When process determines that the address is allowed to perform transactions, process 2000 obliges (2070) the request. When the process obliges a transaction without the transaction already being on an allowlist, process 2000 may add (2080) the address of the requesting party to the allowlist for future reference.

While specific processes for facilitating transactions are described above, any of a variety of processes can be utilized to review transaction requests as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted.

In accordance with many embodiments, quarantine states may facilitate review by third parties including but not limited to the owner(s) and/or creator(s) of the relevant smart contracts, marketplace administrators, and/or pre-determined authorities. For cases where, after review, the third party decides the address is allowed to own and/or receive tokens associated with the smart contract, the address may be added to the allowlist. Additionally or alternatively, when the third party decides the address is not allowed to own the token, the address may be added to the banlist.

Smart contracts configured in accordance with numerous embodiments of the invention may include functionality that allows addresses to be removed from banlists and/or allowlists. In accordance with some embodiments, access to the functionality of smart contracts may be limited to the owners and/or creators of the smart contract. In accordance with numerous embodiments, the functionality may be accessible to limited lists of addresses, owned by parties approved to add and/or remove addresses to allowlists and/or banlists. Additionally or alternatively, in accordance with several embodiments, adding and/or removing addresses to banlists and/or allowlists may involve a requirement for a consensus among a group of pre-determined parties given a conditional level of access to the functionality. For example, consensus may be determined using decentralized autonomous organization (DAO) smart contracts.

In accordance with some embodiments, smart contracts may include particular instructions that can be run before any transactions are acted upon by the smart contract. The instructions may examine whether receiving addresses are on the banlist. When the smart contract determines that the receiving address is on the banlist, the smart contract may refuse to process the transaction. Additionally or alternatively, once the smart contract determines that the receiving address is not on the allowlist, the smart contract may refuse to process the transaction.

A physical model of a smart contract configured in accordance with many embodiments of the invention is illustrated in FIG. 21. The smart contract 2100 includes memory 2130, input/output means 2110, and processing means 2120 configured for transactions including but not limited to minting and/or transfer of tokens (such as NFTs).

Memory means 2130 may include but are not limited to instructions, which when executed by the processing means 2120 can allow the smart contract 2100 to perform various methods configured in accordance with many embodiments of the invention. Additionally or alternatively, the smart contract 2100 methods may be implemented through mediums including but not limited to servers, computers, smartphones, cloud servers and/or any entity/arrangement with processing means.

The smart contract 2100 also includes input/output means 2110 that can enable communication for the smart contract 2100. Smart contracts 2100 may utilize input/output means 2110 to receive, transmit and/or provide information to other units, devices and/or entities.

Systems configured in accordance with various embodiments of the invention may keep registries of token marketplaces that are known to honor and/or ignore royalty payments. These marketplaces may themselves be added to allowlists and/or banlists. In accordance with some embodiments, the smart contracts governing allowlists for token marketplaces may be separate from those governing banlists for token marketplaces. Additionally or alternatively, smart contracts governing one list type (e.g., banlists) may include functionality for calling upon smart contracts governing a second list type (e.g., allowlists) before allowing transactions to be acted upon.

While specific processes are described above with reference to FIGS. 18-21, systems governing royalty payments can be implemented in any of a number of different ways to enable as appropriate to the requirements of specific applications in accordance with various embodiments of the invention. Additionally, the specific manner in which smart contracts can be utilized within NFT platforms in accordance with various embodiments of the invention is largely dependent upon the requirements of a given application.

### NFT Platform Directed Acyclic Token Structure

Currently, non-fungible tokens (NFTs) are used mainly to convey ownership rights. They are not used to convey access rights. In co-pending applications, including but not limited to U.S. patent application Ser. No. 17/808,264, titled “Systems and Methods for Token Creation and Management,” filed Jun. 22, 2022, incorporated by reference in its entirety, it is disclosed how to use NFTs for controlling access rights.

The current application details methods for hybrid service provision. An example of a hybrid service is one that comprises two or more elements, where an element may correspond to the access right to a digital service; another element to a service and/or resource that corresponds to a physical artifact; and yet another may correspond to access to a specialist, including but not limited to a medical doctor, an accountant, service provider, and/or an architect. Some of these elements may be tied to the same ownership, i.e., not be possible to transfer, ownership-wise, independently of each other. Some elements may not be transferable at all. Some elements may require positive identification of users belonging to an access control list (ACL) of permitted users, and some elements may correspond to the generation of data, some of which may be public whereas other such data may not be accessible without positive identification of users corresponding to ACLs of permitted users. In some embodiments two or more elements are associated, where at least two of these elements have different functionality, are governed by different policies, are governed by different terms, and/or are associated with different privacy requirements.

In some embodiments, two or more elements that are tied to each other in terms of ownership are represented by one and the same token. In another, two or more tokens, each one comprising at least one element as described above, are tied together in terms of ownership and/or contractual relationship. The current application will refer to the tying of ownership between tokens as “bundles” herein, where a bundle may be implemented by generating a new token with a new token address and to assign the ownership of the NFTs that are comprised in the bundle not to a wallet address as is traditional, but instead, to the new token address. Thus, a token (including but not limited to an NFT) is made the owner of one or more other tokens. In doing so, the “bundled” NFTs cease to exist as independent entities, as they cannot be sold individually, as their owner does not correspond to a wallet address but another token. This other token is referred to as the meta-token herein. As a meta-token is transferred, in terms of ownership, the associated rights of the NFTs that the meta-token corresponds to are transferred accordingly. Various aspects of meta-tokens were disclosed in co-pending U.S. patent application Ser. No. 17/808,264, titled “Systems and Methods for Token Creation and Management,” filed Jun. 22, 2022, incorporated by reference in its entirety. Additionally, co-pending application “Methods for Assigning and Maintaining NFT Relationships” by Rebecca Fiebrink, Mike Leisz, and Ajay Kapur describes methods for detecting and verifying whether a given token can be considered a member of a set associated with another token, which here can be employed to assess whether a given token can be bundled with another to form a meta-token; that application additionally describes methods for encoding and ascertaining properties of a set and/or members thereof, including but not limited to ordering and completeness, which here may be applied to a set of NFTs which comprise and/or potentially comprise a meta-token.

A meta-token can, optionally, be unbundled into its constituent components (i.e., the NFTs and associated elements described above), e.g., by the meta-token, which acts as an owner, transferring ownership of constituent components, e.g., to other meta-tokens and/or to wallet addresses. The unbundling can be selective, e.g., only some of the bundled components being transferred away, and/or it can be complete, causing all assets to be transferred out, an action that effectively guts the meta-token. Such gutted meta-tokens still exist, unless explicitly destroyed (e.g., by assigning them to a “null” entity), and can be used to house new bundles.

Just as different elements can be tied to each other using a common meta-token, other specifications can also be tied to these elements. One approach to doing that is to express a limitation as an element, and bundle that element with others as described above. A limitation may be a tie to a physical entity, for example, where this may be expressed by bundling one or more elements as described above with a biometric token, and optionally, a description specifying terms of this association. Such terms may specify that the association will cease when there is evidence that the party associated with the biometric token is deceased. The biometric token in this context plays the role of an anchor. Other anchors can be used, including but not limited to an identifier of users by means of their name and address. An associated term may specify that this association may only be modified by users matching the anchor (i.e., having the name and address being specified) showing that they have moved to another address, in which case this new address may be bundled and the old address unbundled, e.g., as described above.

A meta-token can wrap one or more assets, including but not limited to NFTs, where each one of these assets may be associated with a different set of terms, and the meta-token may be associated with yet another set of terms. One example of a set of terms, which may apply to a first NFT associated with a meta-token, may dictate on what types of devices content associated with the NFT may be rendered, e.g., may require that the full-resolution version of the content may only be rendered on a device with a trusted execution environment (TEE), and a degraded version (e.g., one with lower resolution, and/or included watermarks) must be rendered on devices that do not have a TEE. Another set of terms may apply to a second NFT associated with the meta-token. These terms may specify that to use a resource, including but not limited to a script included in and/or referenced by the second NFT, the execution must be performed by a digital rights management (DRM) module. A third NFT associated with the meta-token may be associated with terms specifying that the usage of the content associated with the third NFT requires a reporting of demographic data to a third party. The meta-token may combine the terms of all the wrapped NFTs, resulting in a requirement related to the use of TEEs for a full-resolution version of content; the use of a DRM module for use of the script; and the use of reporting for the inclusion of the asset of the third NFT.

The meta-token may also add additional constraints, including but not limited to a requirement that access to content requires membership in an organization, which may be proved by users by having a token and/or a digital signature certifying a valid membership. When users attempt to use the meta-token in a context that does not satisfy the requirements, a partial experience may be created and/or the meta-token may cause a notification to be rendered, identifying the problem and how to rectify it. A partial experience may correspond to the rendering of a degraded version of content, and/or use of only some elements of some wrapped NFTs. A meta-token may also cause the escalation of rights relative to the intersection of requirements from the wrapped NFTs, e.g., cause some terms to be relaxed and/or removed, e.g., by obtaining a set of relaxed terms from a party with the rights to offer these, e.g., a content creator associated with the NFT for which a relaxation is desired; such relaxations may take the form of digital signatures, an NFT providing greater rights for the identified NFT, potentially limited to the context of the wrapped bundle identified by the creator of the meta-token. The relaxations may be obtained by paying a fee that may be indicated in the NFT and/or associated meta-data for which relaxation is desired.

In multiple embodiments, constituent tokens within a meta-token may be associated with terms that dictate constraints and/or privileges that are contingent in part on being associated with a meta-token and/or with the state of the associated meta-token, including the presence and properties of other constituent tokens. For example, a number of NFTs may each individually represent an episode of a television series, with terms that enable them to be played back according to the requirements of an associated DRM module. But these NFTs may additionally include terms specifying that, when they are associated with a meta-token that wraps all episodes in a particular season of the series, additional content is unlocked, for instance, directors' commentary for the episodes can additionally be viewed. As another example, a musician may release a number of musical tracks as NFTs, one of which includes terms that allow it to spawn when it becomes bundled in a meta-token with certain other tracks; when this happens, the token spawns a new NFT representing a bonus track which can now be played as well as sold.

The disclosed technology can be used to modify access rights associated with tokens, including tokens that have been and/or are being spawned. When a first token spawns a second and a third token, the spawning process may comprise modifying the rights associated with the second and third tokens, relative to the rights associated with the first token. For example, the first token may have the capability of being spawned, whereas the second and third tokens do not. As another example, the first token may be accessible only by its current owner, which may be implemented by a content portion being encrypted using a key that with be provided, in an encrypted format, to the owner of the token, and wherein the encryption may use the wallet address of the owner, which may be a public key, to encrypt the key using which the encrypted content can be decrypted. The modifications of the access rights, and associated actions, may be performed by the entity that performs the spawning action. This may be a distributed action, e.g., performed by a wallet associated with the owner of the token in collaboration with an entity representing the content creator associated with the token. The distributed action may comprise the wallet providing data indicating that a triggering event has taken place, and the entity representing the content creator verifying the validity of the triggering event and generating a digital signature asserting the validity of the second and third token; initiating the minting of the tokens; and/or authorizing the use of data to be incorporated and/or referenced in the minted tokens.

A meta-token can be used to indicate a state of an associated NFT that has been tied to the meta-data by having its ownership transferred to the meta-token. For example, the meta-token may indicate a version of the NFT that is tied to it. This version may correspond to an evolutionary state. Thus, by re-tying the NFT from one meta-token to another, by transferring the “ownership” of the NFT from one meta-token to the other meta-token, the state can be changed, e.g., by association to different data carried in the meta-tokens. Two or more NFTs can be tied to a meta-token in this manner, allowing them to be fused to each other by becoming possessed by the same meta-token, which itself may have an owner that corresponds to a wallet address, and/or which may, in turn, be fused with other tokens (including meta-tokens).

Evolution may also be implemented by carrying in a meta-token a state value indicating a parametrization of relevance to a token that is tied to the meta-token. The rendering of the meta-token is performed by applying the parametrization value to the token(s) tied to the meta-data, including to their associated content data. When a token is owned by another token, it is used (e.g., rendered) in a manner consistent with the token that owns it, which means in accordance with policies, limitations and parametrizations associated with, referenced by and/or contained in the token that owns it.

In a number of embodiments, a first token (token A) is indicated as an owner of a second token (token B) as a way of connecting token A and token B to each other. Token A may be the indicated owner of additional tokens, including but not limited to token C, and token B, which is owned by token A, may be indicated as the owner of other tokens, including but not limited to token D. In this example, The current application may refer to token A as the “root token” as this is the token that is owned by the wallet to which it is assigned, wherein a wallet may be described using a wallet address, and a wallet address may be on the format of a public key. When token A is transferred from a first wallet (wallet 1) to a second wallet (second wallet), this also causes the transfer of the tokens that are owned by token A, including but not limited to token B, for example, and any tokens owned by these tokens. In this example, a collection of tokens are connected in the form of a directed acyclic graph (DAG), wherein the transfer of the root token causes the transfer of all tokens associated with the DAG. That is, any token that owns one or more other tokens is termed herein as a meta-token, whereas any meta-token that is itself owned by the wallet, as opposed to another token, can additionally be referred to as a root as it is the root of a DAG of token ownership. A token, including but not limited to token B, may be reassigned from being owned by one token (including but not limited to token A) to be instead owned by another token (including but not limited to token C) and/or to a wallet (including but not limited to wallet 1). This may be performed in an analogous manner to how other ownership transfers are performed, e.g., by re-associating ownership by recording a new ownership on a blockchain. It may also be performed by generating a digital signature using a private key of the owner token, on an address identifying the owned token and an address identifying the new owner, whether a wallet and/or another token. The determination of whether one token would transfer the ownership rights of another token (which is a form of unbundling) and/or not may be determined by a script associated with the owner token. In some examples, it may instead be determined by a script associated with the owned token. Such scripts can be executed in the execution environment where the DAG of tokens is stored, where this may be a wallet, for example.

Just like a wallet may own a token and/or a token may own another token, it is also possible for a token to own a wallet (which may, in turn, comprise tokens). This enables the automation of trading wherein automated agents are scripts that are associated with tokens, and these automated agents buy and sell tokens, and containers comprising tokens (including but not limited to wallets), based on policies indicating trading strategies.

A token may be transferred from one wallet to another by the direct transfer of that token, and/or by the direct transfer of a token that is a root token. In either case, a script is evaluated to determine whether royalties and/or other fees (including but not limited to sales taxes) are due to be paid. The script may indicate that when a token is transferred from a first wallet to a second wallet, where both first and second wallet are owned by the same entity, then no royalty and/or sales tax is due to be paid, but potentially some other fee, including but not limited to a fee related to insurance of resources associated with the transferred assets. Similarly, when a token is bundled with another token, no royalty payments may be due, but a bundling fee may be required to be paid, where such bundling fee may depend on the exact assets being combined in the bundling process, and which may be described by one or more policies associated with the tokens being bundled. In instances where it is not clear from one or more policies whether a given fee has to be paid and/or not, a report may be generated and logged in response to the bundling, and/or unbundling, of the resources.

A root token can be used to implement the functionality of a meta-token. A root token can also be used to associate two or more tokens with each other, e.g., by being assigned ownership of these. Some of these one or more tokens may be non-fungible tokens, and some of them may be fungible tokens. The root token may reference and/or comprise information specifying the relationship between tokens being associated with each other. A root token is associated with one or more other tokens by being assigned as the owner of these one or more tokens. A root token may be the owner of a first token, which may be the owner of a second token. Rules of inheritance as normally used in computer science mean that the root token is the owner of the entire DAG, including both the first token and the second token, even though the root token is only the “direct” owner of the first token.

A meta-token may be implemented in a variety of ways. One such way is by becoming the owner of one or more other tokens, as the root token disclosed herein is. In many embodiments, one token is associated with content, including but not limited to an audio file, a movie file, an image file, a text file, and/or a combination of such; while another token is associated with an ownership assertion. An example of an ownership assertion is a biometric token, e.g., as disclosed in co-pending application U.S. patent application Ser. No. 17/933,659, titled “Systems and Methods for Token Content Unlocking, Biometric Authentication using Privacy-Protecting Tokens, Ownership-Based Limitations of Content Access, Policy-Based Time Capsule Technology, and Content Lock Mechanisms,” filed Sep. 20, 2022, incorporated by reference in its entirety. Another example of an ownership assertion is the encrypted identifier disclosed in co-pending application U.S. patent application Ser. No. 17/821,444, titled “Systems and Methods for Management of Token Interactions,” filed Aug. 22, 2022, incorporated herein in its entirety. By associating the token associated with content with the token associated with the ownership assertion, e.g., as disclosed herein, the two aspects are combined, e.g., by assigning an ownership assertion to the content. Such ownership assertions may be used for access control, as in the case involving the biometric token; they may also be used for selective tracking, as in the case of the encrypted identifier. A person of skill in the art will recognize that this is only one illustrative example of a benefit obtained by the disclosed structure. The use of ownership associations is a novel structure disclosed herein, enabling an association of tokens with each other, where this association may be a functional association. The setting of token X as the owner of token Y is the association of the two tokens with each other.

In some embodiments, the association of two or more tokens by the representation of them as a DAG is temporary and can be undone, at least in part, by having one “owned” token transferred away from the “owner” token, e.g., by the generation of a digital signature expressing the transfer, where this digital signature is verified using a public key associated with the owner token. As described, other entities may also be allowed to create such digital signatures. One example of such an entity is the wallet to which the root token associated with the DAG is assigned. In certain embodiments, at least some of the associations between tokens cannot be undone. This can be guaranteed, e.g., by having the entity associated with the private key needed to initiate the transfer of one owner token away from an owner token be a private key associated with a party that will not generate the digital signature, whether for contractual reasons, by legal reasons, and/or because it does not have full control over the private key needed to perform the operation. Such tokens, once combined, are destined to remain associated with each other. This can be used to assign irrevocable ownership of a token and/or a DAG representing two or more bundled tokens.

A DAG may comprise tokens that are non-fungible tokens, as described above. It may also comprise tokens that represent crypto-funds, thereby tying these to the tokens to which they are bundled. This can be used to bundle a token providing access rights (e.g., for purposes of mining) with a resource, including but not limited to a coin. This is an alternative approach to express staking. It has many benefits to existing staking approaches in that this approach is more flexible, by virtue of the flexibility enabled by the possible combinations comprising access control tokens, policy, terms, etc.

One or more tokens in a DAG may comprise and/or reference a script, where the script may correspond to an algorithm performing security and/or privacy management, determining what policies apply to use and/or transfer of the DAG, determining how to configure and/or select content based on observations associated with the DAG, and more. For instance, such a script may be used to determine whether conditions for unlocking and/or spawning new content are met by the current configuration of the DAG, enabling the examples including but not limited to unlocking director's commentary on television episodes and/or spawning of a bonus music track described above. Such a script may include non-deterministic behaviors, for instance, implementing the ability to reward a wallet with a prize of non-predetermined value upon purchasing certain NFTs and bundling them together, and/or to spawn a new NFT under certain conditions, certain features and/or properties of which are determined by chance. Such a script may have the effect of automatically modifying tokens in the DAG, for instance updating NFT token URIs with the effect of altering media and/or other metadata associated with them, enabling for instance the evolution of NFT content informed by DAG properties. Such a script may be a machine learning (ML) script and/or an artificial intelligence (AI) script, and/or be part of such. For example, a script may employ an existing classifier, where the classifier logic is embedded in the script itself and/or referenced in the script, to assign a category and/or probability of category membership to the DAG, representing a categorization of the content, owner demographics and/or preferences, security profile, and/or other properties that might be inferred from the DAG and its elements. Or, a script may employ a generative AI method including but not limited to a GAN and/or transformer to generate new content, which could be associated with an existing token for instance through changes to an NFT's metadata, and/or which could be associated with a new token, for instance a newly minted NFT.

In a number of embodiments, a first token and a second token may be assigned as the joint owners of a third token. The third token may correspond to a biometric token and/or a policy indicating DRM rules, for example. This ties both the first token and the second token to the third token. When the first token is transferred (e.g., sold) to another wallet but without the second token being transferred, the connection between the first token and the third token may be severed, e.g., the first token may not be an owner of the third token anymore. This may be the situation in the example where the third token is a biometric token, for example. On the other hand, the severing of the relationship is not necessary, e.g., the first token and the second token may both be the owners of the third token all while the first token has a different owner than the second token. Therefore, ownership of a root token does not necessarily indicate ownership of tokens in the same DAG as the root token. In fact, in the example where both the first token and the second token own the third token, the corresponding DAG has (at least) two root tokens, namely the first token and the second token, which may have different owners.

In various embodiments, three or more tokens may be assigned as the joint owners of another distinct token. This joint ownership structure may be conjunctive, disjunctive, and/or more complex, e.g. requiring certain combinations of owning entities to agree to a transfer of ownership.

A token may indicate, e.g., in a metadata field, the manner in which it exercises control over tokens that it is indicated as the owner of. For example, the indication in the metadata field may indicate that a script associated with the token is responsible for transferring out any ownership rights associated with the token, e.g., by this script being provided an input related to an owned token, process the input, and conditional on the processing outcome, generate a digital signature that causes the owned token to be transferred away from the token that the script is associated with. As another example, the indication in the metadata field may indicate that the wallet owning the applicable root token has the right to generate the digital signature conditional on validating that a given token should be transferred away from a given DAG associated with the root token. The indication in the metafield may also indicate an external service as being responsible for determining whether to initiate a transfer of a token.

In several embodiments, the disclosed technology is used for trash collection. It is common that tokens are transferred to wallets without the permission of the wallet owner to do so. Some such tokens are spam, others may be associated with other threats, including but not limited to malware. A token performing trash collection for a wallet may be used to transfer unwanted tokens to. The trash collection token can bundle all the unwanted tokens and keep them away from the owner of the wallet, except in cases where the wallet owner inquires about the collected tokens, in which case information about these can be provided to the associated user, potential scripts evaluated in a sandbox and/or other protected environments. Multiple trash collection tokens may be used, where the assignment of ownership of an undesirable token is made based on a classification of its type, e.g., “dangerous” and/or “nuisance”. Trash can be emptied by transferring the trash collection token (i.e., the root token) to an external entity, and/or by individually assigning partitions of the DAG to an external entity. To lower costs of transfers of ownership, whether in the context of trash collection and/or for other reasons, side chains can be used for some of these transfers; alternatively, one may use ownership transfers using the techniques disclosed in co-pending U.S. patent application Ser. No. 18/299,546, titled “Systems and Methods for Instant NFTs and Protection Structure, Detection of Malicious Code within Blockchain Smart Contracts, Tokens with Transfer Limitations, Mirror Tokens and Parallel Addresses, Smart Contract Risk Scoring Method, and Cross-Device Digital Rights Management,” filed Apr. 12, 2023, incorporated by reference in its entirety.

In some embodiments, a first token has its ownership assigned to a second token, where the second token may be a root token, and/or may belong, in terms of ownership, to yet another token, including but not limited to a third token. This is what enables the creation of DAGs. Other means of associating tokens to graphs including but not limited to DAGs may be performed, e.g., not involving ownership changes but the assignment of access rights, for example. Such access rights may be expressed using an access control list (ACL).

In numerous embodiments, a first token has its ownership assigned to two or more different entities. These entities may be tokens, for example, including but not limited to token A and token B, which may both “own” the first token. Token A may be owned by the first wallet. Token B may also be owned by the first wallet, and/or may belong to another wallet, including but not limited to the second wallet, where the first wallet is distinct from the second wallet. In this context, the ownership may be of a type that enables either the first wallet and/or the second wallet, independently of the other, to change the ownership of the first token, e.g., to third wallet. That may be indicated by an ownership assignment of the first token to the first wallet and the second wallet, where the ownership is indicated using a flag to be disjunctive, meaning either the first wallet and/or the second wallet can cause the transfer of ownership of the first token. Ownership can also be conjunctive, e.g., by indicating this using a flag. For example, in a conjunctive ownership assignment of a first token to a second token and a third token, the second token and the third token (or their representatives) can cause the ownership change of the first token to a fourth token by both agreeing to the transfer. Similarly, the first wallet and the second wallet may be the conjunctive owners of the first token, requiring both of them to agree to an ownership change of the first token, e.g., to the third wallet, in order for this change to take place. This is a beneficial security mechanism that protects against unwanted transfers of tokens, e.g., by malware to a wallet owned by a criminal, unless the malware infects both the first wallet and the second wallet. Similarly, the construction protects against malicious contracts, which are contracts that may, for example, transfer funds from a token owner to a criminal upon evaluation of the contract. In the above, the second wallet may be a cold wallet, and/or may comprise two or more wallets that both and/or all need to approve a transfer. A token, including but not limited to the first token may also be owned by the second token and a first wallet, where the second token belongs to a second wallet. This ownership may be conjunctive and/or disjunctive. More generally, ownership may be associated with any type of access structure, e.g., requiring four out of five owners to agree to an ownership transfer for this to go through. This can be controlled, e.g., using secret sharing methods, which are commonly used in the field of cryptography, where one example such secret sharing method is polynomial secret sharing over modular fields and/or groups.

In many embodiments, a token is owned by two entities, wherein the first entity is a wallet associated with the token owner, and the second entity is a process module that the current application may refer to as P. The ownership of the token is set to conjunctive in this illustrative example. When an ownership change is initiated for tokens, which may be performed by users of the wallet to which the token(s) belongs, by malware infecting the wallet, and/or by a malicious contract, then that causes the wallet to agree to an ownership change. This ownership change may not be complete until P also agrees, though, as the ownership is conjunctive. As the wallet initiates the ownership change, P will be notified of this. P is a process that may execute in a safe environment on the same device as the wallet is executing, including but not limited to in TrustZone and/or another Trusted Execution Environment (TEE). P may also be executing on another device, including but not limited to a cold wallet, a cellular phone of the users to which the wallet belongs, on a cloud server, etc. As P is notified of the change of ownership request from the wallet, P initiates a verification which may include additional details normally not available within the wallet approval environment, and pending that verification, determines whether to agree to and/or refuse to agree to the ownership change initiated by the wallet. When P agrees to the ownership change, P copies the assignment of ownership change from the request initiated by the wallet, thereby causing the ownership change to take place, e.g., be recorded. When P does not agree to the ownership change, the token remains in the possession of the wallet and P, and/or alternatively, only to P. It does not belong to the proposed new owner, nor to the proposed new owner and P. Thus, P is able to block the transfer of the ownership, based on the result of the verification.

The verification can take many forms. For example, P may cause a message to be displayed to users, wherein the message identifies the transfer request and at least some of the terms of the transfer. For example, the message may state that a token with an identified name and icon is requested to be transferred to users with identified names and icons; the message may state whether the proposed recipient user is a party that the wallet has previously interacted with; what the reputation is of the proposed recipient user; etc. The message may also specify the terms of the transfer, e.g., 1 ETH is being transferred out, and/or an NFT believed to be worth $1000 is being sold for $0.10. Any great discrepancy may be highlighted and require the users receiving the message to perform an action to approve the transfer, e.g., confirm that he understands that the exchange is much below market rates. The user receiving the message may have to approve the transaction for P to complete the transfer. Alternatively, the users receiving the message may have to not block the transaction within a set time period, including but not limited to 48 h, for P to complete the transfer. Alternatively, the users receiving the message may have to approve the transaction within a set time period, including but not limited to 36 h, for P to complete the transaction. P may generate multiple messages, each one of which, and/or some threshold number of which needs to be responded to in a pre-specified manner, for P to complete the transfer. This way, P may cause a message to be sent to 5 users, and require that at least 3 of these respond positively for the transfer to be completed. Alternatively, when only one recipient of the message is available to approve the transfer, this may be sufficient, but may require an escalation verification in which this available user has to perform additional actions in order for the transfer to be effectuated by P.

In certain embodiments, the process may perform user interaction as part of the verification process, e.g., using the user interaction approach disclosed in co-pending PCT Patent Application No. PCT/US23/62851, titled “Systems and Methods for Abuse Safeguards in NFT-Directed Environments,” filed on Feb. 17, 2023, incorporated by reference in its entirety. In many embodiments, the verification performed by P comprises a determination of whether a pending transaction is safe, unsafe and/or undetermined in terms of safety. A safe transaction may be automatically approved by P, without the use of user-facing verification including but not limited to what is illustrated above. An unsafe transaction may be automatically blocked by P, also without the use of user-facing verification including but not limited to what is illustrated above. P may perform user-facing verification when the automated verification step results in an assessment that corresponds to being undetermined in terms of safety. This may correspond to having a risk score that exceeds a threshold value of 16 (below which the transaction is considered safe) but below 75 (above which the transaction is considered unsafe). The score may be generated using a combination of methods, including heuristic methods, rule-based methods, Artificial Intelligence (AI) methods and Machine Learning (ML) methods; examples of such methods are disclosed in co-pending U.S. patent application Ser. No. 18/299,546, titled “Systems and Methods for Instant NFTs and Protection Structure, Detection of Malicious Code within Blockchain Smart Contracts, Tokens with Transfer Limitations, Mirror Tokens and Parallel Addresses, Smart Contract Risk Scoring Method, and Cross-Device Digital Rights Management,” filed Apr. 12, 2023, incorporated by reference in its entirety. Different processes P may perform different types of automated verification procedures, portions of which may be performed by third parties, including but not limited to cloud-hosted security services receiving requests from P to determine the safety of a given pending transaction, e.g., based on information about recent trends in payment requests by other wallets.

In various embodiments, the verification of an ownership change by the process may employ machine learning (ML) and/or artificial intelligence (AI) techniques. For instance, as described above, a machine learning model may be used to predict whether a pending transaction is safe, unsafe, and/or undetermined, and the prediction outcome may influence the subsequent verification process. In such a case, the machine learning used for this prediction may employ a pre-trained model, for instance trained before the creation of the P token to predict risk based on properties of the transaction, associated wallets and their histories, and so on. P may alternatively and/or additionally employ a model trained, refined, and/or updated to reflect the activities of the owning wallet and/or user, for instance reflecting a history of transactions that are typical and/or atypical for this user in its computation of risk. A machine learning model component of P may be embodied as a script and/or parameters stored within the NFT metadata itself and/or on a server and/or cloud computing service referenced by the NFT metadata.

In numerous embodiments, P may employ differential verification procedures based on properties and/or phenomena that do not explicitly pertain to risk. P may also employ ML and/or AI techniques to accomplish this. For instance, an ML classifier may be used to characterize a proposed transaction as one of several transaction classes, based on the type of asset being potentially sold, the price of the asset, the asset's history, and/or properties of the asset metadata and/or of media and/or other data linked to the asset metadata. The process may then employ different verification processes for different classes. As a simple example, P may employ slightly different verification user interfaces for the transfer of tokens associated with different types of data, for instance employing user interfaces that present an image thumbnail to ask for approval to transfer an NFT associated with an image, while employing an audio playback interface to ask for approval for transferring an NFT associated with an audio file. Additionally or alternatively, the process may employ a machine learning image classifier to determine whether an image NFT is of class “NFT artwork” and/or “personal/family photo”, and it may employ one user verification process for all NFT artworks, for which fraudulent transactions may be the primary concern, and a different process for personal/family photos, for which ease of sharing with certain known contacts and preservation of privacy beyond those trusted contacts are primary concerns.

The use of the process may protect against unwanted transfers, e.g., transfers initiated by malware and/or malicious contracts. It also helps protect against unwanted transfers that are based on social engineering of users authorized to initiate transfers, where one example social engineering attack may involve the theft of access credentials used by such an authorized user, e.g., by a criminal, and another example social engineering attack may involve the criminal posing as a trusted party and requesting the users authorized to initiate transfers to perform an action. The use of the process may also help protect children against hasty decisions, e.g., by requiring a parent to be the party approving a transfer request. The process may also be used to govern other actions, including but not limited to changes of access control, and is therefore not limited to protecting against undesirable ownership changes only. This can be achieved in contexts where changes of access control must be approved by an owner of a token, and the token is assigned to the process may as at least one of its owners. P may be the only owner, but operate on behalf of the wallet it is associated with. The process may operate on-chain, on another chain layer (including but not limited to an L2 layer), and/or from an oracle. The process may be fully automated and work to detect risk of fraudulent activity based upon characteristics of the market, the origination wallet, the destination wallet, previous transactions, etc. For example, an artificial intelligence (AI) may identify a relatively fresh and non-doxxed destination wallet as having received assets from a variety of wallets without an appropriate level of reimbursement, such as a wallet associated with widespread phishing attacks.

A DAG may comprise one or more components, including but not limited to tokens comprising and/or referencing executable scripts, and one or more tokens representing data, value, and/or access, wherein the components associated with the executable scripts control and/or govern access to and/or by the one or more tokens representing data, value, and/or access. Such a DAG may, at least in part, be controlled by one or more external entities, which may also be DAGs and/or which may be external service providers. Such external control may be applied in the form of consensus operations, e.g., wherein the external entities cast votes that determine one or more actions associated with the DAG, and wherein the DAG may also cast a vote. The casting of votes may be performed based on staking mechanisms, e.g., as disclosed in co-pending U.S. Patent Application No. 63/383,217, titled “Green Proof of Stake,” filed Nov. 10, 2022, and/or using techniques disclosed in co-pending U.S. patent application Ser. No. 17/810,085, titled “Distributed Ledgers with Ledger Entries Containing Redactable Payloads,” filed Jun. 30, 2022, both of which are incorporated by reference in their entireties.

In a number of embodiments, P is a third-party service, e.g., implemented using a web server, receiving requests from a wallet to transfer ownership of one or more tokens; performing a verification and conditional on the outcome of the verification, determining whether to approve the ownership transfer. P may perform an automated verification, e.g., as described above, and then optionally contact one or more parties in order to perform an interactive component of the verification. Based on the responses from the one or more parties contacted, a second automated verification may be performed, and optional additional interactive verifications. After completing the verifications, third-party service P performs an action, which may comprise one or more of approving the transfer, not approving the transfer, generating a log, charging at least one user and/or user account, notifying a security service provider, notifying a tax collecting authority, and notifying a royalty tracking entity whether a royalty was paid.

In a number of embodiments, provided as illustrative examples that are not meant to be limiting, the process may comprise an off-chain program P1 and an on-chain program P2 (a smart contract) operating in conjunction. P2, as a program running on a blockchain, operates in a hermetically contained environment, in which external data (for example, NFT marketplace floor prices, stock prices, public election results, environmental data including but not limited to temperatures and weather conditions, and/or other real-world data is not directly accessible to P2, whereas P1 running in user wallets may have access to such external data, as controlled and allowed by the user. When the users attempt to undertake an action through P2, including but not limited to submitting a payment and/or transfer transaction to P2, P1 may supply supplementary information to P2 through a second transaction, and/or optionally through an addition to the user's transaction, on which P2 may base a decision as to whether to act on the user's transaction. Thus P1 performs a function equivalent to a “private oracle” for the user.

In accordance with various embodiments, P1 may comprise an autonomous program which runs on a regular basis, for example, every day, once a week, the first Monday of every month, and/or some other schedule, and transmits a transaction comprising a notification to P2. P2 may then examine how many blocks have been added to the blockchain since the notification in order to estimate a time since a last notification, and/or may examine a timestamp within a prior block comprising a prior notification from P1, and/or some other means to determine a passing of time. P2 may subsequently change a state within the smart contract based on one or more of: content of the notification, the prior notification, and the passing of time. Said change to the state may result in an asset being locked for a period of time, released from a lock, restricted to only being able to be transferred to an address on a whitelist, and/or some other limitation and/or removal of a limitation.

Another use of the disclosed technology is detailed in co-pending U.S. patent application Ser. No. 17/933,659, titled “Systems and Methods for Token Content Unlocking, Biometric Authentication using Privacy-Protecting Tokens, Ownership-Based Limitations of Content Access, Policy-Based Time Capsule Technology, and Content Lock Mechanisms,” filed Sep. 20, 2022, incorporated by reference in its entirety. This application may reflect that conjunctive ownership with a process is used to control that a policy is respected, where one such policy is a policy that royalties are paid when a token is transferred between two wallets owned by different entities. Other such policies can be implemented and controlled using variants of the disclosed mechanism, as will be appreciated by a person of skill in the art.

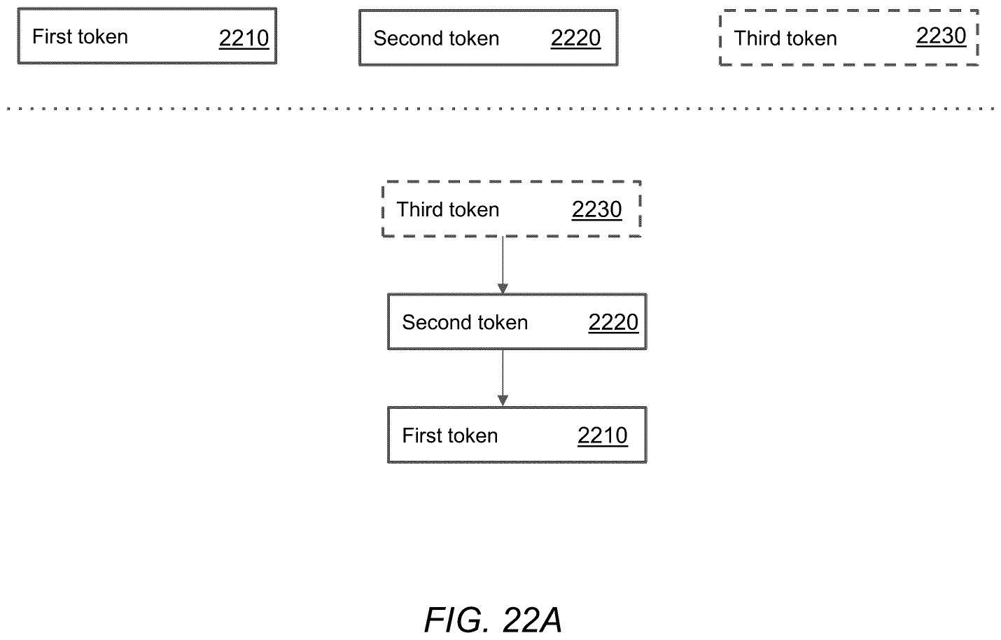

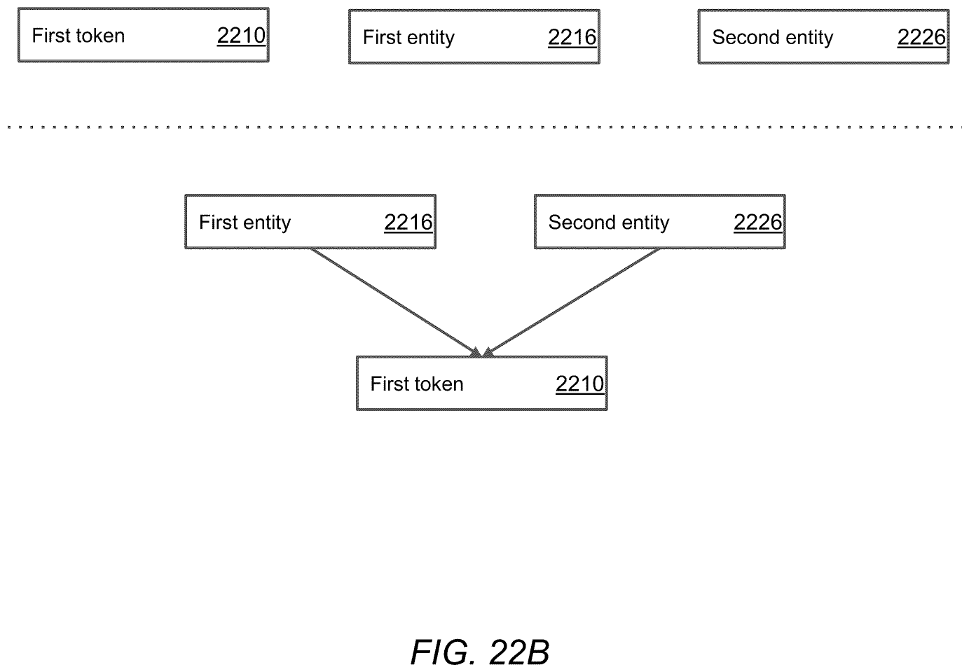

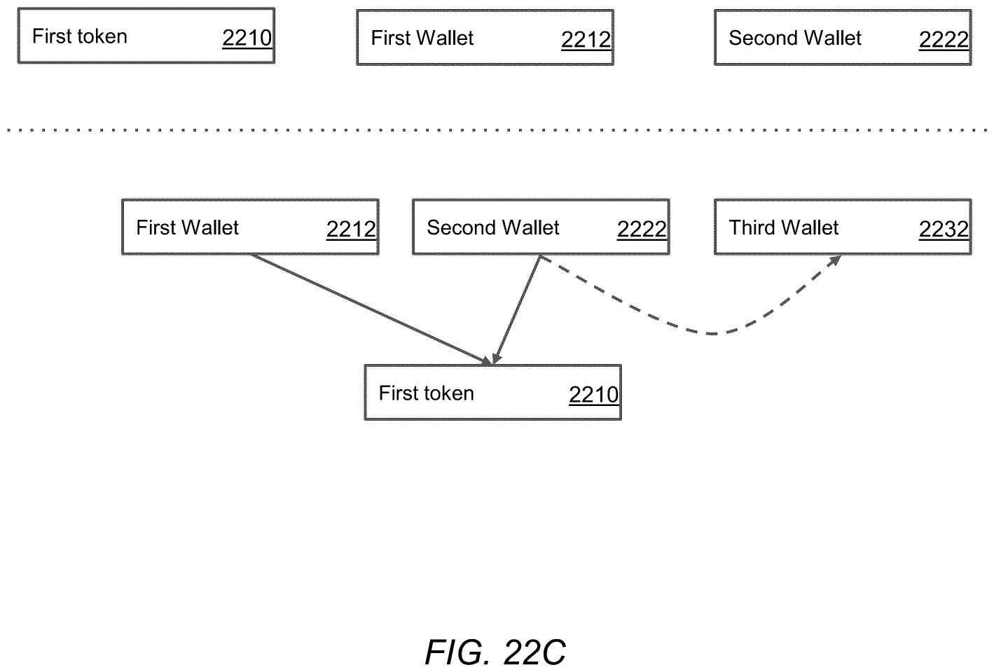

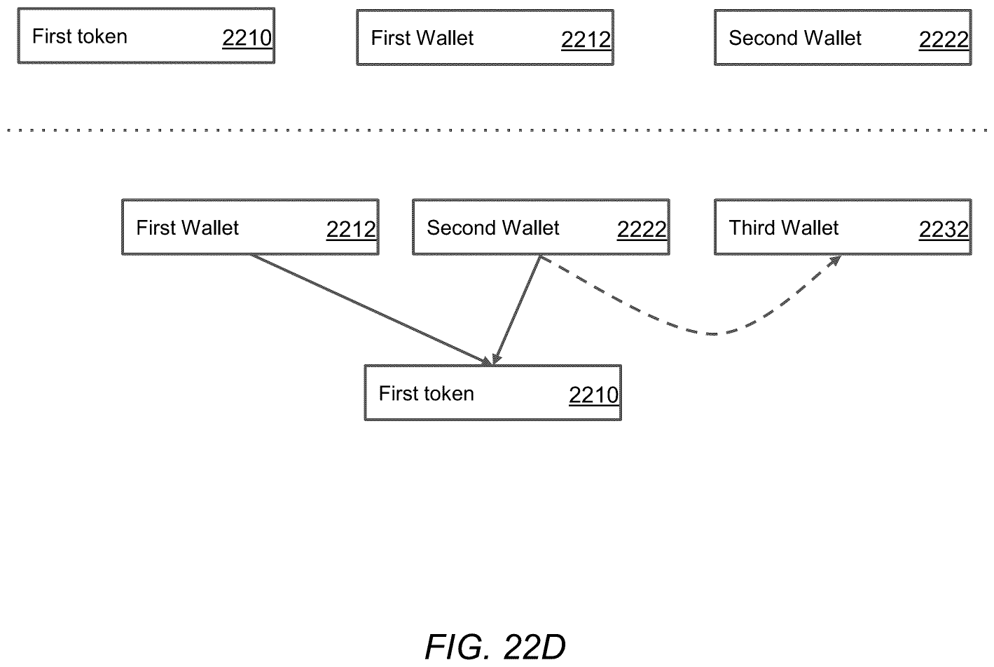

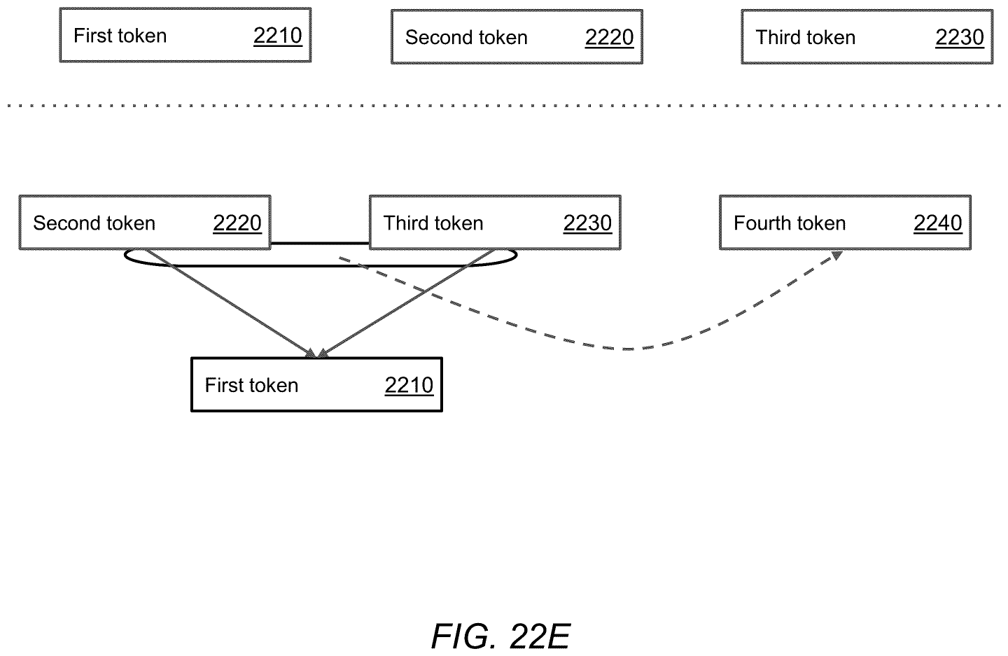

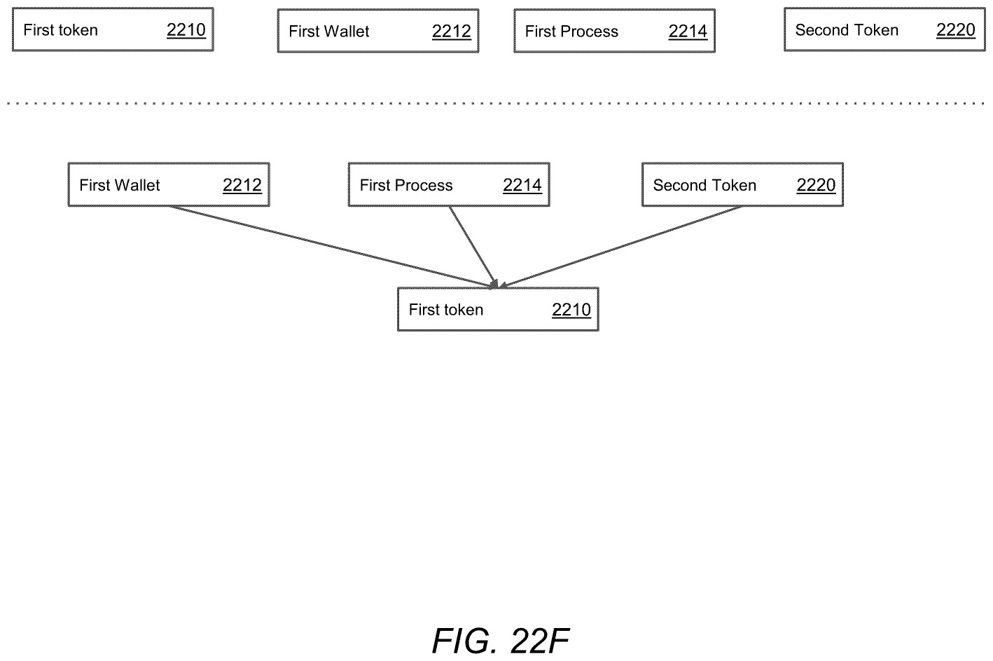

FIGS. 22A-22F illustrate token configurations established in accordance with numerous embodiments of the invention.

FIG. 22A is an illustration of three tokens, a first token 2210, a second token 2220 and an optional third token 2230. In this exemplifying illustration, the first token 2210 has its ownership assigned to the second token 2220, which is illustrated by the second token 2220 having an arrow toward the first token 2210. In this illustration, the second token 2220 is thus a meta-token. When the second token 2220 is owned by the wallet, it is also a root token. Alternatively, when the ownership of the second token 2220 is assigned to a third token 2230, then the third token 2230 is the root token. The third token 2230 is also a meta-token in this case, since it owns the second token 2220.

FIG. 22B is an illustration of a first token 2210 and two entities, a first entity 2216 and a second entity 2226. In this exemplifying illustration, the first token 2210 has its ownership assigned to the first entity 2216 and the second entity 2226. This is illustrated by the first entity 2216 and the second entity 2226 having respective arrows towards the first token 2210. The ownership by the first and second entity may be equal meaning that the first entity 2216 owns half of the first token 2210 and the second entity 2226 owns the other half of the first token. However, the ownership may be unequal, e.g., the first entity 2216 owning % of the first token 2210 and the second entity 2226 owning % A of the first token 2210. It may also be that both the first and second entity owns unspecified portions of the first token 2210, but that both the first and second entity need to engage in a transaction to transfer first token 2210 to another entity; alternatively, at least one of the first and second entity need to engage in such a transaction, depending on the nature of the ownership.

FIG. 22C is an illustration of a first token 2210 and three wallets, a first wallet 2212, a second wallet 2222 and a third wallet 2232. In this exemplifying illustration, the first token 2210 has its ownership assigned to the first wallet 2212 and the second wallet 2222. This is illustrated by the first wallet 2212 and the second wallet 2222 having respective arrows towards the first token 2210. The ownership may be indicated by e.g., a flag (not in the figure) to be disjunctive meaning that either one of the wallets may sell its share of the first token. Of course, it may be that only one of the wallets, 2212 and 2222, may be able to sell its share as well as both wallets being able to sell its share of the first token 2210. In this illustrative example, second wallet, i.e., the second wallet 2222 sells its share of the first token 2210 to a third wallet 2232, which is illustrated by a dotted curved arrow going from the second wallet 2222 to the third wallet 2232, i.e. from the second wallet 2222 to the third wallet 2232.

FIG. 22D is an illustration of a first token 2210 and three wallets, a first wallet 2212, a second wallet 2222 and a third wallet 2232. In this exemplifying illustration, the first token 2210 has its ownership assigned to the first wallet 2212 and the second wallet 2222. This is illustrated by the first wallet 2212 and the second wallet 2222 having respective arrows towards the first token 2210. The ownership may be indicated by e.g., a flag (not in the figure) to be conjunctive meaning that both the first wallet 2212 and the second wallet 2222 need to agree to sell the first token 2210. In this illustration, the conjunctive nature of ownership is illustrated by the ellipse covering the bottom part of the boxes of the first wallet 2212 and the second wallet 2222. In this illustrative example, the first wallet 2212 and the second wallet 2222 both agree to sell the first token 2210 to the third wallet 2232, illustrated by the dotted curved arrow from the ellipse to the third wallet 2232.

FIG. 22E is an illustration of four tokens, a first token 2210, a second token 2220, a third token 2230 and a fourth token 2240. In this exemplifying illustration, the first token 2210 has its ownership assigned jointly to the second token 2220 and the third token 2230, which is illustrated by the second token 2220 having an arrow towards the first token 2210 and the third token having an arrow towards the first token 2210. In this illustration, the ownership is conjunctive, illustrated by the ellipse covering the bottom part of the boxes of the second token 2220 and the third token 2230. By the ownership being conjunctive, both the second token 2220 and the third token 2230 may need to agree to sell the first token 2210. In this illustrative example, they do agree and sell the first token to the fourth token 2240, illustrated by the dotted curved arrow from the ellipse to the fourth token 2240.

FIG. 22F is an illustration of a first token 2210, a first wallet 2212, a first process 2214, and a second token 2220. In this exemplifying illustration, the first token 2210 has its ownership assigned jointly to the first wallet 2212, the first process 2214, and the second token 2220.

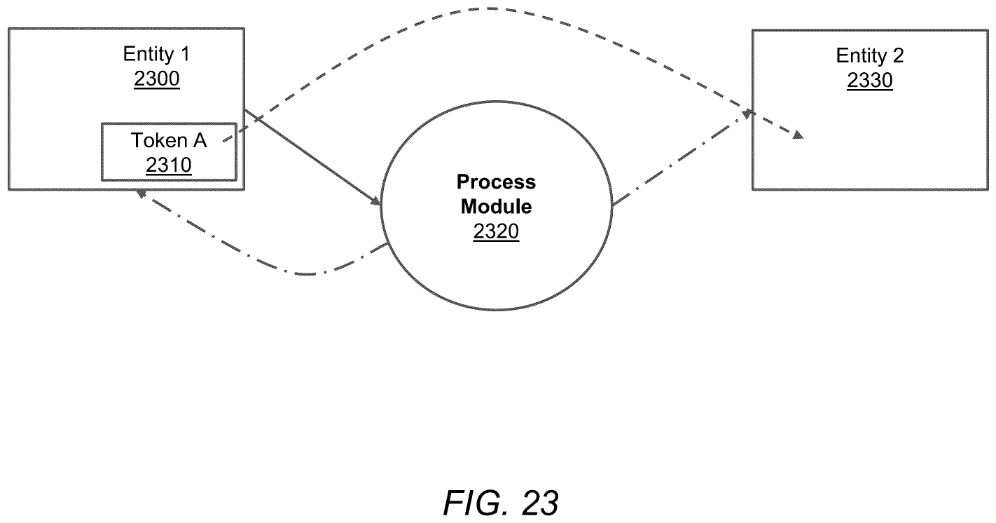

FIG. 23 is an illustration of a situation in which users wish to transfer ownership of tokens, in accordance with many embodiments of the invention. Here, the transfer is from Token A 2310, from Entity 1 2300, to another entity, Entity 2 230. In order to execute the transfer of Token 2310 from Entity 1 2300 to Entity 2 230, the Process Module 2320, illustrated as a circle, is involved. Entity 1 may be e.g., a wallet and/or a token. Likewise, Entity 2 may be a wallet and/or a token. Process Module 2320 performs a determination of whether and/or not the transaction is safe and/or undetermined as described above. In this illustrative and simplified example, when the Process Module 2320 determines that the transaction is safe, Process Module 2320 executes and/or approves the transaction to be made. However, when the Process Module 2320 determines that the transaction is unsafe, it may block the transaction and e.g., notify the user(s) and/or script, e.g., the owner of Entity 1 that the transaction is deemed unsafe and thus e.g., is either aborted and/or put on hold until the users indicates that they still want to go through with the transaction and/or until an evaluation and/or verification has been performed in order to make a decision of how to proceed. As described above, the determination by Process Module 2320 may include an automated component, user-interactive components, and/or a combination thereof.

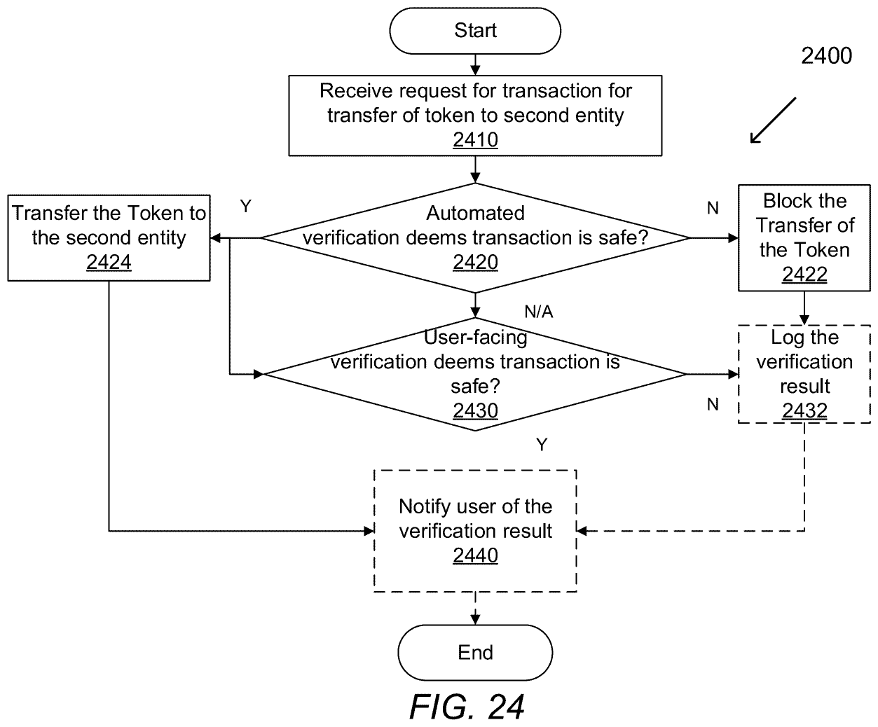

FIG. 24 illustrates one sequence of steps which may occur in the situation illustrated in FIG. 23. The process may be performed by entities including but not limited to the Process Module 2320. Here, in the first step in the sequence, process 2400 receives (2410) a request to transfer a Token to a second entity. Then, process 2400 uses automatic verification to determine whether the transaction is safe. In the case it is determined to be safe, then, process 2400 transfers (2424) the Token's ownership) to the second entity. Optionally, there might be an additional action, in which process 2400 notifies (2440) the user(s) of the verification result through user interface, and/or notifies one or more other processes.

Additionally or alternatively, when the transaction is determined to be unsafe, process 2400 blocks (2422) the transfer of the token. Optionally, the process 2400 may log (2432) the verification result. Additionally or alternatively, process 2400 again may notify (2440) the user(s) of the verification result through user interface, and/or notify one or more other processes. Optionally, there might be an additional action, in which process 2400 notifies (2440) the user(s) of the verification result through user interface, and/or notifies one or more other processes.

Additionally or alternatively, when a determination of whether it is safe and/or unsafe cannot be made; process 2400 performs 2430 user-facing verification. For instance, user-facing verification may involve displaying information about the transaction to users and waiting a set period for positive verification from the user. When the user does verify that the transaction should proceed, process 2400 transfers (2424) the token to the second entity. ownership of Token A is transferred to Entity 2. Optionally, there might be an additional action, in which process 2400 notifies (2440) the user(s) of the verification result through user interface, and/or notifies one or more other processes.

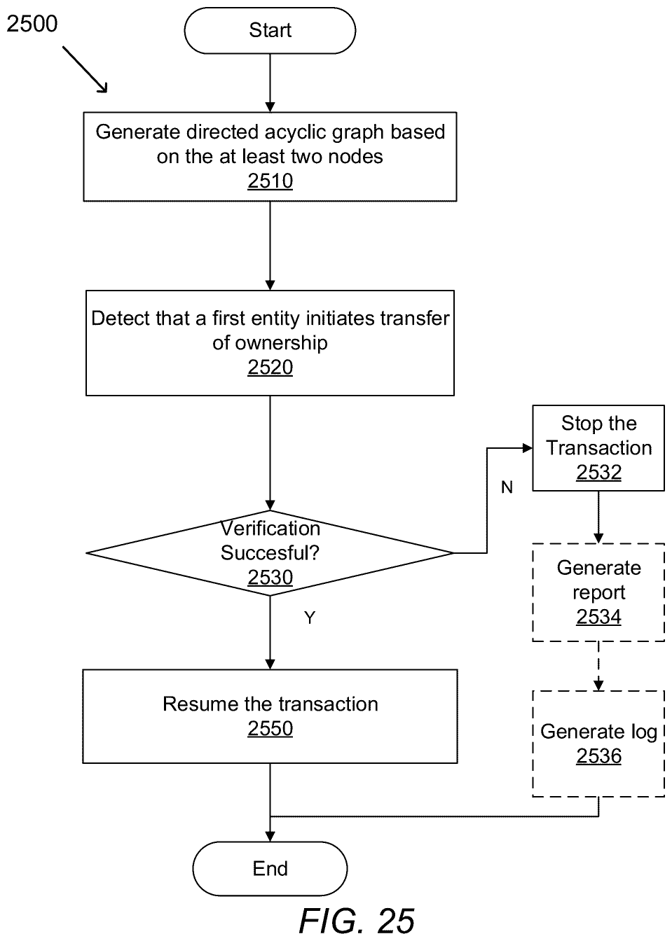

FIG. 25 illustrates a process for generating a directed acyclic graph configured in accordance with various embodiments of the invention. The process 2500 may for example be performed by a device (being implemented on either one physical entity and/or in a distributed manner over two or more physical entities). FIG. 25 illustrates the process 2500 generates (2510) the directed acyclic graph based on the at least two nodes, a first node and a second node. Each of the first node and the second node may include at least one of a fungible token and/or a non-fungible token, and wherein (at least) the first node is recorded to belong to a first entity associated with a first identifier, and wherein the second node is recorded to belong to the first node. This first entity may be a wallet and/or a process. Additionally or alternatively, this first entity may be another node including at least one of a fungible token and/or a non-fungible token, in which case the directed acyclic graph generated of the at least two nodes in step 2510 may be a subgraph of a larger directed acyclic graph. FIG. 25 also illustrates an optional step, wherein process 2500 detects (2520) that the first wallet initiates a transfer of ownership of a token from the first entity to a second entity. The entity may be a wallet and/or a token. The process 2500 may perform (2530) verification of the transfer of ownership, wherein the transfer of ownership of the token is halted until the verification is performed. Further, FIG. 25 illustrates two optional and additional steps 2540 and 2550, which may be performed in response to the outcome of the verification in step 2530. When the verification is successful, then the process 2500 resumes (2550) the transfer of ownership. Alternatively, when the verification is unsuccessful, then the process 2500 stops (2532) the transfer of ownership. Further, in case of stopping the transfer of the ownership, the process 2500 optionally generates (2534) a report and generates (2536) a log of the event.

While specific processes for producing directed acyclic graphs are described above, any of a variety of processes can be utilized as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted.

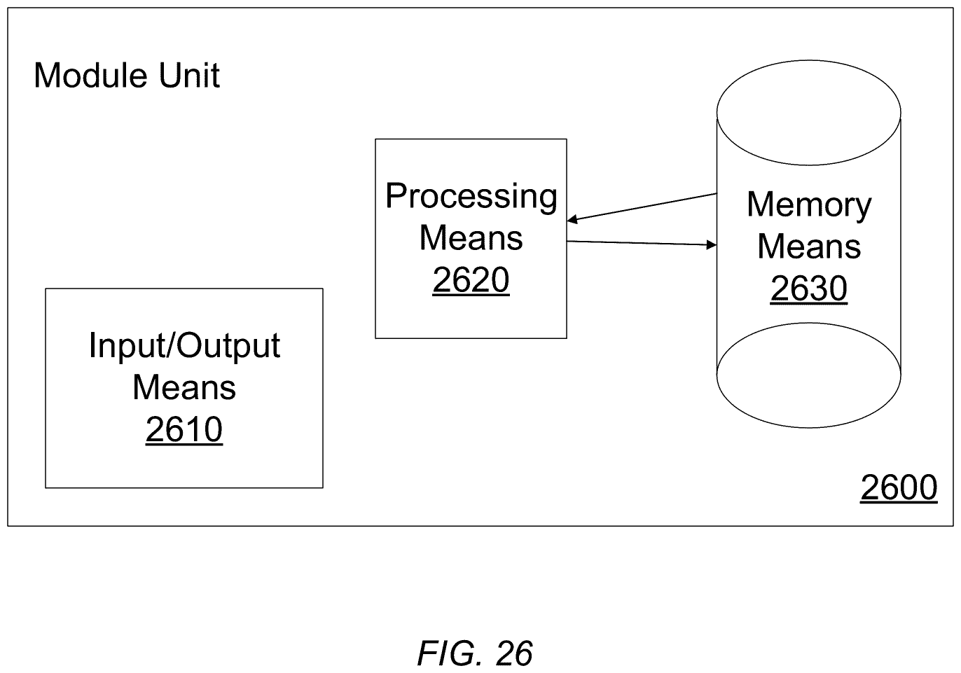

FIG. 26 illustrates a device 2600 for enabling the generation of a directed acyclic graph in accordance with a number of embodiments of the invention. The device 2600 is illustrated including input/output means 2610 by means of which the device 2600 may receive information and transmit and/or provide information to other units, devices and/or entities. FIG. 26 also illustrates the device 2600 including processing means 2620 and memory means 2630, the memory means 2630 including instructions, which when executed by the processing means 2620 causes the device 2600 to perform the methods in accordance with various embodiments of the invention.

While specific processes and structures are described above with reference to FIGS. 22A-26, systems governing directed graphs can be implemented in any of a number of different ways to enable as appropriate to the requirements of specific applications in accordance with various embodiments of the invention. Additionally, the specific manner in which token configurations can be utilized within NFT platforms in accordance with various embodiments of the invention is largely dependent upon the requirements of a given application.

Token Access Structure with Social Overlay

One aspect of the disclosed invention is a technique to encourage the use of an overlay of social networking with token technologies, allowing a token owner to enable users related to her over a social network to utilize tokens in her possession. The token owner may specify conditions for the utilization, and may specify what users may engage in the utilization of the tokens. Such conditions and specifications may be expressed as one or more smart access controls. Smart access controls may include rules and conditions, and may be expressed using data and executable instructions. The data may indicate variable selections and/or references to locations where data and/or executable instructions are stored, which may be in a database including distributed databases. One example of a distributed database is blockchain. Tokens include both fungible and non-fungible tokens. A token may be encapsulated data, which may be authenticated, encrypted, and/or executable, and which may reference other tokens. In this disclosure, the term social network parameter is used. This may be any type of information associated with a social network. Examples of social networks are Facebook, Instagram, Twitter, Snapchat etc. Examples of parameters are friends, followers, followed accounts, contacts of a contact list etc.

For example, an owner, Alice, of tokens (including but not limited to an NFT) may specify that users within a social networking radius of 2 steps from her may borrow and/or rent a token, when available. For example, Alice knows Bob, and Bob knows Cindy. Cindy may use a wallet that is capable of detecting tokens that can be borrowed, where Cindy's wallet identifies Alice's token as being possible for Cindy to borrow, since Cindy is at a distance of 2 from Alice and the terms Alice has associated with the token is that it can be borrowed within a radius of 2 from her, which means Cindy is a friend of a friend. A distance of 1 would mean a friend, whereas a distance of 3 a friend of a friend of a friend. This loan requires no action from Bob. It also does not require any action from Alice, beyond the setting of the above-mentioned policy. As Cindy borrows the token, she may utilize it in a manner that can also be specified by Alice's initial configuration, which Alice may augment and/or modify at any time. For example, Cindy may display the token, and/or Cindy may determine whether having the token in her wallet causes her tokens to evolve. Here, having tokens in the wallet may mean having ownership of it, having borrowed it, and/or having rented it; it may also require that a copy is cached in the wallet storage, but does not have to. Evolution was disclosed, among other places, in U.S. patent application Ser. No. 17/929,894, titled “Methods for Evolution of Tokenized Artwork, Content Evolution Techniques, Non-Fungible Token Peeling, User-Specific Evolution Spawning and Peeling, and Graphical User Interface for Complex Token Development and Simulation,” filed Sep. 6, 2022, incorporated by reference in its entirety. Cindy may discover that a second token, which she owns, may evolve when she were to purchase Alice's token from her. Alternatively, Cindy's tokens may automatically evolve as soon as she borrows Alice's token, e.g., as governed by settings of the system; by settings associated with Alice's token; by settings associated with Cindy's token; and/or a combination of these.

In another example, Alice may instead set a physical distance as a term, e.g., only allow an action for a person within 10 miles. This can be combined with the social networking distance so that an action is only allowed by users at distances corresponding to a radius of 1 (i.e., a direct contact of Alice's) who is within 10 miles. The action may be to be allowed access to a resource, including but not limited to the token in the example above, and/or to be allowed to render an avatar representing Alice on a map, where the location that the avatar is rendered corresponds to Alice's location, as determined using, for example, a GPS coordinate associated with a device associated with Alice, where this device may include a wallet used by Alice.

Lending tokens is only one example of an action. Another example is renting of tokens, and/or renting of tokens at a discounted rate. These actions may be associated with one or more configuration parameters. In the example above, Alice specified a radius governing who may borrow tokens. This can also be applied to renting and/or renting with a discount. Alice may also indicate that all her contacts within radius 1 who have indicated in their social networking configuration that they are single men may see a given token; and/or that anybody matching Alice's profile of a person she wishes to get to know may borrow tokens. This profile may be derived from and/or be part of the social networking profiles of users, including but not limited to Dave. One requirement, for example, for being able to borrow Alice's token may be that the person is not connected within a radius of 2 to Alice's mom. Another token of Alice's may have yet another condition. Thus, Alice may categorize her tokens into classes specifying who may perform actions on the tokens (e.g., anybody within radius 2) as well as into classes specifying what actions may be performed (e.g., render the content of the token, borrow the token, rent the token at a discounted rate, etc.) The classifications can be performed by Alice using a visual classification method including but not limited to what was disclosed in U.S. patent application Ser. No. 17/821,444, titled “Systems and Methods for Management of Token Interactions,” filed Aug. 22, 2022, incorporated by reference in its entirety. Distance can also be expressed in terms of physical distance, e.g., two users being no more than 5 miles from each other according to, e.g., geolocation data using IP addresses, GPS coordinates, user-specified locations, and/or a combination of such.

The disclosed technology encourages users, including but not limited to Alice, to provide other users with limited access, as this may lead to these users appreciating Alice, reaching out to Alice, requesting to purchase tokens from Alice, and/or renting tokens which may cause a profit to Alice using a revenue sharing method under which both Alice and the content creator associated with the token being rented benefit from the payment of the rental. Alice might also be credited with having influenced and/or recruited a visitor, viewer, and/or potential new customer, for example, as may be the case with advertisement and promotions utilizing blockchain technologies. Users being provided with access also benefit: they may learn about new contents from users like them; they may find that they benefit from having access to and/or ownership of such content, e.g., in the form of their own content evolving. Users, whether Alice, Cindy and/or Dave in the examples above, may generate markups of content, e.g., in the form of ratings of it, which helps provide quality rankings for content, and/or classification of what types of users (e.g., by demographics) are associated with such rankings. Such quality rankings and demographic associations may be used by the system to improve recommendation mechanisms, e.g., to select potentially interesting content for users (such as Cindy and Dave) to access. This enables users to “try before they buy”. It also allows users owning content to benefit from being able to show off desirable content, and having it receive high ratings, which may help them sell the content at a profit and/or find users wishing to trade other desirable content for the rated content. The disclosed technology also helps inform the system of what users find what content desirable, and to benefit from the correlation between socially connected users in the efforts of promoting material, e.g., using advertisements, giveaways, discounts, etc.; such efforts benefit from generating ratings for content and associate such ratings with users.

Ratings may be provided explicitly, e.g., by users including but not limited to Cindy indicating that she liked some content, including but not limited to content associated with the token she borrowed from Alice. It may also be implicitly determined by actions of Cindy's, including but not limited to viewing the content of the borrowed token multiple times; requesting to borrow other tokens associated with Alice; requesting to borrow other tokens associated with the same content creator as the party that generated the content in Alice's token, etc.

A wallet may be configured to enable users to see only their own resources, including but not limited to her own tokens, profile information, and configurations. It may also be configured to see resources associated with other users, where such users' wallets are permitting such access. A user wallet may, for example, indicate the tokens that are owned by the wallet in question in one way, and the tokens that are not owned by the wallet but accessible by the wallet being indicated in another way. This second way may be represented by an icon of the token circled by two thin circles, for example, while owned resources may be indicated without the two circles and with slightly more vivid colors. The wallet may also render icons of the two or more types, where the types may correspond to the permissible actions, in different visual compartments. Here, one permissible action may be the right to sell the token, another may be the right to access the content of the token, whereas a third permissible action may be to access the content of the token in response to a payment. Accessing content may correspond to rendering a movie, integrating a game play character corresponding to the token in a game, and/or computing a function including but not limited to locating user(s) associated with the wallet that owns the token.

In various embodiments, an owner of a digital asset, e.g., tokens, may grant access to the digital asset, wherein the granting of access to the digital asset includes one or more constraints and/or limitations associated with the access to the digital asset. Some illustrative and non-limiting examples of such constraints and/or limitations are (a) a number of times the digital asset may be accessed, (b) a quality level of rendering content associated with the digital asset, (c) a time period during which the digital asset may be accessed, (d) an amount of rent fee paid by the at least one second entity, (e) a type of device representing the at least one second entity, and/or (f) a location of the second entity. In one example assuming the digital asset includes a movie, renting the asset may include being able to watch the movie once and/or twice, optionally during a predefined time period, which again optionally may depend upon a fee paid by the renter of the digital asset as defined by the limitations and/or constraints. In another corresponding example assuming the digital asset includes a movie, renting the asset may include being able to watch the movie in different quality levels which may optionally depend on the fee paid by the renter of the digital asset and/or on the physical location of the renter as defined by the limitations and/or constraints. In yet another example, the constraints and/or limitations may depend on a social network parameter associated with the first entity, wherein less strict limitations and/or constraints may be applied to an entity having a social networking radius of 1 as compared to an entity having a social networking radius of 2 and/or 3. In still another example, the constraints and/or limitations may depend on the physical distance between the first entity owning the digital asset and a second entity renting and/or borrowing the digital asset, wherein less strict limitations and/or constraints may be applied to a second entity being physically closer to the first entity than to a second entity being physically further away from the first entity.

The actions available to users disclosed above are merely illustrative, and there are many other actions that can be associated with conditions, including but not limited to those disclosed above. Just like smart contracts govern the conditions of changes of ownership of tokens, executable terms and conditions associated with actions govern, in certain embodiments, what actions can be performed and under what conditions. We refer to such instructions as smart access control. Smart access control may govern how users exchange information, whether there is a reciprocity requirement for lending, what types of access a child may have to content, including whether the child may use, sell, lend and/or modify a token and/or content associated with it, and more. Whereas a smart contract resides in a token, a smart access control may reside in a multiplicity of locations, corresponding to an entity that owns the token. This entity may be a wallet. It may also be one or more tokens, as disclosed in co-pending application Ser. No. 63/365,269 titled “Directed Acyclic Token Structure” by Markus Jakobsson and filed on May 23, 2022, incorporated by reference in its entirety. Thus, the entity that owns a token may select and/or generate a smart access control and associate it with the token. The information that specifies the instructions, conditions and other data associated with a smart access control may be stored on the blockchain and may indicate the identity/identities of the token(s) whose usage it governs, where the identity may be a public key of the token and/or another unique value associated with the token. The ownership record for a token, which may reside on a blockchain, may also indicate and/or include the smart access control information, and/or a reference thereto. A wallet may thus be associated with a multiplicity of smart access controls, where different smart access controls may be associated with different tokens, as determined by the wallet. Similarly, when the owner of a token is not a wallet, but, for example, another token, then this other token (or code representing it) may determine the smart access control of the owned token. The smart access control of a token may be updated by the entity that owns the token, and/or a proxy of the same, at any time, e.g., by replacing what smart access control references and/or is referenced by the token in question.

In an example, a user Mona has tokens in her possession. The token includes e.g., an avatar of herself and a description of her, her likes and dislikes, wishes, dreams etc. Mona may lend out, i.e., letting a second party access her token and thus discover her, who she is and thus make a decision on whether and/or not the second party is interested in going on a date with her and/or getting to know her. Mona may set some parameters of who may access her token, e.g., (i) gender, (ii) age, (iii) physical distance between her and the second party either between their homes and/or a current position of Mona and the second party, (iv) interests, (v) the second party having a similar token describing the second party that will automatically accessible to Mona etc. In this illustrative example, Mona is a hairdresser living in the city center, loves gardening and cats and wants to meet a man who is good with tools and has an income above a certain amount. At some point in time, a man called Niklas happens to be within a predefined distance of Mona as defined by one of Mona's parameters. Niklas is a man with matching criteria according to parameters defined by Mona and is thus provided with information that he may us to access Mona's token upon request. Niklas decides that Mona sounds like a woman he would like to meet and requests to access Mona's token, thereby also giving Mona access to his token describing his likes and dislikes, wishes, dreams etc. In this illustrative example, Niklas is a man living in a house with a big garden with two cats and has one or more matching wishes with Mona, and Niklas may then send feedback, and/or rating, to Mona. Mona may likewise send feedback, and/or rating, to Niklas. when they match, they may then establish some form of contact, for example by giving access to another respective digital asset including, e.g., phone number, username for a social media app, email and/or any other means of establishing contact, whereby they may be in contact and possibly go on a date. In another example, Mona may have one token representing her profile, and is willing to lend that token to parties meeting some pre-specified criteria, but only for a limited time, unless she renews the loan. Niklas may be able to borrow the token, and is able to determine that this type of token can only be lent out to one party at a time. Thus, Niklas knows that as long as he has borrowed the token, nobody else has access to it. Mona can forcibly cause the token to be returned, e.g., by terminating the loan, but may also extend its expiration date.

In another setting, users may be able to lend out and/or rent out tokens to a larger simultaneous number of users, including but not limited to 5 at a time, where having possession (whether by borrowing and/or renting) tokens may correspond to having access to a set of associated resources, which may be digital, and/or which may be based on a service and/or a physical access. A hotel may rent out tokens representing a key, for example, where this key enables access to a given room. It may provide up to 4 such tokens simultaneously, to different members of a party staying in the room. These users would not be able to transfer the access rights by further lending out and/or renting out the token, unless this is permitted by the terms associated with the token. Thus, access control can be provided using such techniques.

A token may correspond to the right to access a service, which may be limited in terms of how many users may simultaneously access the service. The service may be to access the Wi-Fi of a building, to get access to an admin that provides support, to be able to access a website, to get a discount for a product, to get a higher quality of service (QoS) than without the token, etc. Access to the token can be proved by using the content associated with the token, which may include executable functionality, access keys, etc., and which may be limited in terms of the duration of access, e.g., using an expiration date and/or time.

Smart access controls can be used for a variety of purposes. One such type of purpose is to govern what entities can view the existence of an asset, and under what conditions; another type of purpose is to govern other actions related to the asset, e.g., by what entities it can be rendered/played, at what cost, at what resolution, how many times, provided what assurances, in what computational environments, etc. An example of a computational environment is a specified type of trusted execution environment (TEE), and another is a specified type of digital rights management (DRM) module. Smart access controls can be based on the successful authentication by users, tied to specified and/or allowed computational environments. For example, users may place a condition on an asset, using a smart access control, that limits what parties can access the asset to the user and their spouse, and/or by a pre-specified attorney and/or other trustee representing the user. The user may specify that some users can access the asset simply using a biometric authentication technique, which may be supported, e.g., by a biometric token. Biometric tokens are disclosed, e.g., in co-pending U.S. patent application Ser. No. 17/933,659, titled “Systems and Methods for Token Content Unlocking, Biometric Authentication using Privacy-Protecting Tokens, Ownership-Based Limitations of Content Access, Policy-Based Time Capsule Technology, and Content Lock Mechanisms,” filed Sep. 20, 2022, and U.S. patent application Ser. No. 17/821,444, titled “Systems and Methods for Management of Token Interactions,” filed Aug. 22, 2022, both incorporated by reference in their entireties. Alternatively or in addition, the users may specify that the authentication needs to be performed relative to a given role and/or ownership, e.g., being an attorney in a specified firm, and/or having access to a given computational device. The user may specify that at least a specified number of pre-specified entities must authenticate in a pre-specified manner. The smart access control can evaluate any regular expression associated with identities, roles, and authentication types, and permit and/or deny access based on these. The access may also be based on location, whether identified by GPS coordinates within a pre-specified area, by proximity to pre-specified physical equipment, and/or a combination thereof. Physical equipment can be pre-specified by specifying, in the smart access controls, the need for a device to possess the capability to generate a digital signature relative to an approved public key, where public keys can be approved using a certification infrastructure rooted in a trusted certificate authority.

Smart access controls can be used to implement sharing of resources, e.g., based on membership in a family, enterprise, organization, community, and/or set of content subscribers. This is related to technology disclosed in co-pending U.S. patent application Ser. No. 18/155,662, titled “Crypto Wallet Configuration Data Retrieval,” filed Jan. 17, 2023, incorporated by reference in its entirety. Specifically, in the application a collection of related wallets are disclosed, said wallets being given permissions to access content between each other. The smart access control may specify a name of an entity, to which users have to prove membership of as part of the task of authenticating, thereby limiting access to resources by means of smart access controls specifying rules relating to roles, for example, such roles being expressed in terms of membership in organizations, where such expressions can be managed by means of certificates and/or certificate chains used to validate public keys of users, wallets, and/or other entities. One benefit to implementing access control for dependent wallets in this manner is the flexibility this implementation lends to its users, wherein access control can be seamlessly controlled by means of adding and/or revoking certificates, and wherein the certificates may further specify conditions of access to be incorporated in the evaluation along with conditions expressed by the rules including the smart access controls.

Smart access controls are not limited to tokens, but can also be applied to fungible tokens, including but not limited to cryptocurrency tokens. This is implemented in an analogous manner to how it is implemented for non-fungible tokens. One example of such a use is for a smart access control to be associated with a fungible token, enabling borrowing of funds, potentially up to some maximum amount, under a set of conditions that are expressed in and/or referenced by the smart access control. For example, this may specify who may borrow a given amount, whether they need to pay interest, when they need to return the money, whether they need to put up some security, whether the lender requires the use of second factor authentication (2FA) techniques to address the potential threat of a lender having been phished, and the loan being made by the attacker from a friend's account and/or wallet. The smart access control may specify, in the case of some security, what types of assets qualify, and how to place them in escrow. Some aspects of escrowing are disclosed in U.S. patent application Ser. No. 17/821,444, titled “Systems and Methods for Management of Token Interactions,” filed Aug. 22, 2022, incorporated by reference in its entirety. Some of said aspects are related to escrowing of identity information for conditional tracking of transactions and conditional determination of identities. This is applicable to determine who the borrower was, should they not pay back, for example.

In accordance with multiple embodiments of the invention, a smart access control specification is included in a first token, where said token is associated with a public key and/or other unique identifier, and where a second token is associated with the smart access control specification by assigning the ownership of the second token to the first token. This ownership can later be released, i.e., the ownership re-assigned, by use of the private key associated with the public key of the first token. The first token may be assigned in terms of its ownership to a specified wallet, which could indicate that the second token, being owned by the first token, also belongs to the specified wallet. Alternatively, the second token may have its ownership identified both as being the specified wallet and the first token, where the latter ownership assignment is simply a matter of specifying that the second token is governed by the smart access control specification of the first token. This way, a token may be governed by smart access control specifications of multiple tokens, e.g., by assigning ownership of said token to tokens associated with these smart access control specifications. including but not limited to assignments of ownership may be performed by a party with ownership of the second token, e.g., users of specified wallets. The assignment of ownership, and other properties, including but not limited to indications of being governed by smart access controls, may be done using the techniques disclosed in co-pending application Ser. No. 63/365,269 titled “Directed Acyclic Token Structure” by Markus Jakobsson and filed on May 23, 2022.

A smart contract is an aspect of a token, and is determined and incorporated in the token at the time of minting. In contrast, the smart access control is not tied to a token, but can be modified by an owner of a token. The owner of the token may modify the smart access control any number of times, as long as they remains the token owner. This can be done, e.g., using the wallet. For example, users may select one or more tokens using a graphical user interface (GUI) of the wallet and/or associated display software, including but not limited to a browser, and use a mouse and/or finger to click; then select from a scroll-down menu an option that indicates a modification and/or setting of the smart access control; the user may then select, input and/or otherwise generate a smart access control for the indicated tokens. This control will be applied for each token for which the smart control is not causing a conflict with data associated with the token, where an example conflict may be related to the terms of service indicated in a smart contract. For any conflict, this conflict may be resolved by conveying the conflict to the user and removing elements that cause conflict; by automatically suggesting a compatible smart access control; by not performing the modification for the one or more tokens for which there is a conflict, etc. The selectable smart access controls, and/or building blocks thereof, may be stored by the wallet and/or be accessed by the wallet from an external storage, including but not limited to a blockchain. The smart access controls and/or building blocks thereof may be digitally signed by a certification authority to convey a quality and security level. Associated with each such smart access control and/or building block thereof, a human-readable description and/or code and data to determine such a human-readable description, may be included and also certified. This allows the users to assess what a given smart access control and/or building block thereof will result in, in terms of functionality. Some example smart access controls may need to be configured by users before it is complete, i.e., an access control that includes a second-factor authentication (2FA) aspect may require a selection of the type of 2FA method, what users qualify to authenticate, etc. This may be input by the user, and/or selected from a list of auto-complete options and/or previous choices, and/or a combination of such methods.

A token can be lent to users by the owner, e.g., by indicating in a blockchain record that the users borrowing the token may do so, e.g., by listing the public key of this party and associating that public key with an indication that the item is borrowed. Some items may be associated with policies indicating the number of simultaneous times they can be lent out, which may be 1 when the item can only be accessed by one party at a time. There may also be policies indicating how many times an item may be lent out, consecutively over its life, per year, and/or without the payment of a royalty to the content creator. Such policies may be created by the content creator. Such policies may also be added to tokens, e.g., by wrapping it in a smart contract, e.g., by the owner of the token. Lending an item can be seen as renting it out at zero cost. Thus, all of these actions also apply to renting of tokens, where there is a cost associated with the access rights, said access rights corresponding to those described in the context of a loan. Similarly, a subscription can be seen as a loan of a series of related items (such as tokens and/or content elements of one or more tokens), that is provided in exchange for some condition related to subscription membership having been met. This condition may be a payment having been performed, a resource having been staked, tokens having been contributed to a pool of available tokens that can be accessed using the subscription, etc. The token may be configured such that any party, and/or select parties, may choose to rent the token when configured as such by policy, rather than requiring the owner to perform the lending action.

A policy associated with tokens may indicate an expiration date and/or time of access to the token and/or associated contents. For example, when Alice borrows and/or rents tokens from Bob, the policy may indicate Alice's public key (or a public key of Alice's wallet) and one or more conditions of access, where example conditions include but is not limited to: the expiration date/time not having been reached; Alice's wallet being run in a trusted execution environment (TEE), potentially of a specified type; Alice's wallet being run in a digital rights management (DRM) environment, potentially of a specified type; a maximum number of content accesses of the content associated with the token, by Alice, has not been exceeded a limit; a smart contract determines that the content of the token may be rendered, wherein this may entail verifying that a payment has been made, and/or that a decryption key has been received.

The owner of tokens may be users, where the users are associated with a public key. It may also be a wallet, where the wallet is associated with one or more public keys. It may further be another token, as disclosed in co-pending application titled “Directed Acyclic Token Structure” by Markus Jakobsson. The techniques disclosed herein apply to ownerships of all such types. They also apply to contexts in which one entity (such as a user, wallet, and/or token) have borrowed and/or rented a given token, where a user may be a single entity, an organization including a distributed organization including but not limited to a DAO, and/or a collection of associated users including but not limited to a family. Collections may be hierarchical, and may have some members controlling access of other members. The access may be to render content, compute on and/or using the content, initiate a transfer, perform evolution, to cache content locally, etc.

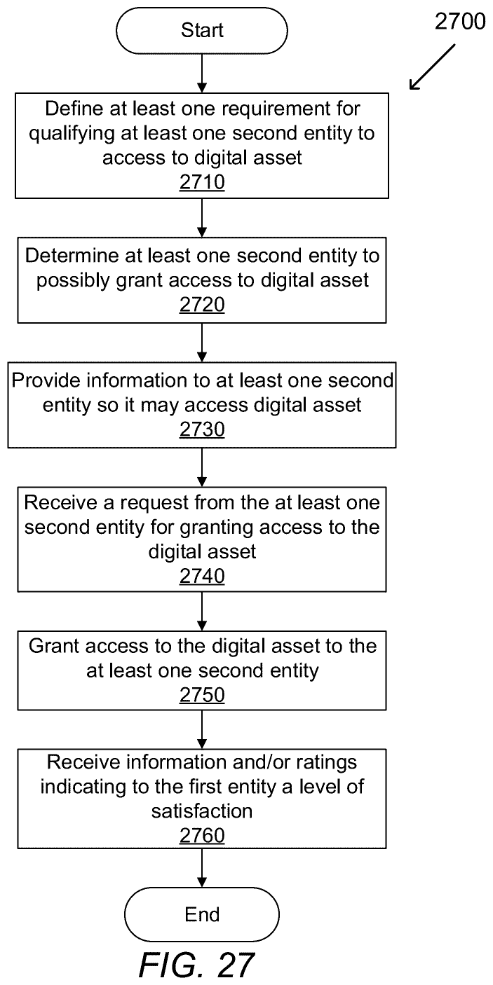

FIG. 27 illustrates a process for granting digital content access in accordance with a number of embodiments of the invention. Process 2700 may be performed by an entity including memory and processing means. Process 2700 defines (2710) at least one requirement for qualifying at least one second entity to access a digital asset for a second entity. The digital asset may belong to a first entity, for purposes including but not limited to renting out and/or lending the digital asset to a second entity. Process 2700 determines (2720) at least one second entity to possibly grant access to the digital asset. Process 2700 provides (2730) information to the at least one second entity so it may access the digital asset. Specifically the information may include functionality such that, upon approval, the at least one second entity can use the functionality to access the digital asset. Process 2700 receives (2740) a request from the at least one second entity for granting access to the digital asset. Process 2700 grants (2750) access to the digital asset to the at least one second entity. Access may be based at least on the at least one second entity having been determined to be allowed access to the digital asset.

As described above, there may be several criteria for determining at least one second entity to possibly receive access to the digital asset. Merely as non-limiting an illustrative examples are a social networking radius of up to 3 steps from the owner of the digital asset and/or within a predefined physical distance of the owner of the digital asset. The entities, for example persons, that are eligible for renting, loaning and/or otherwise accessing the digital asset are somehow informed that he/she/they may rent, loan and/or otherwise access the digital asset. This enables one or more persons requesting access to the digital asset. Fulfilling the requirements the digital asset may thus be rented out to, loaned to and/or otherwise accessible to one or more persons requesting access to the digital asset.

FIG. 27 further illustrates the process 2700 including an optional step, where process 2700 receives (2760) information and/or ratings indicating to the first entity a level of satisfaction and/or appreciation associated with the content of the digital asset, from the at least second entity.

FIG. 27 further illustrates the process 2700 including an optional step 2710 of defining at least one requirement for qualifying at least one second entity to access the digital asset. This has been exemplified above e.g., as Alice indicating that all her contacts within radius 27 who have indicated in their social networking configuration that they are single men may see a given NFT; and/or that anybody matching Alice's profile of a person she wishes to get to know may borrow an NFT. This is of course just an illustrative example. Another illustrative example is defining a geographical distance between the first and the second entity, defining a social network distance, wherein for example a friend and/or entity in a contact list of the first entity has a social network distance of 1 and a “friend of a friend” has social network distance 2. This is also referred to as a social network parameter herein. Still other illustrative examples of defining at least one requirement for qualifying at least one second entity to access to the digital asset is defining age, gender, interests etc. of the second entity.

A person having rented, loaned and/or otherwise accessed the digital asset may provide information and/or rating of the digital asset. For example, the person may give a rating within an interval for example between 1 and 10, wherein 1 means that the person didn't like the content of the digital asset and 10 means that the person really loved the content of the digital asset. Ratings can be seen as a type of information. Alternatively, and/or additionally, the person may give more elaborate feedback as information to the owner who rented out, lent and/or otherwise gave access to the digital asset. Generally, a digital asset is associated with a specific content, wherein accessing the digital asset means being somehow provided with the content. Merely as a very illustrative and non-limiting example, the digital asset may be associated with a music video, wherein accessing the digital asset corresponds to viewing and listening to the music video.

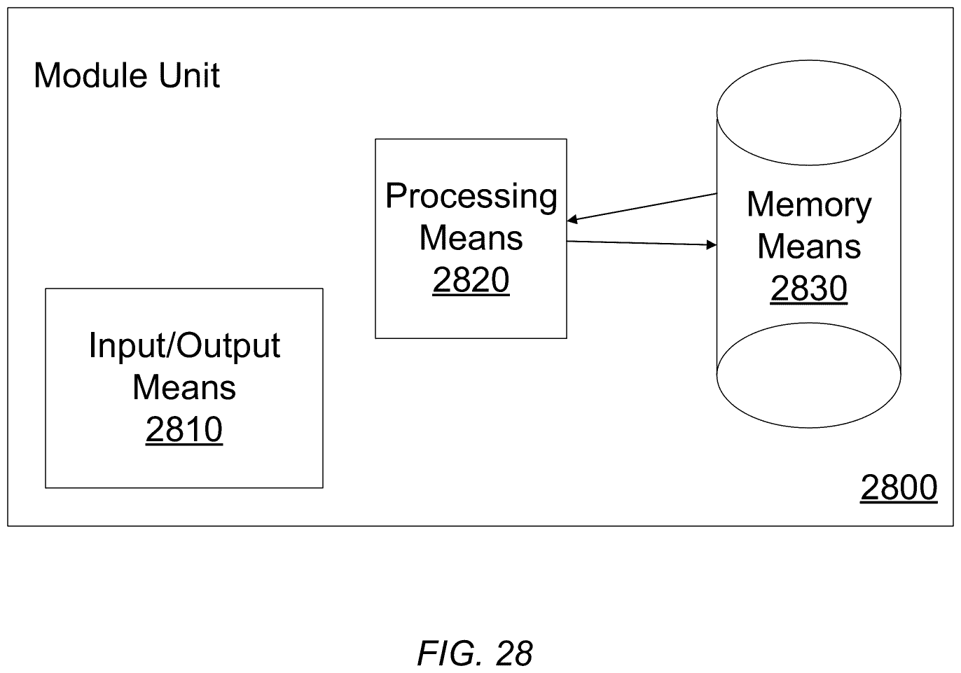

FIG. 28 illustrates a block diagram of a module unit configured in accordance with some embodiments, that may be used in granting entities access to digital assets. The module unit 2800 includes memory and processing means for granting access to a digital asset for a second entity, the digital asset belonging to a first entity, for purposes including but not limited to renting out and/or lending the digital asset to a second entity. The module unit 2800 is illustrated including input/output means 2810 by means of which the module unit 2800 may receive information and transmit and/or provide information to other units, devices and/or entities. FIG. 28 also illustrates the module unit 2800 including processing means 2820 and memory means 2830, the memory means 2830 including instructions, which when executed by the processing means 2820 causes the module unit 2800 to perform the method described herein. The module unit 2800 may for example be a server, a computer, a cloud server and/or any entity and/or arrangement including processing means for executing the method.

While specific processes and structures are described above with reference to FIGS. 27-28, systems governing digital assets can be implemented in any of a number of different ways to enable as appropriate to the requirements of specific applications in accordance with various embodiments of the invention. Additionally, the specific manner in which token configurations can be utilized within NFT platforms in accordance with various embodiments of the invention is largely dependent upon the requirements of a given application.

### NFT Asset Ownership

The following disclosure provides systems and methods for a smart contract providing NFTs with a capability to own cryptocurrency and digital fungible tokens. Various general aspects of bundling NFTs and NFTs owning other NFTs have been described in co-pending application Ser. No. 63/365,269 titled “Directed Acyclic Token” by Markus Jakobsson and filed on May 23, 2022.

Commonly known standards for NFTs include the Ethereum ERC721 standard for non-fungible tokens, and the ERC1155 for fungible and non-fungible tokens. In these standards, a smart contract instantiating NFTs may include a data structure known as a mapping, which is used to store data concerning each NFT. Typically each data entry, and/or row, in the mapping maps a token identifier represented by an integer to an owner represented by an Ethereum address. When a token is transferred to a new address, the data entry for the corresponding token identifier is replaced with the new address. When a token does not exist, the token identifier is mapped to the zero address. Rows representing tokens in the data structure may also include other data fields, including but not limited to a universal resource identifier (URI) to metadata and/or other underlying digital information.

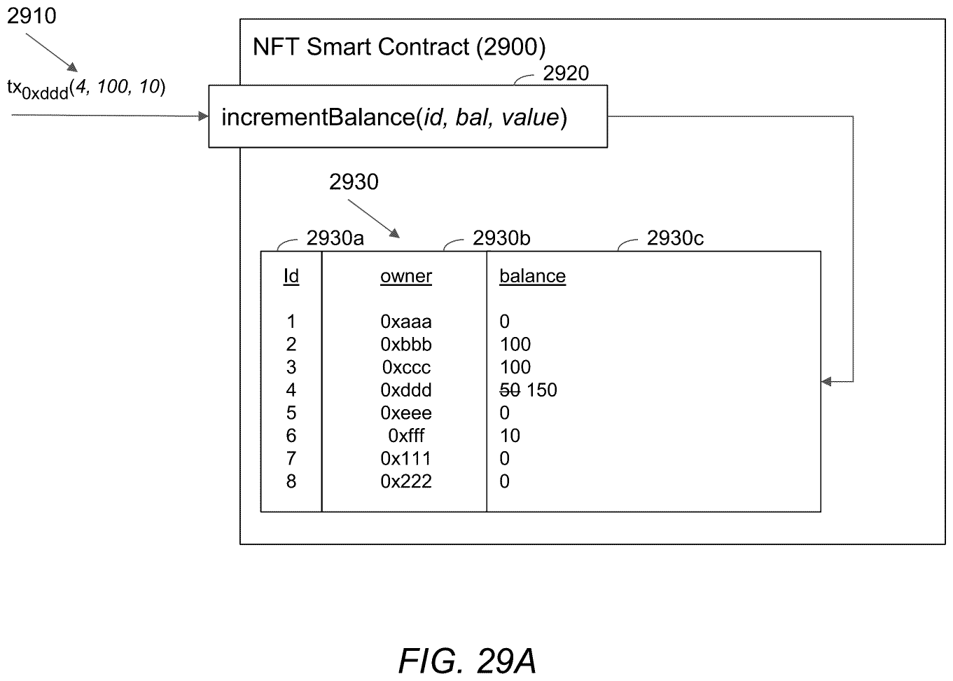

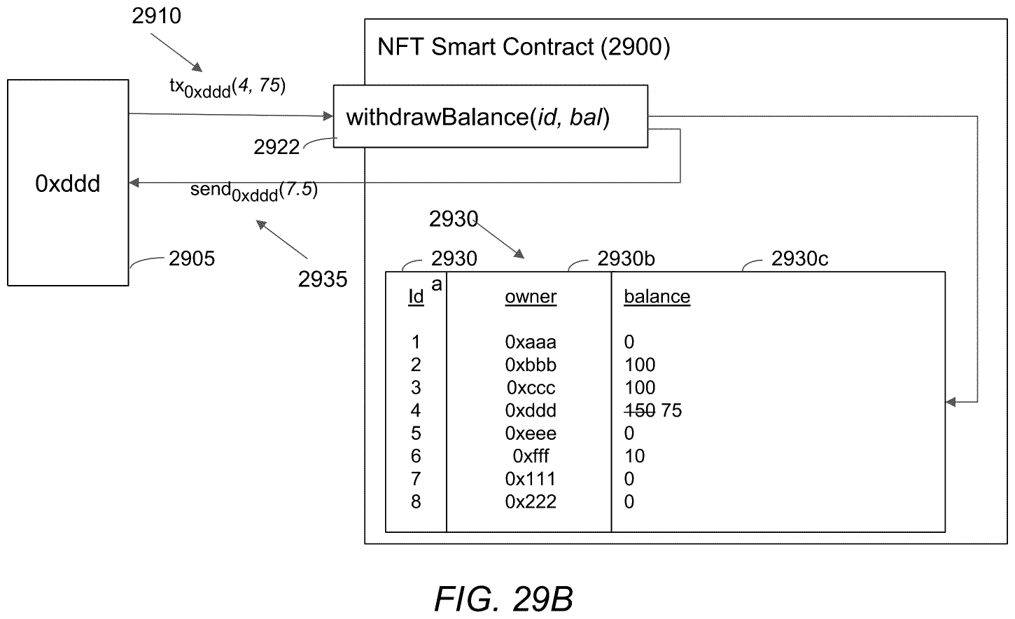

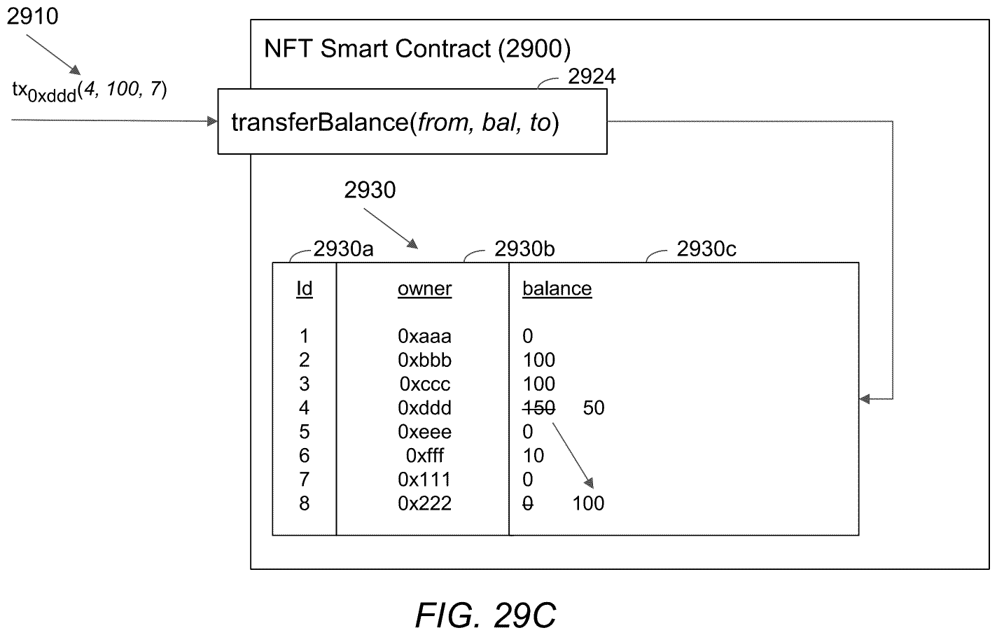

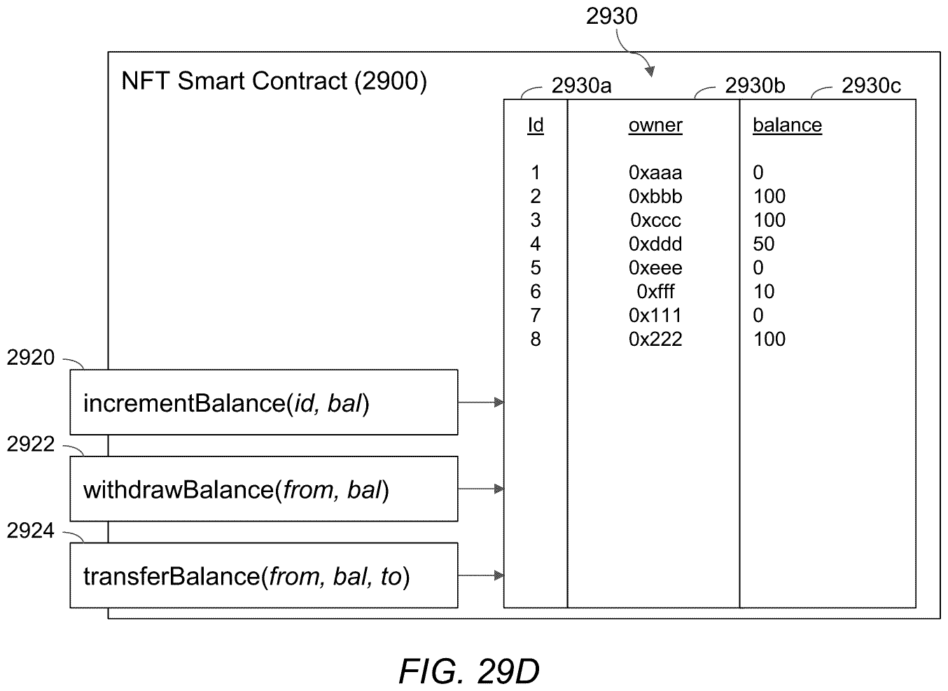

FIGS. 29A-29D illustrate various functions used to modify digital assets in accordance with various embodiments of the invention.

Systems in accordance with some embodiments may be utilized to implement transferable wallets, in which an NFT holds a balance of a cryptocurrency rather than a blockchain address.

In accordance with several embodiments, the smart contract may include an incrementBalance( ) function taking as arguments a token identifier, a balance increment amount, and optionally a payment. On inclusion of a valid transaction calling the incrementBalance( ) function on the blockchain, optionally with appropriate payment, the smart contract may increment a balance recorded against the NFT by updating data within the data structure mapped to by the mapping from the token identifier for the NFTs such that the balance is increased. The owner of the NFT may thus “deposit” funds in the NFT.

In FIG. 29A the disclosure in the paragraph above is illustrated. Those skilled in the art will appreciate that in FIG. 29A specific parameter values are presented for illustration, that these parameter values are not meant to be limiting, and that FIG. 29A should be interpreted without loss of generality.

An NFT smart contract 2900 may receive a transaction 2910 to be processed by an incrementBalance( ) function 2920. The transaction 2910 may originate from a sender identified, in this case, as address 0xddd. The transaction 2910 may include parameters representing a token identifier, a balance increment amount, and a payment. In this specific example, the token identifier is 4, the balance increment amount is 100, and the payment is 10 units of cryptocurrency. For the purposes of illustration, the NFT smart contract 2900 may expect a payment of one unit of cryptocurrency for each 10 units of balance increase.

The incrementBalance( ) function 2920 may then examine the transaction 2910, determine its validity by comparing the structure of the transaction with accepted blockchain protocols and verifying it has been correctly digitally signed using a digital signing algorithm as specified by accepted blockchain protocols, and act on the transaction 2910. In the example of FIG. 29A, the NFT smart contract 2900 may include a data structure 2930 storing information regarding NFTs the NFT smart contract 2900 instantiates. The data structure 2930 may be understood by a human reader to represent a table including columns corresponding to token identifiers 2930a, associated owners 2930b, and balances 2930c.

On determining that the transaction 2910 is valid and correctly digitally signed, the incrementBalance( ) function 2920 may edit a row corresponding to a token with identifier 4, verified as belonging to address 0xddd, such that the balance is incremented from 50 to 150, namely by 100 balance units.

As those skilled in the art will be aware, NFTs may be transferred from one ownership to another. Systems in accordance with some embodiments of this disclosure may instantiates NFTs that may function as “gift cards”, in that users may mint NFTs, load it up with balance units, and then transfer the ownership of the NFT(s) to another party. The other party may now have access to and ownership of the balance units.

Systems in accordance with numerous embodiments may be utilized to wrap other cryptocurrencies and/or digital tokens as balances of NFTs.

In the embodiment, the owner of the NFT may sell some or all of the balance of the NFT for cryptocurrency and/or tokens. In the embodiment, the smart contract may include a withdrawBalance( ) function taking as arguments a balance to withdraw. On receiving a transaction calling withdrawBalance( ) the smart contract may reduce the balance of the NFT, for example, by updating data within the data structure mapped to by the mapping from the token identifier for the NFTs such that the balance is decreased, and transferring payment in the form of cryptocurrency and/or digital tokens to the address of the owner of the NFT equal to the reduction of the balance.

In FIG. 29B the disclosure in the paragraph above is illustrated. Those skilled in the art will appreciate that in FIG. 29B specific parameter values are presented for illustration, that these parameter values are not meant to be limiting, and that FIG. 29B should be interpreted without loss of generality.

An NFT smart contract 2900 may receive a transaction 2910 transmitted from a wallet with address 0xddd 2905 to be processed by a withdrawBalance( ) function 2922. The transaction 2910 may include parameters representing a token identifier, and a balance to sell. In this specific example, the token identifier is 4, and the balance to sell is 75 balance units. For the purposes of illustration, the NFT smart contract 2900 may pay out one unit of cryptocurrency for each 10 units of balance withdrawn.

The withdrawBalance( ) function 2922 may then examine the transaction 2910, determine its validity, and act on the transaction 2910. In the example of FIG. 29B, the NFT smart contract 2900 may include a data structure 2930 storing information regarding NFTs the NFT smart contract 2900 instantiates. The data structure 2930 may be understood by a human reader to represent a table including columns corresponding to token identifiers 2930a, associated owners 2930b, and balances 2930c.

On determining that the transaction 2910 is valid and correctly digitally signed, the withdrawBalance( ) function 2922 may examine and edit a row corresponding to a token with identifier 4, verified as belonging to address 0xddd, such that a balance of the NFT is greater than or equal to a withdrawal request of 75 balance units. When the balance of the NFT is greater than or equal to the withdrawal request, then the withdrawBalance( ) function 2922 may: decrement the balance of token 4 owned by 0xddd by 75 balance units, from 150 to 75 in this example, and submit a second transaction 2935 to transfer 7.5 units of cryptocurrency from the NFT smart contract 2900 to the wallet 2905 including address 0xddd, because as was previously stated, in this example ten balance units correspond to one unit of cryptocurrency.

Through this, native cryptocurrency of a blockchain, and/or non-fungible tokens instantiated by another smart contract, may be deposited against an NFT instantiated by the present smart contract, and may later be withdrawn, thus implementing wrapped tokens stored against an NFT rather than a blockchain address.

In accordance with various embodiments, the owner of the sending NFT may transfer some or all of the balance of the NFT. In the yet further embodiment, the smart contract may include a transferBalance( ) function taking as arguments a token identifier of a sending NFT to transfer balance from, a balance to transfer, and a receiving NFT token identifier. On receiving a transaction calling transferBalance( ) the smart contract may reduce the balance of the sending NFT, for example, by updating data within the data structure mapped to by the mapping from the token identifier for the sending NFT identifier and the receiving NFT identifier, such that the balance of the sending NFT is decreased, and the balance of the receiving NFT is increased by a corresponding amount, optionally minus a fraction of the balance transferred as a royalty and/or transfer commission for the smart contract.

In FIG. 29C the disclosure in the paragraph above is illustrated. Those skilled in the art will appreciate that in FIG. 29C specific parameter values are presented for illustration, that these parameter values are not meant to be limiting, and that FIG. 29C should be interpreted without loss of generality.

An NFT smart contract 2900 may receive a transaction 2910 transmitted from a wallet with address 0xddd to be processed by a transferBalance( ) function 2920. The transaction 2910 may include parameters representing a token identifier from which the balance is to be transferred, a balance to transfer, and a token identifier to transfer the balance to. In this specific example, the token identifier from which the balance is transferred is 4, the balance to transfer is 100 balance units, and the receiving token is identified by token identifier 8.

The transferBalance( ) function 2920 may then examine the transaction 2910, determine its validity, and act on the transaction 2910. In the example of FIG. 29C, the NFT smart contract 2900 may include a data structure 2930 storing information regarding NFTs that the NFT smart contract 2900 instantiates. The data structure 2930 may be understood by a human reader to represent a table including columns corresponding to token ids 2930a, associated owners 2930b, and balances 2930c.

On determining that the transaction 2910 is valid and correctly digitally signed, the transferBalance( ) function 2924 may examine and edit a row corresponding to a token with identifier 4, verified as belonging to address 0xddd, such that a balance of 150 is more than the balance of 100 to be transferred. When the balance to be transferred is less than or equal to a present balance of the sending NFT, then the transferBalance( ) function 2924 may: decrement the balance of token 4 owned by 0xddd by 100 balance units, from 150 to 50 in this example, and increment the balance of token 7 by 100 balance, from 0 to 100, as shown in the balance table 2930c.

An NFT smart contract may include some or all functionality from FIGS. 29A-29C, and should be interpreted in the light of said functionality.

FIG. 29 illustrates an NFT smart contract configured in accordance with some embodiments. The NFT smart contract 2900 may include a data structure 2930 storing information regarding NFTs that the NFT smart contract 2900 instantiates. The data structure 2930 may be understood by a human reader to represent a table including columns corresponding to token ids 2930a, associated owners 2930b, and balances 2930c.

The NFT smart contract 2900 may include an incrementBalance( ) function 2920 as disclosed in FIG. 29A.

The NFT smart contract 2900 may include a withdrawBalance( ) function 2922 as disclosed in FIG. 29B.

The NFT smart contract 2900 may include a transferBalance( ) function 2924 as disclosed in FIG. 29C.

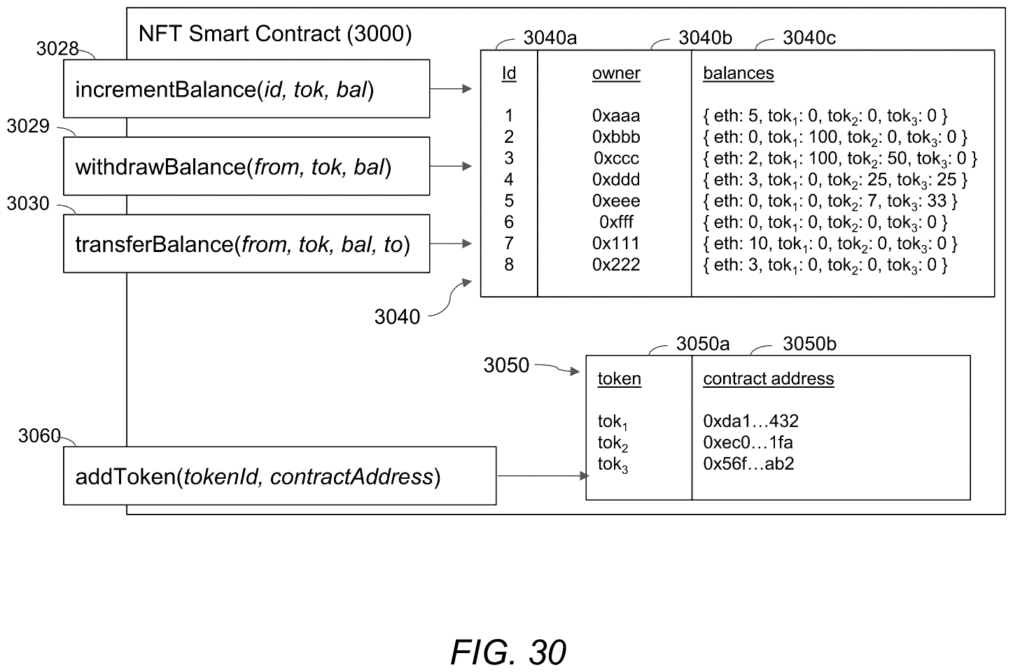

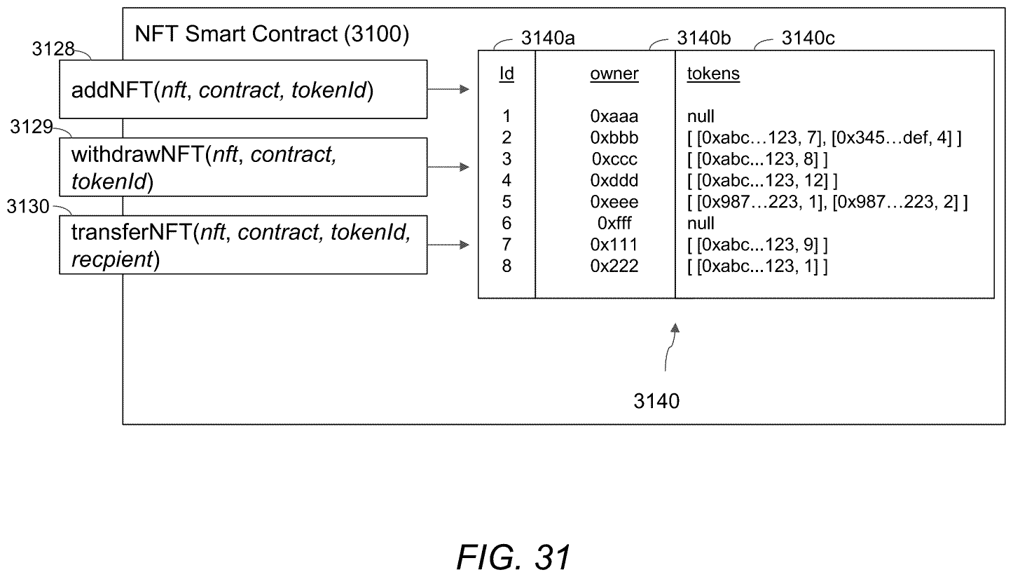

In the previous embodiments the disclosed NFT smart contract may hold balances of one specific fungible token, for example on Ethereum, only Ether, and/or only a single specific ERC20 token including but not limited to USDC. An NFT smart contract capable of instantiating NFTs that may hold a plurality of token types, configured in accordance with numerous embodiments of the invention, is illustrated in FIG. 30.

Those skilled in the art will appreciate that in FIG. 30 specific parameter values are presented for illustration, that these parameter values are not meant to be limiting, and that FIG. 30 should be interpreted without loss of generality. Those skilled in the art will also appreciate that FIG. 30 is described in the context of the Ethereum blockchain and smart contracts, but that the invention may be similarly applied to other smart contract blockchains.

In accordance with several embodiments, an NFT smart contract 3000 may include an incrementBalance( ) function 3028, a withdrawBalance( ) function 3029 and a transferBalance( ) function 3030 as previously described, with, in an embodiment, each function including further parameters specifying a token type, indicated by tok, to which operations conducted using a function apply.

For example, users may call incrementBalance( ) 3028 through a transaction, providing parameters for an NFT token id indicated by id, a balance token indicated by tok, and a balance amount indicated by bal.

For a native cryptocurrency, including but not limited to ether in the Ethereum blockchain system, the transaction may include a value transfer of ether in the transaction, commensurate with the balance indicated by bal, and with tok specified as eth:

tx(contract.incrementBalance(1,eth,5,{value:5})) [1]

In the example in transaction [1], an NFT is identified by a token id parameter of 1, a token to credit to the NFT is identified by eth, and an amount of eth is identified by 5.

In other embodiments, in an absence of tok and bal as parameter argument, the NFT smart contract may deduce an increase in a balance of native cryptocurrency by inspecting any value transferred by the transaction and crediting said value to a balance stored against an NFT specified by a token id parameter.

For a fungible token defined through a smart contract, including but not limited to, for example, an Ethereum Request for Comment 20 (ERC20) type token, the transaction may include parameters specifying the ERC20 type token and a balance to transfer to the NFT specified by the token id parameter:

tx(contract.incrementBalance(1,dai,5)) [2]

In the example in transaction [2], an NFT is identified by a token id parameter of 1, a fungible token to credit to the NFT is identified by dai, and an amount of the fungible token is identified by 5.

Those skilled in the art will appreciate similar approaches apply for withdrawBalance( ) 3029 and transferBalance( ) 3030 in light of FIG. 29B and FIG. 29C respectively. For the edification of those not skilled in the art, the following examples, which are presented for illustration only and are not meant to be limiting, are presented and explained:

tx(contract.withdrawBalance(1,dai,5)) [3]

In this example in transaction [3], an NFT is identified by a token id parameter of 1, a fungible token to credit to the NFT is identified by dai, and an amount of the fungible token (DAI) is identified by 5. Provided the transaction is issued by an owner of the token with a token id of 1 and the token with the token id of 1 has a balance of at least 5 DAI, the amount of DAI registered against the token may be decreased by 5, and the NFT smart contract may transfer 5 DAI to the owner of the token

tx(contract.transferBalance(1,dai,5,2)) [4]

In this example in transaction [4], an NFT is identified by a token id parameter of 1, a fungible token to credit to the NFT is identified by dai, and an amount of the fungible token (DAI) is identified by 2, and provided the transaction is issued by an owner of the token with a token id of 1 and the token with the token id of 1 has a balance of at least 5 DAI, the amount of DAI registered against the token may be decreased by 5, and the NFT smart contract may register an increment of 5 dai against the token identified by 2.

The NFT smart contract 3000 may include a data structure 3040 for recording information concerning tokens, ownership, and balances. The data structure 3040 may be understood by a human reader to represent a table including columns corresponding to token ids—a token id column 3040a, associated owners—an owner column 3040b, and balances—a balance column 3040c.

Rows in the balances column 3040c may include a data structure for recording balances for a plurality of cryptocurrencies and tokens, for example, an array, a JSON object, a dictionary, and/or some other data structure. For the purposes of illustration and not meant to be limiting, in FIG. 30, a possible embodiment utilizing a JSON object is presented in the balances column. In the possible embodiment balances for an NFT smart contract on the Ethereum blockchain include a key for ether, eth, and a value for a quantity of eth stored against an NFT instantiated by the NFT smart contract 3000. For example, token 1 owned by owner 0xaaa has a balance of 5 ethers. In the possible embodiment, non-fungible token balances may be stored against token identifiers, for example, tok₁, tok₂, and tok₃. Again, in the present example, token 3 owned by owner 0xccc has a balance of 50 of a fungible token denoted by tok₃.

In the possible embodiment, the NFT smart contract 3000 may include a lookup table 3050 including a token identifier column 3050a and a contract address column 3050b. Through the lookup table 3050 the NFT smart contract 3000 may look up a contract address for a token identifier. For example, a token with token identifier tok₁ may correspond to a contract with address 0xda1 . . . 432.

In a further enhancement to the possible embodiment, users may approve the NFT smart contracts 3000 to withdraw tokens from token smart contracts. For example, users may approve the NFT smart contract 3000 to withdraw 50 tokens from a token smart contract with identifier tok₂ and contract address 0xec0 . . . 1fa. The user may then submit an incrementBalance( ) transaction to the NFT smart contract 3000 as shown below:

tx(contract.incrementBalance(1,tok₁,50)) [5]

The NFT smart contract 3000 may subsequently look up a contract address for a token contract corresponding to the token with identifier tok₁, withdraw 50 tok₁ tokens from the token smart contract with contract address 0xec0 . . . 1fa, and when successful, increment a balance of tok₁ in a JSON object in row 1 of the balances table 3040c corresponding to an NFT with token identifier 1.

In accordance with a number of embodiments a second smart contract may act as a broker between the NFT smart contract 3000 and the user, confirming that tokens have been transferred to the NFT smart contract 3000 and subsequently instructing the NFT smart contract 3000 to increment, withdraw, and/or transfer balances registered against an NFT instantiated by the NFT smart contract.

In the previous embodiments the disclosed NFT smart contract may hold balances of fungible tokens. An NFT smart contract capable of updating balances of fungible token, in accordance with certain embodiments of the invention, is illustrated in FIG. 31.

In FIG. 31 the invention outlined in the paragraph above is disclosed. Those skilled in the art will appreciate that in FIG. 31 specific parameter values are presented for illustration, that these parameter values are not meant to be limiting, and that FIG. 31 should be interpreted without loss of generality. Those skilled in the art will also appreciate that FIG. 31 is described in the context of the Ethereum blockchain and smart contracts, but that the invention and the systems and methods it discloses may be similarly applied to other smart contract blockchains.

In accordance with various embodiments, a NFT smart contract 3100 may include functions for adding, withdrawing, and transferring NFTs held by NFTs instantiated in the NFT smart contract 3100.

The NFT smart contract 3100 may include a data structure 3140 for recording information concerning tokens, ownership, and balances. The data structure 3140 may be understood by a human reader to represent a table including columns corresponding to token ids—a token id column 3140a, associated owners—an owner column 3140b, and tokens—a token column 3140c.

Rows in the tokens column 3140c may include a data structure for recording information about a plurality of NFTs instantiated in a plurality of NFT smart contract, for example, an array, a JSON object, a dictionary, and/or some other data structure. For the purposes of illustration and not meant to be limiting, in FIG. 31, a possible embodiment utilizing an array of arrays is presented in the tokens column. In the possible embodiment, token ownership for an NFT instantiated by the NFT smart contract 3100 on the Ethereum blockchain may be recorded by elements in the array, with each element including an array with two elements, the first corresponding to a contract address of one of the plurality of NFT smart contracts, the second corresponding to a token identifier for a second NFT owned by the NFT. For example, in FIG. 31, token 1 owned by owner 0xaaa holds no NFTs, and token 2 owned by owner 0xbbb holds two NFTs, namely token number 7 instantiated by smart contract 0xabc . . . 123 and token number 4 instantiated by smart contract 0x345 . . . def.

The NFT smart contract 3100 may include an addNFT( ) function 3128, which in an embodiment may take parameters nft, contract and tokenId, with nft corresponding to a token identifier for a token instantiated by the NFT smart contract 3100, contract specifying a second NFT smart contract, and tokenId specifying a second NFT instantiated by the second NFT smart contract. On receiving a transaction calling the addNFT( ) function 3128, the NFT smart contract 3100 may: receive the second NFT from the second NFT smart contract, and/or withdraw the second NFT from the second NFT smart contract when prior approval and/or authorization has been granted to withdraw the NFT; and/or update an entry in a row in the data structure 3140 identified by the nft parameter in the token identifier table 3140a such that the row entry for the tokens table 3140c includes the contract and the tokenId.

The NFT smart contract 3100 may include a withdrawNFT( ) function 3129, which in some embodiments may take parameters nft, contract and tokenId, with nft corresponding to a token identifier for a token instantiated by the NFT smart contract 3100, contract specifying a second NFT smart contract, and tokenId specifying a second NFT instantiated by the second NFT smart contract. On receiving a transaction calling the withdrawNFT( ) function 3129, the NFT smart contract 3100 may:
verify that there exists an entry in a row in the data structure 3140 identified by the nft parameter in the token identifier table 3140a such that the row entry for the tokens table 3140c includes the contract and the tokenId,
verify that the NFT smart contract 3100 is the owner of the second NFT identified by tokenId in the second NFT smart contract identified by contract,
verify that the sender of the transaction is registered as the owner in the row identified by the nft parameter in the owner table 3140b,
transfer the second NFT to the sender of the transaction, and/or
remove contract and tokenId from the entry in the tokens table 3140c in the row identified by the nft parameter.

The NFT smart contract 3100 may include a transferNFT( ) function 3130, which in many embodiments may take parameters nft, contract and tokenId, and recipient, with nft corresponding to a token identifier for a token instantiated by the NFT smart contract 3100, contract specifying a second NFT smart contract, and tokenId specifying a second NFT instantiated by the second NFT smart contract. On receiving a transaction calling the transferNFT( ) function 3130, the NFT smart contract 3100 may:
verify that there exists an entry in a row in the data structure 3140 identified by the nft parameter in the token identifier table 3140a such that the row entry for the tokens table 3140c includes the contract and the tokenId,
verify that the NFT smart contract 3100 is the owner of the second NFT identified by tokenId in the second NFT smart contract identified by contract,
verify that the sender of the transaction is registered as the owner in the row identified by the nft parameter in the owner table 3140b,
remove contract and tokenId from the entry in the tokens table 3140c in the row identified by the nft parameter, and/or
update an entry in a row in the data structure 3140 identified by the recipient parameter in the token identifier table 3140a such that the row entry for the tokens table 3140c includes the contract and the tokenId.

An amusing corollary of the present disclosure is that NFTs instantiated by the NFT smart contract 3100 may own other tokens instantiated by the NFT smart contract 3100, for example, by specifying a contract address for the NFT smart contract 3100 as a contract parameter for a call to the addNFT( ) function 3128. This may be applied recursively.

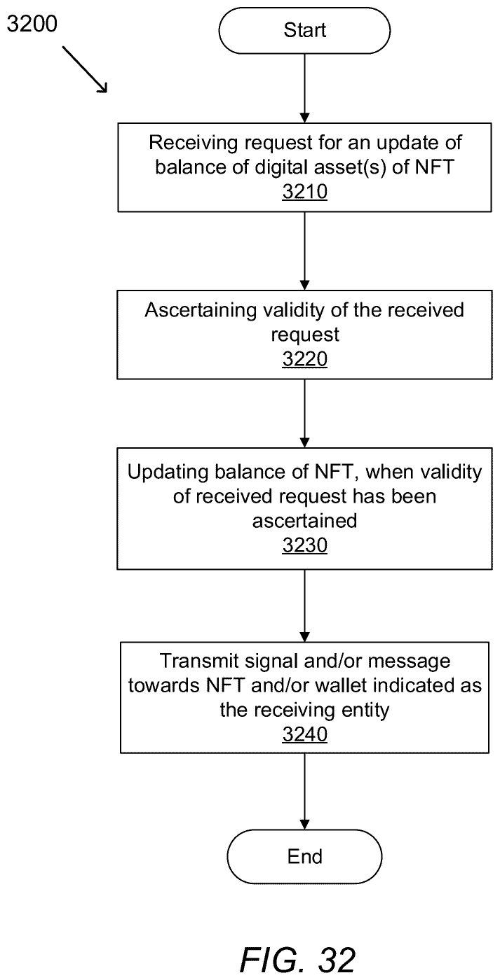

FIG. 32 illustrates a flowchart of a process for updating a balance with regard to digital assets of an NFT configured in accordance with a number of embodiments of the invention. A smart contract instantiates the NFT, may be considered associated with the NFT, and may be used to perform the process 3200. Process 3200 receives (3210) a request for an update of a balance of digital asset(s) of the NFT, the request indicating at least type of update of the balance and the NFT for which the update is to be performed. As explained and exemplified above, the update of the balance may allow for an increment, withdraw and/or transfer. Process 3200 optionally ascertains (3220) a validity of the received request. As said, this step may be optional and it is performed in order to make sure that the received request is a valid request. Process 3200 updates (3230) the balance of the NFT, when the validity of the received request has been ascertained. Process 3200 transmits (3210) a signal and/or message towards the NFT and/or wallet indicated as the receiving entity.

While specific processes for modifying tokens are described above, any of a variety of processes can be utilized for governing the use of NFTs as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted.

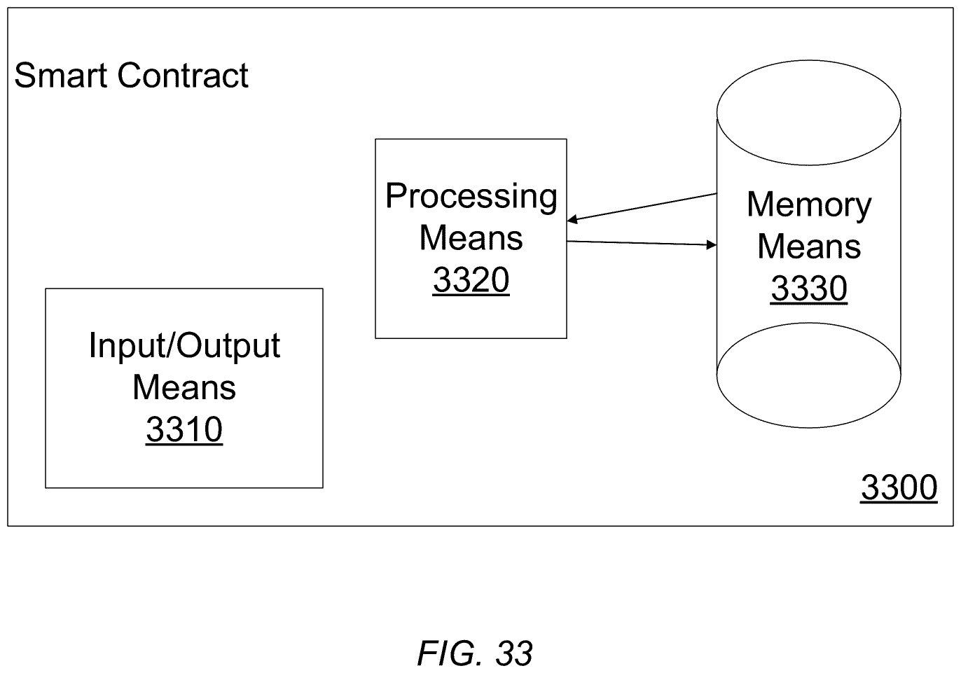

FIG. 33 illustrates a block diagram of a smart contract configured in accordance with many embodiments of the invention for updating digital asset balances associated with NFTs. The smart contract instantiates the NFT and is thereby said to be associated with the NFT. The smart contract 3300 is illustrated including input/output means 3310 by means of which the smart contract 3300 may receive information and transmit or provide information to other units, devices and/or entities. FIG. 33 also illustrates the smart contract 80 including processing means 3320 and memory means 3330, the memory means 3330 including instructions, which when executed by the processing means 3320 causes the smart contract 3300 to perform the processes described herein.

While specific processes and structures are described above with reference to FIGS. 29A-33, systems governing digital assets can be implemented in any of a number of different ways to enable as appropriate to the requirements of specific applications in accordance with various embodiments of the invention. Additionally, the specific manner in which token configurations can be utilized within NFT platforms in accordance with various embodiments of the invention is largely dependent upon the requirements of a given application.

### Access Management Through Time-Limited NFTs

Systems and methods in accordance with many embodiments of the invention may allow smart contracts to provide enhanced NFTs encapsulating subscription data and time-limited access to services capabilities.

Commonly known standards for NFTs include the Ethereum ERC721 standard for non-fungible tokens, and the ERC1155 for fungible and non-fungible tokens. In these standards, a smart contract instantiating NFTs may include a data structure known as a mapping, which is used to store data concerning each NFT. Typically each data entry in the mapping maps a token identifier represented by an integer to an owner represented by an Ethereum address. When a token is transferred to a new address, the data entry for the corresponding token identifier is replaced with the new address. When a token does not exist, the token identifier is mapped to the zero address.

1. Validity Periods

Systems and methods in accordance with various embodiments, rather than a mapping from token identifiers simply mapping to an address, may map to a data structure including: an address of an owner, and a validity period. In some embodiments the validity period may include a date and time, represented by, for example, a Unix timestamp, up to which each NFT stored in the smart contract remains valid. In certain embodiments, the validity period may include a block height for a blockchain on which the smart contract instantiating the NFTs has been deployed.

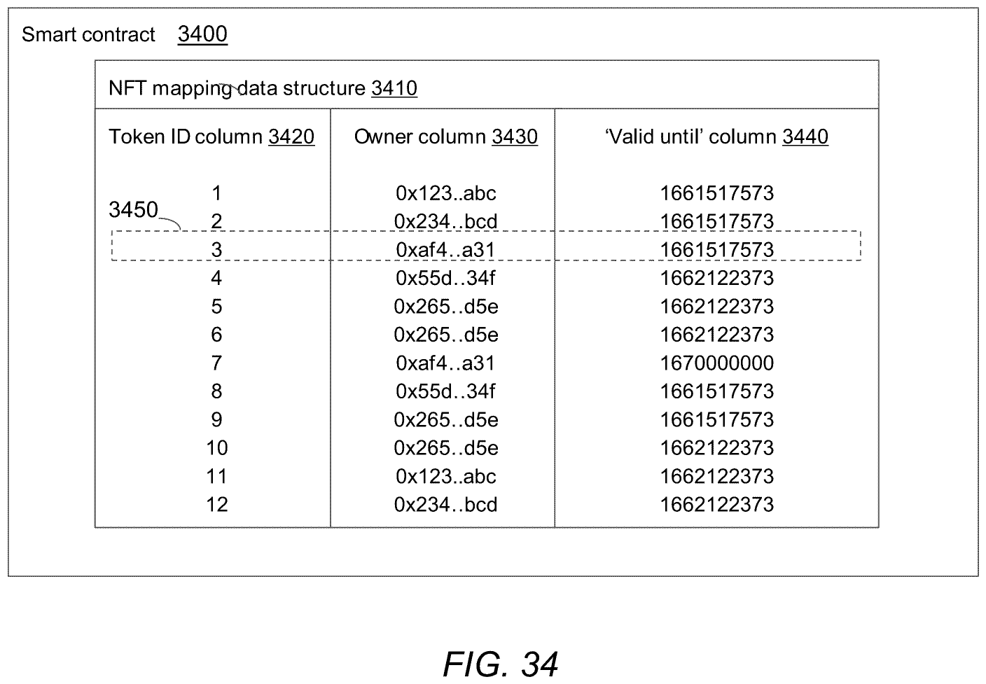

FIG. 34 illustrates a validity period configured in accordance with certain embodiments of the invention. A smart contract 3400 may include NFT-instantiating code, with ownership information relating to individual NFTs stored in an NFT mapping data structure 3410. In FIG. 34 the NFT mapping data structure 3410 is illustrated through the use of a three column table, with a first column, token ID column 3420 providing a list of NFT identifiers, and functioning as a key to the mapping. Columns two and three, labeled owner column 3430 and ‘valid until’ column 3440 present an illustration of an array of two-entry data structures, with a first entry representing an owner, and a second entry representing a validity time.

In an illustrative example presented for clarification and not meant to be limiting, a row 3450 in the NFT mapping data structure 3410 may instantiate an NFT with identifier 3, owned by an address 0xaf4 . . . a31, with a ‘valid until’ value of UNIX timestamp 1661517573, corresponding to a date and time of Fri Aug. 26 2022 12:39:33 GMT. Said NFT may subsequently fall under restrictions after said date and time. In some embodiments the NFT may longer grant access to services and/or information on a server. In many embodiments the NFT may no longer be transferable, a special fee may apply for any transfer of the NFT, a suggested royalty for a transfer of the NFT may change, either increasing and/or decreasing, and/or other conditions may apply.

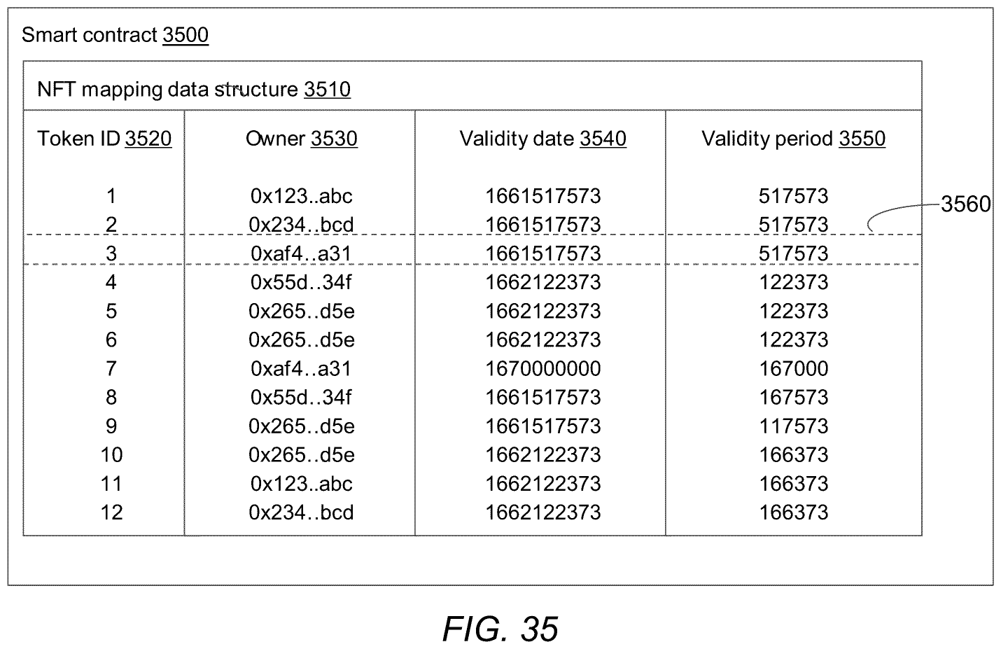

A diagram of a smart contract with an NFT mapping data structure, configured in accordance with multiple embodiments of the invention, is illustrated in FIG. 35. A smart contract 3500 may include an NFT mapping data structure 3510, which may include a column for token IDs 3520, a column for addresses of owners 3530, a column for validity dates 3540, and a validity period 3550. A minting date may be represented by a block height at which a transaction minting an NFT was accepted onto the blockchain. Additionally or alternatively, as illustrated in FIG. 35, minting dates may be represented as Unix timestamps and/or times and dates of: a block including the transaction, a first record of the transaction, and/or some other time. Alternate times may include but are not limited to, a starting validity date in which NFTs are minted and become valid at a later date including but not limited to in a stock vesting contract. A validity period may be represented by a time period, specified in seconds, minutes, hours, and/or some other time unit, and/or the validity period may include a number of blocks for which the NFT remains valid.

The smart contract 3500 may then determine whether any given NFT is valid by retrieving the minting date and the validity period from the mapping using a token identifier for the given NFT as a key to retrieve said minting date and validity period, and examining whether a current block height is less than the minting data plus the validity period. For example, examining a row 3560 for illustrative purposes in a manner not meant to be limiting, an NFT with token identifier 3 may be owned by an address 0xaf4 . . . a32, with a validity date of a Unix timestamp 1661517573 corresponding to a date and time of Fri Aug. 26 2022 12:39:33 GMT, and a validity period of 517573 seconds. Thus the NFT with token identifier 3 would, in this example, no longer be valid after Thu Sep. 1 2022 12:25:46 GMT.

2. Validity Applications of Time-Limited NFTs within Smart Contracts

The smart contract instantiating NFTs may utilize the validity in different ways. Examples for the use of the validity period are now presented. When an NFT is not valid, restrictions may apply to the NFT through functionality within the smart contract:
A transaction to transfer the NFT may fail;
The smart contract may return the owner of the NFT to be one or more of: the zero address, the smart contract deployer address, the smart contract address, and/or another address that is not the registered owner's address;
The smart contract may implement a function that may be called by one or more of: the smart contract owner, the contract deployer, an authorized address, and/or any address, to transfer ownership of the NFT to a new owner;
A function call to the smart contract for the universal resource identifier (URI) to retrieve metadata for the NFT may return one or more of: a “not found” result, a URI to an error page, a URI to a “this NFT is no longer valid” message, metadata including an indication that the NFT is no longer valid, and some other resource indicating that the NFT is no longer valid.

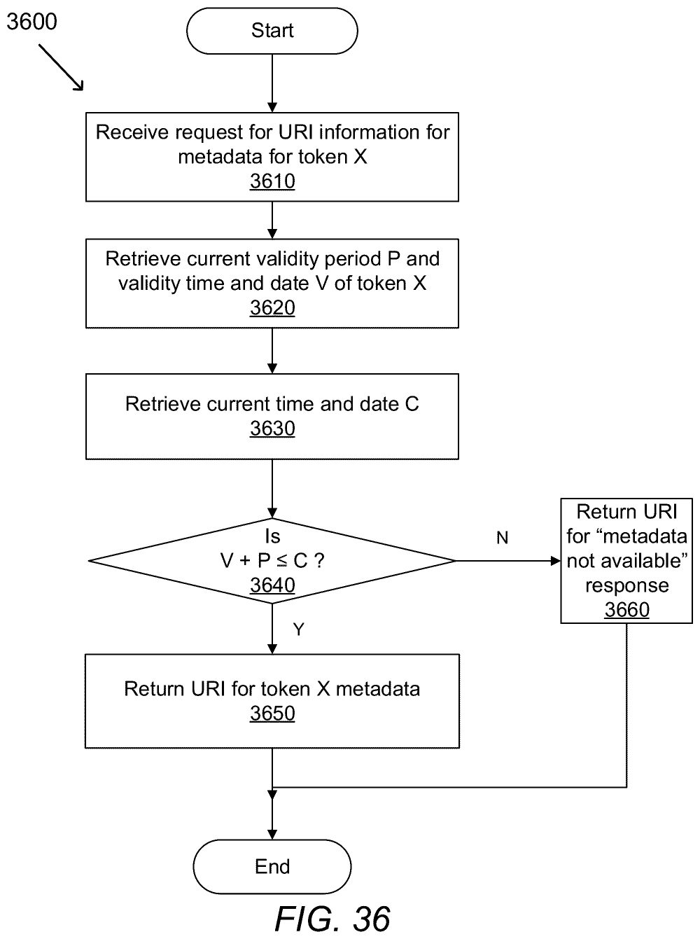

A process reflecting the flow of activity for a time-limited NFT configured in accordance with a number of embodiments of the invention is illustrated in FIG. 36. Process 3600 may be performed by an NFT contract. Process 3600 receives (3610) a request for a URI for metadata for a token X. Process 3600 retrieves (3620) the current validity period P and validity time and data V of token X. Process 3600 retrieves (3630) the current time and date, recorded as C. Process 3600 compares (3640) the sum of V and P with the current time C. When V+P is less than and/or equal to the current time C, token X is valid, and actions proceed to step 3650. When V+P is greater than the current time C, token X is invalid, and actions proceed to step 3660.

After token X has been determined to be valid, process 3600 returns (3650) a URI pointing to valid metadata for token X.

After token X has been determined to be invalid, process 3600 returns (3660) a URI pointing to a “metadata not available” response. In other embodiments, the NFT contract may return an error and/or some other response indicating that token X is no longer valid.

3. Validity Applications of Time-Limited NFTs within Web3

Validity of an NFT may be utilized outside of the scope of the smart contract, for example in a web application. A web3-enabled website may determine that the NFT is no longer valid through a function call to the smart contract, and may restrict access management previously allowed for the owner of the NFT.

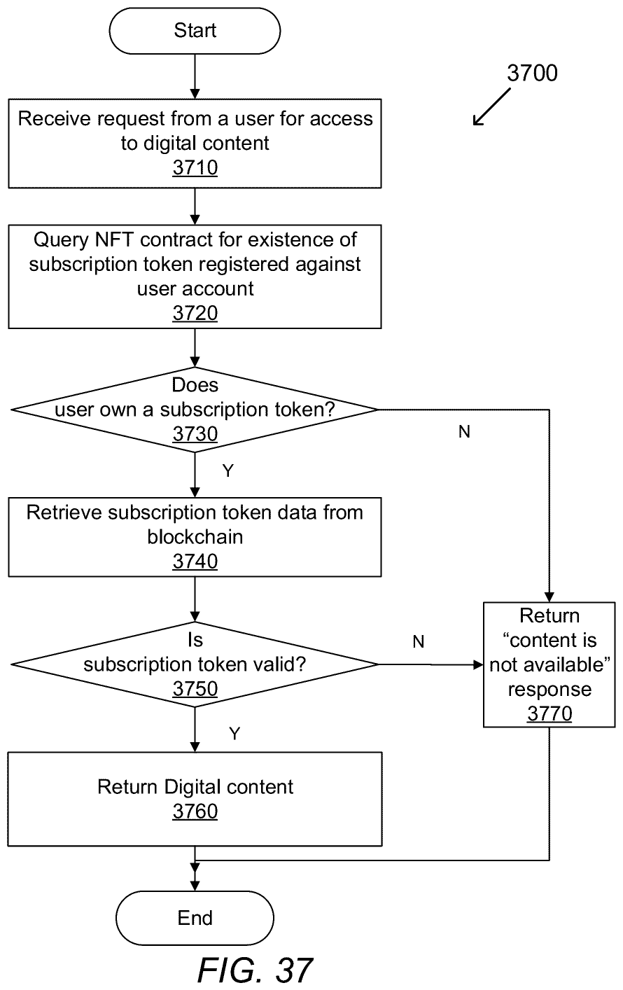

FIG. 37 illustrates a process for facilitating content availability in accordance with many embodiments of the invention. In an exemplary utilization of the present disclosure presented for illustrative purposes and not meant to be limiting, process 3700 may be performed by a web server that can provide subscription content and/or services, for example articles, software, artwork, access to computing resources, access to financial services, and/or other content and/or services.

Process 3700 receives (3710) a request from a user to access to digital content and/or services. Process 3700 queries (3720) an NFT contract on a blockchain for the existence of a subscription token registered against a blockchain address controlled by the user. In some embodiments the web server may provide a digital signing challenge to the user, with the user signing the digital signing challenge with the private key of the public blockchain address belonging to the user and returning the signed digital signing challenge to the web server for verification that the user does own the public blockchain address in question. In other embodiments the user may provide information on the subscription token for simplification of the search and retrieval process.

Process 3700 determines (3730) whether the user owns a subscription token. When the web server determines that the user does not own a subscription token, actions may proceed to step seven 3770. When the web server determines that the user does own a subscription token, actions may proceed to step four 3740.

Process 3700 retrieves (3740) a subscription token data from the blockchain. In other embodiments, another component may continuously retrieve subscription data from the blockchain and store it in a local database, and the web server may retrieve subscription data from the local database. Actions may then proceed to step five 3750.

Process 3700 determines (3750) whether the subscription token is valid. When the subscription token is valid, process 3700 returns (3760) the digital content. When the subscription token is not valid, process 3700 returns (3770) a response indicating that the requested digital content and/or services are not available to the user.

In accordance with numerous embodiments, in step 3730 the web server may offer an option to the user to purchase a subscription token when it is determined that the user does not own a subscription token. Additionally or alternatively, in step 3750 the web server may offer an option to the user to purchase an extension of the subscription token validity period when it is determined that the subscription token is not valid.

4. Subscriptions and NFTs

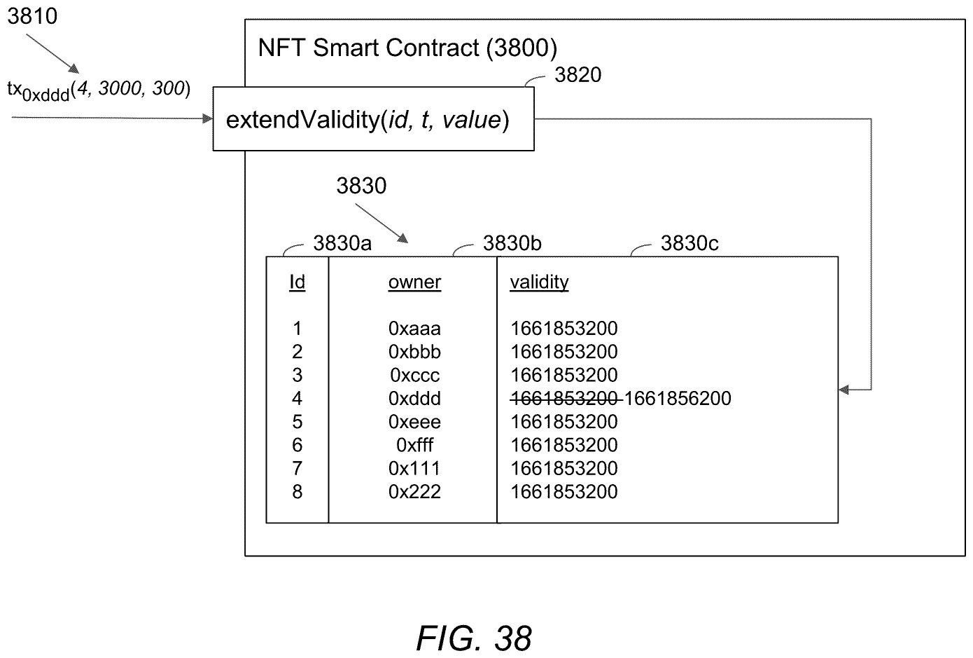

FIGS. 38-41 illustrate various configurations and functions of smart contract in accordance with some embodiments of the invention.

In an enhancement to the present disclosure, the smart contract may include further functionality allowing the validity period of the NFT to be extended and/or reduced. In accordance with several embodiments of the invention, the smart contract may include an extendValidity( ) function taking as arguments a token identifier, a second validity period and optionally a payment. On inclusion of a valid transaction calling the extendValidity( ) function on the blockchain, optionally with appropriate payment, the smart contract may extend the validity of an NFT identified through the token identifier, by updating data within the data structure mapped to by the mapping from the token identifier for the NFTs such that the validity period is increased. The owner of the NFT may thus reinstate its validity.

In FIG. 38 the disclosure in the paragraph above is illustrated. Those skilled in the art may appreciate that in FIG. 38 specific parameter values are presented for illustration, that these parameter values are not meant to be limiting, and that FIG. 38 should be interpreted without loss of generality.

An NFT smart contract 3800 may receive a transaction 3810 to be processed by an extendValidity( ) function 3820. The transaction 3810 may originate from a sender identified, in this case, as address 0xddd. The transaction 3810 may include parameters representing a token identifier, a time period whereby the validity period of the token identified by the token identifier should be extended, and a payment. In this specific example, the token identifier is 4, the time period extension is 3000 seconds, and the payment is 300 units of cryptocurrency. For the purposes of illustration, the NFT smart contract 3800 may expect a payment of one unit of cryptocurrency for each 10-second extension.

The extendValidity( ) function 3820 may then examine the transaction 3810, determine its validity, and act on the transaction 3810. In the example of FIG. 38, the NFT smart contract 3800 may include a data structure 3830 storing information regarding NFTs the NFT smart contract 3800 instantiates. The data structure 3830 may be understood by a human reader to represent a table including columns corresponding to token identifiers 3830a, associated owners 3830b, and validity times 3830c.

On determining that the transaction 3810 is valid and correctly digitally signed, the extendValidity( ) function 3820 may edit a row corresponding to a token with identifier 4, verified as belonging to address 0xddd, such that a validity time of 1661853200 is incremented to 1661855200, namely by 3000 seconds.

In accordance with many embodiments, the owner of the NFT may sell some and/or all of the validity period of the NFT. In certain embodiments, the smart contract may include a sellValidity( ) function taking as arguments a validity period to sell. On receiving a transaction calling sellValidity( ) the smart contract may reduce the validity period of the NFT, for example, by updating data within the data structure mapped to by the mapping from the token identifier for the NFTs such that the validity period is decreased, and transferring payment to the owner's address in proportion to the reduction of the validity period.

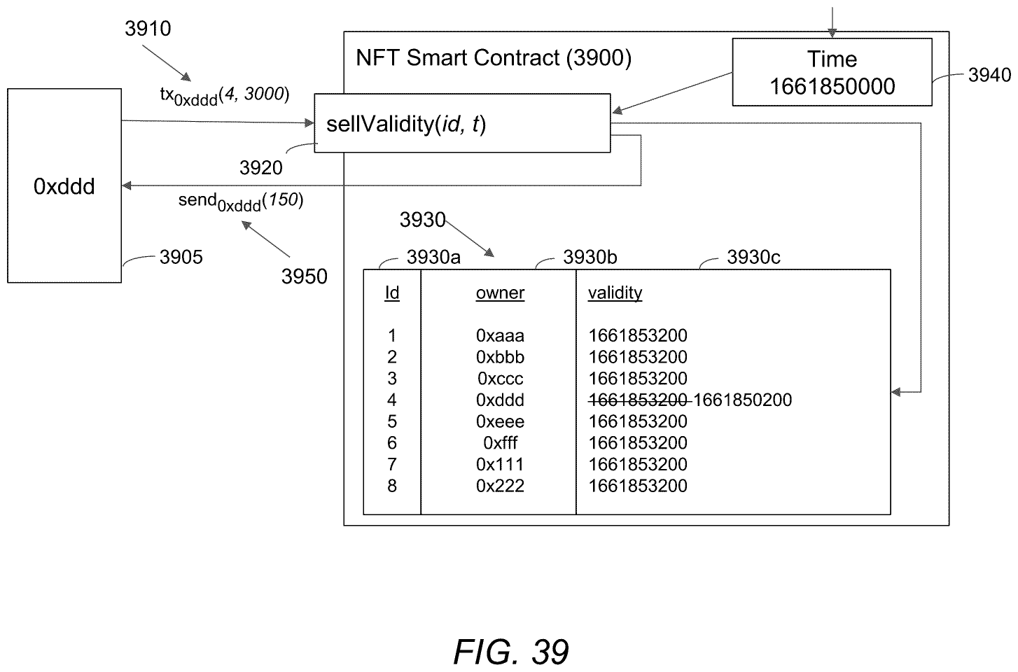

In FIG. 39 the disclosure in the paragraph above is illustrated. Those skilled in the art may appreciate that in FIG. 39 specific parameter values are presented for illustration, that these parameter values are not meant to be limiting, and that FIG. 39 should be interpreted without loss of generality.

An NFT smart contract 3900 may receive a transaction 3910 transmitted from a wallet with address 0xddd 3905 to be processed by a sellValidity( ) function 3920. The transaction 3910 may include parameters representing a token identifier, and a time period to sell. In this specific example, the token identifier is 4, and the time period to sell is 3000 seconds. For the purposes of illustration, the NFT smart contract 3900 may pay out one unit of cryptocurrency for each 150 seconds of valid time period sold.

The sellValidity( ) function 3920 may then examine the transaction 3910, determine its validity, and act on the transaction 3910. In the example of FIG. 39, the NFT smart contract 3900 may include a data structure 3930 storing information regarding NFTs the NFT smart contract 3900 instantiates. The data structure 3930 may be understood by a human reader to represent a table including columns corresponding to token identifiers 3930a, associated owners 3930b, and validity times 3930c.

On determining that the transaction 3910 is valid and correctly digitally signed, the sendValidity( ) function 3920 may examine and edit a row corresponding to a token with identifier 4, verified as belonging to address 0xddd, such that a validity time of 1661853200 is more than 3000 seconds by comparison with the current time 3940 of 1661850000. When the validity period to be sold falls in the future, that is, time already consumed is not being spent, then the sellValidity( ) function 3920 may: decrement the validity of token 4 owned by 0xddd by 3000 seconds, from 1661853200 to 1661850200, and submit a transaction to transfer 150 units of cryptocurrency from the NFT smart contract 3900 to the wallet 3905 including address 0xddd.

In accordance with numerous embodiments, the owner of the NFT may transfer some and/or all of the validity period of the NFT. In multiple embodiments, the smart contract may include a transferValidity( ) function taking as arguments a validity period to transfer and a receiving NFT identifier. On receiving a transaction calling transferValidity( ) the smart contract may reduce the validity period of the NFT, for example, by updating data within the data structure mapped to by the mapping from the token identifier for the NFT and from the receiving NFT identifier, such that the validity period of the NFT is decreased, and the validity period of the receiving NFT is increased by a corresponding amount, optionally minus a fraction of the validity period transferred as a royalty and/or transfer commission.

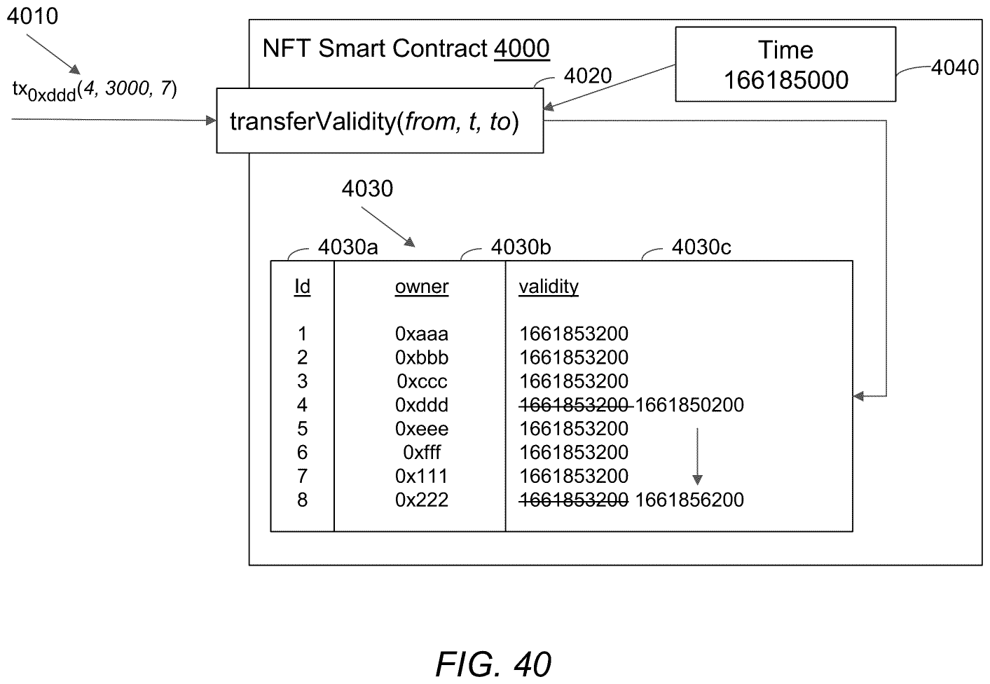

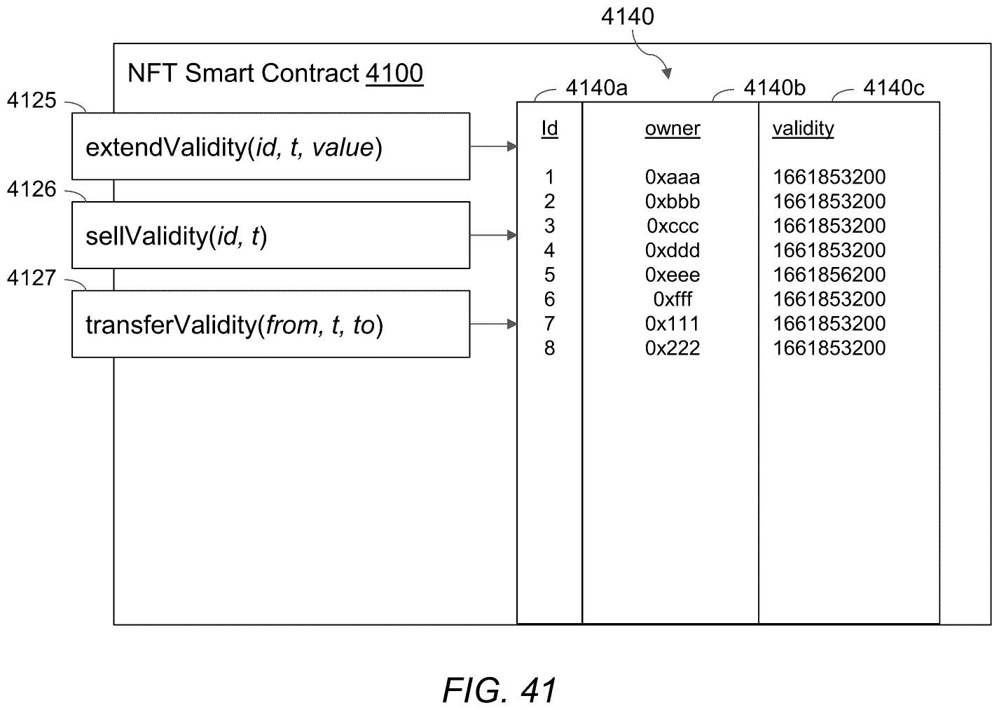

In FIG. 40 the disclosure in the paragraph above is illustrated. Those skilled in the art may appreciate that in FIG. 40 specific parameter values are presented for illustration, that these parameter values are not meant to be limiting, and that FIG. 40 should be interpreted without loss of generality.

An NFT smart contract 4000 may receive a transaction 4010 transmitted from a wallet with address 0xddd to be processed by a transferValidity( ) function 4020. The transaction 4010 may include parameters representing a token identifier from which validity time is to be transferred, a validity time period to transfer, and a token identifier to transfer the validity time period to. In this specific example, the token identifier from which validity time is transferred is 4, the validity time period to transfer is 3000 seconds, and the receiving token is identified by token identifier 8.

The transferValidity( ) function 4020 may then examine the transaction 4010, determine its validity, and act on the transaction 4010. In the example of FIG. 40, the NFT smart contract 4000 may include a data structure 4030 storing information regarding NFTs the NFT smart contract 4000 instantiates. The data structure 4030 may be understood by a human reader to represent a table including columns corresponding to token identifiers 4030a, associated owners 4030b, and validity times 4030c.

On determining that the transaction 4010 is valid and correctly digitally signed, the transferValidity( ) function 4020 may examine and edit a row corresponding to a token with identifier 4, verified as belonging to address 0xddd, such that a validity time of 1661853200 is more than 3000 seconds by comparison with the current time 4040 of 1661850000. When the validity period to be transferred falls in the future, that is, time already consumed is not being spent, then the transferValidity( ) function 4020 may: decrement the validity of token 4 owned by 0xddd by 3000 seconds, from 1661853200 to 1661850200, and increment the validity of token 7 by 3000 seconds, from 1661853200 to 1661856200, as shown in the validity table 4030c.

5. Patent Maintenance Through NFTs

In an example presented for illustration only and not meant to be limiting, a granted patent may be represented by an NFT in a smart contract, henceforth the granted patent NFT. A maintenance fee for the granted patent may be due at 3.5 years, 7.5 years, and 11.5 years. On minting, the granted patent NFT may be instantiated with a first validity period of 3.5 years. When no payment is received before the first validity period plus an optional 0.5 year grace period, the granted patent NFT may become invalid, and the granted patent may no longer be enforceable. The owner of the NFT may make a payment through a call to an extendValidity( ) function, which in this example may be called payMaintenance( ), said call including an appropriate payment in cryptocurrency. On receiving the appropriate payment, the smart contract may extend the validity of the NFT to 7.5 years from the date of minting. Similar actions may be taken at 7.5 years and 11.5 years.

6. Subscription Services

In an example presented for illustrative purposes only and not meant to be limiting, a subscription to a streaming service may be represented by an NFT in a smart contract, henceforth the streaming service NFT. An owner of the streaming service NFT may be able to log on to the streaming service and view and/or listen to content, provided the owner logs on using the address owning the streaming service NFT, and provided the streaming service NFT is valid. The owner may extend their subscription to the streaming service by making a payment to the smart contract instantiating the streaming service NFT. Such an implementation also allows the owner to sell their subscription to a third party before the subscription has lapsed.

7. An NFT Smart Contract Combining Multiple Functionalities

An NFT smart contract may include some and/or all functionality from FIGS. 38, 39 and 40, and should be interpreted in the light of said functionality.

FIG. 41 illustrates a possible configuration of an NFT smart contract in accordance with certain embodiments. The NFT smart contract 4100 may include a data structure 4140 storing information regarding NFTs that the NFT smart contract 4100 instantiates. The data structure 4100 may be understood by a human reader to represent a table including columns corresponding to transaction ids 4140a, associated owners 4140b, and validity times 4140d. The NFT smart contract 4100 may include an extendValidity( ) function 4125 as disclosed in FIG. 38. The NFT smart contract 4100 may include a sellValidity( ) function 4126 as disclosed in FIG. 39. The NFT smart contract 4100 may include a transferValidity( ) function 4127 as disclosed in FIG. 40.

The smart contract may include at least a function portion and a data portion, wherein the function portion includes functions of the smart contract and the data portion includes editable data. The data portion further includes a data structure and/or mapping. The data structure and/or mapping includes information about at least one token including but not limited to an NFT and/or a fungible token, the information about the at least one token includes at least information pertaining to an identity of the token, an owner of the token and a validity period of the token.

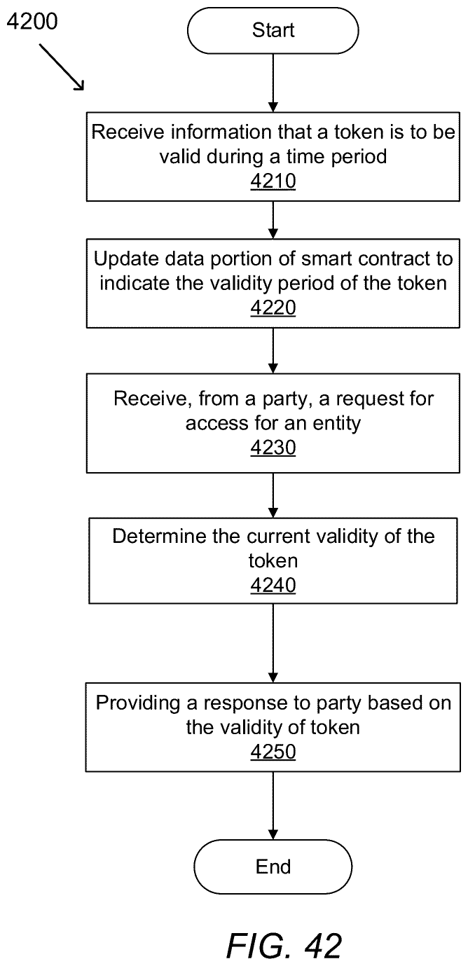

FIG. 42 illustrates a process performed by a smart contract configured in accordance with several embodiments of the invention, for managing access to an entity. Process 4200 receives (4210) information that a token is to be valid during a time period. Process 4200 updates (4220) the data portion of the smart contract to indicate the validity period of the token. When for example, users buy subscriptions and/or otherwise obtain rights to access an entity for a period of time, the data portion of the smart contract may be updated accordingly. Process 4200 receives (4230) from a party, a request for access for the entity, the access being dependent on the validity of the token. Parties may include but are not limited to users requesting access to the entity and/or party may be the entity to which the users are requesting access. Process 4200 determines (4240) the current validity of the token. Process 4200 provides (4250) a response to the party based on the validity of the token. How the smart contract may determine whether and/or not the token is valid is described in detail and exemplified herein above. The response provided to the requesting party depends on whether and/or not the token is valid and may also depend on “who” the requesting party is, e.g., the user(s) and/or the entities to which access is requested. This is also explained in detail above and may not be repeated anew.

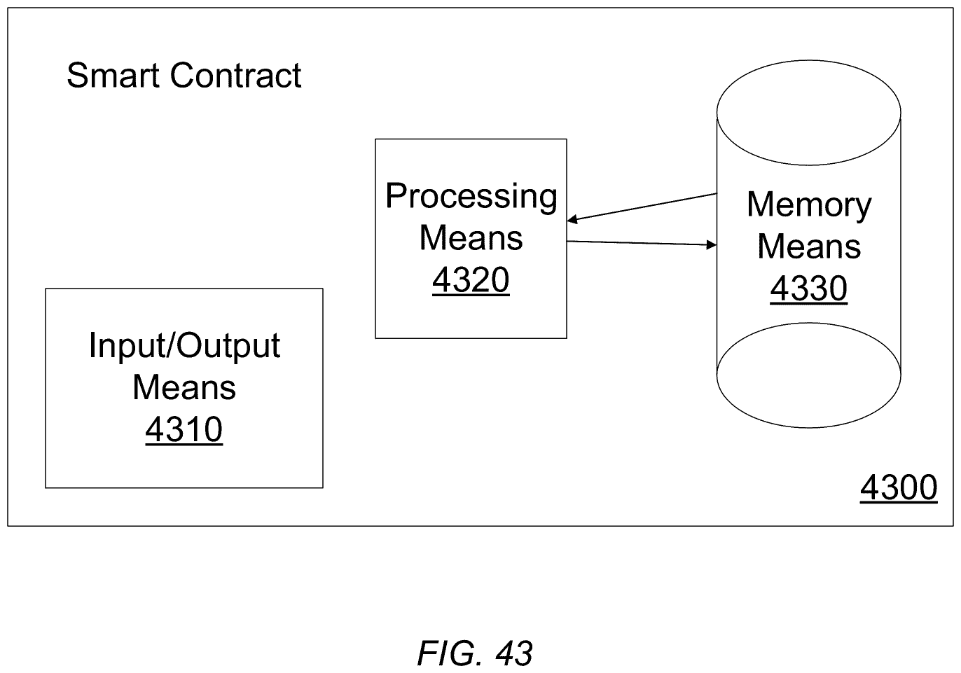

A physical model of a smart contract configured in accordance with many embodiments of the invention is illustrated in FIG. 43. The smart contract 4300 includes memory 4330, input/output means 4310, and processing means 4320 configured for transactions including but not limited to minting and/or transfer of tokens (such as NFTs).

Memory means 4330 may include but are not limited to instructions, which when executed by the processing means 4320 can allow the smart contract 4300 to perform various methods described in this section. Additionally or alternatively, the smart contract 4300 methods may be implemented through mediums including but not limited to servers, computers, smartphones, cloud servers and/or any entity/arrangement with processing means.

The smart contract 4300 also includes input/output means 4310 that can enable communication for the smart contract 4300. Smart contracts 4300 may utilize input/output means 4310 to receive, transmit and/or provide information to other units, devices and/or entities.

While specific processes for governing token access tokens are described above, any of a variety of processes can be utilized by smart contracts as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted.

While specific processes and structures are described above with reference to FIGS. 34-43, systems content access can be implemented in any of a number of different ways to enable as appropriate to the requirements of specific applications in accordance with various embodiments of the invention. Additionally, the specific manner in which smart contract configurations can be utilized within NFT platforms in accordance with various embodiments of the invention is largely dependent upon the requirements of a given application.

### AI Guided Content Creation, Configuration and Distribution

In the current marketplace, product creation decisions are made by humans, guided by measurements of consumer actions. As Web 3.0 enables vast numbers of content creators to participate in the marketplace, users may need AI-based recommendation tools to identify what content is of highest likely relevance to them. We refer to these autonomous software agents as client-side AI agents, even though they do not have to be physically located with the client.

As content screening decisions thereby are increasingly made by client-side AI agents, content creators may wish to understand the content screening decisions and the resulting human-made selection decisions in order to tailor content creation to the needs of the marketplace and maximize their fit with their intended audience. It is desirable for this tailoring of content to be highly responsive to market needs, such as to the preferences of individual clients and groups of clients. Performing at least a portion of the tailoring using AI-based autonomous agents is therefore desirable. We refer to these autonomous software agents as creator-side AI agents, but note that they do not have to be physically co-located with the content creators.

A benefit of the creator-side AI agents is to evaluate the “desirability” of a client to a creator. “Desirability” is defined specifically for both creators and clients. For creators, it defines a client's willingness and/or ability to deliver value to the creator in the form of trial, future purchase, word-of-mouth discussion, etc. Similarly, for clients, it defines a creator's willingness and/or ability to deliver value to the client in the form of reduced prices, promotional links between products and/or services, early and/or special access to products and services and experiences, etc.

In this sense, defining, promoting, tracking, and responding to client desirability becomes a value-creating activity for creators. Similarly, identifying and evaluating offers from creators becomes a value-creating activity for clients. And for both creators and clients, effective and timely desirability ratings at scale require automation.

As an example of value-creation for creators, the desirability may correspond to an estimate of the value of future actions of a user to a content provider, such as in the form of revenue derived from this user; revenue resulting from word-of-mouth actions of the user; revenue derived from the contributions of the users in the form of product exposure, etc. Such desirability may be estimated based on machine learning (ML) implementations that fit past observations of revenue results to observed user actions, and may be expressed in the form of one or more values indicating the probability of a collection of user actions. Inputs may include past purchase history, travel history, demographics, income, contents of virtual wallets, etc. There may be various estimates indicating desirability, including different estimates generated in different ways, by different entities, and based on different types of observations. The estimates can be expressed as tokens; may be stored by agents of the user(s) including but not limited to wallets; may be available to select service providers based on preferences stated by one or more users, etc.

As an example of value-creation for clients, the desirability may correspond to an estimate of the short and/or long term value of offers relative to other offers given an individual client's unique priorities and relative preferences, such as in the form of reduced pricing, bundled pricing and/or products, additional services, early access to new innovations, etc. Such desirability may be estimated based on machine learning (ML) implementations that fit past observations of offer trends and relative and/or competitive offers, and may be expressed in the form of one or more values indicating the match between personal preference and market offers and/or opportunities. Inputs may include historical offers and trends, competitive offers (such as replacements and/or substitutes), past purchase history, social media activity indicating interests, news reports about new products, travel history, demographics, income, contents of virtual wallets, etc. There may be various estimates indicating desirability, including different estimates generated in different ways, by different entities, and based on different types of observations. These various estimates may and/or may not be in the direct control of the client. The estimates can be expressed as tokens; may be stored by agents of the client including but not limited to a wallet; may be available to creators as market data in support of future offers, etc.

In accordance with numerous embodiments, it is desirable for the creator-side AI agents to receive information provided by the client-side AI agents. This information could, for example, be responsive to the filtering decisions made by the client-side AI agents related to product offerings by a given content creator associated with a given creator-side AI agent receiving information. The collection of information may be implicit, such as in the form of whether an access request is being made by users and/or user agents, in which case it is determined that the client-side AI agent must have recommended the item to the associated user. The transmission of information may also be explicit in the sense that the client-side AI agent transmits information to the creator-side AI agent, indicating its actions with respect to the user, including but not limited to how various items are rated by the user-side AI agent. The transmission of information may also relate to preferences that are not tied to existing content associated with the receiving creator-side AI agent, including but not limited to aggregate preference data associated with the client-side AI agent and/or the associated user. Such aggregate preference data may, for example, indicate one or more genres, one or more consumption preferences including but not limited to rental, purchase, subscription, loan, and/or investment. The aggregate preference data may be, at least in part, anonymized, such as relating to a collection of users of which a given user is a member. The transmission of information may either be in response to a request, such as by the creator-side AI agent, and/or be performed by the client-side AI agent as an announcement made to attract content of a type that is likely to match the needs and preferences of users associated with the client-side AI agent.

The AI agent may, for example, be a machine learning (ML) unit. It may be a distributed algorithm, such as one that executes on a multiplicity of computational entities, where these computational entities may select a result based on consensus methods. One example of distributed computing using consensus algorithms was disclosed in co-pending U.S. patent application Ser. No. 17/810,085, titled “Distributed Ledgers with Ledger Entries Containing Redactable Payloads,” filed Jun. 30, 2022, incorporated by reference in its entirety.

The AI agent may also be operated by an individual entity, including but not limited to a traditional centralized entity that interacts with a distributed system. For example, a service provider may receive measurements from a network of entities, where some of these entities may represent consumers of services provided by the service provider, and others may represent typical consumers that may be interested in such services, and where the received measurements are used by an AI agent to customize the services provided by the service provider. One example of such a customization is a modification of a product that is provided to a multiplicity of users, such as all users that navigate to the homepage of the service provider. Another example of a customization is a classification-based method in which users are identified as belonging to one of two or more classes, and based on the identification of class membership, services associated with the associated class are provided. This may correspond, for example, to the selection of background music played in a given context, based on the estimated music preferences of a given user, where these preferences correspond to the selection of a class of users. Such a class may be “jazz fans”, for example, and/or “heavy metal fans”. The customization of content may be performed by the service provider, such as by the servers of the service provider; it may also be performed, at least in part, on a computational device associated with an individual user for which the customization is performed. One way of customizing content is to perform NFT evolution, as disclosed in U.S. patent application Ser. No. 17/929,894, titled “Methods for Evolution of Tokenized Artwork, Content Evolution Techniques, Non-Fungible Token Peeling, User-Specific Evolution Spawning and Peeling, and Graphical User Interface for Complex Token Development and Simulation,” filed Sep. 6, 2022, incorporated by reference in its entirety. The AI agent may, for example, include AI elements including but not limited to a neural network, a GAN network, a machine learning (ML) component, as well as a rule engine, an expert system, and/or a combination of such components.

The disclosed technology may use a self-organizing network of computational nodes, where such computational nodes may identify trends, preferences and/or needs within a group of users, where these users may correspond to a class as described above. The network may collect measurements from nodes, including nodes that are part of the network. It may also incorporate new nodes, such as of users identified to belong to the class, and/or to remove nodes that are identified as no longer belonging to the class. This way, the class can be maintained to correspond to an expression of a likely need uniting the users associated with the member nodes. These users may be presented with customized information selected based on the assessed needs and preferences of the class with which the users are associated. The self-organized network may include nodes including but not limited to wallets. It may also include nodes that provide services, such as content. The customization of services may be determined by one or more of the nodes, such as described above. The customization can determine content selections, content modifications, what material is likely to be desirable to the users, and may operate to protect the users and their computational resources according to an understanding of threats applicable to the class, preferences (including but not limited to privacy preferences) of the users corresponding to the class, financial characterizations of the users, as well as demographic information. Users and their computational entities may belong to multiple self-organizing networks; for example, one such network may identify food preferences; another music preferences; and a third investment preferences.

A representative of a class can generate a classifier C that can be published, allowing a potential class member to execute the classifier C on its data (including but not limited to wallet contents, browser history, demographic information, user location data, etc.) to determine the fit between the potential class member and the class. Consider a wallet and/or other entity representing users determined to be likely to have a high fit with a class, such as where the fit value exceeds a threshold that may be a static value of the wallet and/or other entity, and/or may be set by users. This wallet and/or other entity may identify a location and/or a representation of the class using data included in and/or associated with the classifier C. The location may be an address on a blockchain, a URL, and/or a physical location. A representative may be identified using a unique user identifier including but not limited to an email address and/or a wallet identifier. An example wallet identifier is a public key, and/or a hash value that is exceedingly likely to be unique. The wallet and/or other entity may use this information to join the class, such as by transmitting information requesting to gain membership. This may be done with and/or without the explicit approval of the user associated with the wallet, and may be based on a configuration made by the user, identifying the user's preferences for automatically joining suitable classes.

Classes may identify advertising preferences, where membership in a given class indicates an interest in a given product and/or service. Members of a class, including but not limited to an advertisement class, may use the class membership to augment content, including but not limited to movies, where the augmentation of content replaces the need for the user to pay for the content, and/or allows the user to qualify for a lower acquisition cost for the content. Other benefits can also be provided based on class membership, including but not limited to discounts, such as of products and services related to the class. This enables a fully distributed provision of commercial information (including but not limited to ads and other promotional content) based on user preferences and interests, but without the need for a central provider to determine, based on a user's action, what the user's interests are. User membership in the class may be established according to a privacy policy wherein the class learns of an identifier that enables transmission of promotional content to the entity representing the user, but without an identification of the user, the user's past actions and/or other information supposedly qualifying the user for membership.

A group of users corresponding to a class may be provided with a benefit in response to displaying promotional content. The group may also be rewarded when there is a conversion. Non-limiting examples of conversions include promotional content being viewed; users taking an action in response to being provided with promotional content; and users providing another user with promotional content. Actions include but are not limited to performing a purchase, using a discount coupon, clicking on a hyperlink, forwarding material, requesting material from a service provider, subscribing to a service, becoming a member of a class. Benefits may be provided to the class as such, and/or to some members of the class, where not all recipients may receive the same benefit and the size and type of benefit may depend on the actions of a given user, and the associated conversions that are recorded. Some members of the class may be in charge of locating material suitable for the class, including promotional material, and may be rewarded in response to a conversion leading from the access to such material. Group members may compete to be the intermediary that obtains material and is given a reward when there is a conversion. The group members may establish the right to do this based on staking a resource, including but not limited to a certain amount of funds, by selecting material with a high conversion rate, and/or a combination of such actions. Intermediaries may also earn the right to be intermediaries by establishing the class in the first place and attracting members to it, such as by providing benefits for those who join. The intermediary described above may also be a Decentralized Autonomous Organization (DAO), corresponding to a set of users who have invested in DAO membership. As the class grows, the rewards to the DAO members may increase, enabling the DAO members to resell their membership at a profit. This dynamic encourages DAO members to guide the provision of services of the class that increases conversion, increases membership, etc.

Some classes may allow any users (and/or associated computational entities) to join the class free of charge. Other classes may charge a membership fee. The membership fee may be paid one time only and/or may be recurring; may be based on what services are consumed by the member; may depend on whether the member recruits other members; and may be refundable, at least in part, when a member leaves. Some memberships may be transferable, such as possible to gift and/or sell, whereas others may be tied to users acquiring the membership. Some memberships may require users to have a specified execution environment, including but not limited to using a wallet running in a trusted execution environment (TEE) including but not limited to TrustZone, and/or a Digital Rights Management (DRM) platform matching specified criteria. Membership requests may be required to be signed using a key associated with the execution environment to prove that the associated users are associated with an acceptable execution environment. Different service provisions may be offered based on what type of execution environment users are associated with, such as only high-resolution content for DRM modules running in TEEs, and medium-resolution content for other devices.

A first class and a second class may have a large common membership, such as due to correlation of interest. The two classes, and/or representatives thereof, may identify the overlap, such as by polling of membership, and determining that members of one class may wish to become members of another class. When the first class is associated with a classifier C1 to determine likely interest of a person, based on activities and preferences, to become a member, and the second class has a classifier C2, then the two classes may exchange classifiers and distribute these to their members, such as by transmitting the classifiers to the associated wallets and/or other computational entities, thereby enabling the associated computational entities to determine a likely interest of users associated with them to join the other class. This joining may be performed automatically, and/or based on asking associated users for decisions. It may also be performed temporarily, such as by acquiring material from the class of potential interest and observing user interaction with the material. For example, when the two classes correspond to two different musical genres, then by playing a song from a potentially matching class to users and determining the actions of the user, the system may automatically determine whether to join, and/or whether to ask the user whether they wishes to join. Example user actions may be to indicate a like, to perform a purchase, to play a song again, to skip the song, to indicate a dislike.

A representative of a class may generate a new classifier that is a better predictor of user wishes to become and remain a member, such as based on data associated with users that join and/or leave the class, and their fit with one or more candidate classifiers. The new classifier may be distributed to members of the class, such as along with content being distributed to them as part of being members of the class. Multiple such classifiers may be distributed. Based on responses from members and tentative members, indicating the what classifier(s) are the best fits, and/or have a fit above a threshold that may be specific to the various devices corresponding to the users, the representative of the class can perform clustering of the class members, where this clustering is useful to determine whether to introduce new classes to which the users are added as class members, where such additions may require user approval. In the case where one class is split into two or more subclasses, the members of the class may be automatically moved to one or more of these sunglasses based on their initial membership of the class. This corresponds to a refinement of the targeting of material. Such material may be content, content recommendations, services, service configurations, promotional material including discount coupons and other membership-based discounts.

An influencer may act as a representative of a class associated with the influencer, and fans who subscribe to the influencer's channel may correspond to the members of the class. Thus, membership can depend on user actions, including but not limited to subscribing to a channel. The membership in such a class does not have to be based on a classifier, but on user actions. However, the class can be further partitioned into subclasses based on the fit with classifiers, where one classifier may correspond to the action of users in response to content distributed by the influencer. An influencer may, for example, provide content that relate to cats and shoes, and given users may be interested in the cat related content but not the shoe related content, and may express that preference by indicating that they likes several of the cat content elements, but fewer when any of the shoe content elements; by watching the cat content multiple times; by interrupting the watching of shoe content; by performing an action corresponding to a conversion in response to cat content but not in response to shoe content, etc. This way, the influencer may partition the content provision into two classes, corresponding to cats and shoes, where members of the class get subscribed to one or more of these subclasses. These subclasses can also be considered classes, and be partitioned further.

The influencer may further use automated methods to configure content, such as to emphasize content that is determined to be likely to have high conversion rates based on the presence and/or absence of components that an AI determines result in a high conversion rate for a given class and makes modification to contents to increase the expected conversion rate for the class the modifications are made with respect to. This is an iterated process where feedback is constantly collected and used to improve the predictor used in the AI, thereby improving the quality of service delivered to individual users. Such automated methods may act as filters that are applied to original content. For example, an influencer may produce video material with two cats playing with shoes. This material may be automatically configured, such as cut and set to background music, to emphasize various features that are present in the material, thereby resulting in one or more versions of the content, where these different versions may be adopted for distribution to different classes of users. One class of users may be the users who like cats but do not like shoes; another may be the users who like shoes but not cats; and a third may be the users who like both cats and shoes. The content provided to users who like cats but not shoes may include a discount offer for cat food and/or stuffed animal toys looking like the cats in the movie; the content for the users who like shoes but not cats may contain pricing information for the shoes shown, and a labor day sales offer at a nearby store; while the content for the users who like both cats and shoes may include offers related to both cats and shoes, and/or for products that are found to appeal to people who like both cats and shoes.

At the same time, users are represented by autonomous agents, such as executing in their wallets and/or browsers, where these autonomous agents identify preferences, actions and settings associated with the user(s) of the wallet. We refer to such information as profile information, and/or plainly, a profile. A wallet may have multiple users, each one represented by a different profile. By evaluating classifiers, including but not limited to C, C1 and C2 mentioned above, on profile information associated with the user(s), where such profile information may be stored in the wallet, browser and/or other software and/or hardware entity, the autonomous agents can determine what classes are most likely to result in the greatest fit with the user preferences, based at least in part of the evaluation of the classifiers on the stored information. However, while the service providers, represented by the classes, may wish to maximize a fit that corresponds to a predicted conversion rate, the individual users may have other ways of measuring what includes a good fit. This may be measured based on user actions including but not limited to likes and dislikes, content forwarding actions, and similar, but not using the conversion to commercial content including but not limited to promotional material in the form of advertisements. The autonomous agent representing the user may therefore select to request membership of classes that are expected to maximize the user's satisfaction. This can be determined based on a vector of information of the content being provided, where this vector may indicate the type of material associated with the class, and where this is provided along with the classifier. We refer to this vector as the class content identifier.

The content being distributed may include movies, text, music, executable files (including but not limited to games), recommendation values, references including but not limited to URLs, and more. The content may be part of non-fungible tokens (NFTs), and/or may be included in another form of digital container, including but not limited to a digital rights management (DRM) container. Content may be transmitted using FTP packets, and may be served by a web server. It may be hosted/stored on a blockchain, in a private database, and/or a cloud database. One example of a private database is one associated with a member of a class, such as the hard drive and/or other storage associated with a computational device of the class member. The content may correspond to blog posts, full-length movies, commercials, music, and/or data/code used to configure the member devices. Examples of data/code used to configure member devices include entertainment applications, including but not limited to games, enterprise applications, crypto mining applications and their configuration data, code and data used by members of a DAO to interact with the other DAO members. The content may also include user interface code and configuration files. These are illustrative and non-limiting examples of content that can be configured and delivered to users, including members of a class.

Individual users can specify one or more configurations. Configurations can also be specified by another entity (including but not limited to a parent, a church leader, and/or an employer); as well as by a jurisdiction (including but not limited to a country and/or a state). Some configurations can be specified by one entity, and others by another entity. The configurations associated with a given user and their computational representative (including but not limited to a laptop, phone, trusted execution environment, digital rights management application, browser, wallet, and/or combination thereof). We refer to the computational representative here as the user agent, for denotational simplicity. The user agent stores the configuration data, and/or a reference to it. The configuration data and/or the reference to it can be conveyed to a content provider, for purposes of performing on-the-fly configuration of the content to be provided, where the resulting modified content is provided to the user agent, such as for rendering and/or other usage. The modifications according to the configuration data can also be performed by the user agent and/or an entity that is communicatively connected to the user agent, including but not limited to a gateway, a cloud processing device, etc.

One user may specify configuration data indicating that he does not want to be exposed to violent scenes in movies, to scenes indicating cruelty to animals, nor any political views he disagrees with unless held by a villain in the movie. Another user may specify configuration data indicating that she does not want to be exposed to nudity, and that she prefers happy endings to sad endings, Yet another user may live in a jurisdiction where the government places constraints on what views and/or facts are expressed in the movie; these specifications would apply to users in this jurisdiction, unless that user finds a way to circumvent it.

Some content providers may create content, including but not limited to movies, including multiple parts, where a playable version of the content can be configured based on configuration specifications by selecting a subset of the content parts that make up a cohesive story, as indicated by a storyline that is approved by the content provider. The configuration may be performed on a computational entity representing the content provider, which may be a cloud service provider; it may also be performed by the user agent. In some embodiments, parts of the configuration is performed in one location and others are performed in another. For example, configurations that are required by a jurisdiction may be performed by the service provider, and inspectable by a representative of the jurisdiction; they may also be performed by a representative of the jurisdiction. Configurations performed by the user agent may receive a labeled set of content parts and determine which ones are to be played and in what order, such as based on a description associated with the content.

In many embodiments, configurations are performed using heuristic techniques, and using, at least in part configuration data that is not explicitly specified by the users and/or representatives of the users, including but not limited to the examples above. Instead, the configurations may be implicitly obtained by observation of user behavior, where user behavior includes ratings, repeated paying of content, and by identifying the nature of content used by the user. For example, users who mostly play movies with a happy ending can be assumed to prefer such movies. Therefore, a movie that can be configured can be modified to provide a happy ending.

In some embodiments, configurations may be performed based upon previous content reviews provided by the users, and/or similar users. Similarity can be determined based on well-known clustering algorithms, which may be implemented using machine learning techniques in manners understood by a person of skill in the art. Additionally or alternatively, “similar users” may be defined as the other users of the same class, and/or users with overlapping class memberships.

Some configurations of content may be performed on legacy content, i.e., content that has not been broken up in parts and labeled by a content provider. Labeling may be provided from external sources, including but not limited to a reviewing organization that specifies that a given movie has violent content stretching from a location A to a location B, where A and B may be indicators of time from the beginning of the movie. This content can be skipped by user agents representing users who prefer content that is not violent. The user agent may perform modifications to the content in addition to removal of content that is not aligned with target user preferences; for example, it may provide a smoothing of transitions, including but not limited to sound effects, visual effects and subtitles to account for the removal of content.

Some configurations of content may be generated through “stitching together” pre-produced segments providing alternatives, for example, a director may produce a happy ending, a sad ending, and an enigmatic and/or open-ended ending to a movie, and a configuration for a specific viewer based on their previously determined preferences may be selected accordingly. In several embodiments, sound scores and/or background music, dialogue, and camera angles may be selected to generate a specific desired configuration, deep-faking may be used to make lip movement match speech, voices may be synthesized, and scenery may be constructed using machine learning and/or artificial intelligence art generation software to dynamically alter and/or extend existing footage. In various embodiments, content may be dynamically altered based on the user preferences. For example, users who have indicated a preference for less violent content may be presented with footage that is subsequently edited to remove “blood and gore”, and users who have indicated a preference for less nudity may be presented with footage in which clothing is edited onto unclad actors.

Some configurations of content may be dynamically adapted based on active and/or determined feedback from the viewer, and/or a combination of active and determined feedback. For example, a viewer who has indicated a preference for comedic material may be presented with humorous footage of various types, and based on a measurement of laughter responses and other physical measurements, such but not limited to heart rate, pupil dilation, general restlessness and/or passivity, to preceding footage, may subsequently be presented with more slapstick-based footage, more vulgarity, or more wordplay humor, depending on a rating of their previous responses.

When multiple users are viewing content, the content may be rendered in distinct manners to different viewers, such as using individual augmented reality glasses and associated headsets. This can be done in a manner that synchronizes the access to content around main content elements, to enable the sharing of reactions. The disclosed technology can also be used to configure content based on the preferences of multiple users. For example, when a first viewer wishes to avoid violent scenes and a second user wishes to avoid nudity, both violent scenes and scenes with nudity may be filtered out in the configuration step. The user agent may identify the preferences of the present audience members by conveyance of identities linked to preferences, and/or by conveyance of preferences and/or references to these, where the preferences indicate configurations the user has made. Such conveyance of information can be made to the user agent and/or to a content provider, such as by scanning a QR code, by synchronizing a mobile device carrying the information with the user agent, by the user agent identifying radio frequency (RF) transmissions from a mobile device and associating the device with users to determine presence, and/or by logging in to a portal associated with the user agent.

Configurations, whether implicit and/or explicit, may also specify advertisement preferences. Users may connect a search engine to their user agent, to import search queries made by the users from the search engine user interface to the user agent(s), where the user agent(s) identify interests and preferences. The user agent may also be connected to auditing entities and/or shopping services to determine what purchases the user(s) have made, to determine what interests are no longer relevant from a commercial perspective.

The user agent may be implemented using a rule engine, an expert system, an AI agent, and/or a combination of such entities. The configuration associated with user agents may represent a class C, including but not limited to what is described above, and/or a combination of one or more such classes. Classes can be combined by forming their union, by forming their intersection, and/or by forming their complement, and may be composed in various manners, as may be appreciated by a person of skill in the art. Such classes can specify the configuration preferences for entertainment, information finding, employment-related material including blogs and mailing lists, commercial preferences, such as specified by recent searches, recent interests expressed by user actions, and by recent purchases. Here, “recent” may mean the actions performed during a 2-month window of time, for example, and/or in the last week. This parameter can be tailored to individual users, such as based on inputs by these users. Examples of user actions include but are not limited to inputs provided by users using user interface (UI), such as connected with the user agent; by metrics including but not limited to location data; by social network data including but not limited to indication of identities and preferences of other users that are connected to the primary user over a social network, communication interaction involving the user, such as with servers and services; with peer users; with news outlets, etc. User actions identify user preferences and changes in such, all of which may be used to automatically and/or semi-automatically determine configurations for users and select classes to associate with. An example of a semi-automatic event is one that is proposed, such as by the user agent to the users, and when the users approve, is set to take effect. An example of an automatic action is one that takes effect without requesting explicit user permission at the time of making the action take effect, but still optionally based on the collection of user preferences including but not limited to security preferences at a previous time.

In accordance with many embodiments, one or more restriction rules are associated with content of a digital container, including but not limited to an NFT, where the restriction rules govern what types of modifications may be performed on the content associated with the digital container. For example, a rights holder including but not limited to a content creator may permit a customization of a first type but not of a second type. Here, the first type of customization may be a selection of the appearance of a hero character in a movie to match the appearance of the child watching a movie, making, for example, the princess of the movie have features similar to the viewer. Similarly, applying personal features to a game may be permitted. The line between games and movies is likely to become blurred in the future, but even when it does not, the disclosed techniques herein may apply to game-based content, text-based content, voice-based content, and other types of educational, entertainment and/or professional content, as may be appreciated by a person of skill in the art. The focus of movies is merely for illustrative purposes, and is non-limiting.

Content changes may be pre-approved by the content creator. However, the content creator may not permit a modification of the appearance of a villain in the movie, as such modifications may be initiated to discredit a given person and/or set of people. Different digital containers may be associated with different restriction rules. These are assessed in the context of the creation of content modifications, including but not limited to the content modifications described herein. The restrictive rules may also be verified to have been complied with in the context of an auditing entity, which may be included in a rendering entity. One example of a rendering entity is an application that plays movie content; such an application may be controlled by a digital rights management (DRM) entity and/or a trusted execution environment (TEE), such as is disclosed in U.S. patent application Ser. No. 18/299,546, titled “Systems and Methods for Instant NFTs and Protection Structure, Detection of Malicious Code within Blockchain Smart Contracts, Tokens with Transfer Limitations, Mirror Tokens and Parallel Addresses, Smart Contract Risk Scoring Method, and Cross-Device Digital Rights Management,” filed Apr. 12, 2023, incorporated by reference in its entirety. The disclosed techniques apply to content that the content creator has neither approved configuration for and/or stipulated limitations for configuration; one example of such content is legacy content.

Restrictive rules may be associated with certificates indicating the validity of the restriction rules, for example, being attested by a trusted entity. The validity may rely on the restrictive rules having been specified and/or selected by an entity that has the right to do so, and may indicate this entity's public key and/or other unique identifier. The validity may also rely on the national laws and/or that of local jurisdictions, where the validity of a restrictive rule may be assessed at the time of rendering, such as on a display entity.

In accordance with various embodiments, commercial content is configured based on one or more profiles associated with one or more estimated viewers, such as of a movie. One example of commercial content is a commercial that may be played in a manner similar to how commercials currently are played, but selected on the basis of the estimated preferences of the viewer(s). Another example of commercial content is a product placement. A product placement may be made relevant to the viewer(s), such as a person who does not drink alcohol may see an actor drink a can of soda whereas a beer drinker may see the actor drink a can of beer. This selection and/or substitution may be made based on information about the preferences of the viewer, token information associated with the viewer on public and/or private blockchains, the context of the playing of content including but not limited to the time of the day, based on sensory information collected from a rendering device, where sensory information may be the input to microphones and may be used to determine the age and gender of viewer(s), the reaction (including but not limited to laughter and/or gasps of horror) to movie content, etc. Sensors may also determine whether a viewer is paying attention, such as based on eyeball tracking information from a camera sensor, movement data from a sensor detecting movement, by determining whether users laugh at the funny parts in the movie, etc. The integration of content can be performed by an AI that splices in scenes, that replaces visual and/or audio data to be rendered, etc.

In accordance with certain embodiments, video and/or audio content is configured to optimize the expected conversion rate, which is a measure of likely commercial success of the content. For example, user agents residing in user wallets may have access to a set of preferences and/or search results and/or other indications of likely user interests for the user(s) associated with the wallet, and may configure content received from a content server accordingly, such as by skinning content elements including but not limited to bottles, boxes, signs. It may also add, remove and/or replace clothing according to such preferences, which may in part be set by jurisdictional requirements, parental input and user interests. User interest can be inferred from user actions, including but not limited to clicks, eye-tracking, microphone input, search results, purchase history, etc. AI can also select audio tracks, such as to avoid expletive language; may select endings (such as select the happy ending for users who prefers this, and/or based on the mood and/or context of the users); may select focal points (such as what team players get most coverage in a game). The configuration of content may be performed, at least in part, by the wallet and/or an associated client-side processing unit, in order to limit the leak of preferences to external entities. The wallet and/or other unit may access the appropriate rules and content elements from public resources, and potentially in a manner that does not reveal what party is requesting them, such as using ToR and/or another mix network, by using Private Information Retrieval (PIR) and/or simply by using a proxy with which the users have a trust relationship.

Content may also be modified and/or configured without consideration of conversion rate, but instead, to maximize a benefit. For example, as two users are taking an online course, their progress may be at different pace, and they may be presented with two differently configured versions of a movie to maximize their understanding of the content. Similarly, the aspect to be maximized may be the estimated appreciation of the content, such as two users with different senses of humor may be given two differently configured copies of content corresponding to one and the same general storyline.

Other illustrative applications of the disclosed technology include but are not limited to: use for purposes of persuasion about events, ideas, etc.; detection of deception, where the deception may be performed by a malicious party making undesired and/or criminal use of the same and/or similar technology to abuse end users; a client-side agent would identify such attempts by means of determining characteristic traits of malicious persuasion; build loyalty (such as the AI realizes that the user returns more often when characters are skinned to his/her race; national brands are not visible as product placements; music is added to background; etc.); built repeat “visits” back to the creator's content (may be same as “build loyalty” above and/or one may imply a more emotional relationship while the other implies a more transactional relationship); increase entertainment value (which may also be a subset of “repeat visits” above); helping users sort through resources (a “personalized page rank”); “selling” additional/remaining content: such as partway through the content, non-paying users only get a summary of the remainder and/or a teaser while paying users get full content; protection from racial and/or other sensitivities via automatic edits to eliminate and/or reduce culturally insensitive language while maintaining primary content; supporting user desires to be protected from various inputs (such as preference to “avoid any content and/or references to active political candidates in my entertainment and/or content searches”); and variable length content (such as the original concept of hypermedia envisioned a joystick letting users “push forward to increase the length of text and pull back to shorten.”).

Content configuration applies both to payload content, including but not limited to the different parts of a movie that advance the plot, and to commercial content, whether added as product placements, i.e., seemingly as part of the payload content, and/or is spliced in a manner that is distinct to the viewer(s) from the content. As configured content is rendered, one or more sensors collect feedback indicating the interest of viewers in rendered content. For example, when within 10 minutes of showing a product placement of a soda there is a sound of a can being opened, and/or the addition of a grocery item to an electronic to-do list, and/or a product-related command to a voice-enabled assistant, that may be seen as a conversion that indicates that one or more viewers were potentially influenced by the product placement. Such conversions may be reported to an auditing entity, causing a payment for the product placement to be made. Just like the sound of the opening of a can be detected, the laughter of one or more viewers may be identified and potentially attributed to one or more of the viewers based on frequency analysis, including but not limited to Fast Fourier Transform (FFT) of the captured sound file and comparison to one or more profiles associated with likely viewers of the content, where these likely viewers may be determined based on the history of sensor inputs, the presence and/or absence of radio beacons including but not limited to the Bluetooth transmitter of a cellular phone associated with a recurring viewer, etc.

A configuration of content may be made based on one or more detected and/or otherwise identified viewers. Viewers may be determined based on recognition of recurring viewers, using audio analysis of microphone inputs, for example, and/or by users explicitly identifying themselves, such as using fingerprinting on a sensor to select their profile; by a parent identifying the presence of the home's 9-year old in a menu, using a voice command and/or in response to a popup, and/or based on the language selection at the beginning of the movie. Configurations can be made based on more than one viewer at the same time, thereby selecting what content selections to be made based on the intersection of preferences of two or more viewers.

A viewer that watches content more than once may be provided with a slight variation of content, to make things interesting, to slightly change the storyline, and/or to accommodate for the preferences of another viewer. The viewer may have watched a non-optimal version in the first consumption based upon the presence of other viewers—and now has the ability to watch a personally-optimized production when viewing alone. Or, the viewer may be presented with alternative content based upon their reaction and/or review of the first showing. In-show product placements may shift based upon a different mixture of viewers, a different viewing location and/or country, and/or based upon contractual obligations with advertisers. Reactions and reviews may come in many forms, as described earlier in this document. It is entirely possible that viewers may watch multiple showings simply to enjoy the variations possible. The probabilistic and/or deterministic identification of users can be made based on a Machine Learning (ML) model taking as inputs sensory inputs, content selections, time information, the presence and/or absence of radio transmitters, etc.

Legacy content can be modified by the disclosed technology. For example, a product placement for a product that either failed and/or no longer is a top priority to promote may be replaced by an AI, as the content is viewed. The replacement may be made based on locally available products, based on the estimated preferences of the viewers, based on past observations of conversion events including but not limited to described above, and based on the content of a wallet associated with the content being viewed, the browser history of users determined to be likely viewers, the presence of multiple viewers and/or only a single viewer, based on what jokes are considered funny vs. awkward to the viewer(s), such as based on the detection of viewer reactions, and/or simply the end of, and/or changing contract obligations between the advertiser and producer.

The detection of content to configure may be based on a labeled version of the content, such as including content labels identifying the segment of a given element, the type of element, and the type of configurations that are applicable. For example, the cover of a magazine can be replaced in different ways than the label of a bottle. In accordance with various embodiments, the tags are determined by an AI, such as using pattern matching technology and using, as input, data provided by an advertiser, an entity representing a jurisdiction, a parent identifying the content constraints for different children of hers, etc.

The configuration of content may be performed on live content streams, including but not limited to a game between two basketball teams. A viewer who favors the blue team over the red team may be shown more close-ups of players in the blue team, and/or on-screen advertisements befitting a blue team fan. The configuration may be performed without any explicit labels, and may use AI to automatically label the streamed data, such as based on colors, numbers associated with players, face recognition of players, etc., and make selections from multiple concurrent streams from different camera angles to maximize the enjoyment of the game to a viewer.

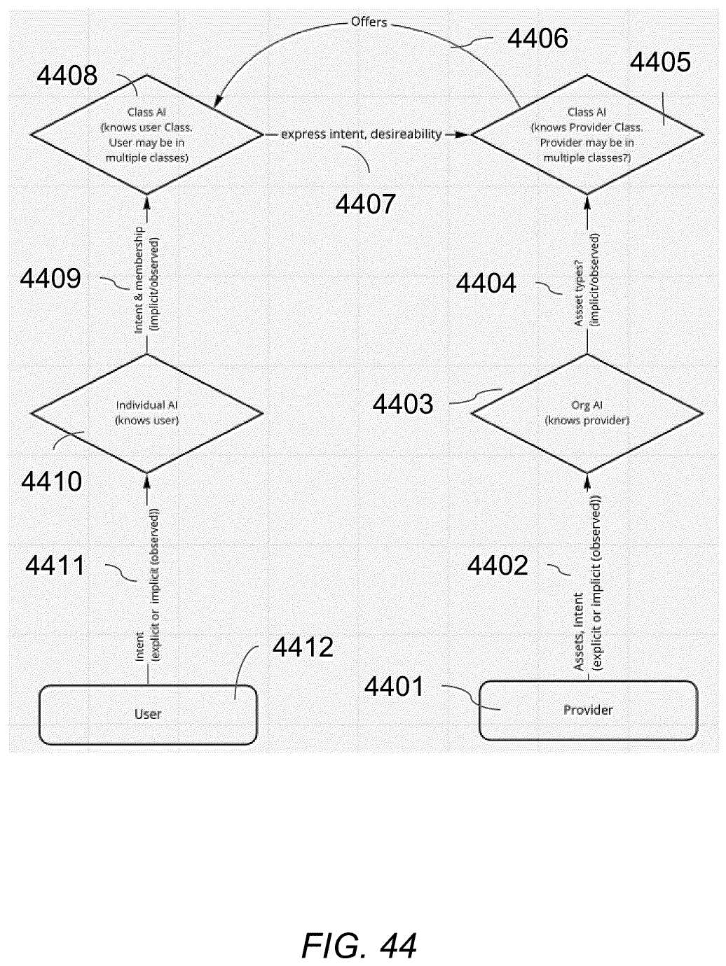

FIG. 44 illustrates the flow of explicit and implicit data through systems configured in accordance with numerous embodiments of the invention. The flow of data, desire and intent between users and providers, may be managed at scale by respective AI agents. User 4412 can be thought of as a device utilized by a customer and/or member of the public, but this can be generalized to any group of Users of any offering of any content, product, and/or service by any Provider. User 4412 expresses desire and/or intent by taking Actions 4411. These actions can explicitly define desire/intent (such as via a pick list of options) and/or implicitly define desire/intent by taking observable actions (e.g. purchasing a product and/or clicking a link). An Individual AI 4410 “serves” User 4412 by using Actions 4411 to create a Profile 4409 of the Desires/intent of User 4412. Individual AI 4410 shares that Profile 4409 with Class AI 4408, which uses observations of actions of User 4412 as well as observations of others it derives to be the same “Class” as User 4412 to create a more complete Profile 4407. In general, forecasts from Class AI 4408 carry less weight than Individual AI 4410 when the forecasts differ. Class AI 4408 then shares the aggregate Individual and Class Profile 4407 with the Provider Class AI 4405.

In parallel, a Provider 4401 can be thought of as a vendor, content provider, and/or other entity with a vested interest in User 4412 taking specific actions (such as buying a product, viewing media, clicking a link, etc.). Provider 4401 expresses available offerings (“Assets”) plus their own Desire/intent 4402. Desire/intent 4402 is likely more complex than Desire/intent 4411 by User 4412 because it likely includes both the Desire/intent for User 4412 to take specific actions (including but not limited to the examples above) plus User characteristics beyond desire. For example, many users may express a desire to purchase a frying pan, but a high-end provider of frying pans may only be interested in Users who both show a desire and/or inclination to buy and demonstrate above-average income and/or wealth demonstrated and/or observed in ways other than demonstrating Desire/intent 4411. Organizational AI 4403 encapsulates Provider 4401 Assets and Desire/intent in ways that specify actions (such as ad presentation, coupon delivery, other offers) resulting from User 4412 Profile 4407 as represented by Class AI 4408. Organizational AI 4403 shares that Profile 4404 with an optional Organizational Class AI 4405. The optional Organizational Class 4405 adds additional actions Providers in general wish to take. Continuing the example above, Organizational AI 4403 might determine User 4412 should be offered information on a particular high-end frying pan, but Organizational Class AI 4405 might determine that any User spending sufficient time learning about any product offering should be added to a list to get regular informational updates on the product under consideration.

The parallel systems come together at the expression of Desire/intent 4407 to the Organizational Class AI 4405 (or Organization AI 4403 when no Organizational Class Ai is used). In response, Organizational Class AI matches User 4412 Desire/Intent with Provider 4401 potential actions to determine which Offers 4406 that Provider 4401 makes available to User 4412.

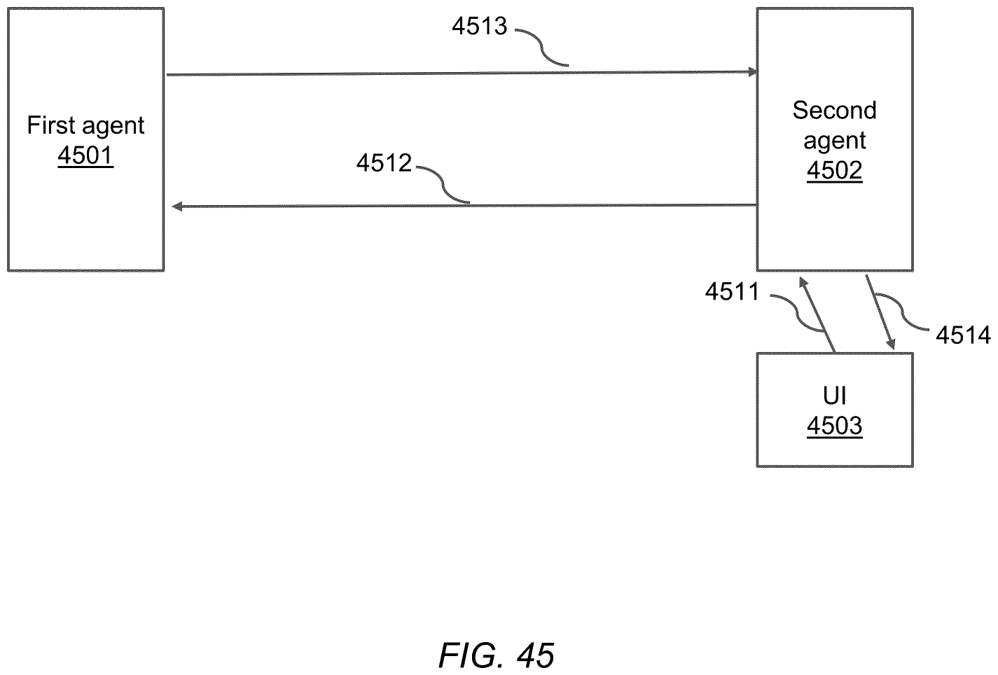

FIG. 45 illustrates the use of a system configured in accordance with a number of embodiments of the invention. First agent 4501 is connected over a network with second agent 4502, which is connected to user interface (UI) 4503. UI 4503 may include a screen, a keyboard, a microphone, tactile elements, a loudspeaker, a mouse, a pointer, a location sensor, etc. A user with access to UI 4503 generates an input 4511, which may be a content selection including but not limited to a movie selection; may be a configuration of the second user agent 4502; and/or may include one or more actions including but not limited to clicks, content selections, text input, location information, etc. The second agent 4502 conveys first data 4512 to first agent 4501, such as by transmitting first data 4512 over a network, by storing first data 4512 in a public database including but not limited to a blockchain, etc. First agent 4501 processes first data 4512 and generates second data 4513, which may include a movie in which some element is selected and/or configured based on information included in first data 4512; alternatively, second data 4513 may include information enabling the generation of a movie requested by the user associated with UI 4503, based on one or more components, where at least one of the components is selected and/or configured based on first data 4512. Second data 4513 is conveyed to second agent 4502, which optionally performs processing of second data 4513 and causes (through instructions 4514) a rendering of content corresponding to second data 4513. For example, the processing may be a verification of content components and their authenticity, an assembling of content components, a request for missing content components, and processing governed by configuration information optionally provided by the user using UI 4503, including but not limited to a selection of a mood, a focus on some aspects of the content including but not limited to a preferred sports team, etc.

The second agent 4502 may be referred to as a client-side AI, and its task may be to learn the needs and wishes of one or more users associated with it, but to limit the disclosure of these needs and wishes. The first agent 4501 may be referred to as a content-creating AI, and its task may be to generate content elements that can be configured, such as by the second agent 4502, based on the needs and wishes of a user associated with the second agent. The second agent 4502 may request content elements and/or provide information indicating the types of content elements needed (“male”, “teenage”, “happy ending”) to the first agent 4501, which then conveys and/or creates a series of elements to be used by the second agent 4502, such as to be selected, assembled, and/or otherwise configured (such as skinned) before presentation of content to the user.

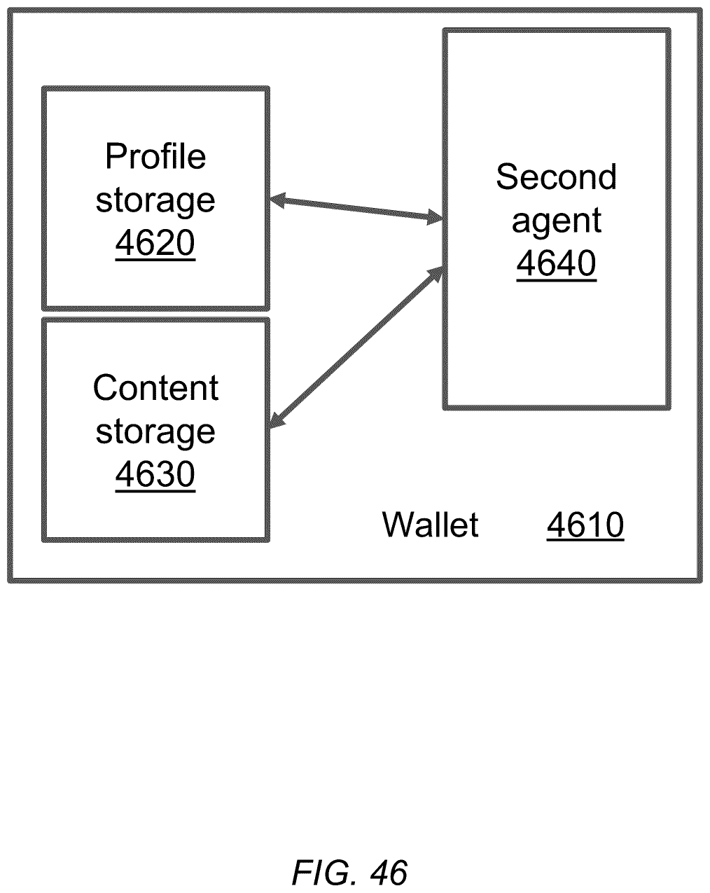

FIG. 46 illustrates a wallet configured in accordance with some embodiments of the invention. Wallet 4610 includes a profile storage 4620, a content storage 4630 and a second agent 4640. The profile storage 4620 includes records indicating needs, preferences and actions of one or more users associated with wallet 4610, and is accessible by second agent 4640. Second agent 4640 may have both read access and write access to profile storage 4620, and may add records and entries identifying one or more users and their activities. An example of a record in the profile storage 4620 is a record that identifies the demographics of users, and another example record is one that identifies likely movie preferences of users, including but not limited to humor, happy endings, romance, and more. Different records may be associated with the same user and/or with different users, as indicated by a record identifier associated with a given user. The contents of profile storage 4620 may be considered private and sensitive, and not be exported outside the wallet except for in an encrypted and/or otherwise protected format. Second agent 4640 may use the content of profile storage 4620 to identify appropriate content for one or more users, to perform selections of content elements, to configure content and content elements, and more, where the results of such operations may be stored in content storage, and/or may be output, such as rendered on a screen and/or sent to a speaker. The content storage 4630 may include content and content elements, both those that have been configured based on user needs, preferences, etc.; and those that have not. Content elements may be components that can be combined to make up content. The wallet 4610 can request content and content elements that suit the needs of a given user, but may also request content and content elements that are not of relevance but which are requested in order not to convey any private information to outside content providers, and/or to reduce the amount of insights about the user that can be gleaned from such. The wallet may include a digital rights management (DRM) unit (not shown) that identifies what content and content elements users have rights to, and determines what entities including but not limited to content creators should be paid based on the consumption of content by the user. The DRM unit may also identify when product placements take place, identify likely conversions, and communicate triggers for revenue events, such as causing the payment for a product placement that was made and, optionally, which resulted in an action.

In some embodiments, users may wish for their preferences to be disclosed to content creators and content configuration entities, for purposes of obtaining better customized content. The user may wish to disclose some preferences but not others. A user may be provided with user interface in which they can select what types of information may be shared, such as movie preferences, book preferences, types of endings preferred, genres appreciated, types of products of interest, etc. The user may also be asked to identify what parties are provided such information, such as marketers, a specific content producer, a consumer watchdog entity of the user's choice, members of a specified DOA, etc.

While specific processes and structures are described above with reference to FIGS. 44-46, systems governing content creation can be implemented in any of a number of different ways to enable as appropriate to the requirements of specific applications in accordance with various embodiments of the invention. Additionally, the specific manner in which content configurations can be utilized within NFT platforms in accordance with various embodiments of the invention is largely dependent upon the requirements of a given application.

### Detection of Abusive Smart Contracts

Systems and methods configured in accordance with a number of embodiments may be applied to assessing the validity of smart contracts. In accordance with multiple embodiments of the invention, smart contracts may be identified by enumerating them and/or by storing identifying information about each one of them in collections that may include but are not limited to databases. In records of identifying information, systems and methods configured in accordance with numerous embodiments may store information indicating the risk level(s) associated with the smart contracts. Risk level assessments may include but are not limited to assessments by trusted third parties. Additionally or alternatively, risk level assessments may include age and/or download indicators specifying durations smart contracts have been known and used without serious complaints.

Identifying information may include but is not limited to one or more indications of risk, such as references to abuses potentially related to the use of smart contracts. The identifying contract of smart contracts may include but is not limited to cryptographic hashes of the smart contract, address(es) indicating the location of the smart contract(s), and/or variations of such identifiers. Smart contracts can be assessed by identifying them and determining whether they are known by searching the database(s) for the identifier and generating risk scores based on the one or more assessments associated with the smart contracts.

In special cases, allowlist approaches can be used where only reasonably well-regarded smart contracts may be enumerated and stored in the database. Systems in accordance with various embodiments, may additionally or alternatively, store banlists of known abusive contracts. Additionally or alternatively, lists that incorporate both allowlisted contracts, banlisted contracts, and/or contracts for which no assessment has been made may be stored.

As the number of smart contracts increase, the viability of enumeration approaches may be reduced. The viability of enumeration approaches may especially reduce when the introduction of new smart contracts are rapid in comparison to the time it takes to confidently generate security assessments. For example, when honest and/or abusive users create high volumes of smart contracts that defy classification (according to the identifier-based scheme described above), the benefit of enumeration may wane.

Systems and methods configured in numerous embodiments may be configured to identify when smart contracts are exactly the same as previously known ones and/or when they are substantially similar to previously known ones. One such approach may determine the effect(s) of two or more contracts, and/or compare these effects.

One effect may be to transfer an amount X1 to a user Y1, where Y1 is a party the user has interacted with before. Another effect may be to transfer an amount X2 to a user Y2, where X2 is significantly more than X1, and/or Y2 is a party different from Y1. The latter would be a very different effect from the transfer of an amount X3 to Y3, where Y3=Y1 and X3 is 1% more than X1. In such cases, the smart contract corresponding to (X3,Y3) is rather similar to that corresponding to (X1,Y1), but different from the one corresponding to (X2,Y2).

Another comparison may be a “fuzzy” comparison wherein smart contracts can be compared to one or more other smart contracts that have already been accepted (e.g., engaged in by users). In doing so, systems and methods configured in accordance with some embodiments may determine whether the contract(s) being compared to the database entries are anomalous. Anomalies may include but are not limited to smart contracts that relate to greater amounts, greater transfers, purchases of substantially different artifacts, etc.

In accordance with a number of embodiments, assessments can be made using AI. The AI can, additionally or alternatively, be configured to determine whether smart contracts being evaluated (which may be referred to as “tentative smart contracts” in this application) are similar to collections of already accepted smart contracts (i.e., smart contracts that the user(s) considering the smart contracts has accepted) and/or similar to collections of smart contracts that were not accepted.

AI configured in accordance with many embodiments may compare smart contracts in tandem with corresponding users (e.g., receiving and/or requesting parties). For example, AI may review collections of users who behave similarly to the relevant user (for the specific smart contract being assessed). In doing so, the AI may be configured to determine whether the specific smart contract is similar to the smart contracts accepted by the collection of users and/or similar to the rejected smart contracts.

Systems in accordance with some embodiments of the invention may follow different methods of rejecting certain smart contracts. In accordance with several embodiments, methods may include but are not limited to randomized samplings of similar contracts, with rejections occurring when it is determined that users have not accepted similar contracts. In accordance with various embodiments, these smart contracts may correspond to smart contracts that users in the collection have evaluated but not accepted. Other related approaches for identifying what not accepted means are also possible, as will be appreciated by a person of skill in the art.

Systems and methods configured in accordance with some embodiments may be configured to avoid situations where attackers create new variations of previously recognized malicious smart contracts including but not limited to by encryption of code, by “packing” of code in which code and random data is zipped, and/or by polymorphism of smart codes in which new expressions of the same functionality are generated.

Obfuscation may be performed manually and/or automatically from a centralized location, such as the computers of the attackers. Additionally or alternatively, malicious smart contracts may cause the generation of new versions of itself, where the new versions are distributed over the network. entered on a blockchain where other tokens can reference it, and/or made to replace the original in a storage location indicated by a fixed address (such as a URL addressing a corrupted server and/or a proxy server forwarding traffic to such a server). This may be done with the goal of (a) creating new contracts that are not detected by traditional detection methods but which perform the same and/or similar tasks as previous malicious contracts that are known by traditional defense systems, and/or (b) identifying new vulnerabilities and approaches to subvert security mechanisms.

Systems and methods configured in accordance with some embodiments may address the problem of attackers that use generative AI through creating repositories. Such repositories may include but are not limited to variants of malware and malicious smart contracts that have already been observed, and/or variants generated by generative AI. The entries of the repository may, additionally or alternatively, include but are not limited to samples of real malware and malicious smart contracts that have been seen live. In such cases, samples may be collected from devices that have been exposed to the abusive code, and such devices may be connected to the repository by networks. Additionally or alternatively, entries of the repository may include but are not limited to samples that are generated by the repository, and/or associated parties. These “derivative” samples may be based on, but are not limited to similar techniques that attackers used, such as requesting new malware from generative AI.

In accordance with several embodiments of the invention, repositories may be automatically analyzed. In doing so, rules may be generated including but not limited to behavioral markers and code pattern markers. These markers may be distributed to entities that use the markers to scan incoming smart contracts. By scanning incoming smart contracts, the entities may determine whether there is a match between an incoming smart contract and one or more markers.

Matches may be used to govern security decisions for systems configured in accordance with multiple embodiments. For example, based on one or more such matches, risk scores may be generated and/or used to perform actions including but not limited to determining whether to allow, block, and/or provide warnings for the smart contract.

In accordance with many embodiments, risk scores can be distributed to end-point devices (including but not limited to user wallets). Additionally or alternatively, security decisions may be applied on networks, and/or applied by proxies connected to the end-point devices. In accordance with some embodiments, markers may be handled (and analyses performed) directly by end-point devices. Additionally or alternatively, approaches may be combined, such as where some markers are stored on the network and others at end-point devices. The markers that are more likely to be matched, for example, may be pushed to end-point devices to decrease prospective access to the network. Additionally or alternatively, the decision of what markers to push to what locations may be determined based on subscription levels and/or configurations (e.g., of the end-point devices). These may be represented by user wallets, for example.

Independent of maliciousness, smart contracts may contain references to elements to be incorporated into the smart contracts. These references may be in the form of, but are not limited to: URLs and/or other addresses, cryptographic hashes identifying the component to be integrated, and/or pointers to other smart contracts (such as residing on blockchains and/or in other storage facilities). In accordance with many various embodiments, smart contracts may include multiple references, and/or the referenced objects may, in turn, contain further references. Some of the references may be conditional on the inputs to the smart contract, including but not limited to identifiers of tokens, wallet addresses, geographic boundaries, political boundaries, conditions for the transfer such as the need to use an escrow service, and/or other conditions.

In accordance with several embodiments, references may be selected based on the evaluation of portions of the smart contract(s) in response to the inputs to the smart contract(s). Systems and methods configured in accordance with numerous embodiments may address complications resulting from a lack of access to smart contract input, which might be taken advantage of by an attacker. This is addressed in a multiplicity of ways, including but not limited to real-time evaluation of contracts, their conditions, their components, and the resulting set of code elements to be executed and/or otherwise applied. In accordance with some embodiments, each component of smart contracts can be evaluated independently and given scores that indicate whether they are believed to be benevolent and/or malicious. Additionally or alternatively, the components may be evaluated in combination with each other, to address concerns that some combinations of benevolent components may be malicious (e.g., based on their input). Systems configured in accordance with multiple embodiments of the invention may, additionally or alternatively, assess the security of smart contracts that have conditions and/or references to elements that may themselves have conditions and/or references.

In accordance with certain embodiments, smart contracts and their components may be evaluated and one or more scores are determined. In such cases, scores for the collection of elements may be determined and used to make security decisions.

Systems configured in accordance with a number of embodiments may add further assessment to the determination of the safety of smart contracts, in that the transaction that is used to interact with it may need to be taken into account. One transaction may be perfectly safe, whereas another may carry significant risks. For example, an exchange of one token for another using a decentralized exchange (DEX), may carry little risk, whereas a large exchange may cause slippage, namely a significant shift in the exchange rate received.

Risk assessment performed in accordance with various embodiments of the invention may consider the impact of other transactions that take place before and/or after the transaction under consideration. To return to the DEX example, a given transaction taken in isolation may carry little risk, but a “front-running” attack (wherein another party submits a transaction that reaps the benefits of the transaction under consideration before the transaction under consideration) and/or a “sandwiching” attack (wherein another party submits two transactions, the first of which shifts some parameter to the disadvantage of the transaction under consideration, and the second, executed after the transaction under consideration, reaps the benefits of the shift of the parameter).

In accordance with some embodiments, risk assessment systems may be extended to take the effect of other transactions into consideration when presenting risk score and/or other risk assessments. This may be performed by theoretical means, namely producing models of potential transactions surrounding a transaction under consideration and examining the effect. Additionally or alternatively, it may be performed empirically, by parsing the blockchain(s) (which contain large lists of prior transactions) and/or producing collections of patterns of behavior that are detrimental to the transaction(s) under consideration.

For example, systems configured in accordance with some embodiments may parse blockchains (e.g., Ethereum) for all transactions to smart contracts under investigation. Doing so may be used to produce lists of timestamped transactions. In the above example, the smart contract under investigation may be a DEX, and the transaction may requests to exchange an amount of a first token for an amount of a second token, (or vice versa). The systems may then examine the lists to produce secondary (derivative) lists containing groups of two or more transactions that occurred in the same block. The systems may, additionally or alternatively, process secondary lists to produce tertiary (derivative) lists, in which each group of transactions includes transactions from at least two different parties. Through this, potential frontrunning and sandwich attack transaction clusters may be identified.

Systems configured in accordance with many embodiments of the invention may investigate each transaction group's tertiary lists to determine when front-running and/or sandwich attacks take place. In accordance with many embodiments, systems may respond to front-running and/or sandwich attacks by investigating through running sandbox replications of the blockchains and/or executing the transactions in entries of the tertiary list(s) in each possible combination of ordering. In doing so, systems may record the resulting asset holdings of each address in each transaction before and after the transaction execution. Tables may thereby be constructed comparing different outcomes of different orderings. When asset holdings for given addresses are substantially different, for example below or above a predetermined percentage threshold, systems may conclude a frontrunning attack (in the case of two transactions), and/or a sandwich attack (in the case of three or more transactions).

Other factors that may be considered in accordance with certain embodiments of the invention may include but are not limited to relative gas expenditure for each transaction within a group, and repeated occurrences of the same address being present in transactions preceding and/or following transactions from different addresses at different times. For example, an attack transaction may supply more gas to ensure speedier execution, and an attacker may use the same address to conduct different attacks.

To address external code elements, some of which may be modified dynamically (e.g., based on from where the request is made) systems configured in accordance with numerous embodiments may collect code segments that are requested from smart contracts and determine whether any of them are high-risk. The collection may be performed from end-user devices, including but not limited to devices that have obtained the smart contracts referencing the external component. In accordance with certain embodiments, the received code may be evaluated in a sandbox. Additionally or alternatively, the code may be exported to safe execution environment(s), including but not limited to environments (where the calling smart contract and/or the received component code may be executed) that are cloud-hosted and/or managed by trusted parties.

When executed in sandboxes, the result of execution may be non-predictable (e.g., depend on a random component) and/or be a function of environmental elements (e.g., data in the execution environment, and/or configuration parameters). Such instance may be classified as malicious by virtue of typically being an indication of evasive behavior. Hence, when the same code, which may be evaluated in multiple environments, render different results, systems configured in accordance with many embodiments may consider it indicative of risk.

To control for legitimate use of randomness, including but not limited to the result of on-board random generators, the states of such random generators (i.e., pseudo-random generators) may be set to the same value. Therefore, any discrepancies between executions may be assumed to depend on the use of environmental variables; when not declared and/or used via APIs, these variables may be classified as malicious.

In accordance with multiple embodiments of the invention, the computation can be evaluated and it may be determined whether they are undesirable and/or potentially undesirable. Undesirable computation may include but is not limited to the transfer of assets to known malicious addresses, the transfer of assets in a manner that is inconsistent with user interface conveyances, etc. In such cases, the corresponding smart contract may be optionally blocked, reported as malicious, and/or inquired into via user interfaces (when the user wishes to perform the identified action).

User interfaces configured in accordance with some embodiments may send users messages including but not limited to “This smart contract transfers funds to an entity whose name is similar to one you have previously transacted with, but the entity is not registered with the same owner.”, and/or “This contract specifies the sale of an asset at a price that is below estimated market value.” In such cases, users may asked whether to proceed. Additionally or alternatively, logs may be created. Some user interfaces may require users to respond with 2FA codes (such as those from other devices) when their configuration settings indicate a need to do so. In accordance with numerous embodiments, the one or more sandboxes can evaluate the functionality of smart contracts by static analysis (e.g., matching to banlists and/or allowlists) and/or dynamic analysis (e.g., the use of sandboxed execution). These methods can also be used in execution contexts where the smart contract does not call external resources, and/or where two or more smart contracts reference each other (as may be the situation when there is automated negotiation of terms).

In accordance with certain embodiments, smart contracts may be obfuscated. To compute normal forms of such smart contracts, systems may decompile them and then compile them again, through methods including but not limited to the use of optimizers. As such, when one smart contract specifies that a variable is increased by 3 and then by 7, the optimizer may cause the recompiled version to increase the variable by 10. Another smart contract may be obfuscated in another way by adding 2 to the variable, then 6, and then 2. This, too, corresponds to adding 10, and the optimized and recompiled version will increase the variable by 10. The normalized code may be the one that is entered into the banlist, and later, other normalized codes will be compared to the stored normalized codes on the banlist. Allowlist code, in some embodiments, may also be normalized. In some instances, where obfuscation is used to avoid copyright evasion and/or other attacks, allowlisted code may be normalized before being allowlisted and before being compared to allowlist entries.

One way of obfuscating smart contracts may involve them decrypting themselves, unpacking themselves and/or otherwise creating code that is executed from the smart contract itself. In accordance with multiple embodiments, this behavior may be flagged as being high-risk, and cause smart contracts, unless allowlisted, to be blocked, flagged, cause an alert, and/or perform another related security action. Such behavior may be determined from execution in sandboxes, and/or simply having security module(s) attached to the memory access table to determine consecutive writing and execution from one and the same space.

Systems configured in accordance with multiple embodiments, additionally or alternatively, be used to detect self-modifying code in general. In particular, self-modifying code may be another manner of obfuscation that can be used for purposes of obfuscation, in order to attempt the evasion of detection of banlisted smart contracts. The techniques described herein for processing of smart contracts also apply to components of smart contracts, including but not limited to libraries, external code segments, etc.

In accordance with multiple embodiments smart contracts may have various distinct functionalities. Smart contracts may be expected to have code and parameter caches, where the latter corresponds to configurations of the smart contract, including but not limited to smart contracts made by the wallets of token owners, content creators, and/or other parties with rights to generate smart contracts. Tokens may be associated with multiple smart contracts, where two different smart contracts may be generated by different entities. Systems configured in accordance with some embodiments may determine whether the two or more associated contracts are conflicting, and when they are, what smart contract takes precedence. Collections of smart contracts may therefore govern transactions, where the membership of the collection may be determined as the contracts are being evaluated. Collections of selected smart contracts may be compared to allowlists and/or banlists, additionally or alternatively to the associated members of the collection.

In accordance with numerous embodiments parameter caches and/or code caches may determine what collections are selected, and/or what the precedence is. Parameter caches may be digitally signed, as may code sections, where the one or more digital signatures are verified prior to execution of the contract(s), and/or before the completion of associated transactions.

In accordance with many embodiments, failed verifications may cause alerts: to users whose wallets perform the evaluations, the parties supposedly creating the smart contracts, and/or third parties that collect information about contract modifications and abuse attempts. Such notifications may, additionally or alternatively, be performed in response to the detection of any risk, as described elsewhere in this disclosure.

When potential abuse is reported in this way, reporting entities may, additionally or alternatively, transmit the associated smart contract, code and/or parameters, to at least one entity receiving the report. The receiving entity may use the reported information to trigger the rollout of new patches of detection rules, to identify trending threats, to identify what types of risks are predominant at given points in time, and/or how threats are targeting various users. The latter type of information can be correlated to the known actions of these users, and may be used as input that determines policies including but not limited to the cost of insurance, the coverage of insurance, and/or the required and/or recommended use of various protection measures.

In accordance with numerous embodiments, banlist entries may contain but are not limited to segments of code, hashes corresponding to segments of code, and/or series of API calls that are performed by segments of code. Allowlist entries may be represented similarly, but while banlisted code segment may be represented in multiple ways to avoid successful obfuscation, the allowlist entries may not need this, and may be represented by hashes alone, for example.

Additionally or alternatively to banlists and/or allowlists, AI may be used to monitor transactions. In accordance with multiple embodiments, AI may be trained on labeled datasets, the labels corresponding to risk assessments including but not limited to scores and/or binary values indicative of risk. AI may be used to determine, in response to input smart contracts, whether smart contracts are likely to be risky, non-risky, and/or whether no assessment can be made.

Smart contracts that are not known to be bad or good yet may be entered in banlists with identifiers (e.g., flags) indicating that they may not require blocking subject to further analysis. Some wallets may be configured to block unknown smart contracts.

In accordance with a number of embodiments, risk of smart contracts in banlists may be indicated by numeric scores and/or other types of scores. Different wallets may have different thresholds of risk that are compared with the numeric scores and/or other types of score indicating risk to determine what security action to take, if any.

In accordance with certain embodiments, smart contracts may, maliciously, refer to other resources using the principles of return-oriented programming (ROP). In a traditional ROP attack, malware makes calls into legitimate code at locations that were not intended as entry points, thereby causing computation with high privileges (namely that of the legitimate code, which may be the operating system) to be performed. smart contracts may, analogously, attempt to make ROP calls into the smart contracts of matched tokens, wallets and/or other trusted code.

Systems configured in accordance with multiple embodiments may detect any call(s) outside the perimeter of the calling code, and/or blocks them. In accordance with some embodiments, smart contracts that make calls to outside resources, not using approved APIs, may be flagged as being malicious. Additionally or alternatively smart contracts may be flagged unless the smart contracts performing these calls originate from the same content creator(s) as the external code to which calls are being made. In accordance with many embodiments, origination can be determined by means of verifying digital signatures on smart contracts and code, as will be understood by a person of skill in the art. When smart contracts are flagged as malicious, identifiers of them can be entered in the banlists. The verification of being malicious can, additionally or alternatively, be performed dynamically, including but not limited to when smart contracts are not matched by any banlist and/or allowlist.

Malice can be considered subjective in some instances, where one user identifies one behavior as being undesirable, whereas another user does not have concerns. For example, some users may prefer not to engage with tokens that are not associated with policies that help enforce local laws, where such laws may include but are not limited to blocking content from minors, blocking content transfers that are not associated with proof of royalty payment, etc. A number of users may not find such smart contracts a problem, and certain users may find it desirable to enable blocking of contents from minors, but may not have any concern related to automated verification of royalty payments. Such preferences can be embodied in settings, which may be kept locally in the wallets of users and/or with proxies representing users and their wallets. In accordance with several embodiments, one example proxy may be an ombudsman. Techniques such as those disclosed in co-pending application titled U.S. patent application Ser. No. 18/299,546, titled “Systems and Methods for Instant NFTs and Protection Structure, Detection of Malicious Code within Blockchain Smart Contracts, Tokens with Transfer Limitations, Mirror Tokens and Parallel Addresses, Smart Contract Risk Scoring Method, and Cross-Device Digital Rights Management,” filed Apr. 12, 2023, incorporated by reference in its entirety, are compatible with the techniques disclosed herein.

The determination of what smart contracts are acceptable may be made both with respect to sets of guidelines associated with users of given systems. For example, such determinations may exist with respect to sets of personalized guidelines corresponding to the preferences of one or more users associated with given wallets, accounts and/or devices (processing transactions including but not limited to token transactions). In accordance with some embodiments preferences can be obtained by explicit indications from one or more authorized users, and/or learned from AI observing user actions, including but not limited to the selection of preferences and other settings. For example, the AI may select settings indicating inferred preferences of the associated user(s). In some instances, users may pre-approve such automated generation of preference data, including but not limited to setup and/or configuration phases performed by users and/or associated admins.

In accordance with many embodiments, users may be asked to approve and/or refute one or more suggested preference configurations derived by the AI. The preference configurations may be indicated to users along with explanatory information indicating the meaning and impact of the proposed settings associated with the inferred preferences. This may be used to manage the security of users, wallets and/or accounts, where newly detected forms of abuse can help influence the instrumentation of a system for the benefit of an end user. Additionally or alternatively, this can be used for end-users to indicate moral guidelines, including but not limited to what content to access based on information related to the content creators, the associated sales channels, trust information such as data about reputations and other end-user and system feedback related to content creators, content processors, and/or content types.

The moral guidelines may be a form of preferences, as described above, which in turn correspond to settings associated with users, their wallets, and associated accounts. These settings may affect (not only) the processing of smart contracts, as described in this disclosure, but, additionally or alternatively, relate to how systems identify and promote content to end users (e.g., based on likely desirability of content to the user), and to the generation of logging data (e.g., encrypted and/or otherwise escrowed logs of activity data, the existence of which may be based on settings as well as local jurisdiction and wallet requirements).

Based on the filtering settings, including but not limited to settings associated with determined preferences, agents associated with wallets may download and/or access policies and code related to the scanning of and processing of smart contracts and associated tokens.

In accordance with various embodiments, behavioral profiling of smart contracts executing in sandbox environments may be performed. Profiles configured in accordance with many embodiments may include but are not limited to series of API calls made (and/or attempted to be made) by smart contracts; calls to external resources, such as other smart contracts, websites, FTP sites, blockchain locations, etc. In accordance with many embodiments, certain such calls may be indicative of abuse.

By generating profiles of multiple related malicious smart contracts, including but not limited to profiles determined by reporting, manual review, determination of undesirable behavior, matching to banlists, etc., multiple behavioral profiles can be generated. Profiles may be generated from different collections of smart contracts, after which the profiles are clustered with respect to the collection so that two profiles generated from the smart contracts of the same cluster can be assigned to the same cluster.

Clustering may enable intelligence collection in that when two smart contracts that are both believed to be malicious are placed in the same cluster, then that is indicative of them being related. Implications of being related may include but are not limited to belonging to the same strain, having similar functional goals, being generated from related code bases, etc. Two smart contracts can be found to have significant but not complete overlap in the dimensions of the clusters, which may suggest a partial overlap of functionality, partial reuse of code, etc. Determining relatedness and/or profiling may be done to determine the likely origin of malicious smart contracts.

The same type of behavioral profiling described can be done to benevolent smart contracts. This may enable the classification of smart contracts by requiring that clusters are non-overlapping for two smart contracts: one may be malicious and the other one may be benevolent. Additionally or alternatively, profiling of benevolent smart contracts may enable a determination of classifications that need additional attention and scrutiny, including but not limited to review by an expert and/or performing other types of functional sandboxing (in which negative effects such as undesirable accesses and transfers are detected).

Such determinations may be more time-consuming and costly, and/or only performed when it is necessary. For example, systems may be configured for distinguishing between two distinct classifications that correspond to overlapping clusters, where one cluster corresponds to malicious smart contracts and the other to benevolent smart contracts. For benevolent smart contracts, a positive determination can be done by verifying digital signatures, cryptographic hashes, etc., to identify that the smart contract is already allowlisted. Instead of clustering techniques, other related techniques such as AI approaches, Machine Learning, and other statistical methods such as maximum likelihood approaches can be performed in accordance with various embodiments of the invention.

Malicious actors may attempt to replace libraries, functions and/or other portions of libraries, that are called by smart contracts. For example, smart contracts may refer to APIs and/or URLs associated with routines to be called by the smart contracts. Malicious actors may deploy smart contracts that refer to routines that they can replace. For example, when a smart contract is hosted by a service that the malicious actor has corrupted, then the malicious actor can replace the routine and/or cause a replaced routine to be served when requested, potentially in a selective manner based on where the request comes from.

To avoid attacks like those described above, systems configured in accordance with various embodiments may include multiple countermeasures. For example, routines may be verified using cryptographic hashes stored in the calling contract, stored in allowlists, and/or otherwise associated with the underlying address (e.g., making the address include a checksum such as a cryptographic hash of the routine). Additionally or alternatively, when routines are stored in blockchains, they can be verified not to have been modified based on validity checks related to the blockchain entr(ies) not having been modified and/or placed on a banlist. In accordance with several embodiments banlists can be authenticated using digital signatures, associated with trust by being served by trusted parties, and/or stored on blockchains to make any tampering detectable and/or impossible. Another approach may be to use other verification approaches disclosed herein to verify that each component (e.g., smart contracts, procedures called from smart contracts, etc.) is valid and unmodified.

In some embodiments, allowlisting may be performed, at least in part, by including digital signatures of certification authorities in and/or with smart contracts. Use of digital signatures may include but are not limited to referencing storage location(s) of the digital signature, incorporating the digital signature(s), and/or otherwise indicating locations of repositories including the digital signature. Digital signatures may include but are not limited to references to smart contracts, including but not limited to cryptographic hashes of smart contracts and/or portions thereof (such as executable portions, portions including references to code locations, and/or parameters governing the functionality of the smart contracts). In accordance with certain embodiments, digital signatures may, additionally or alternatively, include references to and/or information about assessments including but not limited to ratings, scores, indications of tested functionality, degrees of certainty, levels of trust, and/or indications of liability (such as how much trusted parties will pay if the assessment turns out to be flawed).

Wallets configured in accordance with numerous embodiments may evaluate digital signatures to make verifications including but not limited to: that they are valid with respect to the public key of the certification authority; that the identity of the certification authority matches an entry in a list of approved certification authorities (where this list may be specific to the wallets and configured by users of the wallets); and/or to verify that the information about the assessment matches one or more policies associated with the wallet (where such policies may be selected and/or configured by users of the wallets and/or may be determined by AI observing transactions involving the wallets and their users). In some instances, users may be prompted to approve transactions for which the matches are incomplete, and/or for which the matches indicate a need for users to approve. For example, some policies may be associated with such requirements.

A first type of smart contract, A, may be seen as automation of a trade, wherein the smart contract A (1) identifies a matching resource (such as a token B), and determines that token B satisfies a collection of requirements described by A; (2) awaits a signal from B that B is, additionally or alternatively, matching A; (3) determines exchange conditions based on the requirements described by A and the requirements described by B; and (4) initiates a transaction wherein B is acquired by an entity related to A. Here, acquired may mean, but is not limited to changes of ownership, changes of access rights, and/or other modification of permissions related to B and as specified by the exchange conditions. For example, B may be a token including a movie to which users/wallet associated with and/or specified by A gains “read access”, (possibly with conditions). Conditions may include but are not limited to having access for a specific number of times, within a specified duration, and/or under specified conditions (such as only from a digital rights management (DRM) platform that has been approved by third parties). Example third parties may include but are not limited to such as certification authorities.

A second type of smart contract, C, may be associated with a set of requirements and a list of allowed access types. A token D that is found to match C may be acquired, similar to how A is used to acquire B, but wherein acquisition of D involves D gaining access to a resource associated with C. This access may involve at least partial read access, at least partial write access, permissions to access one or more APIs, and/or otherwise perform a state modification related to C. For example, D may be a token and/or another resource wherein D performs a service on a device related to C, where the service may be to scan for abusive code, provide access to a database of executables, a script for automating and/or otherwise enhancing an action, and/or access to an AI to review a resource associated with C and identify a need.

One of the differences between B and D is that B can be seen as passive, and operated on, whereas D can be seen as active, and perform operations on other entities. This may make B (representing passive tokens) useful for actions like delivery of content including but not limited to entertainment and instructional content. Additionally or alternatively, D (representing active tokens) may be useful for provision of services, including but not limited to scripts, AIs, security software, and more.

In accordance with some embodiments wallets may be configured to permit only one type of contract (such as contract A) and not another (such as contract C). There may be additional types of smart contracts, distinguished by attributes including but not limited to access rights, requirements to report transactions such as to specified jurisdictions, etc. Some wallets may be configured only to allow selected types of contracts, and/or selected sub-types of contracts. In accordance with certain embodiments, subtypes may specify additional restrictions and/or requirements within the smart contract type(s).

### Incentive Mechanism for Content Distribution

Systems configured in accordance with various embodiments may include digital containers that facilitate access to content. Digital containers may include but are not limited to primary assets and/or references thereto; one or more conversion rules; one or more access rules, where access rules may be associated with one or more of the conversion rules. In accordance with many embodiments of the invention, access rules may govern access to the digital containers and/or primary assets. Additionally or alternatively, digital containers may include but are not limited to one or more secondary assets and/or references thereto. In accordance with some embodiments, conversion rules may govern access to the secondary assets. Digital containers may be and/or correspond to non-fungible tokens (NFT). Additionally or alternatively, assets may correspond to one or more forms of media.

Users may obtain access to digital containers configured in accordance with some embodiments of the inventions through processes, including but not limited to being gifted the digital container, being lent the digital container, and/or obtaining access to the digital containers in response to accessing a resource such as a movie. In response to getting access to containers, users may be granted access to the primary assets. Users may, additionally or alternatively, get access to digital containers because they are lent to them, because they are rented to them, because they are included in subscriptions, because users request them, and/or because the digital containers are associated with other elements that users get access to.

Prospective primary assets may include but are not limited to digital representations of songs, movie clips, text such as book chapters, commercials, teasers for movies, descriptions of secondary assets, and/or a combination of such. The primary assets may, for example, describe the secondary assets, and/or may provide advertisements unrelated to the secondary assets in terms of their content.

Systems configured in accordance with a number of embodiments of the invention may allow users to take various actions. Actions that may be performed may be indicated in the digital container, and/or may be commonly understood. The actions may include but are not limited to making copies of the digital containers and/or providing copies to friends and/or colleagues with similar interests as the users. Users may not be obligated to take actions, but may be provided with conditional access to one or more of the secondary assets when one or more of the conversion rules are satisfied. The secondary asset(s) can therefore be seen as rewards related to performing actions (such as sharing the digital container), in a manner that is satisfying one or more conversion rules.

In accordance with multiple embodiments of the invention, digital containers may be shared by providing access to others. Possible methods for sharing may include but are not limited to: posting links to and/or claiming keys for copies of the digital containers on public platforms including but not limited to social media sites, and/or special interest groups within social media platforms; emailing links and/or claiming keys for copies of the digital containers to contacts within the users' email applications; and providing access and/or ownership through some other means of distribution.

For example, one conversion rule may state that when three new users receive a copy of the digital containers from users, when these new users have not been exposed to the digital containers already, and at least two of them make copies of the digital container and pass it on to other new users, then the users obtain access to secondary assets. Another conversion rule may indicate that users get access to secondary assets when at least five new users make a purchase associated with the digital container, including but not limited to indicated by it, after being gifted a copy of the digital containers by users. In accordance with many embodiments of the invention, digital container copies include but are not limited to verbatim copies. Additionally or alternatively, digital container copies may have different identifiers, including but not limited to identifiers specifying the owner of the original. Yet another conversion rule may indicate that when at least two new users end up renting content associated with the digital containers provided by users, then users get a copy of the same content without having to pay a rental cost. Additionally or alternatively, users may, as a side effect of conversion rules, obtain benefits including but not limited to financial benefits.

Rewards and/or conversion rules may apply in relation to the method used for distributing copies of digital containers. For example, rewards may be proportional to factors including but not limited to the number of new users reached, the relevance of social media special interest groups, the duration for which contacts have been known for transferring copies of the digital container(s), the duration between the distributing of copies of the digital container(s) and the claiming of the copies

In accordance with certain embodiments triggering conversion rules may cause the generation of log entries, which may be implemented as tracking records, as disclosed in co-pending application titled “Managing Watchful Changes” by Markus Jakobsson. The tracking record may be automatically transmitted to an auditing entity, and/or logged on blockchains and/or off-chain databases. The selection of action may depend on one or more conditions associated with the token(s), specifying rules detailing when various actions are taken, where example tracking actions may include but are not limited to the transmission of encrypted data identifying ownership, and/or royalty payments.

In accordance with multiple embodiments, conversion rules may, additionally or alternatively, indicate that, when at least a certain fraction of new users (that receive copies of the digital content from users) perform certain actions (such as one of the actions described above) the older users receive benefits (such as one of the benefits described above).

Limits on conversion rules may be used to encourage “responsible” forwarding, since, if many new users receiving the digital containers do not take the required action(s) (such as watching the primary assets—e.g., a commercial—to the end, and/or performing a purchase) then the older users do not receive the benefit(s). Such limits may stop older users from spamming large numbers of new users with content that these new users are not interested in, and force users to instead consider who would desire the content associated with the digital container(s). In accordance with certain embodiments, conversion rules may have absolute thresholds (such as “at least 10 new users performing an action”) and/or relative thresholds (such as “at least a quarter of the new users taking an action”) and require that either one of the rules or more (including all of them) are satisfied. Conversion rules and/or policies may require that transfers of the digital containers are required to have destinations that are in use. This may be used to deter the use of never-before-used addresses, and/or addresses that have never signed transactions, such as null and/or burn addresses.

In a number of embodiments, the parties receiving content may have already been exposed to the content. For example, parties may have received content from other friends, colleagues, fans and/or social media contacts. The digital containers may encode rules indicating how benefits are shared among the older users forwarding content to (newer_recipient users which may be based on, but not limited to what action(s) the recipient users took and when. For example, a recipient user may watch a commercial from beginning to end the first time he is exposed to one or more digital containers associated with the commercial. The second time, he may watch only a portion of the commercial, but then take another desirable action, such as performing a purchase. In response to this, the older users forwarding the digital containers the first time and the second time may both derive some benefit, where some of the benefit (e.g., to the first user) may be provided at a first time, and some other portion of the benefit may be provided (e.g., both to the first and second user forwarding the digital container) when the receiving user performs a purchase.

In accordance with various embodiments, primary assets may be limited in terms of the frequency of benefits allowed. For example, older users may only have the right to access primary assets five times, unless conversion rule(s) indicate that secondary assets should be provided to older users in response to completed conditions (e.g., watching the full video digital content, and/or purchasing the item corresponding to the commercial digital content).

In accordance with many embodiments, primary assets may be content elements, including but not limited to promotional videos and/or songs, advertisements, access passes, and/or discount coupons. The secondary assets may include but are not limited to conditional payment orders, where the conditions can be associated with conversion events specified by conversion rules. The conversion rule may specify that when the primary assets has been accessed (e.g., viewed) by at least a threshold number of unique users (such as 1000 unique users) then the distributor of the digital containers including the primary and secondary assets is provided with a reward of $1.

Distributors may include but are not limited to advertisers, content promoters, bloggers, content owners, content originators, etc. Another conversion rule may specify that when at least one user has performed a purchase in response to accessing the primary assets, then a payment (e.g., $2) is made to the distributor of the digital asset. A third conversion rule may specify that when 100 unique users matching given demographic profiles (such as being 30 to 40-year-old women) have accessed the primary assets, then the distributor receives $5. Digital containers may include but are not limited to multiple conversion rules.

Digital containers may, additionally or alternatively, include one or more identifiers specifying the identity and/or identities of the distributors. This can be implemented by adding such identifiers using derived tokens associated with tokens that include assets and conversion rules, where the digital containers include the derived token as well as the token with the assets and conversion rules. Digital containers can, additionally or alternatively, be implemented by personalization steps performed in the minting phases of the tokens, and/or by registering the tokens on blockchains in a manner that associates them with the one or more identifiers. An example of such identifiers may be public keys of users. Another example is URLs unique to users. A third example is an email address associated with users. The token(s) can be associated with the identifier(s) by recording the elements together in blockchain entries, and/or provide references to stored item(s) to users wishing to access the token(s).

To protect against bot-based attacks used to make it appear that conversions that did not take place instead did take place, one approach is to require communications from devices of users to be digitally signed by digital rights management (DRM) modules, trusted execution environment (TEEs) and/or a combination of such. This can be done to select messages only, where these are used to ascertain the validity of the reported action and avoid bot farms to be used. In addition and/or in its place, heuristic detection mechanisms can be used, including but not limited to determining that there are no recurring access attempts by small numbers of entities within short periods of time (also referred to as velocity verifications).

When users access assets and/or events of relevance to conversions that are determined to take place, the events may be reported to entities indicated in the conversion rules. For example, when the rule is that payment is performed to the distributor when at least 100 users with given demographics access the assets of the digital containers, the event may be the access of the asset. When such access takes place, the wallets, browsers and/or other applications used to access the assets may identify that there is an event and reports the event according to specification in the conversion rules.

Reporting of events may, include but is not limited to conveying the associated distributor identifier to web addresses indicated in URLs of the conversion rule. In some cases, the web addresses may correspond to auditing entities. These entities may record the events, and/or determine whether the reports correspond to qualifying events through verifications, including but not limited to verification of demographic information. That may be performed by requesting such information from the wallet, browser, etc., in response to the conveyance of the information. The demographic information may be encoded by and/or indicated by an HTML cookie that is automatically transmitted. It may, additionally or alternatively, be generated and/or reported by the wallets and/or browsers when user privacy settings of the wallet/browser agree with such reporting.

The auditors may determine whether conversion has taken place by determining whether the number of qualifying accesses exceeds the threshold associated with the conversion rule. Auditors may, additionally or alternatively, determine that a purchase took place by verifications including but not limited to getting reports from a payment gateway, scrutinizing blockchains for entries of payments referencing the token associated with the identifiers of the distributors, etc. In some instances, DRM modules associated with wallets of users may identify whether conversion rules have been triggered, and/or whether events of relevance to conversion rules have taken place, and report such occurrences. For example, the wallets may determine that assets were rendered and that users viewing the asset content have demographic profiles that match descriptors in at least one conversion rule. As a result of that, they report the conversions to auditors. Auditors may be, but are not limited to being, fully-automated algorithms and/or machine-learning/artificial intelligence solutions that identify patterns of conversion performed by bot networks as opposed to targeted individuals.

In several embodiments, brands may obtain and/or create digital containers. Additionally or alternatively, brands may configure the digital containers for first influencers, whose identities may be indicated in association with the digital containers.

The digital containers that fall into the category of NFTs may include and/or be associated with the identities of particular influencers. Some associations may be performed by, but are not limited to, selling, gifting and/or renting them to the influencers, placing the recording of the NFTs and the influencer identifiers on blockchains. The influencers may provide the NFTs to collections of followers, who access primary content elements (i.e., primary assets) of the NFTs. The access to the primary content elements may be recorded by wallets of the followers, and optionally conveyed to auditors. Some of the followers may take actions in response to accessing the primary content elements, where example actions may include but are not limited to performing purchases.

In accordance with certain embodiments, purchases made by newer users of digital containers may be discounted. For example, in cases of influencer followers, the purchase may be discounted in response to the follower providing the NFTs, parts thereof, and/or references thereof, in connection with the purchase(s). Additionally or alternatively, associations may be made between coupons (that are part of and or referenced by the NFTs) and followers and/or influencers.

When conversions (e.g., purchases) are made, as described above, the older users (e.g., influencers) may obtain rewards conveyed through the conversion rules of the NFTs. These rewards may include but are not limited to financial benefits and/or access to certain resources.

Additionally or alternatively, older users (e.g., influencers) may identify what causes conversions by newer users (e.g., followers) and/or determine (possibly based on this information) the preferences of newer users. In the case of influencers, they may thereby be able to target specific content (that may be part of other NFTs) to followers with interests aligned with the content. The influencers may, additionally or alternatively, use this information to compile demographic profiles of followers, including but not limited to analysis of their actions and transactions. Additionally or alternatively, profiles may be based on information provided by followers in response to requests for information by the influencers. Information obtained may include but is not limited to age, gender, favorite pet, and favorite pastime. Some followers may agree to provide the answer to this request whereas others may not. The influencers may determine, based on the demographic information, what followers may prefer what other services and products, and provide these selectively.

As indicated above, in accordance with several embodiments, digital containers may include and/or reference smart contracts associated with physical resources including but not limited to items for sale and temporary physical access to items and/or space. In accordance with numerous embodiments, physical resources may be essentially unlimited (i.e., capable of being provided to any number of users acquiring the rights). One example may be a physical resource that corresponds to the right to enter an entertainment park during a specified month. Here, the exact number of access rights bequeathed may not be not critical. When the provider of access wishes to limit access at some point, it may signal this by communicating the fact to influencers and the public, and to prevent and/or refund purchases made in excess of the intended limit.

The physical resource may, additionally or alternatively, be limited, with a specific number of units available. Given digital containers may reference storage areas where a count indicating the number of still available units is accessible, and/or from which a count can be derived. These operations may be performed by but are not limited to prospective buyers and/or representatives thereof. Additionally or alternatively, the providers of the physical resources may issue specific numbers of digital containers, each one of which has one-to-one relationships with given physical resources. In such cases, possession of digital containers may enable the possession of and/or access to physical resources.

In accordance with many embodiments, approach, possession of the digital containers is the same as possession of the physical resource and the digital containers may evolve and/or change their metadata based upon the acquisition of the physical resource, but using another approach, the possession of the digital containers simply allows, including but not limited to by performing payment and the destruction of the digital container, the acquisition of the rights to the physical resource.

Digital containers, such as NFTs, can be destroyed by burning them, including but not limited to re-assign ownership of them to a non-existent entity, including but not limited to a public key generated in a manner that is understood not to correspond to a private key useful to transfer ownership of digital containers, and/or a null address.

The destruction of digital containers is a special case of a stateful digital container, which is disclosed herein. In some embodiments, the digital container, which may be an NFT, can be associated with a pre-specified number of states, including but not limited to 100 different states. These may be ordered in a linear manner and/or according to a graph structure indicating the possible transitions. The number of states may be infinite. With each state comes a set of rights, including but not limited to access rights. These can be described algorithmically, including but not limited to as the right to a specified number of funds that can be computed from the state number. They can, additionally or alternatively, be specified in a table and/or computed by an executable element, such as smart contracts that may be part of and/or referenced by the digital container.

Owners of digital containers may be parties with knowledge of private keys associated with public keys to which ownership rights of the digital containers have been assigned. In accordance with some embodiments, owner may change the state of the digital containers by assigning the ownership of the digital container to himself and a NULL entity, such as an entity with a public key but no associated private key, where this entity is associated with a state change. Techniques relating to NULL entities were disclosed above. The ownership assignment may specify the state to which the digital containers are moved, but this may, additionally or alternatively, be implicit, including but not limited to where the states are linearly ordered. The selection of a given NULL entity out of a collection of available NULL entities may, additionally or alternatively, indicate the state that is selected and optionally, additionally or alternatively, other states that are available and/or were previously not available. Some state changes may not be legitimate, e.g., based on the state in which digital containers are at the time of prospective state changes. This enables a governing of control of how states are changed. Some states may affect whether the digital containers can be transferred to another owner (not counting another NULL entity), including but not limited to blocking the resale.

Some state changes may only be allowed based on the satisfying of rules associated with the state change, which may be specified in smart contracts of the digital container(s). One example rule is that a given state change is only allowed after a given time, such as Jan. 1, 2031; another is that a given state change is only allowed after a given entity (such as a specified person) has passed away and an oracle has attested to this fact. Yet another rule may require a payment to change state, where the payee may be specified by a public key referenced in the digital containers for which a state change is sought. The container may include a model of a state machine encoding permitted state changes.

Tools to enhance the capabilities of influencers were disclosed in co-pending U.S. patent application Ser. No. 17/806,728, titled “Systems and Methods for Encrypting and Controlling Access to Encrypted Data Based Upon Immutable Ledgers,” filed on Jun. 13, 2022; and U.S. patent application Ser. No. 17/929,988, titled “Systems and Methods for Token Management in Social Media Environments,” filed Sep. 6, 2022, incorporated by reference in their entireties; the methods disclosed therein are compatible with the techniques disclosed herein. They are, additionally or alternatively, compatible with the techniques for incorporating augmented reality techniques and advertisements, as disclosed in co-pending application U.S. patent application Ser. No. 17/811,831, titled “Systems and Methods for Token Management in Augmented and Virtual Environments,” filed Jul. 11, 2022, incorporated by reference in its entirety.

Systems configured in accordance with many embodiments of the invention may incorporate rights management technology for tokens, including but not limited non-fungible tokens (NFTs) and fungible tokens (e.g., cryptofunds). The disclosed rights management technology can associate one or more rights with tokens and with an entity holding such rights.

For example, a first right may provide the right to undo an ownership change of the token, and may be granted to a security organization protecting token owners against malware causing a change of ownership by means of canceling and/or effectively reversing such actions, and/or of a governmental organization based on the detection of abuse by the same.

A second right may provide the right to burn tokens, i.e., to cause them to no longer be valid. This right may be granted to content creators associated with the tokens. Burning tokens can be performed by assigning their ownership to non-existent entities, including but not limited to a public key that does not have a corresponding private key known to any parties.

In accordance with some embodiments, additional rights may exist. A third right may be to identify one or more entities having held ownership of a token, based on access to encrypted logs of ownership information. A fourth right may be to initiate evolution for tokens, and may be granted to a content creator associated with the token. A fifth right may be to augment tokens, including but not limited to providing append-only write access to a field storing content data for the token. This right may be granted to one or more entities including but not limited to a car manufacturer, an insurance company, and law enforcement of a jurisdiction associated with the token. In relation to a given car, the corresponding token may then describe the vital statistics of the car, such as its vehicle identification number (VIN), its repair history, and any information relating to reports of theft.

Many embodiments of the rights management technology may involve the association of governed tokens with controlling tokens, where said controlling tokens are associated with one or more rights, as described above. In accordance with numerous embodiments, the association between governed tokens and controlling tokens can only be undone by using a specific dissociation process that can be initiated only by specified trusted parties, which may be the parties to which rights are assigned and/or parties that own tokens that control the tokens controlling the governed tokens. This is an example of a hierarchic structure of rights assignment. An example of such a structure was disclosed in co-pending application Ser. No. 63/365,269 titled “Directed Acyclic Token” by Markus Jakobsson and filed on May 23, 2022, incorporated by reference in its entirety.

The owners of controlling tokens may be associated with one or more rights, including but not limited to the right to receive royalties associated with the sale and/or use of the governed token, determine ownership of the governed token, reverse ownership changes of the governed token, burn the governed token, and more. One or more parties may be associated with such rights. One controlling token may be associated with the right to receive royalties, for example, whereas another controlling token may be associated with the capability to determine ownership. Here, ownership information may be kept in an escrow account, including but not limited to as described in the pending application U.S. patent application Ser. No. 17/821,444, titled “Systems and Methods for Management of Token Interactions,” filed Aug. 22, 2022, incorporated by reference in its entirety. The owner of some controlling tokens may be provided with the right to change the state of governed tokens, including but not limited to as described above. The ability to act as an auditor, as described above, may be associated with a particular one or more controlling tokens.

### Improved Distributed Storage

Systems configured in accordance with a number of embodiments may be configured to engineer monetization mechanisms for Web 3.0 services. In multiple embodiments, parties requesting services including but not limited to searches, may be associated with rights, which may be expressed in the form of certificates. The certificates may express and/or be associated with the identity of the parties to enable tracking of abusers.

Systems in accordance with certain embodiments may allow the revocation of damages associated with abuse, including but not limited to adversarial take-overs of certificates and associated credentials. Trusted third parties, which this application may refer to as consumer ombudsmen, may have the capability of associating expressions of rights (e.g., certificates) with identities. These associations may be utilized to revoke and/or limit the capabilities associated with the right; and/or to otherwise modify the access associated with the expression of the right based on feedback (including but not limited to positive feedback, indications of abuse, and assessments of usage volume and/or QoS-level requests at various levels).

In accordance with some embodiments, consumer ombudsmen may be certificate authorities, which may for example be implemented using a consensus mechanism; correspond to a DAO; and/or which may be a centralized entity that corresponds to one or more nodes in the distributed network.

As indicated above, rights may be used to enable services. An example service may be to search all nodes available to a maximum depth of 10, and another example service may be to search all nodes available to a maximum depth of 100. Here, the depth corresponds to the number of steps in a hierarchy of connected nodes, where a node that does not have the answer to the search request connects one or more nodes it is connected to and requests the information of behalf of the original requestor, wherein an answer gets returned through nodes that have forwarded the request in this manner, but where the number of forwardings corresponds to the maximum depth.

One type of certificate (or more generally, right) may correspond to one maximum depth, whereas another may correspond to another. Similarly, one certificate may have a first limit on the fan-out, and another may have another limit. The fan-out corresponds to the maximum number of nodes that get forwarded a request by a node that does not have the answer. Some rights may be associated with a predetermined limit of requests, including but not limited to per time unit. This can be implemented using coupons associated with the right, where a series of coupons can be handed out to make a sequence of requests.

Different rights may be associated with different quality of service (QoS) levels. These level may be used for operations including but not limited to implementing priority for requests, such that requests with higher priority are taken care of before requests with lower priority, provided both are available at the same time. Here, coupons may be values on hash chains that terminate rights through the certificate, and where consecutive preimages are provided to validate requests. The most recently used coupons may be stored by one or more nodes and be used to verify that new requests are not using old coupons but ones that hash to previously recorded coupons.

In some embodiments, certificates may be used to limit who can make requests. Users that have certificates can make requests, but if the certificate is used too many times, users may be blocked, and/or the certificate revoked. This enables the control against DoS attacks, including distributed denial of service (DDoS) attacks. Users that do not have a certificate and/or wish not to use it may request service from a traditional search engine, such as Google™, which may then interface with the distributed search, and may utilize one or more certificates associated with itself to do so. The traditional search engine may then implement proprietary security measures, including but not limited to DDoS security, including but not limited to the use of account-based and/or IP-based mapping of parties making requests. These traditional search engines may, additionally or alternatively, accept certificates from requestors, potentially treating requests accompanied by certificates (or other rights expressions, such as account-based rights and priorities) in a different way than it treats unaccompanied requests.

Different certificates may be associated with different limits. Limits may exist on the number of responses that may be generated (and/or combined) in response to requests. Additionally or alternatively, the may be different limits in terms of the number of answers any node in the hierarchy can send to the node from which it received the associated request. Systems may refer this to the cardinality of the request. In accordance with many embodiments, higher cardinality may correspond to better quality response. The ordering of two or more responses may be performed by nodes in the network and/or by agents associated with requestors.

One benefit for users utilizing certificates is that they may increase the depth at which the nodes of the network are searched. Greater depth may correspond to likely better results. Similarly, consider a party that wishes to store data that this data owner wishes to be found. The larger the number of nodes that store the data, the greater the likelihood that the data can be returned as a response to a query. This, in part, is because of limitations of depth and fan-out, as described above, where these aspects may limit the number of responses that are generated in response to a request.

In accordance with many embodiments, the number of nodes that store data can be expressed as a density, where density may be specific to given jurisdictions and/or given topics of search (including but not limited to patents, cartoons, and/or images of movie stars). The density can be a quality of service level in that a greater density corresponds to a greater likelihood of success. Users wishing to store data may be willing to pay more for higher-density storage.

Data in systems configured in accordance with numerous embodiments may be labeled with random numbers and/or tags describing content. The labels can be used by the nodes storing data to determine, along with the density at which the data is to be stored, whether they should store the data or not, given known constraints on available storage capacity. Nodes may choose to store data based on orderings of density. In some cases, all higher-density storage requests may end up being taken before a lower-density request. The density value may, additionally or alternatively, indicate a size of a reward that is provided for storing the associated data.

Users may request services, such as searches, by communicating with one or more nodes with access to the distributed storage. One or more of these nodes may generate responses. The response may be “raw,” and correspond to at least a subset of the data matching the request, where matches may be partial. The responses may, additionally or alternatively, be “processed,” wherein the response is a function of the subset of data matching the request(s).

One example function may be a prioritization of elements of the response, including but not limited to ordering based on likely relevance. The likely relevance may be a personalized predicate that depends on the identity of users requesting the service, including but not limited to being a function of past requests and/or a determination of what previous results and/or portions thereof were identified as likely relevant. These determinations may include but are not limited to observing user actions related to such elements.

Another example function used by systems in accordance with multiple embodiments may be the modification of content, including but not limited to translation to preferred languages, and/or transformation(s) to match the likely preferences of the requestor. Some nodes may perform transformations as a service. Alternatively or in addition, processing units associated with users who request the service may perform some of these transformations, including but not limited to selecting relevant data without disclosing preferences to external entities.

In accordance with some embodiments, search requests may include but are not limited to requests to perform transactions related to assets searched for. For example, users may wish to locate services, NFTs and/or crypto currency objects to acquire. Requests may include information about the nature of assets, including but not limited to a description, a serial number, an amount, etc. Requests may, additionally or alternatively, include an offer, including but not limited to in the form of an executable function that determines an offer price based on descriptions of the assets found.

Search requests may have options, where fixed numbers of items from longer lists of options may be required for a match. The terms of matches may be described by a regular expression, for example. As one or more items associated with the request are found, a response indicating availability may be generated. More than one parties may generate this. From one or more responses, a selection may be performed and an automated purchase performed. A matching mechanism such as that described in U.S. patent application Ser. No. 17/328,241, titled “Privacy Preserving Matchmaking,” filed May 24, 2021, incorporated by reference in its entirety, can, additionally or alternatively, be used.

### AI-Guided Augmented and Virtual Reality

Systems and methods in accordance with numerous embodiments can be used to address aspects related to the application of Artificial Intelligence to content personalization and configuration in augmented reality (AR) environments and/or virtual reality (VR) environments. This application may be based on factors, including but not limited to personal preferences, commercial interests, etc. Doing so may involve addressing concerns including but not limited to limited attention, the extent to which various needs are determined, the likely exposure time, and more.

Mechanisms in accordance with some embodiments of the invention may be used to identify AR and/or VR elements that are configurable within a certain perimeter. Additionally or alternatively, the mechanisms may determine for such elements whether configurations are applicable for users. The perimeter may be measured in distance using various units (e.g., two rooms away, 20 meters away, and/or in terms of the time to arrive at the location of the elements at the current pace and with the likely direction of movement). Applicability may be determined based on the options available for the configuration assessed in the context of the profiles of users (i.e., observers) based on factors, including but not limited to log-ins, biometric identification, behavioral profiling, and/or other methods to assess likely identity.

The sizes of perimeters can be set to depend on the computational resources available, on servers and/or client devices, where communication constraints are considered in the context of server-based generation. The size of perimeters may, additionally or alternatively, be determined by the speed of travel of users, the computational complexity of the configuration, and a priority value that may be determined based on the value of the configuration (wherein such value can be set by entities including but not limited to an advertiser, an application such as a gaming application, and/or users indicating personal preferences).

Preferences can, additionally or alternatively, be determined by analysis of user actions. For example, users whose interaction and engagement are strongly correlated with the performance of a given configuration may be flagged to have the configuration performed, whereas users whose interaction and engagement are likely not affected by the configuration may be flagged to not have the configuration performed.

The decision of whether to perform a given configuration may, additionally or alternatively, depend on the anticipated duration. During the “anticipated duration,” users may be exposed to the elements to be configured based on factors, including but not limited to the users' current speed and attention. The decision may, additionally or alternatively, be performed based on the expected needs of users. For example, users who need directions may be flagged to be provided with a directional configuration but not an advertisement configuration.

In various embodiments, a collection of elements within a set radius of users' locations, in a VR and/or AR environment, can be scanned to generate rankings. The rankings can indicate the relative importance of configuring the element(s), based on factors including but not limited to significance, value, visibility, likelihood of being seen by users, relevance to user interests, available computational resources, required computational resources for configuring the elements, and more. Based on the ranking, one or more elements can be configured. Configuration may, in accordance with a few embodiments, start with the highest-ranked element. Periodically, the ranked list is resorted to account for changes of location, changes of importance, changes of value, etc.

The computational effort of generating new ranked lists may be lower when a ranked list is already available. Additionally or alternatively, the effort may be lower when an approximate ranking is acceptable, including but not limited to where low-cost verifications of quality scores are made. Low-cost verifications may be made by generating a first-order estimate of the quality score and comparing this estimate to the previous estimate, which may be more precise and more computationally intensive to compute. When the first-order estimate is similar to the previous estimate, and/or when the context underlying the element has not undergone a significant change, then the more precise quality score does not have to be computed. This results in the ranked list being approximate. This reduces the cost of determining the ranking.

Periodically, the quality score of a given element may be recomputed in a more precise manner. These re-computation points may include but are not limited to when the first-order estimate indicates a significant change from the previously computed estimate and/or the context associated with the element has undergone a significant change. The latter case may happen at times including but not limited to wherein such a change exceeds a threshold value.

Many configurations can be precomputed. This may involve actions including but not limited to determining when system resources are available and/or ensuring the element(s) have not yet fallen within the horizon of visibility to users. A configuration may, for example, be the skinning of an element for product placement, including but not limited to causing an AR view of people at a restaurant to indicate that they all have ordered a particular beverage that is part of a product placement campaign targeting a given user walking into the restaurant. This computation may start before users arrive at the restaurant, including but not limited to suitable graphics and visual models may be downloaded as users make reservations at the restaurant, sets their driving directions to indicate going to the restaurant, and/or when users approach the entrance of the restaurant.

Additional computations (e.g., computing the visuals of overlaying the images onto items associated with the restaurant) may be performed in advance. This pre-computation can enable rapid configuration of AR video feed. As users enter the area (e.g., restaurant), the visual overlay from the camera feed can add the graphics to user view, for example, modifying items at the tables that users passes.

The technology of the instant invention is compatible with the technology disclosed in co-pending U.S. patent application Ser. No. 17/811,831, titled “Systems and Methods for Token Management in Augmented and Virtual Environments,” filed Jul. 11, 2022, incorporated by reference in its entirety. This may occur in operations including but not limited to enabling the overlay using elements from a multiplicity of sources, wherein some of these sources may require payment for the use of the graphical data (and others may be willing to pay for their corresponding elements to be rendered).

The payments to and/or from the content creators and content managers, may depend not only on the rendering of the elements but users' reactions to the rendered content. Different types of reactions may result in different sizes of payments. For example, in the context of promotional content, the recognition of users that the element was rendered, including but not limited to as determined by eyeball tracking software, may be sufficient for a first size payment, whereas user actions such as placing an order related to the element within a specified time period may result in a second size payment. In that example, the first size payment may be two cents and the second size payment may be five dollars.

In certain embodiments, one or more elements that are rendered using the disclosed technology may be licensed by users through methods including but not limited to those disclosed in co-pending U.S. patent application Ser. No. 18/155,662, titled “Crypto Wallet Configuration Data Retrieval,” filed Jan. 17, 2023, incorporated by reference in its entirety. The elements may, additionally or alternatively, be determined based on the wallet contents of users, including but not limited to as disclosed in U.S. patent application Ser. No. 17/811,831, titled “Systems and Methods for Token Management in Augmented and Virtual Environments,” filed Jul. 11, 2022, incorporated by reference in its entirety.

Systems in accordance with several embodiments may be compatible with the control mechanisms disclosed above, and may be implemented in various ways. For example, this may include but is not limited to representing in ranked lists those elements that the system determines should be rendered to a given user in a given location at a given time. This may, for example, suppress the rendering of advertisements and/or product placements of competing products in commercial locations (e.g., stores). Otherwise, brand A may cause user B to see product placement elements, using AR and/or VR, in a location corresponding to a store selling only brand C.

### Ombudsman Management Platform and Wallet Integration

Systems and methods in accordance with a number of embodiments of the invention may utilize one or more potentially collaborating ombudsman entities that represent the needs of one or more user entities. Ombudsman entities can be incorporated in and/or associated with wallets, network nodes, marketplaces, miners, and/or other participants. Ombudsman entities may be used in environments including but not limited to Web 2.0 and/or Web 3.0 service providers. Examples of user entities may include but are not limited to wallet owners, people with access rights to the contents of wallets, content creators, content distributors, influencers, etc.

Ombudsmen can represent two or more separate entities and/or have functionality that protects the needs of wallet owners and/or content creators. In accordance with certain embodiments, the needs of these two entities may be in conflict with each other. This can be achieved, for example, by the ombudsmen representing the needs of users. Ombudsmen operations may include but are not limited to identifying and blocking risks (such as phishing attacks and/or malicious smart contracts); identifying the needs of content creators; and creating content usage audit trails that can be used to determine that proper royalties were paid.

Systems in accordance with some embodiments may utilize markup language that identifies the properties of digital (content) containers including but not limited to tokens. Example tokens include but are not limited to crypto funds and non-fungible tokens (NFTs). The digital containers may, additionally or alternatively, relate to web 2.0 functionality, including but not limited to producing receipts for online transactions such as a purchase on Amazon™. Additionally or alternatively, digital containers may relate to digital rights management (DRM) container such as Netflix™ movies. The markup language can govern the actions of the ombudsmen relative to the digital containers. We will refer to this language as Ombudsman Markup Language (OML). OML objects configured in accordance with some embodiments may, for example, specify how content associated with a given token may be used; whether its use requires reporting and/or payments; and what type of access rights are required to access the content.

Systems in accordance with various embodiments may involve collections of compliance levels, corresponding to the safety of associated nodes including but not limited to ombudsmen. Such nodes may have high compliance levels (e.g., 7/10) when of specified brands, including hardware DRM units of specified types, up-to-date with software patches, and/or in good standing. Reputation scores may be based on complaints generated by other network nodes with compliance levels exceeding a threshold value, such as 5. Another node may have a lower compliance level (e.g., 4) when it is of a specified brand but does not have a hardware DRM unit, and its patching is (at most) two weeks out of date. Yet another node may have a compliance level of 0 when it is not associated with any assurances. Negative compliance levels may indicate nodes that are known to be associated with malicious behavior, including but not limited to which have been placed on a blocklist by trusted parties.

OML objects may specify access to content that is based on the compliance level of the entity requesting the access. Here, an access request may be digitally signed by the requestor, and may include (and/or reference) certificates and/or other assurances indicating the compliance level of the requesting entity. Nodes with sufficient compliance levels may request access keys from other network nodes, including but not limited to ombudsmen nodes with compliance levels above another threshold (e.g., 8/10), where such units may operate as trustees on the network, for example.

OML objects may, additionally or alternatively, specify the required actions to be taken by accessing units, which may include ombudsmen. These actions, such as the generation of audit logs, may be audited by other parties (e.g., ombudsmen nodes with compliance levels exceeding 9), where these auditing units may create feedback scores associated with the accessing units. One example feedback score is the reputation score referred to above. Example audit logs may be at least in part encrypted, through methods including but not limited to using the cryptographic key of an auditing entity. These audit logs may, for example, include escrowed data, such as what was disclosed in U.S. patent application Ser. No. 17/935,541, titled “Systems and Methods for Transaction Management in NFT-Directed Environments,” filed Sep. 26, 2022, incorporated by reference in its entirety.

OML objects may further be generated by wallets, and encode information about the preferences and configurations of one or more users associated with the wallets. For example, one user of a wallet may have a first security setting, a first content preference setting, and a first setting related to privacy, whereas a second user of the wallet may have a second security setting, a second content preference setting, and a second setting related to privacy.

OML objects may be generated using generative AI, based on factors including but not limited to interactions with users, observations of user behavior and preferences, and/or a combination of such.

OML objects may accompany content, users, and/or user requests, as described above. OML objects may, additionally or alternatively, specify organizational and/or jurisdictional requirements, including but not limited to in terms of safekeeping of personal information. One or more OML objects may apply to the same transaction and/or tentative transaction, wherein it is determined what priority these objects, and/or individual aspects of them, have relative to each other in case there are conflicts between these objects and/or aspects. Thus, different OML aspects and objects may be associated with priority levels, where these priority levels may be explicitly stated and/or implicitly determined. The basis for determining priority levels may be based on the identities of the entities issuing the aspect and/or object.

OML objects may, additionally or alternatively, accompany digital containers that do not correspond to individuals, organizations, jurisdictions and/or content elements. For example, an OML object can reference and govern other OML objects, where OML objects can be arranged in classes, and where these classes may be hierarchically arranged.

As one example use case, consider a group of users differing in technical experience, wallet ownership duration, age, risk tolerance, etc. The persona would express to the AI Agent managing the ombudsman their characteristics and the AI Agent would suggest ombudsman parameters, including but not limited to clawback duration, transaction delay, transaction limits, acceptable offer sources (whitelisting and/or heuristics), etc. This user/AI interaction may for example be performed in a manner that involves (a) typing in the style of a modern generative AI prompt, (b) typing in the style of a prompt plus programmatic questions from the AI Agent, and/or (c) a complete “wizard” interface taking users through a series of standard questions. Once users accept suggested parameters, AI Agents may instantiate them in the ombudsmen.

In some use cases, functionality could include limits on AI suggestions and/or acceptable parameters based on users in a way users cannot change. For example, a minor might have limits imposed by a parent which can only be overridden by the parent.

Ombudsmen may operate as matchmakers in situations, including but not limited to between users (with the associated wallet) and content, between two users (with their associated wallets), and between users and service providers, where the service providers may provide some ombudsman services for users, including but not limited to escrow capabilities, backup, audit, security, privacy, etc.

The ombudsmen can be thought of as guardian angels of one or more users that they represent, where the actions of the ombudsman include but are not limited to: suggesting security settings and configuration settings based on user behaviors observed by the ombudsman and/or an associated entity; identifying and blocking risks and abuse; determine user preferences; maintaining fairness and compliance with laws, local regulations and user preferences; collecting advertisements and promotional material of likely interest to the associated users; suggesting better deals based on preferences and wishes expressed by the user; and other related activities, as will be understood by a person of skilled in the art.

In numerous embodiments, wallets may be connected to and/or include ombudsman entities. Multiple ombudsman entities may be involved in singular transactions and/or may represent different protocol participants. Some ombudsman entities may represent multiple protocol participants. One example protocol participant may be wallet users. Another example protocol participant may be content creators. A third example protocol participant may be sellers/vendors of tokens and/or services.

In accordance with some embodiments, wallets may have multiple registered users, each one of which may have different privileges. An example privilege is what tokens are accessible to users. Another example privilege is what actions users are able to initiate on a given token. A third example privilege is the ability to add and/or remove registered users to a wallet, and to set their privileges.

In accordance with many embodiments ombudsman entities may be associated with envoys, as described below. Envoys may manage messaging between the ombudsmen and associated entities, including but not limited to using restricted interfaces such as API. Envoys may be part of wallets, and/or may be freestanding entities paired with one or more wallets (and which provide services for such wallets).

The ombudsmen may be physically located on networks controlled by users of the wallet, including but not limited to home networks and/or in a cloud hosting environment accessible by users. This may be used to protect the ombudsmen against abuse such as malware, as the controls over the ombudsman can be stronger than those of the wallet (e.g., not being physically present with users and therefore not possible to steal by a robber).

Ombudsmen may, additionally or alternatively, be included in wallet implementations of users. There may be several such wallet implementations, including but not limited to implementations for different users of the same wallet, and for different devices used by one and the same user. These different wallets can be controlled by external wallets and/or wallet controllers, which may be hosted in the cloud and/or in a secure execution environment, such as Trusted Execution Environment (TEE). An example TEE can be implemented using TrustZone.

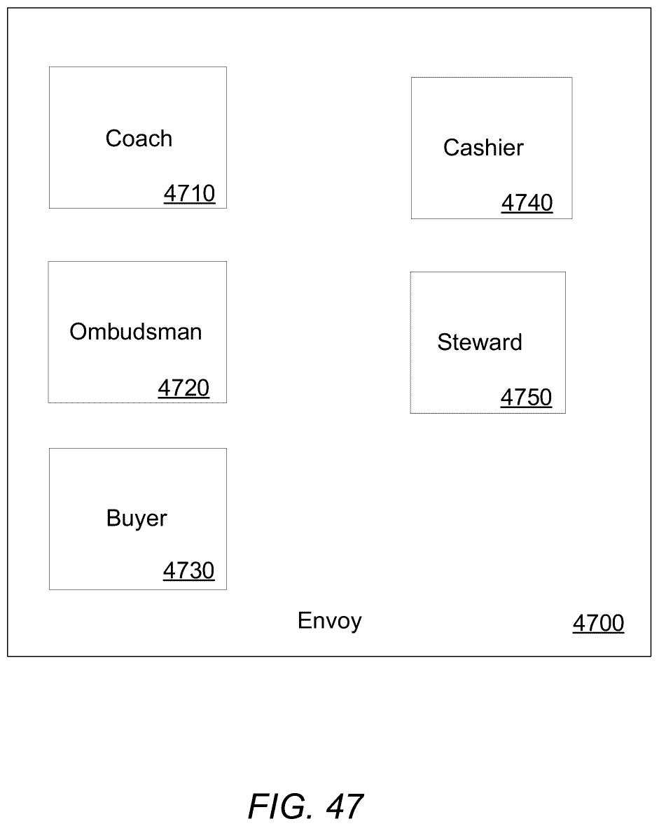

An overview of how Top-Level Digital Agents, configured in accordance with several embodiments of the invention, may support wallet owners with growing arrays of services is illustrated in FIG. 47. Here, Top-Level Digital Agents may also be referred to as “Envoys” 4700 and/or “Artema Envoys.” The Envoy 4700 in FIG. 47 represents a platform supporting and managing growing arrays of wallet-owner services. In accordance with many embodiments, Envoys 4700 may correspond to extensible platforms for Distributed Wallet Management.

The underlying services provided by Envoys 4700 may largely fall into around five different (but potentially overlapping) groups: Coach 4710 services may be used for initial onboarding, including but not limited to wallet initialization, interface settings, security and transaction parameters used by the ombudsman; Ombudsmen 4720 services may be used for safety and/or security services to protect wallet(s) of owner(s); Buyer 4730 services may encapsulate transaction support services including but not limited to automatic searches for similar offerings at lower prices; Cashier 4740 services may be used transaction management services including but not limited to the facilitation of interfaces for specifying and confirming transaction; and Steward 4750 services may involve asset management and custodial services, including but not limited to the facilitation of multi-platform interfaces to display wallet contents and/or send alerts regarding expiring (and/or rarely-used) wallet items. In accordance with a number of embodiments of the invention, each service group may be handled by their own modules: Coach 4710, Ombudsman 4720, Buyer 4730, Cashier 4740, and Steward 4750.

In accordance with many embodiments, Envoys 4700 may be modular, so different wallet users can use and/or install (or choose not to) individual wallet-owner services. Additionally or alternatively, Envoys 4700 may be extensible. Extensibility may allow Envoy developers, Envoy owners, and/or third parties to build growing arrays of service offerings (and/or allow community creativity in extending services). Initial services provided by Envoys 4700 may include but are not limited to: Onboarding, Offer acceptance, Proactive offer alternatives, Transaction Management, and Entitlement Management.

In some instantiations, Envoys 4700 may be wallet-type and wallet-contents “agnostic.” Agnosticism in relation to Envoys 4700 may refer to the capacity for wallet owners to add Envoys 4700 to existing wallets that themselves exist on any blockchain, platform, and/or device. Additionally, wallet owners can stop using Envoy and begin using different and/or competitive Envoys 4700 created by different parties with no loss of wallet functionality and/or access to wallet contents.

Coaches 4710 may be implemented both in and outside of Envoys 4700, and exist in software, hardware, and/or combinations thereof. Portions of the functionality of Coaches 4710 may be provided by external entities, including but not limited to processors hosted in cloud environments, executing scripts that are configured to match at least one user preference. Such user preferences may be associated with the Ombudsman 4720. In accordance with various embodiments, Coach 4710 can be integrated with the Ombudsman 4720, and performs actions (such as those described above) as part of the actions performed by the Ombudsman 4720.

Coach 4710 modules may, among other things, simplify onboarding while ensuring appropriate protections. For example, Coaches 4710 may capture required would-be wallet owner information and establish safety parameters for the wallet(s) based on factors, including but not limited to observed actions and data associated with one or more users.

Coaches 4710 may, additionally or alternatively, interact with users, through methods including but not limited to using AI-driven interfaces. By doing so, Coaches 4710 can determine user preferences of users. As an example, after a user acquires a token, Coaches 4710 may ask the user why they preferred the selected token to one or more alternative tokens, optionally providing multiple-choice options (such as “the purchased token was less expensive” and “the purchased token was more interesting”). Additionally or alternatively, Coaches may request and/or collect free-form responses to parse.

Coaches 4710 may, additionally or alternatively, utilize simplified and/or wizard-based UX. This UX makes entry into Web3 wallet ownership and uses as simple as setting up Web2 transaction readiness (e.g., creating an Amazon account with credit cards for payment).

Ombudsmen 4720 may perform services including but not limited to accepting/rejecting offers and providing gatekeeper functionality to accept and/or reject offers based on parameters. In the latter case, parameters guiding gatekeeper functionality may be determined by Coaches during initialization. Examples of parameters may include but are not limited to limits on transaction size, frequency, and/or selection of products, services, and/or vendors.

Buyer 4730 modules configured in accordance with various embodiments may proactively seek to optimize financial benefit for users. As such, Buyers 4730 may attempt to obtain better offers (e.g., reactive to wallet owner requests and/or external offers that are being evaluated before accepting).

Buyer 4730 may be part of Ombudsman 4720 modules, and/or may interact with separate Ombudsman 4720 modules. In the latter case, Buyers 4730 may perform actions, including but not limited to using Envoys 4700 as intermediaries controlling the interaction. This may be beneficial in situations in which it is desirable to isolate Ombudsmen 4720 from Buyers 4730, for purposes including but not limited to improving security by reducing the complexity of the modules performing sensitive actions. Additionally or alternatively, systems configured in accordance with certain embodiments may benefit when the different modules are created and/or maintained by different organizations (for instance, in the form of software packages, firmware code, plug-and-play hardware elements, USB dongles, and/or chip cards with similar form factors as SIM cards and/or micro-SIMs). Additionally or alternatively, integrating the Buyer 4730 and Ombudsman 4720 modules with each other may be desirable in situations wherein the modules are maintained by one and the same service provider.

Buyer 4730 modules configured in accordance with numerous embodiments may have many functionalities. For example, in response to offers for service and/or products from external providers, Buyers 4730 may automatically search for similar products, services, and/or entitlements at better terms. Those offers may then be presented to users, optionally along with the service product(s) included in the incoming offer(s). Alternatively or additionally, Buyers 4730 may, in response to specific user requests, search for products, services, and/or entitlements at optimal terms, and present responses to users. Buyers 4730 may, additionally or alternatively, proceed with purchases that fit pre-determined requirements without first needing to verify with users. Such functionality may be desirable when there is significant time pressure on making rapid transactions. Examples of significant time pressure may include but not limited to when it is estimated that there may be an upcoming shortage of resources of the requested type and/or the offered product and/or service is remarkably well priced (such as an error-fare offered by an airline and/or an obviously mispriced NFT).

In accordance with numerous embodiments, Cashier 4740 modules may manage transactions. As the other modules described in FIG. 47, the Cashiers 4740 may be integrated with the Ombudsman 4720 modules or may be separate. In some instances, at least a part of a Cashier 4740 may reside external to the device implementing the Envoy 4700. Additionally or alternatively, at least a portion of Ombudsman 4720 may be located in a manner that is separated from the wallet through methods, including but not limited to the use of in-network proxies. Keeping the modules (partially) separate may improve security, as the portion(s) located external to the wallets may have their security managed more strictly than the security of the wallets themselves are managed (and/or may not have the same potential software vulnerabilities as the wallets may have). Methods of strengthening security may include but are not limited to requiring both portions of distributed Ombudsmen to be corrupted in order for an adversary to successfully compromise the system.

In accordance with certain embodiments Cashiers 4740 may replace the role of credit cards in Web2. One role of the Cashiers 4740 may be to carry the ease, speed, reliability, and protections available to purchasers in heavily-centralized Web2 environments to distributed Web3 environments. As such, Cashiers 4740 may have proprietary transaction management system(s). The proprietary transaction management systems may offer increased safety (e.g., protection from loss) for mainstream wallet owners in (dangerous) distributed Web3 environments.

In some embodiments, Cashiers 4740 may include AI-powered wallet protection agents characterized by scalability in both breadth and depth of protection. Breadth may refer to the sense of a modular architecture for overarching protective agents allowing parties (e.g., Artema) to deliver plug-in modules offering new forms of protection under the umbrella of and controlled (or executed) by top-level agents. The mechanisms may include API passing inputs and outputs on how the module operates and/or the results of the modules' protective actions. Depth may refer to the fact that each module can be configured (e.g., via a UX expressed through the top-level agent) to various levels of protection from simple reminders for sophisticated users to full-blown third-parties approvals for unsophisticated users. Sophisticated users can, additionally or alternatively, use systems configured in accordance with many embodiments, but do not require the same level of protection.

Cashiers 4740 may, additionally or alternatively, implement user experience (UX) for the front end of third-party transaction management systems. Cashiers 4740 may offer users consistent, clear, configurable interfaces for each transaction, similar to Web2 users finalizing transactions on Amazon™ and/or eBay™, while exposing to vendors and/or other systems on the other side of the transaction(s) via expected programmatic interfaces. In doing so, Cashiers 4740 may function as real-time escrow engines, ensuring the wallet owners receive the goods and/or services desired while the vendors and/or third parties receive the expected compensation.

In accordance with multiple embodiments of the invention, Steward 4750 manages and tracks entitlements based on assets in wallets. Examples of actions include but are not limited to: providing UX for the reporting on the balance and/or current values of fungible coins (such as Bitcoin and/or Ethereum); managing, maintaining, processing and/or enabling the use of entitlements based on assets ownership (e.g., NFT allows entry to private dining club); and providing umbrella functionality for existing and emerging alerts and/or reminders about entitlements, including but not limited to services, support, products, upgrades, add-on products and/or services, purchase opportunities, etc. based (at least in part) on wallet contents.

For example, wallet owners can manually look for entitlements offered by individual digital assets. Additionally or alternatively, via location services, Stewards 4750 can alert the wallet owners of entitlements at retailers and/or service providers based on user location. Additionally or alternatively, via schedule, Steward 4750 can remind wallet owners of entitlements based on predetermined timing. Additionally or alternatively, via promotions offered at any time by third parties based on ownership of specific digital assets, Steward 4750 can alert wallet owners of new entitlements and/or offers.

In accordance with numerous embodiments Stewards 4750 may be part of Ombudsmen 4720, and/or may be separate modules that can interact with Ombudsmen 4720, including but not limited to using Envoys 4700 as intermediaries and/or schedulers of messaging between the entities. A portion of the functionality of Stewards 4750 may be provided by entities that are external to the wallet(s) that incorporates Envoys 4700. In some embodiments, Envoys 4700 may be external to user wallets as well, including but not limited to being housed in a proxy that represents users and their needs.

In many embodiments, Ombudsmen may be configured by users selecting one or more plug-in modules that describe the policies and functionality of the ombudsmen. These plug-in modules may be created by but are not limited to security companies, consumer representatives, government agencies, religious groups, etc. Additionally or alternatively, plug-in modules may be screened and rated by other entities that assign them a score indicating the trustworthiness of the module. Users may select plug-ins based on the reputation scores of the plug-ins, and the identities of the parties creating the scores, and based on how the users feel about these parties.

Users may configure plug-ins, through operations including but not limited to identifying preferences, setting parameters, and/or identifying modes of operation (such as “newbie mode”, “advanced user mode”, etc.). Such modes may come with a collection of parameter choices associated with how certain types of users would prefer to configure the plug-in modules. In accordance with some embodiments, users may install multiple plug-ins. To the extent that these overlap, there can be a tie-breaking method for determining what policies and functionality gets priority. This may be set by users, and/or may be a requirement of the plug-in(s) and creator(s).

Users may create a new (combined) module by combining two or more modules. This new module can be configured by users (e.g., user selection for how ties are broken). Combined modules can, additionally or alternatively, be configured by providing inputs, as described above. The combined modules can then be marketed by users as new modules. Anybody interested in new modules may be able to determine information including but not limited to what component plug-in modules it is made from; what the associated scores are for the associated plug-in modules; and what types of selections and parameterizations were performed by users, as part of the configuration resulting in the new module(s).

When modules are sold and creators obtain royalties (as modules change hands and/or are rented out) the combined modules may be used to enable can result in royalties being paid to the creators of the constituent modules (from which the combined modules was created), in addition to the users that created the combined modules from the input modules.

Plug-in modules may be expressed as non-fungible tokens (NFTs) with payloads identifying the code and/or the policies of the modules. Additionally or alternatively, they may include scores and certificates of the parties providing the scores, and/or references to such parties and assessments. When users create new plug-in modules from input plug-in modules, systems may require the user(s) to own these plug-in modules, and/or to have obtained the right to use them in the new plug-in module(s).

Additionally or alternatively, input modules may be available for anybody to combine when creating new plug-in modules, as long as the creators of the input plug-in modules get paid a pre-specified royalty (such as $2 per sale and/or a corresponding cryptocurrency amount) when their creation is used. In some instances, the royalties may depend on how significant the usage is, including but not limited to how many sub-modules of a given module are used when generating a new module.

Plug-in modules defining and/or modifying ombudsman functionality can be associated with compliance levels, as described above, where the compliance level of a module may be attested to by trusted third parties, such as a government agency, a security organization, and/or an entity that owns technology that facilitates functionality associated with the compliance, including but not limited to evaluation of royalty payments and/or tax payments. Where two plug-ins are combined and/or one is modified by parameter choices, the result is automatically evaluated in terms of the resulting compliance, based on what functionality is selected and/or given priority for functionality that is required for compliance.

In a few embodiments, an ombudsman may advertise at least some of the policies it supports and/or enforces to third parties such as potential parties in transactions. For example, an ombudsman representing a tentative seller of an NFT may specify a clawback policy associated with the seller and the ombudsman of the seller, to the buyer and/or the ombudsman of the buyer. When this policy is not acceptable to the other side, i.e., the buyer in this example, then the transaction can be blocked and will not be performed without explicit user approval. The advertisement of supported and enforced policies of the ombudsman can be expressed in a message that is formatted to comply with the OML (Ombudsman Markup Language) described above.

While specific processes and structures are described above with reference to FIG. 47, systems governing content access can be implemented in any of a number of different ways to enable as appropriate to the requirements of specific applications in accordance with certain embodiments of the invention. Additionally, the specific manner in which content configurations can be utilized within NFT platforms in accordance with numerous embodiments of the invention is largely dependent upon the requirements of a given application.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

What is claimed is:

1. A method for content security, the method comprising:
receiving a request from a requesting party, wherein the request includes:
information about a transaction to be performed,
a reference to a token corresponding to the transaction, and
an address of a receiving party corresponding to the transaction;
recovering, from a smart contract associated with the token, at least one address list, wherein:
the at least one address list comprises a token banlist; and
the token banlist comprises at least one address banned from receiving the token;
determining whether the address of the receiving party is listed on the token banlist; and
when the address of the receiving party is listed on the token banlist, transmitting a transaction rejection to the requesting party.

2. The method of claim 1, wherein:
the at least one address list further comprises a token allowlist; and
the token allowlist comprises at least one address approved for receiving the token.

3. The method of claim 2, further comprising determining whether the address of the receiving party is listed on the token allowlist.

4. The method of claim 3, further comprising, when the address of the receiving party is listed on the token allowlist:
transmitting an approval to the requesting party; and
allowing token access to at least one of the requesting party and the receiving party.

5. The method of claim 3, further comprising: when the address of the receiving party is not listed on the token allowlist and the token allowlist, making an independent determination of whether to approve the transaction.

6. The method of claim 5, wherein making the independent determination comprises transmitting the request to an external authority, wherein the external authority is at least one selected from the group consisting of an owner of the smart contract, a marketplace administrator, and an agent of the owner of the smart contract.

7. The method of claim 5, wherein making the independent determination comprises reviewing a record of the receiving party for paying token royalty rates.

8. The method of claim 5, further comprising, adding the address of the receiving party to at least one of the token banlist and the token allowlist, based on the independent determination.

9. The method of claim 1, wherein:
the transaction is selected from the group consisting of a self-dealing transaction and a transfer transaction;
the self-dealing transaction:
is a transaction where the requesting party is also the receiving party; and
is at least one selected from the group consisting of:
a minting of the token;
a derivation of the token; and
an importation of the token, wherein the requesting party is a token marketplace; and
the transfer transaction is a transaction wherein the requesting party is an owner of the token, and the receiving party is a consumer of the token.

10. The method of claim 1, wherein the token banlist comprises a registry of token marketplaces known to ignore enforcement of royalty payments.

11. A non-transitory computer-readable medium for content security, wherein the program instructions are executable by one or more processors to perform a process that comprises:
receiving a request from a requesting party, wherein the request includes:
information about a transaction to be performed;
a reference to a token corresponding to the transaction; and
an address of a receiving party corresponding to the transaction;
recovering, from a smart contract associated with the token, at least one address list, wherein:
the at least one address list comprises a token banlist; and
the token banlist comprises at least one address banned from receiving the token;
determining whether the address of the receiving party is listed on the token banlist; and
when the address of the receiving party is listed on the token banlist, transmitting a transaction rejection to the requesting party.

12. The non-transitory computer-readable medium of claim 11, wherein:
the at least one address list further comprises a token allowlist; and
the token allowlist comprises at least one address approved for receiving the token.

13. The non-transitory computer-readable medium of claim 12, further comprising determining whether the address of the receiving party is listed on the token allowlist.

14. The non-transitory computer-readable medium of claim 13, further comprising, when the address of the receiving party is listed on the token allowlist:
transmitting an approval to the requesting party; and
allowing token access to at least one of the requesting party and the receiving party.

15. The non-transitory computer-readable medium of claim 13, further comprising: when the address of the receiving party is not listed on the token allowlist and the token allowlist, making an independent determination of whether to approve the transaction.

16. The non-transitory computer-readable medium of claim 15, wherein making the independent determination comprises transmitting the request to an external authority, wherein the external authority is at least one selected from the group consisting of an owner of the smart contract, a marketplace administrator, and an agent of the owner of the smart contract.

17. The non-transitory computer-readable medium of claim 15, wherein making the independent determination comprises reviewing a record of the receiving party for paying token royalty rates.

18. The non-transitory computer-readable medium of claim 15, further comprising, adding the address of the receiving party to at least one of the token banlist and the token allowlist, based on the independent determination.

19. The non-transitory computer-readable medium of claim 11, wherein:
the transaction is selected from the group consisting of a self-dealing transaction and a transfer transaction;
the self-dealing transaction:
is a transaction where the requesting party is also the receiving party; and
is at least one selected from the group consisting of:
a minting of the token;
a derivation of the token; and
an importation of the token, wherein the requesting party is a token marketplace; and
the transfer transaction is a transaction wherein the requesting party is an owner of the token, and the receiving party is a consumer of the token.

20. The non-transitory computer-readable medium of claim 11, wherein the token banlist comprises a registry of token marketplaces known to ignore the enforcement of royalty payments.
